(19) United States
(12) Patent Application Publication
(10) Pub. No.: US 2013/0024371 A1
(43) Pub. Date: Jan. 24, 2013

(54) ELECTRONIC OFFER OPTIMIZATION AND REDEMPTION APPARATUSES, METHODS AND SYSTEMS

(71) Applicants: PRAKASH HARIRAMANI, San Francisco, CA (US); Mark Carlson, Half Moon Bay, CA (US)

(72) Inventors: PRAKASH HARIRAMANI, San Francisco, CA (US); Mark Carlson, Half Moon Bay, CA (US)

(21) Appl. No.: 13/629,006

(22) Filed: Sep. 27, 2012

Related U.S. Application Data
(63) Continuation-in-part of application No. 13/520,481.
Application No. 13/520,481 is a continuation-in-part of application No. 13/348,634, filed on Jan. 11, 2012.
Application No. 13/348,634 is a continuation-in-part of application No. 13/398,817, filed on Feb. 16, 2012.
(60) Provisional application No. 61/539,969, filed on Sep. 27, 2011.
(60) Provisional application No. 61/665,220, filed on Jun. 27, 2012.
(60) Provisional application No. 61/445,482, filed on Feb. 22, 2011.
(60) Provisional application No. 61/466,409, filed on Mar. 22, 2011.
(60) Provisional application No. 61/469,965, filed on Mar. 31, 2011.
(60) Provisional application No. 61/473,728, filed on Apr. 8, 2011.
(60) Provisional application No. 61/538,761, filed on Sep. 23, 2011.
(60) Provisional application No. 61/545,971, filed on Oct. 11, 2011.
(60) Provisional application No. 61/539,969, filed on Sep. 27, 2011.

(51) Int. Cl. G06Q 20/36

(52) U.S. Cl. 705/41

(57) ABSTRACT

The ELECTRONIC OFFER OPTIMIZATION AND REDEMPTION APPARATUSES, METHODS AND SYSTEMS (“EOOR”) transform payment card information, user payment card selection preference, and purchase inputs via EOOR components into card addition completion. In one implementation the EOOR performs a method, comprising: receiving a purchase order request via a consumer wallet device; determining a wallet account identifier from the purchase order request; determining a merchant from the purchase order request; retrieving a payment card identifier of at least one payment card associated with the wallet account identifier; generating an offer data query on the payment card identifier; executing the offer data query and retrieving offer data; obtaining user payment card and offer selection preference data; determining an optimized payment card and offer selection based on the user payment card and offer selection preference data; and executing a payment transaction using the optimized payment card and offer selection in response to the purchase order request.

### PRIORITY CLAIM

This application claims priority under 35 USC §119 to: U.S. provisional patent application Ser. No. 61/539,969 filed Sep. 27, 2011, entitled “Apparatuses, Methods, And Systems For Finding, Storing, And Applying Discounts For Use In An Electronic Transaction,” attorney docket no. 110US01|20270-197PV and U.S. provisional patent application Ser. No. 61/665,220, filed Jun. 27, 2012, entitled “Payment Card and Coupon Optimization Apparatuses, Methods, And Systems,” attorney docket no. P-42182PRV|20270-146PV.

This application is also a continuation-in-part of, and claims priority under 35 U.S.C. §§120, 365 to United States nonprovisional patent application Ser. No. 13/520,481, filed Jul. 3, 2012, entitled “Universal Electronic Payment Apparatuses, Methods and Systems,” attorney docket no. P-42051US02|20270-136US, which is a National Stage Entry entitled to, and claims priority under 35 U.S.C. §§365, 371 corresponding to, PCT application no. PCT/US12/26205, filed Feb. 22, 2012, entitled “Universal Electronic Payment Apparatuses, Methods And Systems,” attorney docket no. P-42051WO01|20270-136PC, which in turn claims priority under 35 USC §119 to: U.S. provisional patent application Ser. No. 61/445,482 filed Feb. 22, 2011, entitled “Universal Electronic Payment Apparatuses, Methods And Systems,” attorney docket no. P-42051PRV|20270-136PV; United States provisional patent application Ser. No. 61/545,971 filed Oct. 11, 2011, entitled “Universal Electronic Payment Apparatuses, Methods And Systems,” attorney docket no. P-42051US01|20270-136PV1; U.S. provisional patent application Ser. No. 61/473,728 filed Apr. 8, 2011, entitled “Apparatuses, Methods And Systems For An Application Integration Payment Platform,” attorney docket no. P-42189PRV|20270-147PV; U.S. provisional patent application Ser. No. 61/466,409 filed Mar. 22, 2011, entitled “Electronic Wallet,” attorney docket no. P-41963PRV|20270-148PV; U.S. provisional patent application Ser. No. 61/469,965 filed Mar. 31, 2011, entitled “Apparatuses, Methods And Systems For A Targeted Acceptance Platform,” attorney docket no. P-41838PRV|20270-062PV; and U.S. provisional patent application Ser. No. 61/538,761 filed Sep. 23, 2011, entitled “Electronic Wallet Transaction Consumer Leash Apparatuses, Methods And Systems,” attorney docket no. 93US01|20270-194PV.

PCT application no. PCT/US12/26205 is also a continuation-in-part of, and claims priority under 35 U.S.C. §§120, 365 to: United States nonprovisional patent application Ser. No. 13/398,817 filed Feb. 16, 2012, entitled “Snap Mobile Payment Apparatuses, Methods And Systems,” attorney docket no. P-42032US001|20270-127US; and United States nonprovisional patent application Ser. No. 13/348,634 filed Jan. 11, 2012, entitled “Universal Value Exchange Apparatuses, Methods And Systems,” attorney docket no. P-41948US01|20270-089US.

This application is related to PCT international patent application Ser. No. ______, filed Sep. 27, 2012, entitled “ELECTRONIC OFFER OPTIMIZATION AND REDEMPTION Apparatuses, Methods And Systems,” attorney docket no. 110WO001|20270-197PC.

The entire contents of the aforementioned applications are expressly incorporated by reference herein.

This patent for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations generally address apparatuses, methods, and systems for electronic commerce, and more particularly, include ELECTRONIC OFFER OPTIMIZATION AND REDEMPTION APPARATUSES, METHODS AND SYSTEMS (“EOOR”).

### BACKGROUND

Payment card companies offer payment cards with different terms, features, and/or rewards. Consumers may own multiple payment cards to purchase products and make payments to merchants. Consumers may also use coupons in order to get a discount on a purchase.

Consumer transactions requires a customer to select a product from a store shelf or website, and then to check the out at a checkout counter or webpage. Product information is selected from a webpage catalog or entered into a point-of-sale terminal device, or the information is entered automatically by scanning an item barcode with an integrated barcode scanner. The customer is usually provided with a number of payment options, such as cash, check, credit card or debit card. Once payment is made and approved, the point-of-sale terminal memorializes the transaction in the merchant's computer system, and a receipt is generated indicating the satisfactory consummation of the transaction.

### BRIEF DESCRIPTION OF THE DRAWINGS

The accompanying appendices and/or drawings illustrate various non-limiting, example, inventive aspects in accordance with the present disclosure:

FIGS. 1A-1B show block diagrams illustrating example aspects of payment card optimization in some embodiments of the EOOR;

FIG. 2 shows a datagraph diagram illustrating examples of transforming payment card information and user card selection preference inputs via a EOOR new card component into new card addition completion outputs;

FIG. 3 shows a logic flow diagram illustrating examples of transforming payment card information and user card selection preference inputs via a EOOR new card component into new card addition completion outputs;

FIGS. 4A-4B show screen shot diagrams illustrating example user interface(s) of a EOOR card selector component;

FIGS. 5A-5B shows datagraph diagrams illustrating examples of transforming purchase inputs via a EOOR card selector component into purchase transactions using optimized payment card and coupon outputs;

FIGS. 6A-6B show logic flow diagrams illustrating examples of transforming purchase inputs via a EOOR card selector component into purchase transactions using optimized payment card and coupon outputs;

FIG. 6C shows a diagram illustrating examples of the EOOR card selector component.

FIGS. 7A-7B shows a datagraph diagram illustrating examples of transforming purchase inputs via a EOOR coupon selector component into purchase transaction with optimized discounts outputs;

FIG. 8 hows a logic flow diagram illustrating example aspects of capturing customer card information and transforming that information into a discount applied to a transaction at the point of sale in some embodiments of the EOOR, e.g., a EOOR Coupon Selector component;

FIGS. 9A-9C show screen shots illustrating example user interface(s) of a EOOR coupon selector component and a EOOR card selector component;

FIGS. 10A-10H illustrate alternative embodiments of portions of a user interface for the secure digital wallet within embodiments of the EOOR;

FIG. 11 shows a block diagram illustrating example aspects of virtual mobile wallet purchasing in some embodiments of the EOOR;

FIGS. 12A-B show user interface diagrams illustrating example aspects of a shopping mode of a virtual wallet application in some embodiments of the EOOR;

FIGS. 13A-C show user interface diagrams illustrating example aspects of a discovery shopping mode of a virtual wallet application in some embodiments of the EOOR;

FIGS. 14A-B show user interface diagrams illustrating example aspects of a shopping cart mode of a virtual wallet application in some embodiments of the EOOR;

FIG. 15 shows a user interface diagram illustrating example aspects of a bill payment mode of a virtual wallet application in some embodiments of the EOOR;

FIGS. 16A-B show user interface diagrams illustrating example aspects of a (local proximity) merchant shopping mode of a virtual wallet application in some embodiments of the EOOR;

FIG. 17 shows user interface diagrams illustrating example aspects of allocating funds for a purchase payment within a virtual wallet application in some embodiments of the EOOR;

FIG. 18 shows user interface diagrams illustrating example aspects of selecting payees for funds transfers within a virtual wallet application in some embodiments of the EOOR;

FIGS. 19A-B show user interface diagrams illustrating example additional aspects of the virtual wallet application in some embodiments of the EOOR;

FIGS. 20A-B show user interface diagrams illustrating example aspects of a history mode of a virtual wallet application in some embodiments of the EOOR;

FIGS. 21A-C show user interface and logic flow diagrams illustrating example aspects of creating a user shopping trail within a virtual wallet application and associated revenue sharing scheme in some embodiments of the EOOR;

FIGS. 22A-I show user interface and logic flow diagrams illustrating example aspects of a snap mode of a virtual wallet application in some embodiments of the EOOR;

FIGS. 23A-B show user interface and logic flow diagrams illustrating example aspects of an offers mode of a virtual wallet application in some embodiments of the EOOR;

FIG. 24 shows user interface diagrams illustrating example aspects of a general settings mode of a virtual wallet application in some embodiments of the EOOR;

FIG. 25 shows a user interface diagram illustrating example aspects of a wallet bonds settings mode of a virtual wallet application in some embodiments of the EOOR;

FIGS. 26A-C show user interface diagrams illustrating example aspects of a purchase controls settings mode of a virtual wallet application in some embodiments of the EOOR;

FIGS. 27A-C show logic flow diagrams illustrating example aspects of configuring virtual wallet application settings and implementing purchase controls settings in some embodiments of the EOOR;

FIG. 28 shows a block diagram illustrating example aspects of a centralized personal information platform in some embodiments of the EOOR;

FIGS. 29A-F show block diagrams illustrating example aspects of data models within a centralized personal information platform in some embodiments of the EOOR;

FIG. 30 shows a block diagram illustrating example EOOR component configurations in some embodiments of the EOOR;

FIG. 31 shows a data flow diagram illustrating an example search result aggregation procedure in some embodiments of the EOOR;

FIG. 32 shows a logic flow diagram illustrating example aspects of aggregating search results in some embodiments of the EOOR, e.g., a Search Results Aggregation (“SRA”) component 2200;

FIGS. 33A-D show data flow diagrams illustrating an example card-based transaction execution procedure in some embodiments of the EOOR;

FIGS. 34A-E show logic flow diagrams illustrating example aspects of card-based transaction execution, resulting in generation of card-based transaction data and service usage data, in some embodiments of the EOOR, e.g., a Card-Based Transaction Execution (“CTE”) component 2400;

FIG. 35 shows a data flow diagram illustrating an example procedure to aggregate card-based transaction data in some embodiments of the EOOR;

FIG. 36 shows a logic flow diagram illustrating example aspects of aggregating card-based transaction data in some embodiments of the EOOR, e.g., a Transaction Data Aggregation (“TDA”) component 2600;

FIG. 37 shows a data flow diagram illustrating an example social data aggregation procedure in some embodiments of the EOOR;

FIG. 38 shows a logic flow diagram illustrating example aspects of aggregating social data in some embodiments of the EOOR, e.g., a Social Data Aggregation (“SDA”) component 2800;

FIG. 39 shows a data flow diagram illustrating an example procedure for enrollment in value-add services in some embodiments of the EOOR;

FIG. 40 shows a logic flow diagram illustrating example aspects of social network payment authentication enrollment in some embodiments of the EOOR, e.g., a Value-Add Service Enrollment (“VASE”) component 3000;

FIGS. 41A-B show flow diagrams illustrating example aspects of normalizing aggregated search, enrolled, service usage, transaction and/or other aggregated data into a standardized data format in some embodiments of the EOOR, e.g., a Aggregated Data Record Normalization (“ADRN”) component 3100;

FIG. 42 shows a logic flow diagram illustrating example aspects of recognizing data fields in normalized aggregated data records in some embodiments of the EOOR, e.g., a Data Field Recognition (“DFR”) component 3200;

FIG. 43 shows a logic flow diagram illustrating example aspects of classifying entity types in some embodiments of the EOOR, e.g., an Entity Type Classification (“ETC”) component 3300;

FIG. 44 shows a logic flow diagram illustrating example aspects of identifying cross-entity correlation in some embodiments of the EOOR, e.g., a Cross-Entity Correlation (“CEC”) component 3400;

FIG. 45 shows a logic flow diagram illustrating example aspects of associating attributes to entities in some embodiments of the EOOR, e.g., an Entity Attribute Association (“EAA”) component 3500;

FIG. 46 shows a logic flow diagram illustrating example aspects of updating entity profile-graphs in some embodiments of the EOOR, e.g., an Entity Profile-Graph Updating (“EPGU”) component 3600;

FIG. 47 shows a logic flow diagram illustrating example aspects of generating search terms for profile-graph updating in some embodiments of the EOOR, e.g., a Search Term Generation (“STG”) component 3700;

FIG. 48 shows a logic flow diagram illustrating example aspects of analyzing a user's behavior based on aggregated purchase transaction data in some embodiments of the EOOR, e.g., a User Behavior Analysis (“UBA”) component 3800;

FIG. 49 shows a logic flow diagram illustrating example aspects of generating recommendations for a user based on the user's prior aggregate purchase transaction behavior in some embodiments of the EOOR, e.g., a User Behavior-Based Offer Recommendations (“UBOR”) component 3900;

FIG. 50 shows a block diagram illustrating example aspects of payment transactions via social networks in some embodiments of the EOOR;

FIG. 51 shows a data flow diagram illustrating an example social pay enrollment procedure in some embodiments of the EOOR;

FIG. 52 shows a logic flow diagram illustrating example aspects of social pay enrollment in some embodiments of the EOOR, e.g., a Social Pay Enrollment (“SPE”) component 4200;

FIGS. 53A-C show data flow diagrams illustrating an example social payment triggering procedure in some embodiments of the EOOR;

FIGS. 54A-C show logic flow diagrams illustrating example aspects of social payment triggering in some embodiments of the EOOR, e.g., a Social Payment Triggering (“SPT”) component 4400;

FIGS. 55A-B show logic flow diagrams illustrating example aspects of implementing wallet security and settings in some embodiments of the EOOR, e.g., a Something (“WSS”) component 4500;

FIG. 56 shows a data flow diagram illustrating an example social merchant consumer bridging procedure in some embodiments of the EOOR;

FIG. 57 shows a logic flow diagram illustrating example aspects of social merchant consumer bridging in some embodiments of the EOOR, e.g., a Social Merchant Consumer Bridging (“SMCB”) component 4700;

FIG. 58 shows a user interface diagram illustrating an overview of example features of virtual wallet applications in some embodiments of the EOOR;

FIGS. 59A-G show user interface diagrams illustrating example features of virtual wallet applications in a shopping mode, in some embodiments of the EOOR;

FIGS. 60A-F show user interface diagrams illustrating example features of virtual wallet applications in a payment mode, in some embodiments of the EOOR;

FIG. 61 shows a user interface diagram illustrating example features of virtual wallet applications, in a history mode, in some embodiments of the EOOR;

FIGS. 62A-E show user interface diagrams illustrating example features of virtual wallet applications in a snap mode, in some embodiments of the EOOR;

FIG. 63 shows a user interface diagram illustrating example features of virtual wallet applications, in an offers mode, in some embodiments of the EOOR;

FIGS. 64A-B show user interface diagrams illustrating example features of virtual wallet applications, in a security and privacy mode, in some embodiments of the EOOR;

FIG. 65 shows a data flow diagram illustrating an example user purchase checkout procedure in some embodiments of the EOOR;

FIG. 66 shows a logic flow diagram illustrating example aspects of a user purchase checkout in some embodiments of the EOOR, e.g., a User Purchase Checkout (“UPC”) component 6600;

FIGS. 67A-B show data flow diagrams illustrating an example purchase transaction authorization procedure in some embodiments of the EOOR;

FIGS. 68A-B show logic flow diagrams illustrating example aspects of purchase transaction authorization in some embodiments of the EOOR, e.g., a Purchase Transaction Authorization (“PTA”) component 6800;

FIGS. 69A-B show data flow diagrams illustrating an example purchase transaction clearance procedure in some embodiments of the EOOR;

FIGS. 70A-B show logic flow diagrams illustrating example aspects of purchase transaction clearance in some embodiments of the EOOR, e.g., a Purchase Transaction Clearance (“PTC”) component 7000; and

FIG. 71 shows a block diagram illustrating embodiments of a EOOR controller.

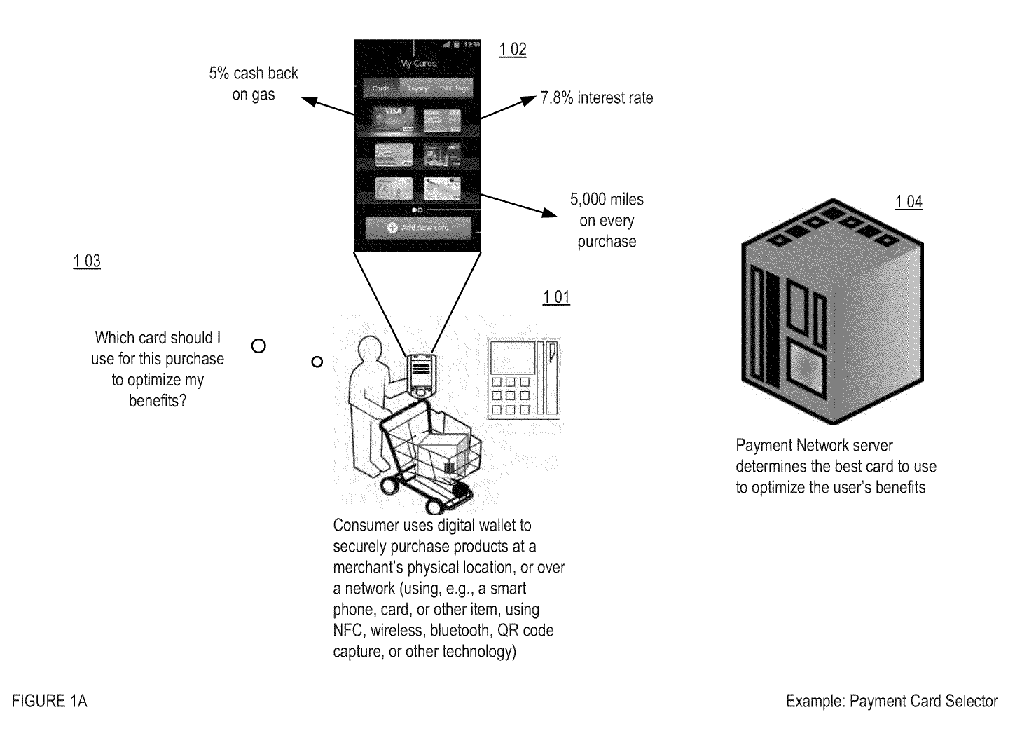

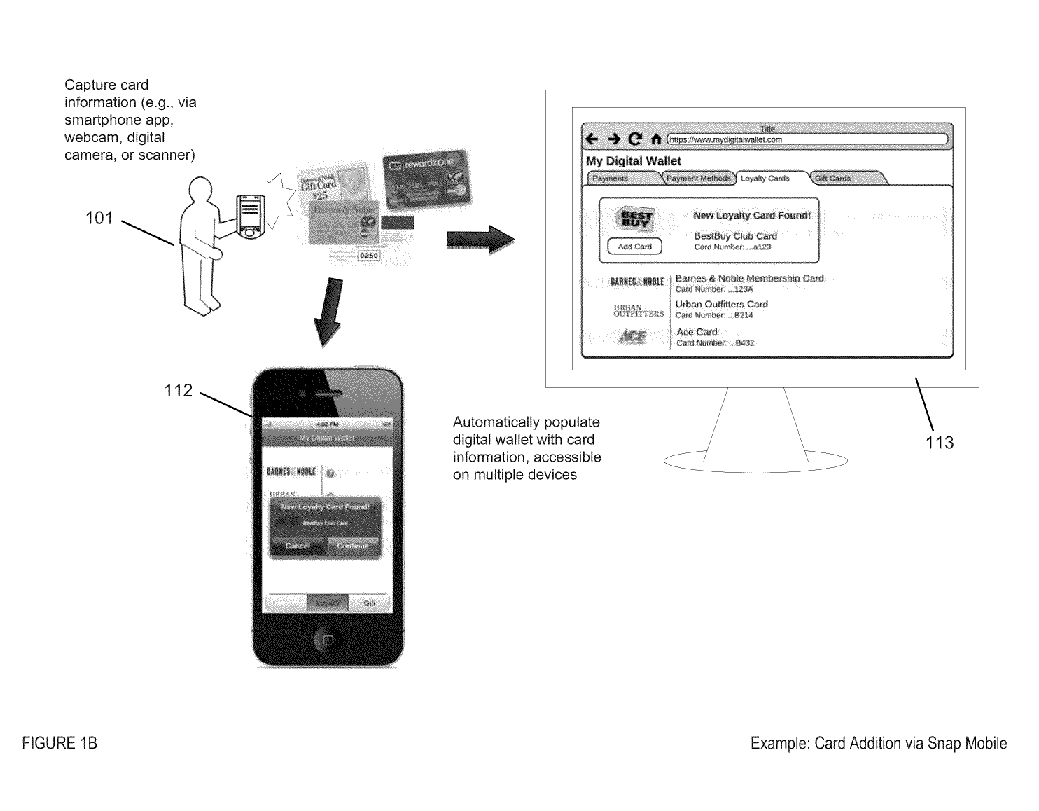

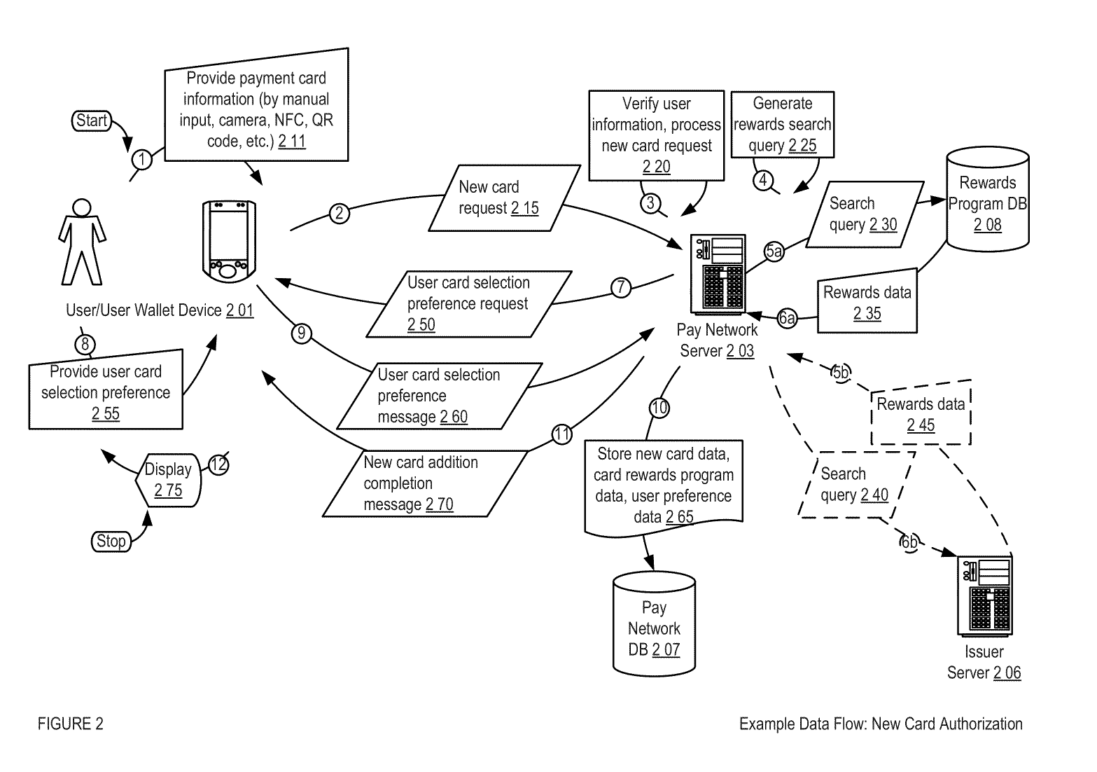

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### Electronic Offer Optimization and Redemption (EOOR)

The ELECTRONIC OFFER OPTIMIZATION AND REDEMPTION APPARATUSES, METHODS AND SYSTEMS (hereinafter “EOOR”) transform payment card information, user card selection preference, and purchase inputs, via EOOR components, into card addition completion, and purchase transactions using optimized payment card and coupon outputs.

For example, a consumer may enroll with an electronic wallet service (e.g., Visa V-Wallet) by creating an e-wallet account and adding a payment account to the e-wallet (e.g., a credit card, a debit card, a PayPal account, etc.). In one implementation, the consumer may fill in information such as but not limited to the card number, bank routing number, CCV code, and/or the like in order to submit a wallet enrollment request. In another implementation, the consumer may operate a camera-enabled mobile device to snap a picture of the payment card, and submit it to EOOR, which may in turn process the received card image and obtain card information for consumer card enrollment.

As another example, the EOOR may generate an optimized card selection for purchasing an item. For example, different payment cards may have different offers/rewards for card usage, e.g. mileage, cash back, additional purchase discounts based on category of purchased items and/or a merchant, etc. A consumer may desire to use the payment card that could optimize his benefits when he makes the purchase with a selected card. In one implementation, the EOOR may recommend a payment card for a particular purchase to optimize the consumer's benefits.

Integration of an electronic wallet, a desktop application, a plug-in to existing applications, a standalone mobile application, a web based application, a smart prepaid card, and/or the like in capturing payment transaction related objects such as purchase labels, payment cards, barcodes, receipts, and/or the like reduces the number of network transactions and messages that fulfill a transaction payment initiation and procurement of payment information (e.g., the consumer does not need to walk to a bank branch, call a bank customer service, or manually type in required card information for a card enrollment, and/or the like). In this way, with the reduction of network communications, the number of transactions that may be processed per day is increased, i.e., processing efficiency is improved. By providing the direct mechanism which to provide offers to consumers, by engaging and having offers optimized for consumers, statistics may be provided to merchants and/or issuers regarding the efficacy in usage of such offers, which will reduce spam offers that may waste bandwidth, storage, and/or otherwise render the offer usage untargeted, undirected, inefficient and ineffective.

It should be noted that although a mobile platform is depicted, a digital/electronic wallet, a smart/prepaid card linked to a user's various payment accounts, and/or other payment platforms are contemplated embodiments as well; as such, subset and superset features and data sets of each or a combination of the aforementioned payment platforms may be accessed, modified, provided, stored, etc. via cloud/server services (e.g., via web, app, and/or the like interfaces, etc.) and a number of varying client devices throughout the instant specification. Similarly, although mobile wallet user interface elements are depicted, alternative and/or complementary user interfaces are also contemplated including: desktop applications, plug-ins to existing applications, stand alone mobile applications, web based applications (e.g., applications with web objects/frames, HTML 5 applications/wrappers, web pages, etc.), a voice interface (e.g., Apple Siri, Samsung S Voice, Google Voice, etc.) and other interfaces are contemplated. It should be further noted that the EOOR payment processing component may be integrated with an digital/electronic wallet (e.g., a Visa V-Wallet, etc.), comprise a separate stand alone component instantiated on a user device, comprise a server/cloud accessed component, be loaded on a smart/prepaid card that can be substantiated at a PoS terminal, an ATM, a kiosk, etc., which may be accessed through a physical card proxy, and/or the like. In this way, the EOOR reduces redundant information exchange and communication messages between consumers and an issuing bank, and thus improves network transmission and processing efficiency.

FIG. 1A shows a block diagram illustrating example aspects of payment card optimization in some embodiments of the EOOR. In some embodiments, a consumer may use digital wallet to securely purchase products at a merchant's physical location, or over a network, using a smart phone, payment card, or other item, e.g., using NFC, wireless, Bluetooth, QR code capture and/or other technology 101. The consumer may own multiple payment cards (e.g., credit cards, debit cards, and/or the like) 102. Each payment card may offer different contractual terms, features, reward programs, and/or the like. For example, one payment card may offer 5% cash back on every gasoline purchase, and 1% cash back on purchases made on everything else. One payment card may offer 7.8% interest rate for 5 years. One payment card may offer 5000 flight miles on every purchase. One payment car may offer preferable contractual terms, e.g., insurance, security, and/or the like. The consumer may desire to use the payment card that could optimize his benefits 103 when he makes this specific purchase. For example, if the consumer makes a purchase on electronic products, he may want to use the payment card which offers features favorable to electronic products. In some embodiments, the Payment Network server of the EOOR may determine the best card to use for a particular purchase to optimize the consumer's benefits 104.

In some embodiments, the EOOR may allow Pay Network server to determine the routing and selection of all cards for a consumer that are optimal for the Pay Network server, the consumer, the merchant or the Issuer. In some embodiments, a customer may register several cards with EOOR. Payment cards may be associated with either a wallet account, or a pseudo Permanent Account Number (“PAN”). In some embodiments, the pseudo PAN may be assigned if a consumer doesn't have a payment card to associate other cards with. The consumer may make a payment at a traditional Point Of Sale device using the master Pan.

In some embodiments, the payment could initiated by the actual master card, or be a special card with the pseudo Pan, or a smart phone, or any mechanism that could pass the desired PAN. The pseudo PAN may be a static or dynamic pseudo Pan. In some embodiments, the Master Pan may be processed to the Pay Network server, so all upstream Bin tables may point at the Pay Network server.

In some embodiments, after the swipe, contact, NFC, and/or the like, the payment arrives at the Pay Network server. Once at the Pay Network server, the Pay Network server may determine the optimal card to use. Selection of the optimal card may be weighted to benefit any party, e.g., what is best for the customer, what is best for the merchant, what is best for the issuer, what is best for the Pay Network server, and/or the like.

In some embodiments, once the determination is made, the master pan may be replaced with the optimal pan and the transaction may be routed accordingly. In some embodiments, when the response is received, the master pan may be substituted back in.

In some embodiments, if the payment is declined, and time remains, a second pan may be tried.

In some embodiments, at payment time, a consumer may make a payment using their mobile device, e.g., NFC chip on their phone. In some embodiments, the phone may be preloaded with several cards, with different brands, and/or different loyalty programs. An application on the phone (or working in conjunction with a backend system) may recognize the merchant the consumer is doing business with, via, for example, Geo coordinates, camera scan, listening, and/or the like.

In some embodiments, once the merchant is recognized the service may select the optimal card for the consumer to make the purchase. Optimization may be any combination of factors, e.g., customer preferences, balance on cards, loyalty programs, gas pays more on one card than another, relationship of the merchant to the issuer, and/or the like.

As shown in FIG. 1B, a user 101 may capture an image of a customer card, including customer card information, using an image-capturing device, such as a smart phone with a built-in camera, a computer with a webcam, a stand-alone digital camera, a scanner, or any other suitable device or combination of devices capable of capturing and transmitting an image. User 101 initiates Coupon Keeper by capturing an image of customer information. In one embodiment, user 101 captures the information found on a customer loyalty card, a gift card, or any other type of closed-loop card. In one embodiment, user 101 captures an image of both the front and the back of the card.

After the image has been captured, Coupon Keeper processes the captured information. In one implementation, this is accomplished by performing an optical character recognition (OCR) scan on the image to extract customer information. Coupon Keeper may also determine the characteristics of any images on the card and compare the images to known images in a database. In one exemplary embodiment, Coupon Keeper may access a database of logos of merchants to determine which merchant issued the card.

Once the information has been extracted and processed from the image, Coupon Keeper stores the information in a secure profile for user 101. Authorization by the user may be required before extracted information can be stored in the secure profile. In one implementation, this authorization can be accomplished by using a trusted device, such as a smart phone or computer previously registered to the user. In another implementation, the authorization may be accomplished by requiring the user to enter a user name and password at the appropriate time.

Once the extracted information has been stored in the secure profile, the user will then be able to access and use the information using a secure digital wallet, accessible to the user on any number of devices capable of connecting to the Internet. As shown in FIG. 1B, such devices may include a smart phone 112, and a desktop computer 113, but any suitable device may also be used to access the secure digital wallet.

FIG. 2 shows a datagraph diagram illustrating examples of transforming payment card information and user card selection preference inputs via a EOOR new card component into new card addition completion outputs. In some embodiments, a user 201 may, via a user wallet device (e.g., mobile phone, or a computer wallet interface, and/or the like), provide new payment card information. It may be provided by manual input the card information (e.g., new card number, expiration date, etc.), by image capture via camera and using Optical Character Recognition (OCR) to identify text strings of the new card, by identifying payload information via QR code, by transmitting data via New Field Communication (NFC), wireless, or Bluetooth, and/or the like 211. Exemplary OCR procedure packages may include, but not limited to Java OCR, Microsoft Office Document Imaging, Microsoft Office OneNote 2007, OCRopus, OCRFeeder, OmniPage, ReadSoft, New OCR, and/or the like. In one implementation, the consumer device 201 may perform the OCR procedure to obtain card information and form a new card request sent 215 from the user wallet device to EOOR server (e.g., the Pay Network server) 203. For example, the user wallet device may provide a (Secure) Hypertext Transfer Protocol (HTTP(S)) POST message including data formatted according to the eXtensible Markup Language (XML). For example, new card request 215 may be an HTTP(S) POST message similar to the message shown below:

POST /requestcardinfo.php HTTP/1.1
Host: www.issuer.com
Content-Type: Application/XML
Content-Length: 788
<?XML version = “1.0” encoding = “UTF-8”?>
<new_card_request>

<request_ID>CNI4ICNW2</request_ID>
<user_ID>john.q.public@gmail.com</user_ID>
<wallet_ID> jqp_wallet001 </wallet_id>
<wallet_certificate> \hat{ }&%$DGSYA </wallet_certificate>
<wallet_password_login> qwe34520-& </wallet_password_login>
<client_ details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<card_info>

<account_name>John Q. Public</account_name>
<account_type>visa</account_type>
<account_num>9786543212345678</account_num>
<expiration_date>12-01-2017</expiration_date>
<wallet_id>73427-34</wallet_id>

</card_info>

</new_card_request>

Alternatively, the OCR procedure to obtain card information may be performed at the Pay Network server 203 (and/or other servers) to improve client end processing efficiency, e.g., the user 201 may capture an image of the card, and send the card image to the Pay Network server 203 in a new card request message 215. For example, an exemplary HTTPS POST new card request 215 may be substantially in the form of XML, as provided below:

POST /requestcardinfo.php HTTP/1.1
Host: www.issuer.com
Content-Type: Application/XML
Content-Length: 788
<?XML version = “1.0” encoding = “UTF-8”?>
<new_card_request>

<request_ID>CNI4ICNW2</request_ID>
<user_ID>john.q.public@gmail.com</user_ID>
<wallet_ID> jqp_wallet001 </wallet_id>
<wallet_certificate> \hat{ }&%$DGSYA </wallet_certificate>
<wallet_password_login> qwe34520-& </wallet_password_login>
<client_details>

<client_IP>192.168.23.126</client_IP>
<client_type>smartphone</client_type>
<client_model>HTC Hero</client_model>
<OS>Android 2.2</OS>
<app_installed_flag>true</app_installed_flag>

</client_details>
<request_type> add card </request_type>
<card_info>

<type> image </type>
<image_info>

<name> mycard </name>
<format> JPEG </format>
<compression> JPEG compression </compression>
<size> 123456 bytes </size>
<x-Resolution> 72.0 </x-Resolution>
<y-Resolution> 72.0 </y-Resolution>
<date_time> 2014:8:11 16:45:32 </date_time>
...
<content> ÿØÿà [symbol] JFIF H H ÿâ\acute{ }ICC_PROFILE ¤appl_{┐}

[symbol]

mntrRGB XYZ •Ü !! $ acspAPPL öÖÓ-appl [symbol]
desc P bdscm \acute{ } \check{S}cprt ^{└}@ $wtpt ^{└}d ¶rXYZ ^{└}x ¶gXYZ ^{└} [symbol]
¶bXYZ ^{└} ¶rTRC ^{└}\acute{ } [symbol] aarg À vcgt ...

</content>

...
</image_info>

</card_info>
...</new_card_request>

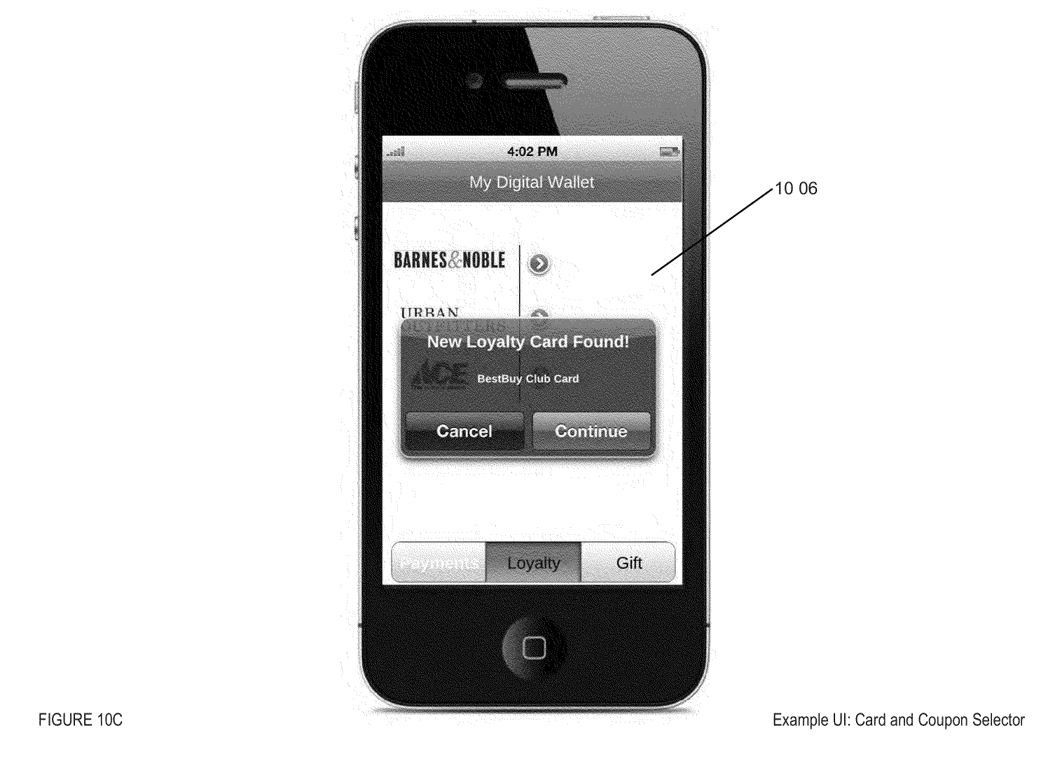

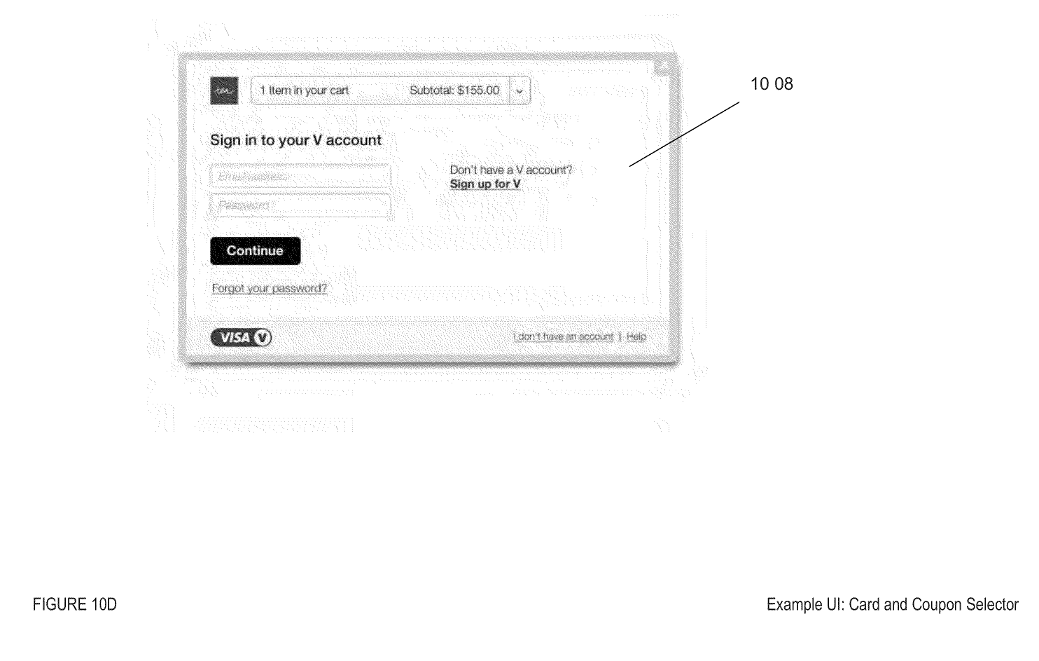

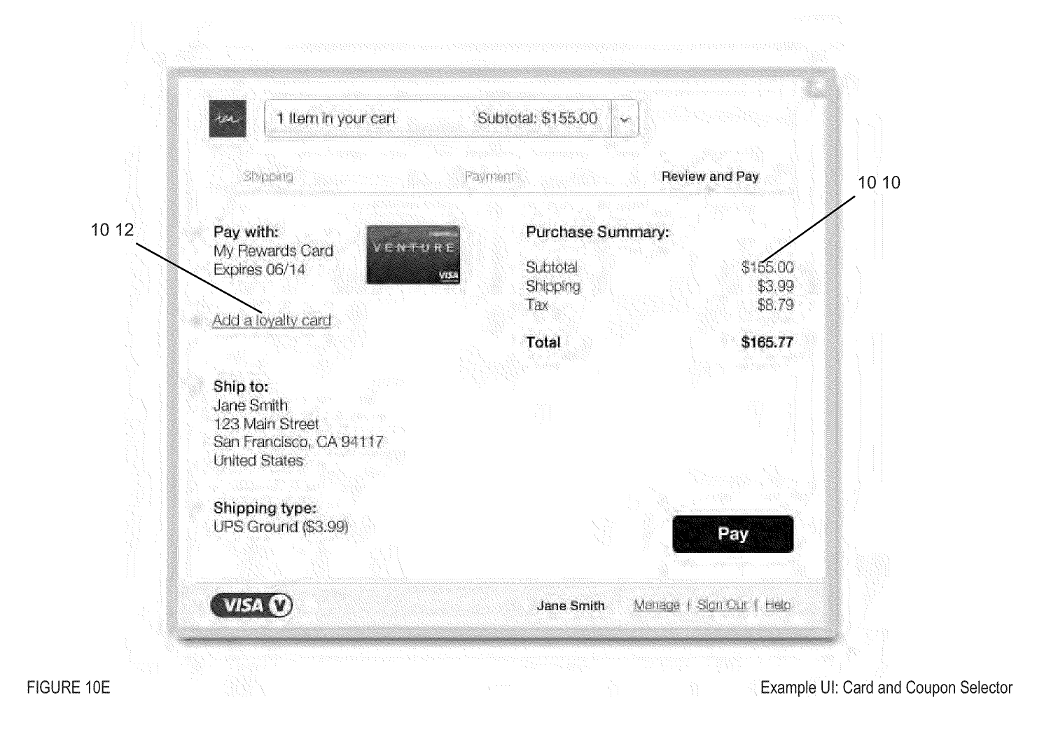

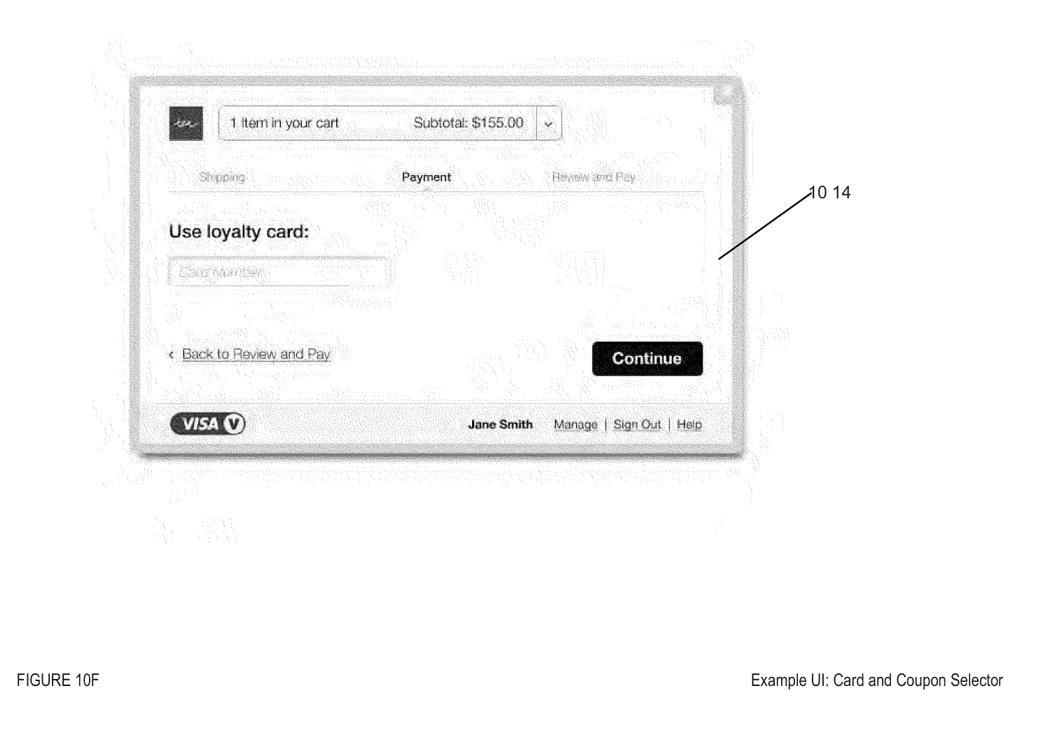

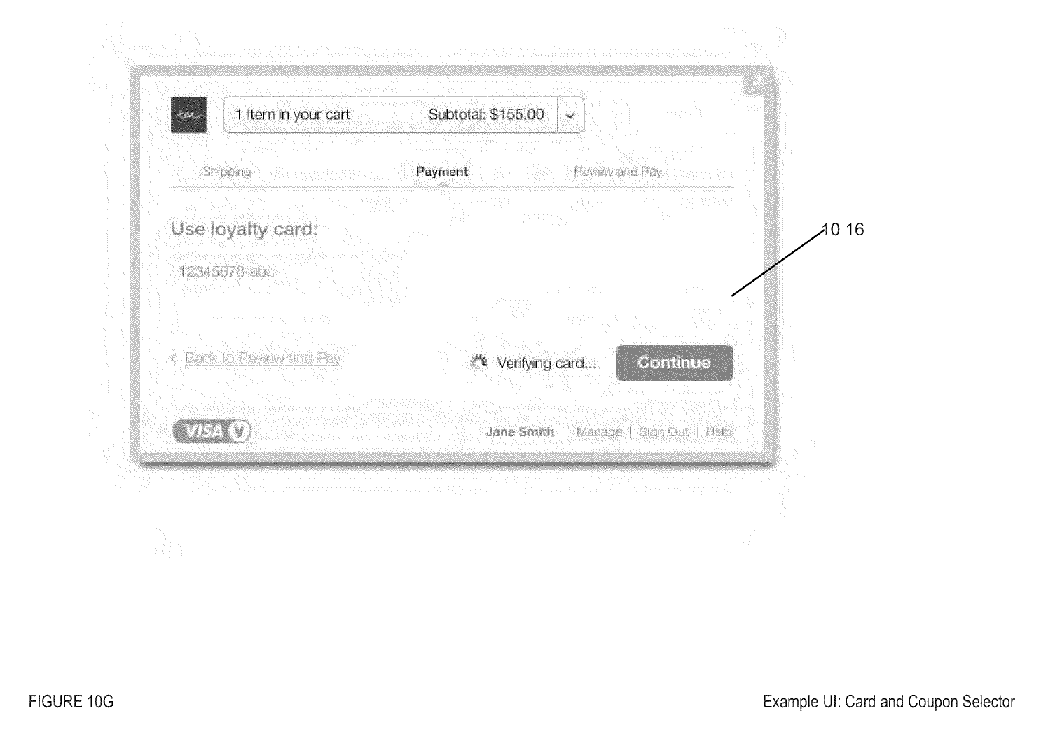

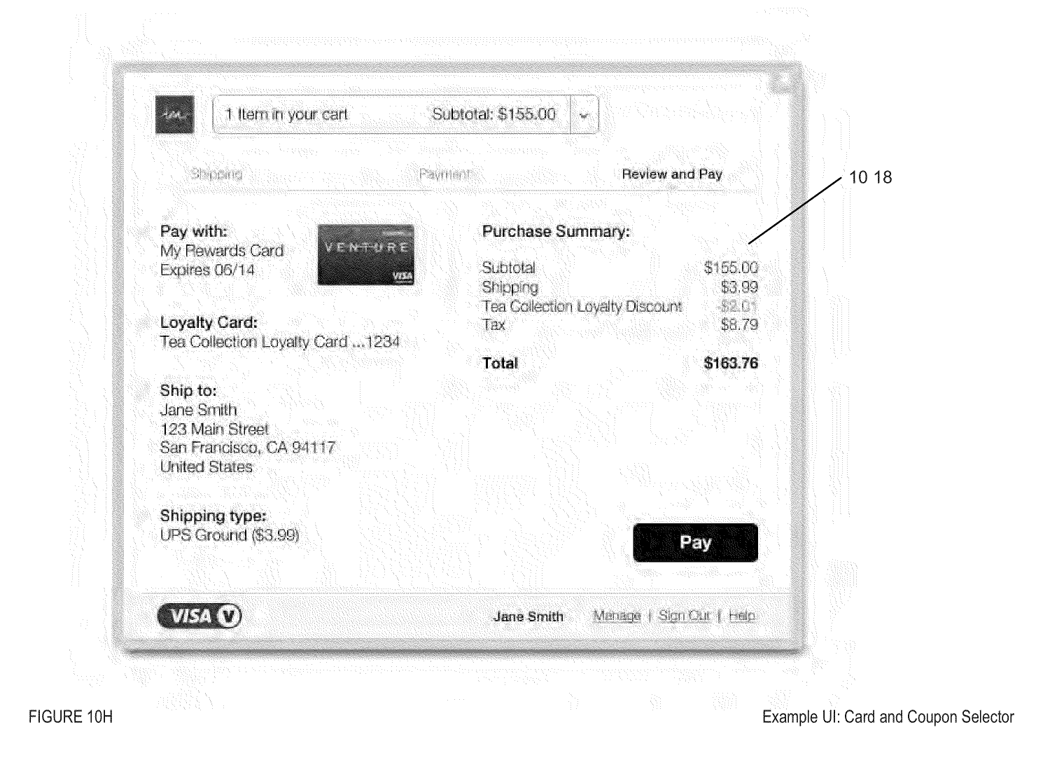

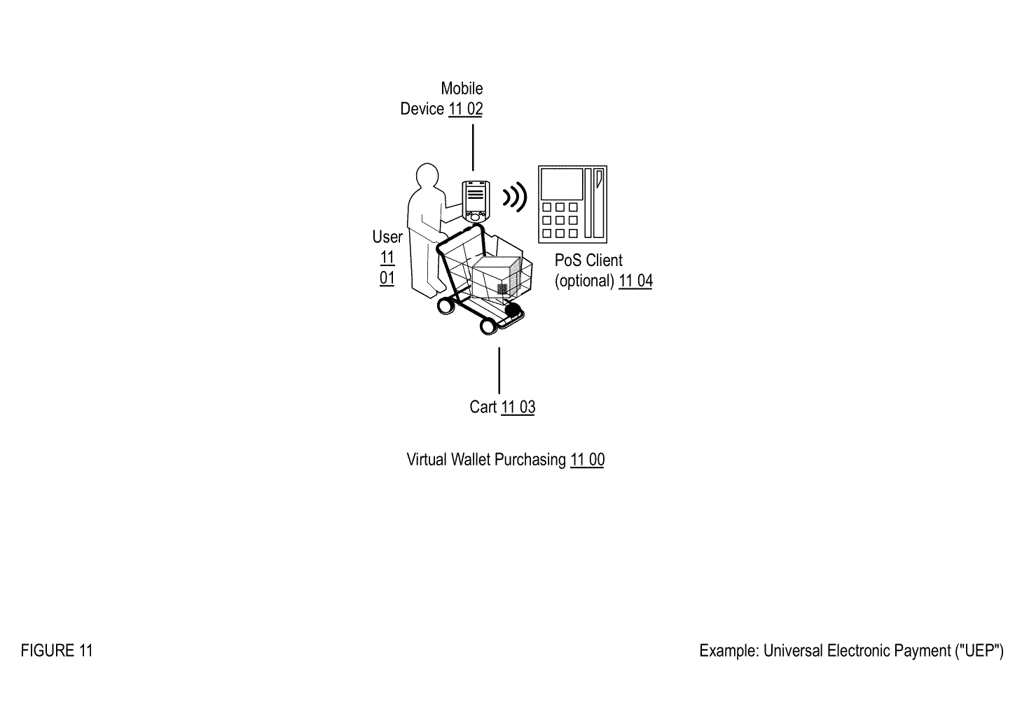

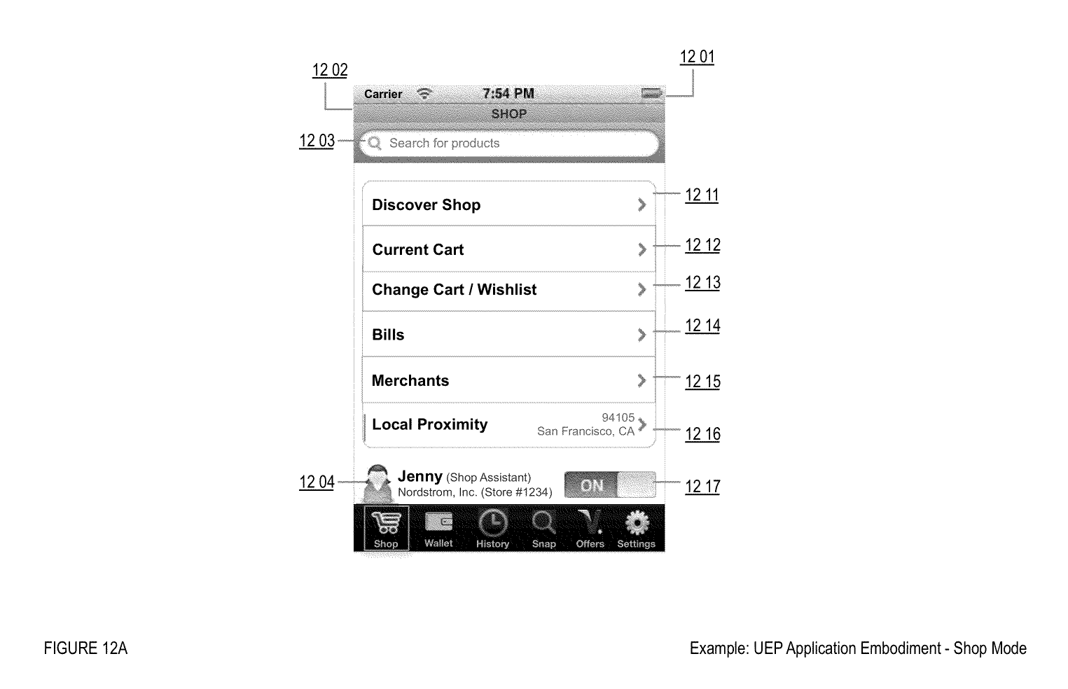

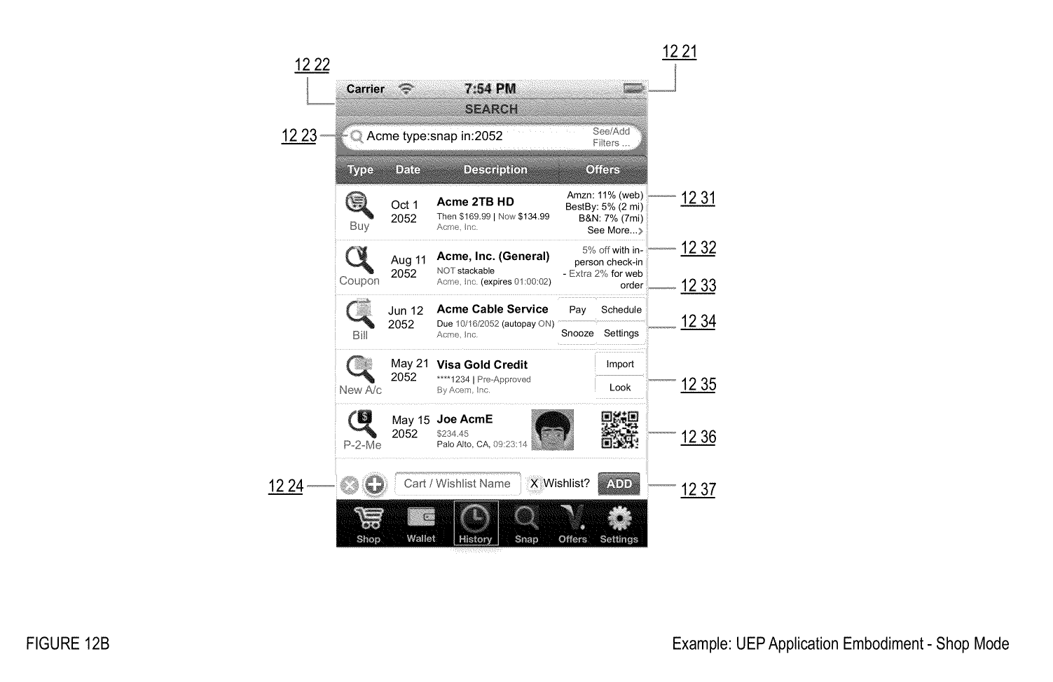

The Pay Network server may verify the user's authentication information and if verified, process the new card request 220. The Pay Network server may generate a search query 225 to retrieve the new card's terms, features, and/or rewards information (hereinafter “rewards data”). In some implementations, the server may send the query 230 to the web with rewards program database(s) 208 to retrieve the rewards data 235. In some implementations, the server may send the search query 240 to the new card's issuer server 206 and retrieve the rewards data 245. For example, the Pay Network server may issue PHP/SQL commands to query a database table (such as FIG. 10, Rewards 1019f) for rewards data. An example rewards data query 230, substantially in the form of PHP/SQL commands, is provided below:

<?PHP
header(′Content-Type: text/plain′);
mysql_connect(“254.93.179.112”,$DBserver,$password); // access
database server
mysql_select_db(“EOOR_DB.SQL”); // select database table to search
//create query
$query = “SELECT rewards_rules rewards_start_date
rewards_end_date

FROM RewardsTable WHERE card_num LIKE ′%′ $card_num”;

$result = mysql_query($query); // perform the search query
mysql_close(“EOOR_DB.SQL”); // close database access
?>

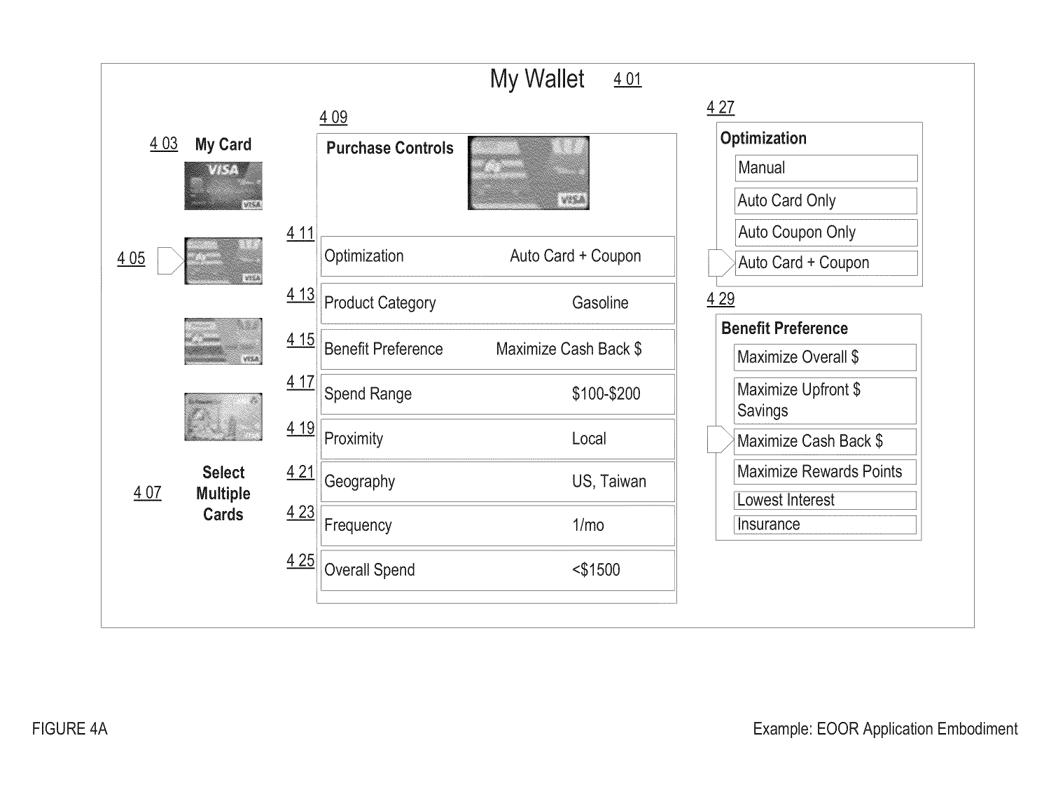

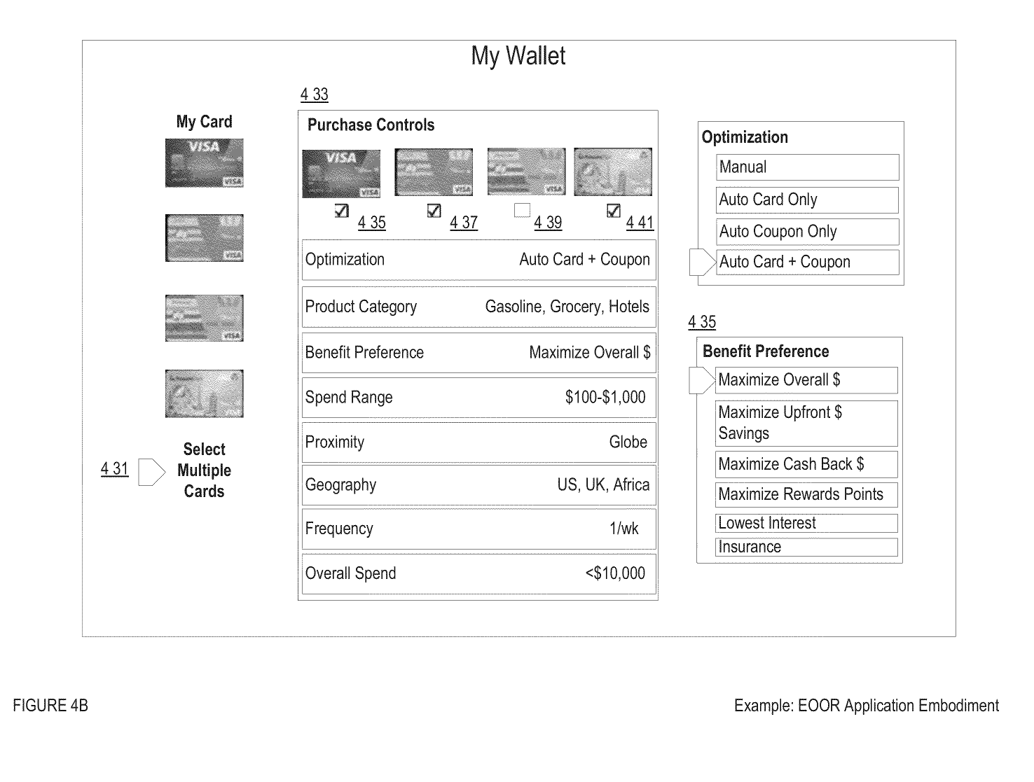

Upon receiving the rewards data, the Pay Network server may send a user card selection preference request 250 to the user or user wallet device. An example user interface to provide input on the user card selection preference is provided in FIGS. 4A-4B. The user may provide the user card selection preference 255 so that the server may determine the optimized card to use for a particular purchase based on the user's customizable preference setup.

In some implementations, the wallet device may generate a user card selection preference request message, and provide the generated user card selection preference request message to the Pay Network server, e.g., 260. For example, the Pay Network server may provide a HTTP(S) POST message including an XML-formatted user card selection preference request message, e.g., 260, similar to the example listing provided below:

POST /cardpreferencecontrols.php HTTP/1.1
Host: www.pcco.com
Content-Type: Application/XML
Content-Length: 624
<?XML version = “1.0” encoding = “UTF-8”?>
<card_preference_control>

<query_ID>VNEI39FK</query_ID>
<timestamp>2011-02-22 15:22:44</timestamp>
<multiple_cards>N</multiple_cards>
<user_approval>Y</user_approval>
<user_wallet_account_params>

<user_name>John Q. Public</user_name>
<wallet_ID>9823935</wallet_ID>
<billing_address>123 Green St., Norman, OK 98765</billing_address>
<phone>123-456-7809</phone>
<sign>/jqp/</sign>

</user_wallet_account_params>
<card_params>

<card_name>John Q. Public</card_name>
<card_type>credit</card_type>
<card_num>123456789012345</card_num>
<billing_address>123 Green St., Norman, OK 98765</billing_address>
<phone>123-456-7809</phone>
<sign>/jqp/</sign>

</card_params>
<Rule>

<RuleID>0001/RuleID>
<optimization>auto card and coupon</optimization>
<product_category>gasoline</product_category>
<benefit_preference>maximize cash back dollar</benefit_preference>
<spend_range_lower_limi>$100</spend_range_lower_limi>
<spend_range_upper_limi>$200</spend_range_upper_limi>
<proximity>local</proximity>
<geography1>US</geography1>
<geography2>Taiwan</geography2>
<frequency>monthly</frequency>
<overall_spend_upper_limit>$1500</overall_spend_upper_limit>

</Rule>

</card_preference_control>

In some embodiments, the new card data, card rewards data, and user card selection preference data may be stored 265 in Pay Network database(s). The Pay Network server may generate a new card addition completion message 270 and send to the user for display 275.

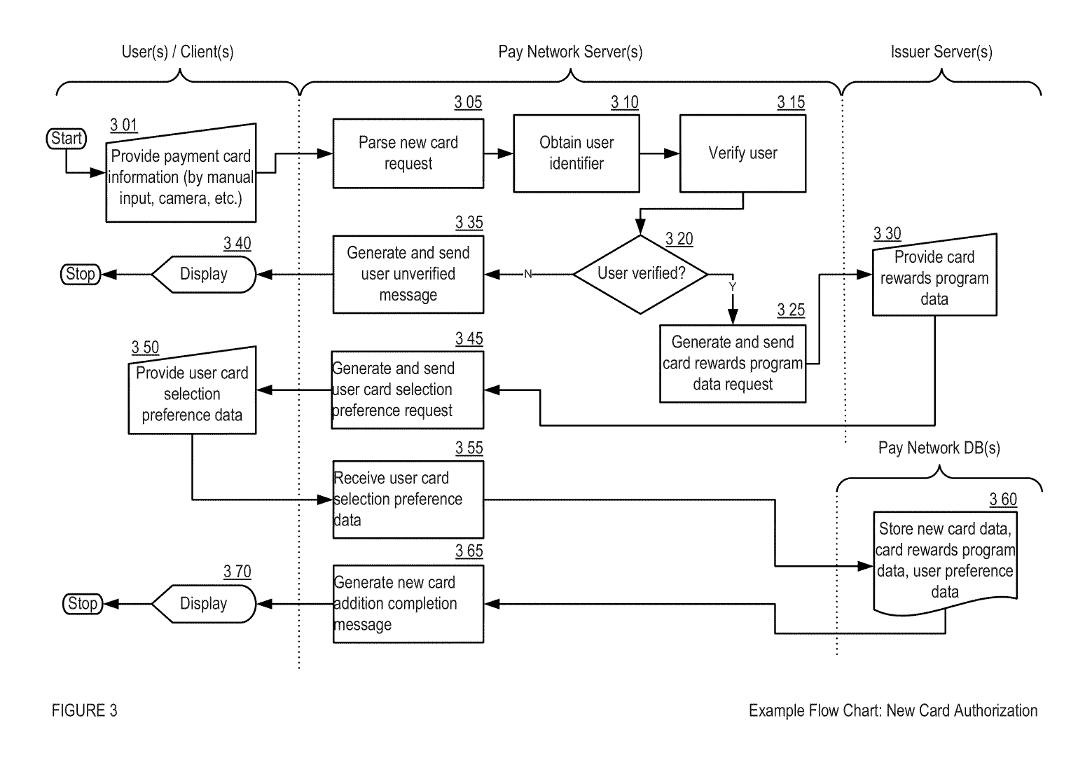

FIG. 3 shows a logic flow diagram illustrating examples of transforming payment card information and user card selection preference inputs via a EOOR new card component into new card addition completion outputs. The user may initiate the process by providing new payment card information 301. Upon receiving the new card request, the Pay Network server may parse the request 305 and retrieve a user identifier 310. The Pay Network server may verify the user's authentication 315. If the user is verified 320, in some embodiments, the server may generate a card rewards program data request 325 and send the request to the card's issuer server. In some embodiments, the Pay Network server may send the card rewards program data request to the web and retrieve the rewards data from the web. In some embodiments, the rewards data may be preloaded to the card via, for example, a QR code.

In some embodiments, the card's issuer server may provide card rewards program dta 330 to the Pay Network Server. Upon receiving the rewards data, the Pay Network server may generate and send user card selection preference request 345 to the user. The user may provide user card selection preference data 350 back to the Pay Network Server. Upon receiving the user card selection preference data 355, the Pay Network server may store the new card data, card rewards program data, and user preference data 360 to Pay Network Database(s). In some embodiments, the Pay Network Server may generate a new card addition completion message 365 and send the message to user for display 370.

In some embodiments, if the user's authentication is not verified 320, the Pay Network server may generate a user unverified message 335 and send the mssage to the user for display 340.

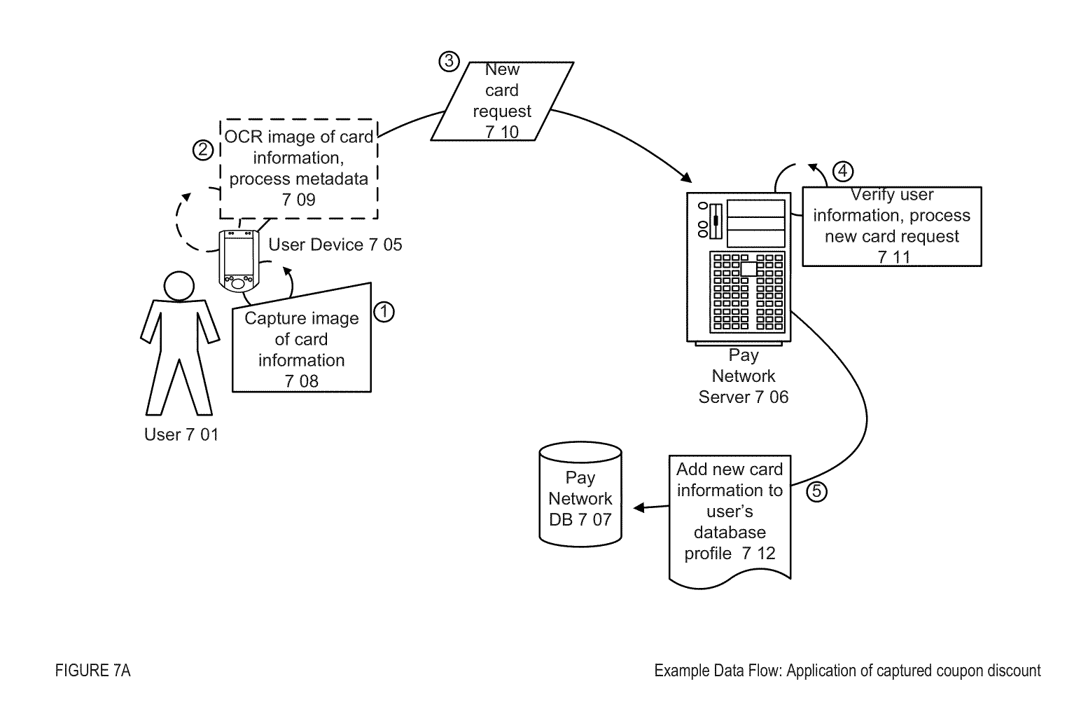

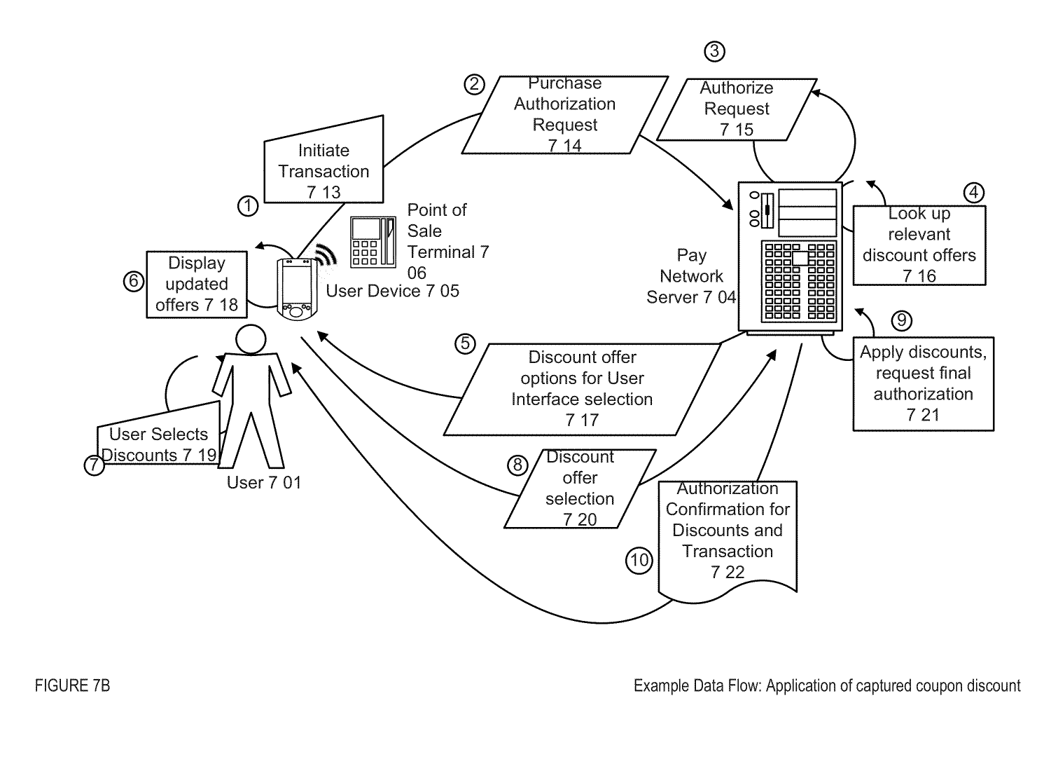

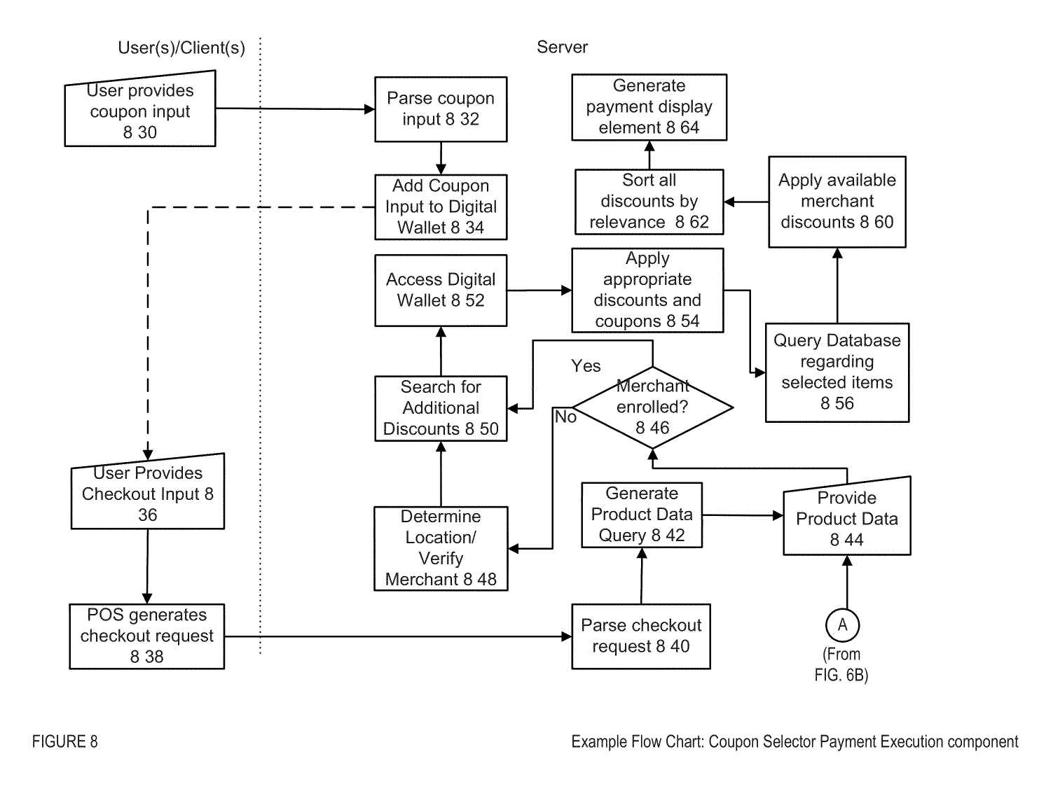

FIGS. 4A-4B show screen shot diagrams illustrating example user interface(s) of a EOOR card selector component. In some embodiments, the user may access the wallet account screen 401 to modify the card selector preference of each card or multiple cards. All of the payment cards stored in the wallet may be made available for the user 403. As an illustrating example only, when the user selects one of the payment cards 405, a panel with purchase controls may be presented 409. The user has the option to change the settings of optimization 411, product category 413, benefit preference 415, spend range 417, proximity 419, geography 421, frequency 423, overall spend 425, and/or the like. In some implementations, in the optimization setting 427, the user may choose to manually select the best payment card to use for a purchase, automatically select the best payment card to use, automatically select the best coupon to use (details are provided in FIGS. 7-8), or automatically select the best payment card and the best coupon to use. The product category setting 413 may include the categories of products which the user may desire to use the card in to maximize the user's benefits. For example, if the payment card offers 5% cash back in gasoline purchase, the user may desire to choose the product category setting for this card as gasoline so that when the user makes a purchase in gasoline, this card is automatically selected for payment.

The benefit preference setting 429 include options that the user may choose in order to maximize the benefits. For example, in some implementations, the user may desire to let the server choose the best payment card for a particular purchase if this selection may maximize the overall dollar savings, maximize the upfront dollar savings, maximize cash back dollar savings, maximize the rewards points, provides lowest insert, best insurance terms, and/or the like. The Spend range setting 417 may provide limits of each purchase that the payment card is allowed to make. The proximity setting 419 may be selected by a user to view a list of merchants that are geographically in close proximity to the user. There may be a geography setting 421, which may be selected by a user so that only purchases in these geography locations are allowed (e.g., US and Taiwan). There may be a frequency setting 423, which may be selected by a user so that a payment card may only be used in the selected frequency (e.g., once per month). There may be a overall spend setting 425, which may be set up by a user so that the balance of a payment card needs to be maintained below a selected limit (e.g., lower than $1,500).

In some embodiments, a user may also have an option to select multiple cards to set up the card selector preference, e.g., 407 and 431. In a panel of purchase controls 433, a user may select multiple cards for the server to determine the best payment card to use. For example, a user may choose three of four payment cards 435, 437, 441 to use. One of the four payment cards 439 is not selected in the EOOR payment card selector component, as an illustrating example only. When a user makes a purchase that satisfies the preferences pre-set in the purchase controls panel, the Pay Network server may compare the rewards data of the selected three cards, and select the optimized card for payment.

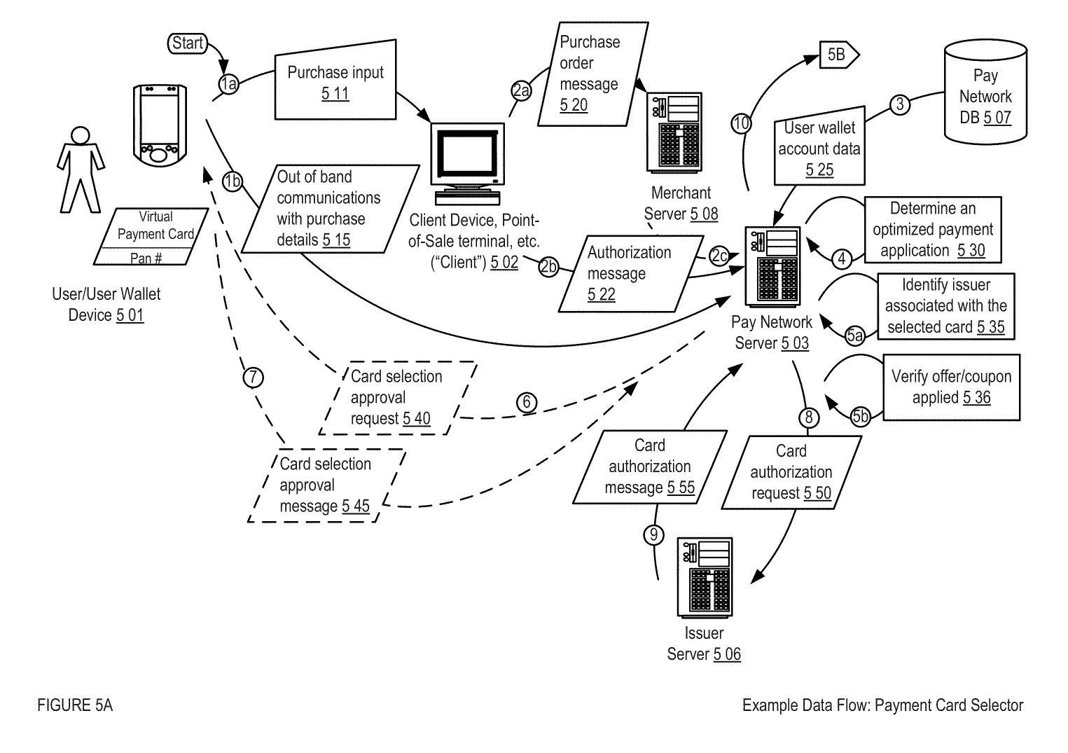

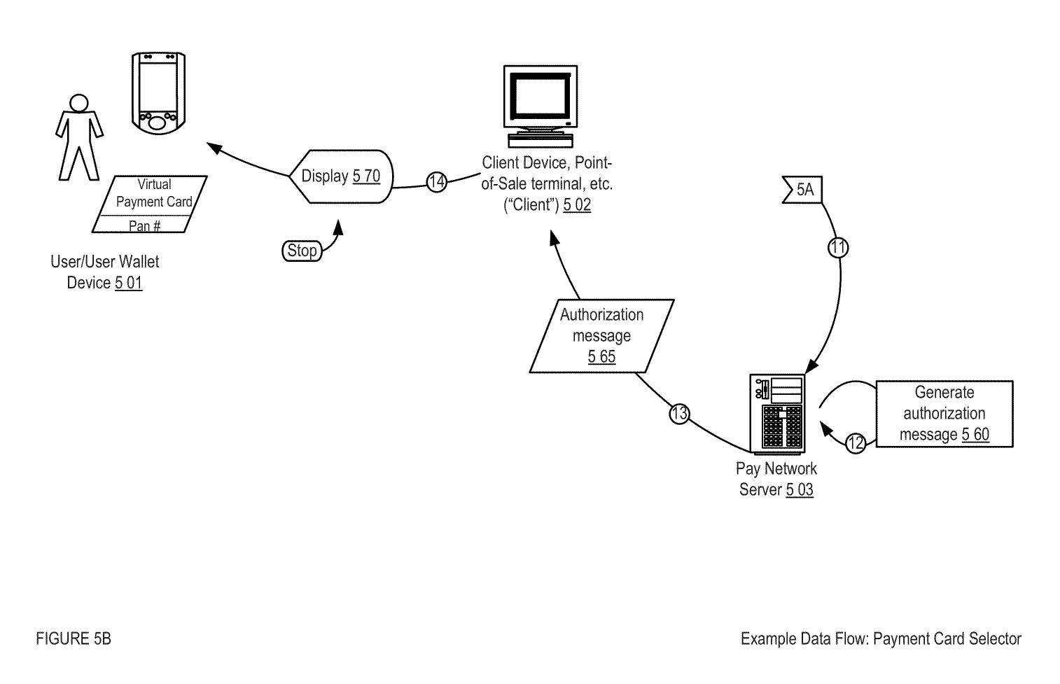

FIGS. 5A-5B shows datagraph diagrams illustrating examples of transforming purchase inputs via a EOOR card selector component into purchase transactions using optimized payment card and coupon outputs. In some embodiments, a user may desire to make a purchase at a merchant using wallet account. The user may present his mobile wallet account at the point of sale terminal, or present a virtual payment card which stores the user's wallet account information. The user or user wallet device 501 may send purchase input information 511 to a client (client device, or point-of-sale terminal, etc.) 502. The client 502 may send the purchase order message 520 to the Merchant Server 508.

In some implementations, the client may generate a purchase order message and provide, e.g., 520, the generated purchase order message to the merchant server. For example, a browser application executing on the client may provide, on behalf of the user, a (Secure) Hypertext Transfer Protocol (“HTTP(S)”) GET message including the product order details for the merchant server in the form of data formatted according to the eXtensible Markup Language (“XML”). Below is an example HTTP(S) GET message including an XML-formatted purchase order message, e.g., 520:

```
GET /purchase.php HTTP/1.1
Host: www.paynetwork.com
Content-Type: Application/XML
Content-Length: 1306
<?XML version = “1.0” encoding = “UTF-8”?>
<purchase_order>
  <order_ID>4NFU4RG94</order_ID>
  <timestamp>2011-02-22 15:22:43</timestamp>
  <user_ID>john.q.public@gmail.com</user_ID>
  <client_details>
      <client_IP>192.168.23.126</client_IP>
      <client_type>smartphone</client_type>
      <client_model>HTC Hero</client_model>
      <OS>Android 2.2</OS>
      <app_installed_flag>true</app_installed_flag>
  </client_details>
  <purchase_details>
      <num_products>1</num_products>
      <product>
            <product_type>book</product_type>
            <product_params>
                  <product_title>XML for dummies</product_title>
                  <ISBN>938-2-14-168710-0</ISBN>
                  <edition>2nd ed.</edition>
                  <cover>hardbound</cover>
                  <seller>bestbuybooks</seller>
            </product_params>
            <quantity>1</quantity>
      </product>
  </purchase_details>
  <account_params>
      <account_name>John Q. Public</account_name>
      <wallet_identifier>FIODPSE_1</wallet_identifier>
      <billing_address>123 Green St., Norman,
      OK 98765</billing_address>
      <phone>123-456-7809</phone>
      <sign>/jqp/</sign>
      <confirm_type>email</confirm_type>
      <contact_info>john.q.public@gmail.com</contact_info>
  </account_params>
  <shipping_info>
      <shipping_adress>same as billing</shipping_address>
      <ship_type>expedited</ship_type>
      <ship_carrier>FedEx</ship_carrier>
      <ship_account>123-45-678</ship_account>
      <tracking_flag>true</tracking_flag>
      <sign_flag>false</sign_flag>
  </shipping_info>
</purchase_order>
```

In some embodiments, the PoS client may provide a transaction authorization input, e.g., 522, to the Pay Network server. In some embodiments, the transaction authorization input may be provided from the Merchant server to the Pay Network server. In embodiments where the user utilizes a plastic card instead of the user wallet device, the user may swipe the plastic card at the PoS client to transfer information from the plastic card into the PoS client, and then further to the Pay Network server. For example, the PoS client may obtain, as transaction authorization input 522, track 1 data from the user's plastic card (e.g., credit card, debit card, prepaid card, charge card, etc.), such as the example track 1 data provided below:

```
%B123456789012345\hat{ }PUBLIC/J.Q.\hat{ }99011200000000000000
**901******?* (wherein ‘123456789012345’ is the card number of ‘J.Q.
Public’ and has a CVV
  number of 901. ‘990112’ is a service code, and *** represents decimal
  digits which change randomly each time the card is used. Also, a
  merchant code may be affixed by the PoS terminal for merchant
  resolution.)
```

The user or user wallet device 501 may initiate out of band communications 515 with purchase details (e.g., the products to be purchased in a transaction, and/or the like) with the Pay Network server 503. In embodiments where the user utilizes a user wallet device, the user wallet device may provide payment information to the PoS client, formatted according to a data formatting protocol appropriate to the communication mechanism employed in the communication between the user wallet device and the PoS client. An example listing of the out of band communications, e.g., 515, substantially in the form of XML-formatted data, is provided below:

```
<?XML version = “1.0” encoding = “UTF-8”?>
<out_of_band_communications>
  <wallet_data>
      <account_name>John Q. Public</account_name>
      <wallet_identifier>FIODPSE_1</wallet_identifier>
      <billing_address>123 Green St., Norman,
      OK 98765</billing_address>
      <phone>123-456-7809</phone>
      <sign>/jqp/</sign>
      <confirm_type>email</confirm_type>
      <contact_info>john.q.public@gmail.com</contact_info>
  </wallet_data>
  <merchant_data>
      <merchant_id>JKPQ84</merchant_ID>
      <merchant_name>Barnes and Noble</merchant_name>
      <Merchant_address>95 Book St., Norman,
      OK 98765</Merchant_address>
  </merchant_data>
  <purchase_details>
      <order_ID>4NFU4RG94</order_ID>
      <num_products>1</num_products>
      <purchase_amount>$20</purchase_amount>
      <product>
            <product_type>book</product_type>
            <product_params>
                  <product_title>XML for dummies</product_title>
                  <ISBN>938-2-14-168710-0</ISBN>
                  <edition>2nd ed.</edition>
                  <cover>hardbound</cover>
                  <seller>bestbuybooks</seller>
            </product_params>
            <quantity>1</quantity>
      </product>
      <session_ID>0243567</session_id>
  </purchase_details>
  <!--optional data-->
  <coupon_data>
      <coupon_id>3467903146</coupon_id>
      <coupon_params>$5 off</coupon_params>
      <coupon_expiration_date>12-31-2030
      </coupon_expiration_date>
      <coupon_rules>Barnes and Noble</coupon_rules>
  </coupon_data>
  <timestamp>2011-02-22 15:22:43</timestamp>
  <device_fingerprint>
      <device_IP>192.168.23.126</device_IP>
      <device_MAC>0123.4567.89ab</device_MAC>
      <device_serial>312456768798765432</device_serial>
      <device_ECID>00000AEBCDF12345</device_ECID>
      <device_identifier>jqp_air</device_identifier>
      <device_UDID>21343e34-14f4-8jn4-7yfe-
      124578632134</device_UDID>
      <device_browser>firefox 2.2</device_browser>
      <device_type>smartphone</device_type>
      <device_model>HTC Hero</device_model>
      <OS>Android 2.2</OS>
      <wallet_app_installed_flag>true</wallet_app_installed_flag>
  </device_fingerprint>
</out_of_band_communications>
```

The Pay Network server may retrieve the user wallet account data 525 from the Pay Network database(s) 507. Upon receiving the wallet account data which may include the payment cards data and the user card selector preference data, the Pay Network server may determine an optimized payment card application 530. The Pay Network server may identify an issuer associated with the selected card 535 and verify coupon and/offers applied 536. The Pay Network server may send a card authorization request 550 to the issuer server 506. Once authorized, the issuer server may send the card authorization message 555 back to the Pay Network server. In some implementations, the Pay Network server may optionally send a card selection approval request to the user or user wallet device 540.

If the user approves the card selection, the user or user wallet device may send a card selection approval message 545 back to the Pay Network server. For example, a browser application executing on the user's mobile device may provide, on behalf of the user, a (Secure) Hypertext Transfer Protocol (“HTTP(S)”) GET message including the card selection details for the Pay Network server in the form of data formatted according to the eXtensible Markup Language (“XML”). Below is an example HTTP(S) GET message including an XML-formatted card selection approval message, e.g., 545:

```
GET /approval.php HTTP/1.1
Host: www.paynetwork.com
Content-Type: Application/XML
Content-Length: 1306
<?XML version = “1.0” encoding = “UTF-8”?>
<card_selection_approval_message>
  <order_ID>4NFU4RG94</order_ID>
  <timestamp>2011-02-22 15:22:43</timestamp>
  <user_ID>john.q.public@gmail.com</user_ID>
  <selected_account_params>
      <account_name>John Q. Public</account_name>
      <wallet_identifier>FIODPSE_1</wallet_identifier>
      <billing_address>123 Green St., Norman,
      OK 98765</billing_address>
      <phone>123-456-7809</phone>
      <sign>/jqp/</sign>
      <confirm_type>email</confirm_type>
      <contact_info>john.q.public@gmail.com</contact_info>
  </selected_account_params>
  <approval>Y</approval>
</card_selection_approval_message>
```

Upon receiving the card authorization message from the issuer, the Pay Network may generate a transaction authorization message 560. The Pay Network server may send the transaction authorization message to the client 565. The client may further display the message to the user or user wallet device 570.

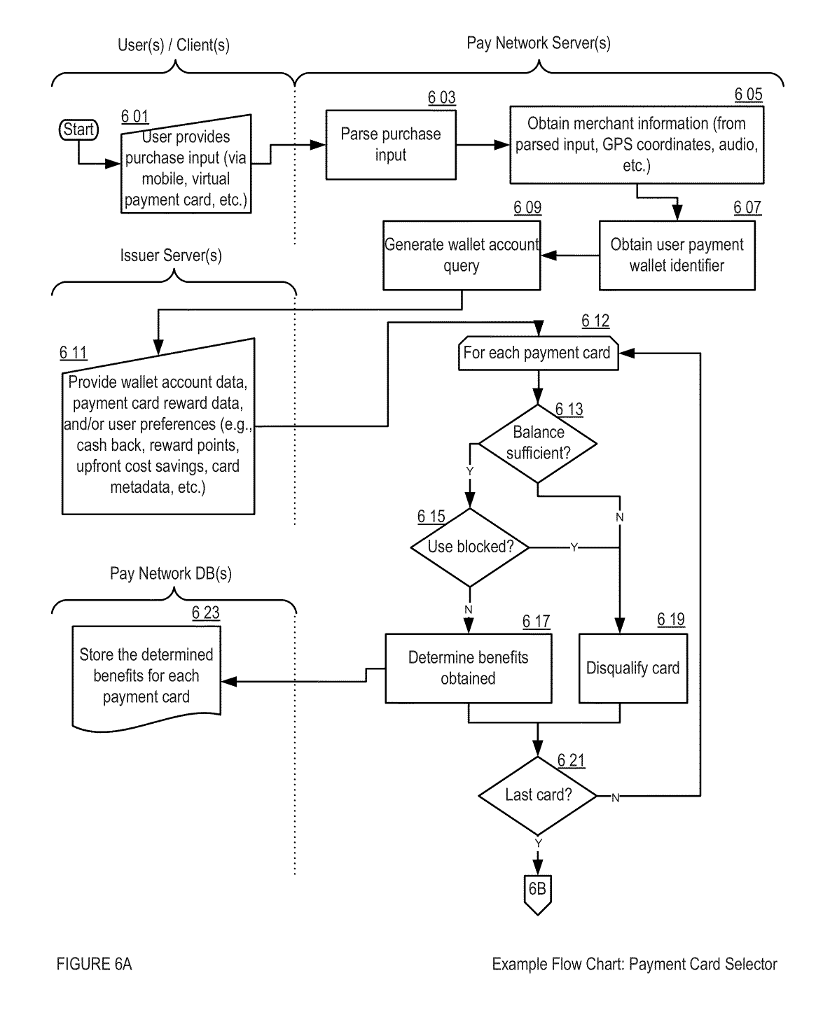

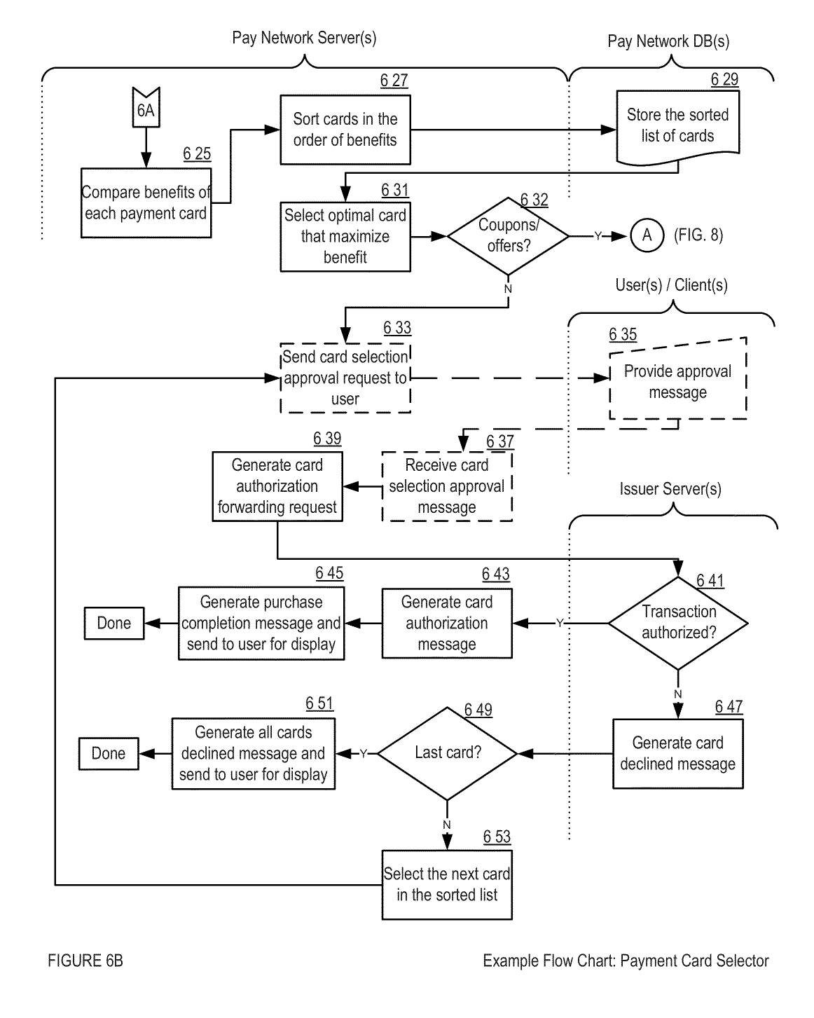

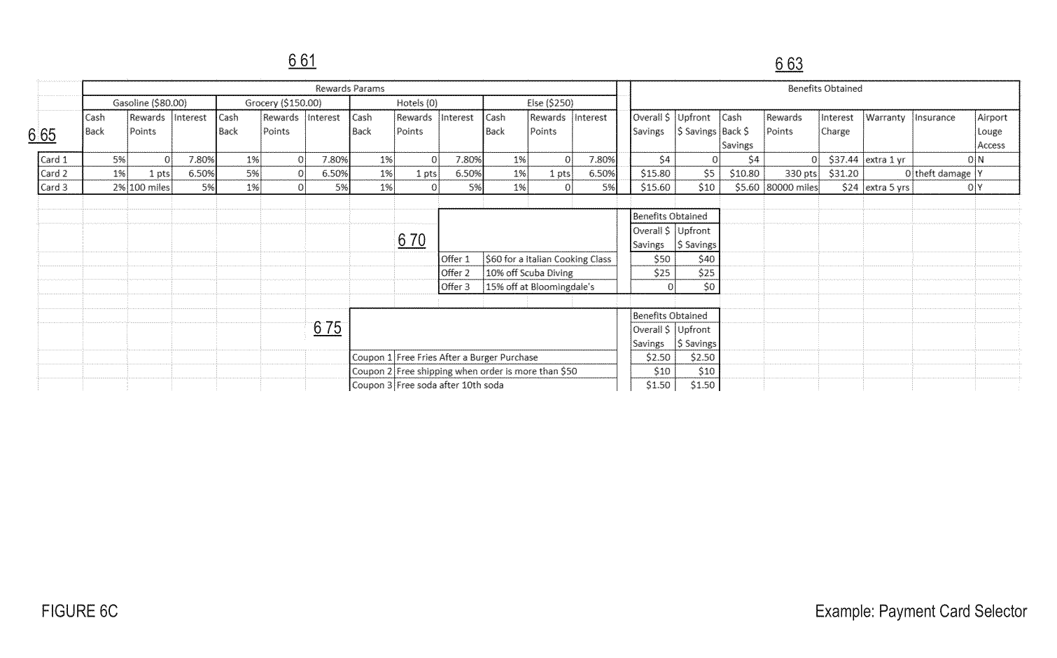

FIGS. 6A-6B show logic flow diagrams illustrating examples of transforming purchase inputs via a EOOR card selector component into purchase transactions using optimized payment card and coupon outputs. The user or client may provide a purchase input via methods including mobile devices, virtual payment cards, and/or the like 601. The Pay Network server may parse the purchase input 603. The Pay Network server may obtain merchant information from sources including parsed input, GPS coordinates, audio, and/or the like 605. The Pay Network server may obtain user payment wallet identifier 607. The pay network server may generate a wallet account query 609. The issuer server may provide wallet account data, payment card reward data, and/or user preferences, including cash back, reward points, upfront cost savings, card metadata and/or the like 611. For each payment card 612, the Pay Network server may determine if the balance is sufficient 613. If the balance is sufficient, then an examination is performed to determine if the use of the payment card is block 615. If the use is not blocked, then a calculation is performed to determine the obtained benefits 617. As an illustrating example only, block 663 in FIG. 6C shows an exemplary method to determine benefits for each payment card. If the balance is not sufficient, or the use is blocked, then the card may be disqualified for use 619. The Pay Network database may store the determined benefits for each card.

In some embodiments, as shown in FIG. 6B, the Pay Network Server may compare the benefits of each payment card 625. The Pay Network Server may sort cards in the order of benefits 627. The Pay Network Server may store the sorted list of cards in the Pay Network Databases 629. The Pay Network Server may select the optimal card that maximizes the benefit 631. As an illustrating example only, the Pay Network server may use the determined benefits as in block 663 in FIG. 6C to sort the benefits, and select the optimal card that maximizes the benefit that satisfies the user card selection preference.

In some implementations, when there is no coupons and/offer applied 632, the Pay Network Server may optionally send the card selection approval request to the user 633. The users or clients may optionally provide approval message 635. The Pay Network Server may receive the card selection approval message 637. The Pay Network Server may generate a card authorization forwarding request 639. The Issuer Server may perform an examination to check whether the transaction is authorized 641. If the transaction is authorized, then the Pay Network Server may generate a card authorization message 643. The Pay Network Server may generate a purchase completion message and send to user for display 645, after which the entire process may end. If the transaction is not authorized, then the Issuer Server may generate a card declined message 647. The Pay Network Server may perform an examination to check whether the card being considered is the last card 649. If it is the last card, then the Pay Network Server may generate a message that all cards have been declined and send the message to users for display 651, after which the entire process may end. If it is not the last card, then the Pay Network Server may select the next card in the sorted list 653 and optionally send card selection approval message to the user.

In some implementations, if there are coupons and/or offers that may be applicable 632, the Pay Network server may proceed to step 840 in FIG. 8 to apply the coupons and/or offers. More details are discussed in FIG. 8.

FIG. 6C shows a diagram illustrating examples of the EOOR card selector component. In some embodiments, the Pay Network server may store rewards data for each product category for each card. For example, for this particular purchase, there may be $80 purchase of gasoline, $150 purchase of grocery, $o purchase of hotels, and $250 purchase of everything else. For each payment card in the wallet account, card 1, card 2, and card 3, e.g., 665, the rewards data are listed 661. For example, for card 1, when the purchase is on gasoline, there is 5% cash back, zero rewards points, 7.8% interest rate, and zero coupon. Once the Pay Network server has all the rewards data for each card, and the purchase details for this purchase, the server may calculate the benefits obtained for each card 663. For example, if transacting with card 1, the overall dollar savings for this purchase may be $4, while the overall dollar savings may be $15.80 if transacting with card 2. If the user set the card selection preference as to maximize the overall dollar savings (e.g., block 429 as in FIG. 4A and block 435 as in FIG. 4B), the EOOR server may select card 2 to pay for this purchase.

In some implementations, the EOOR server may determine if there are coupons or offers available for a particular purchase. For example, the EOOR server may determine the benefits obtained for each offer 670 and/or each coupon 675; and may proceed to select the offer and/or coupon that may maximize the user's benefits.

FIGS. 7A-7B show datagraph diagrams illustrating examples of transforming purchase inputs via a EOOR coupon selector component into purchase transaction with optimized discounts outputs. In some embodiments, merchant loyalty card information, gift card information, or products discount, coupon information may be accessible in a user wallet account, or via web. A user may be able to access the secure digital wallet to make a purchase when shopping online or at a merchant's physical location. User may be given the option of applying the stored discount information to receive the applicable discount at the time of purchase.

For both online and in-person transactions, a payment network server provides access to the secure digital wallet. In addition, the payment network server also searches for additional discounts applicable to a transaction at the time of purchase. For example, in one exemplary embodiment, payment network server may search the Internet for coupons that may be applied to the product selected by user. In another exemplary embodiment, payment network server may also search a designated email account, approved by the user, to find additional coupons applicable to the transaction. Once all of the applicable discounts have been found, user may be able to select which discounts, if any, they wish to apply to the transaction.

The transaction may occur at the physical location of a merchant. In this case, user may access EOOR using a smart phone or other suitable device or method. In one implementation, user may use a smart phone to communicate with a point-of-sale terminal of the merchant using near field communications (NFC), bluetooth, a QR code capture, or any other suitable technology. In this case, payment network server communicates with smart phone to provide both a secure method of payment and to apply any pertinent discounts to the transaction.

The transaction may also occur online, for example, using a website, a web app, a smart phone app, or by any other suitable means. When user is ready to proceed to checkout, they will be given the option of paying for the transaction using their secure digital wallet.

As shown in FIG. 7A, user 701 may desire to capture information found on a card or other object. In one embodiment, the card is a closed-loop card, that is, a card that can be used at a specified merchant or group of merchants. Closed-loop cards can include customer loyalty cards, gift cards, credit cards, and any other suitable type of card. Use of the COUPON KEEPER is not limited to closed-loop cards, however. It can be used to capture information from any image to populate any type of database.

To begin, user 701 captures an image of the card or other object, e.g., 708. This can be accomplished using a digital camera, a smart phone with an integrated camera, a webcam, a scanner, or any other suitable user device or devices, e.g. 708. In one embodiment, user 701 captures the information on the front of a loyalty card. Depending on the type of card, the user may capture an image of the front of the card, the back of the card, or both. Information on the card may include the user's name, a customer number, an expiration date, a security code, a photo, a corporate logo, and any other pertinent information. After the image of the card has been captured, user device 705 performs an optical character recognition (OCR) process to extract the card information, e.g., 709. In an alternate embodiment, the captured image may be sent directly to a server, such as the pay network server 704, which will perform the OCR process to extract the card information. A new card request, e.g. 710, which includes the information extracted as a result of the OCR process, is sent from user device 705 to pay network server 704. User device 705 may generate the new card request 710. For example, the user device may provide a (Secure) Hypertext Transfer Protocol (HTTP(S)) POST message including data formatted according to the eXtensible Markup Language (XML). For example, new card request 710 many be an HTTP(S) POST message similar to the message shown below:

```
POST /requestcardinfo.php HTTP/1.1
Host: www.issuer.com
Content-Type: Application/XML
Content-Length: 788
<?XML version = “1.0” encoding = “UTF-8”?>
<card_request>
  <request_ID>CNI4ICNW2</request_ID>
  <user_ID>john.q.public@gmail.com</user_ID>
  <client_details>
      <client_IP>192.168.23.126</client_IP>
      <client_type>smartphone</client_type>
      <client_model>HTC Hero</client_model>
      <OS>Android 2.2</OS>
      <app_installed_flag>true</app_installed_flag>
  </client_details>
  <card_info>
      <account_name>John Q. Public</account_name>
      <merchant_name>BestBuy</merchant_name>
      <card_name>BestBuy Club Card</card name>
      <account_type>loyalty</account_type>
      <account_num>978654321</account_num>
      <expiration_date>12-01-2017</expiration_date>
      <wallet_id>73427-34</wallet_id>
      <incentive>double points</incentive>
      <participating_loyalty_id>04658</participating_loyalty_id>
  </card_info>
</card_request>
```

Once pay server 704 has received the data associated with new card request 710, pay server 704 verifies the user information, and processes the new card request, e.g., 711. Processing the new card request may include, among other things, verifying that the user has an account with the owner of the pay network, determining whether the card issuer is a participant in a loyalty program, determining whether an incentive applies, and matching the user's account information with a digital wallet profile. Once the user's information has been verified, the pay network server may generate a card information data record, e.g., 712, from the new card request, and store the details of the data extracted from the card in a pay network database 707. For example, the pay network server 704 may issue PHP/SQL commands similar to the example listing below to store the card information in a database:

```
<?PHP
header(‘Content-Type: text/plain’);
mysql_connect(″254.92.185.103”,$DBserver,$password); // access
database server
mysql_select(″CARDS.SQL″); // select database to append
mysql_query(“INSERT INTO LoyaltyCardsTable (timestamp,
  card_number, expiration_date,merchant_name, user_name,
  security_code)
VALUES (time( ), $card_number, $expiration_date, $merchant name,
  $customer_name, $security_code)″);// add data to table in database
mysql_close(″CARDS.SQL″); // close connection to database
?>
```

As shown in FIG. 7B, once the card information has been processed and stored in pay network database, the card information may then be made available to a user when making a purchase, either online or at the physical location of a merchant. For example, with user device 705, user 701 may initiate a transaction, e.g. 713, at a point of sale terminal 706 in a merchant's physical store. The user device may generate a purchase authorization request, e.g. 714 and provide the request to the payment network server 704. For example, the user device client may provide a (Secure) Hypertext Transfer Protocol (HTTP(S)) POST message including the product and merchant details in the form of data formatted according to the eXtensible Markup Language (XML). For example, purchase authorization request 114 may be in the form of an HTTP(S) POST message including an XML-formatted checkout request for the pay network server, as shown below:

```
GET /discountcheck.php HTTP/1.1
Host: www.issuer.com
Content-Type: Application/XML
Content-Length: 718
<?XML version = “1.0” encoding = “UTF-8”?>
<purchase_authorization_request>
  <order_ID>4NFU4RG94</order_ID>
  <timestamp>2011-02-22 15:22:43</timestamp>
  <user_ID>john.q.public@gmail.com</user_ID>
  <password>supersecret</password>
  <digital_cert>456-873</digital_cert>
  <wallet_id>73427-34</wallet_id>
  <client_details>
      <client_IP>192.168.23.126</client_IP>
      <client_type>smartphone</client_type>
      <client_model>HTC Hero</client_model>
      <OS>Android 2.2</OS>
      <app_installed_flag>true</app_installed_flag>
  </client_details>
  <purchase_details>
      <merchant>Best Buy</merchant>
      <num_products>1</num_products>
      <coupon_code>123563</coupon_code>
      <loyalty_program1>Delta Sky Miles</loyalty_program1>
      <loyalty_program2>BestBuy Buyer</loyalty_program2>
      <incentive>double points</incentive>
      <product>
            <product_type>book</product_type>
            <product_params>
                  <product_title>XML for dummies</product_title>
                  <ISBN>938-2-14-168710-0</ISBN>
                  <edition>2nd ed.</edition>
                  <cover>hardbound</cover>
            </product_params>
            <quantity>1</quantity>
      </product>
  </purchase_details>
</purchase_authorization_request>
```

Once pay network server 704 has received the request, pay network server 104 may authorize the request for payment, i.e., 715. Pay network server 704 may also determine whether there are discounts applicable to the particular merchant or to the particular purchase, i.e., 716. For example, pay network server may access the user's digital wallet profile, stored in the pay server database to determine if there are any loyalty cards, gift cards, or other discounts that can be applied to the user's purchase. In one exemplary embodiment, pay server also searches for additional discounts and coupons that may be available publicly on the Internet or elsewhere, and that can be applied to the requested transaction. Once pay network server has determined all discounts that may be applied to the transaction, the server sends the discount offer options, e.g. 717, to user device 705. The discount options may then be rendered and displayed by the user device, e.g., 718. The user 701 may then select which discounts he or she wishes to apply to the transaction, e.g. 719. Again, the available discounts may include discounts from rewards cards, loyalty cards, closed-loop credit cards, Internet coupons, or any other source. For example, a discount offer options message 717 may be sent in the form of an HTTP(S) POST request similar to the example below:

```
POST /discountoffer.php HTTP/1.1
Host: www.issuer.com
Content-Type: Application/XML
Content-Length: 788
<?XML version = “1.0” encoding = “UTF-8”?>
<discount_options_offer>
  <request_ID>CNI4ICNW2</request_ID>
  <user_ID>john.q.public@gmail.com</user_ID>
  <checkout_basket_item_1>
      <merchant_ID>123456</merchant_ID>
      <merchant_name>BestBuy</merchant_name>
      <session_ID>AEBB4356</session_ID>
      <product_ID>13: 978-0-7641-4304-5</product_ID>
      <price>$59.99</price>
      <sales_tax>$3.74</sales_tax>
      <shipping>two day</shipping>
      <stackable_flag>true</stackable_flag>
      <discount_offer_list>
            <Coupon1>
                  <name>deals.com</name>
                  <coupon_ID>012-325</coupon_ID>
                  <amount>−$10.00</amount>
                  <stackable>yes</stackable>
            </Coupon1>
            <Coupon2>
                  <name>Groupon Coupon</name>
                  <coupon_ID>425-023</coupon_ID>
                  <amount>−20%</amount>
                  <stackable>yes</stackable>
            </Coupon2>
            <GiftCard1>
                  <name>Shopper's Card</name>
                  <giftcard_ID>251-524</giftcard_ID>
                  <amount>−$20.00</amount>
                  <stackable>yes</stackable>
            </GiftCard1>
            <Loyalty_Program1>
                  <name>Delta Sky Miles</name>
                  <loyalty_program_ID>725-265
                  </loyalty_program_ID>
                  <amount>500 reward miles</amount>
                  <stackable>yes</stackable>
            </Loyalty_Program1>
            <Loyalty_Program>
                  <name>Best Buy Rewards</name>
                  <loyalty_program_ID>412-568
                  </loyalty_program_ID>
                  <amount>5% off total purchase</amount>
                  <stackable>yes</stackable>
            </Loyalty_Program2>
      </discount_offer_list>
  </checkout_basket_item_1>
  <checkout_basket_item_2>
      <merchant_ID>325641</merchant_ID>
      <merchant_name>Target</merchant_name>
      <session_ID>AER74356</session_ID>
      <product_ID>13: 365-0-5286-5214-5</product_ID>
      <price>$79.99</price>
      <sales_tax>$5.09</sales_tax>
      <shipping>overnight</shipping>
      <stackable_flag>true</stackable_flag>
      <discount_offer_list>
            <Coupon1>
                  <name>deals.com</name>
                  <coupon_ID>012-325</coupon_ID>
                  <amount>−$10.00</amount>
                  <stackable>yes</stackable>
            </Coupon1>
            <GiftCard1>
                  <name>Shopper's Card</name>
                  <giftcard_ID>251-524</giftcard_ID>
                  <amount>−$5.00</amount>
                  <stackable>yes</stackable>
            </GiftCard1>
            <GiftCard2>
                  <name>Target Card</name>
                  <giftcard_ID>584-156</giftcard_ID>
                  <amount>−$75.00</amount>
                  <stackable>no</stackable>
            </GiftCard2>
            <Loyalty_Program>
                  <name>Delta Sky Miles</name>
                  <loyalty_program_ID>725-265
                  </loyalty_program_ID>
                  <amount>%5 off total purchase</amount>
                  <stackable>yes</stackable>
            </Loyalty_Program1>
            <Loyalty_Progam2>
                  <name>Target Visa</name>
                  <loyalty_program_ID>158-235
                  </loyalty_program_ID>
                  <amount>−2%</amount>
                  <stackable>yes</stackable>
            </Loyalty_Program2>
      </discount_offer_list>
  </checkout_basket_item_2>
</discount_options_offer>
```

Once the user has made a selection, user device 705 may then send the discount offer selection information, e.g., 720 to pay network server 704 for processing. For example, a discount offer selection message 120 may be sent in the form of an HTTP(S) POST request similar to the example below:

```
POST /discountselection.php HTTP/1.1
Host: www.issuer.com
Content-Type: Application/XML
Content-Length: 788
<?XML version = “1.0” encoding = “UTF-8”?>
<discount_options_selection>
  <request_ID>CNI4ICNW2</request_ID>
  <user_ID>john.q.public@gmail.com</user_ID>
  <client_details>
      <client_IP>192.168.23.126</client_IP>
      <client_type>smartphone</client_type>
      <client_model>HTC Hero</client_model>
      <OS>Android 2.2</OS>
      <app_installed_flag>true</app_installed_flag>
  </client_details>
<checkout_basket_item_1>
      <merchant_ID>123456</merchant_ID>
      <merchant_name>BestBuy</merchant_name>
      <session_ID>AEBB4356</session_ID>
      <product_ID>13: 978-0-7641-4304-5</product_ID>
      <price>$59.99</price>
      <sales_tax>$3.74</sales_tax>
      <shipping>two day</shipping>
      <stackable_flag>true</stackable_flag>
      <discount_selection>
            <stack_discounts>yes</stack_discounts>
            <Coupon1>yes</Coupon1>
            <Coupon2>yes</Coupon2>
            <GiftCard1>yes</GiftCard1>
            <Loyalty_Program1>yes</Loyalty_Program1>
            <Loyalty_Program2>yes</Loyalty_Program2>
      </discount_selection>
  </checkout_basket_item_1>
  <checkout_basket_item_2>
      <discount_selection>
            <stack_discounts>no</stack_discounts>
            <Coupon1>no</Coupon1>
            <GiftCard1>no</GiftCard1>
            <GiftCard2>yes</GiftCard2>
            <Loyalty_Program1>no</Loyalty_Program1>
            <Loyalty_Program2>no</Loyalty_Program2>
  </checkout_basket_item_2>
</discount_options_selection>
```

After receiving the discount offer selections from user device 705, pay network server 704 then applies the discounts to the requested transaction and requests final authorization for the transaction, e.g., 721. Pay server 704 may then determine how to apply the discounts and allocate payment among various entities including merchants, manufacturers, retailers, and any other pertinent party. Authorization confirmation 722 is then sent to user device 705, which provides final authorization and confirmation of the discounts that are applied to the transaction.

FIG. 8 shows a logic flow diagram illustrating example aspects of capturing customer card information and transforming that information into a discount applied to a transaction at the point of sale in some embodiments of the EOOR, e.g., a EOOR Coupon Selector component 1035. With reference to FIG. 7, in some implementations, a user may want to capture customer information from a loyalty card, gift card, credit card, debit card, coupon, or other object. The user may provide the discount input, e.g., 830 by capturing an image of the information using a smart phone with a built-in camera, a computer with a webcam, a stand-alone digital camera, a scanner, or any other suitable device capable of capturing and transmitting an image. For example, the user may have a closed-loop card, meaning a card that can be used with a particular merchant. The card could be a loyalty card, which provides the user with a certain discount or rebate every time the user shops at the particular merchant, or the card could be a pre-paid gift card, allowing the user to purchase goods at the particular merchant's website or physical store. By capturing the image of the consumer information on the card and storing it in the user's digital wallet, the user is able to easily access the pertinent discount information at the point of sale without having to carry the physical discount cards or commit the information on the cards to memory.

Once the user has captured an image of the customer information, the user transmits the image to a pay network server, which has access to the user's secure digital wallet. The pay network server parses the discount information, e.g., 832 and sends this information to a pay network database where it is added to the user's digital wallet profile, e.g., 834. Processing of the discount information may be performed at either the user's client device, at the pay network server, or some combination of both. For example, the user may send only an image file to the pay network server, which then performs an optical character recognition (OCR) operation to extract the customer information shown in the image. Alternatively, the OCR operation may take place on the user's client device. Pattern recognition operations may also be performed to extract other relevant information from the image. Once the information has been stored in the user's digital wallet, it will become available during a checkout event initiated by the user.

The user initiates a checkout event when he or she would like to purchase a product, service, offering, or the like (product), from a merchant via a merchant online site or in the merchant's store. The user may communicate with a merchant server via a client. For example, the user may provide user input, e.g., 836, into the client indicating the user's desire to checkout shopping items in a (virtual) shopping cart. The client may generate a checkout request, e.g., 838, and provide the checkout request to the merchant server. The merchant server may obtain the checkout request from the client, and extract the checkout detail (e.g., XML data) from the checkout request, e.g., 840. The merchant server may extract the product data, as well as the client data from the checkout request. In some implementations, the merchant server may query, e.g., 842, a merchant database to obtain product data, e.g., 844, such as product pricing, sales tax, offers, discounts, rewards, and other information to process the purchase transaction.

EOOR Coupon Selector component then determines whether the merchant is enrolled with the pay network, e.g., 846. A merchant may enroll with the pay network to facilitate transactions at the merchant's website or at the merchant's store using the secure digital wallet. If the merchant is not enrolled with the pay network, EOOR Coupon Selector component may use location-based services, geo-coding, or other suitable means to determine where the user is located, and if the user is at the store of a merchant. For example, the pay network server may determine the location of a user's client device—a smart phone, perhaps—and then compare that location to a database of known merchant locations in the area. By this method, EOOR Coupon Selector component is able to determine the location and the name of the merchant.

Once the location of the merchant has been determined and verified, any coupons and discounts added to the consumer's digital wallet, for example at 834, will be automatically included in the checkout data to be sent back to the user's device. Further, the pay network server may also search for additional discounts that may be available to the user, e.g., 850, based on the merchant information and the product information received from the merchant. For example, the pay network server may search the Internet or other publicly available networks for applicable discounts. The pay network server may also pull information from coupon aggregators, social media networks, or any other source.

In one embodiment, a user will provide his or her authentication information for social network accounts such as Facebook, Twitter, Google+, or the like, and the pay network server will determine if the user's feeds on each of these services contain discount information. Similarly, the user may provide a designated email account, which the pay network server will then search to determine if there are any applicable discounts that were sent to the user by email. In another embodiment, if the user does not wish to permit the pay network server to access his or her primary email account, the user may forward any discounts to a dedicated email address, maintained by the pay network provider, which can then be searched for discounts at the time of purchase.

The pay network server will then access the user's secure digital wallet, e.g., 852, and then all discounts, both from the digital wallet, and as a result of the pay network server searching other sources, will be applied to the user's transaction, e.g., 854. EOOR Coupon Selector component may then query the merchant database regarding the items that the user has selected to purchase, i.e., 856. The component may then apply any available merchant discounts to the selected purchase items at 860. In one exemplary embodiment, if there are numerous query results relevant and applicable to each selected purchase item (e.g., in a shopping cart), they may be relevantly sorted for each cart item. All relevant discounts, including discounts from the digital wallet, from outside sources, and from the merchant, are then sorted by relevance 862, and displayed to the user, 864 on the user's device The user then provides payment input, after which the user's device will generate a card authorization request.

In one implementation, the Pay Network server 704 may store the card and offer information associated with the user's 701 wallet profile at a central or distributed data repository, and perform the card/coupon selector procedure as described in FIG. 8. Alternatively and/or in conjunction with, the consumer's electronic wallet may store coupon information associated with each payment card in the wallet at a client wallet device (e.g., a mobile device, a prepaid card, a computer, and/or the like), which may retrieve stored card and offer information locally and perform the payment card and offer optimization. For example, in one implementation, the consumer wallet device may constantly, periodically and/or intermittently (e.g., every 60 minutes, etc.) synchronize payment card and offer information with the Pay Network server in order to obtain the most up-to-date card/offer information for card selection optimization. In another implementation, the consumer may request card/offer information update on the wallet device for card selection optimization at the wallet device.

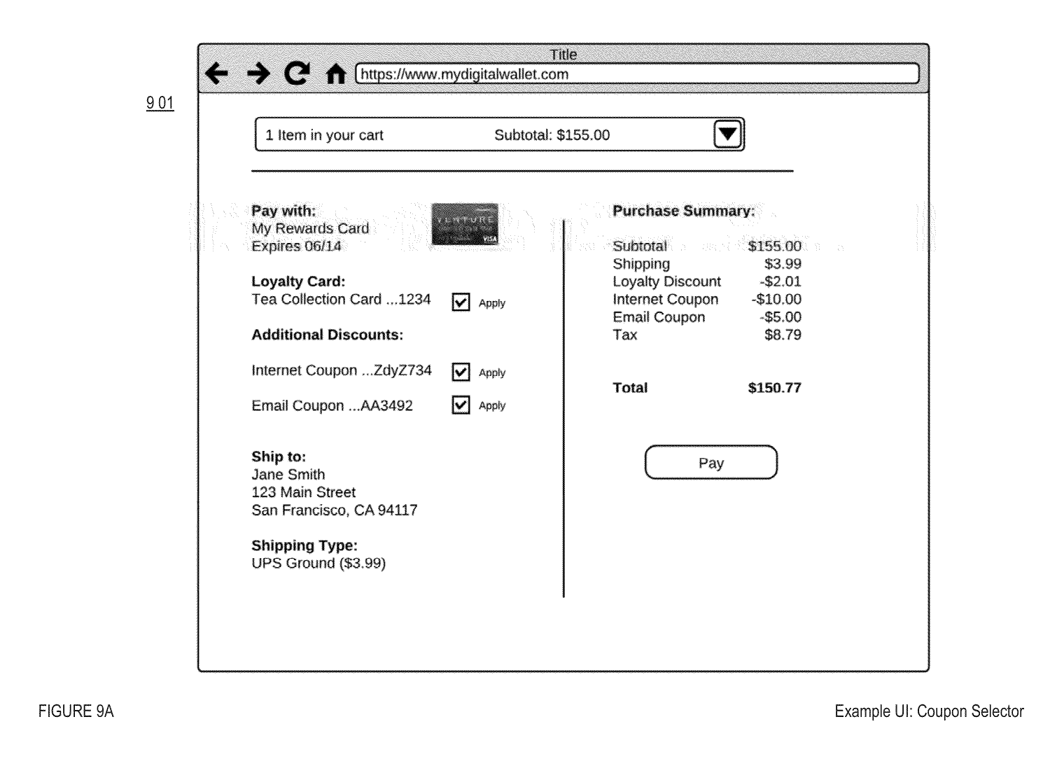

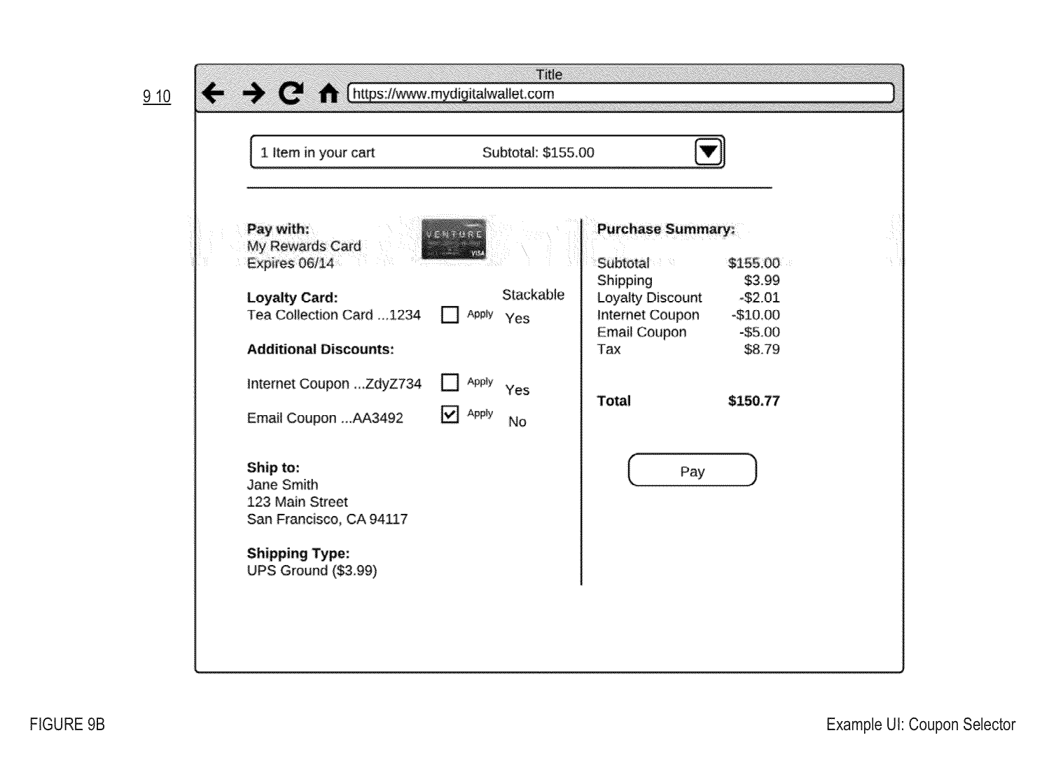

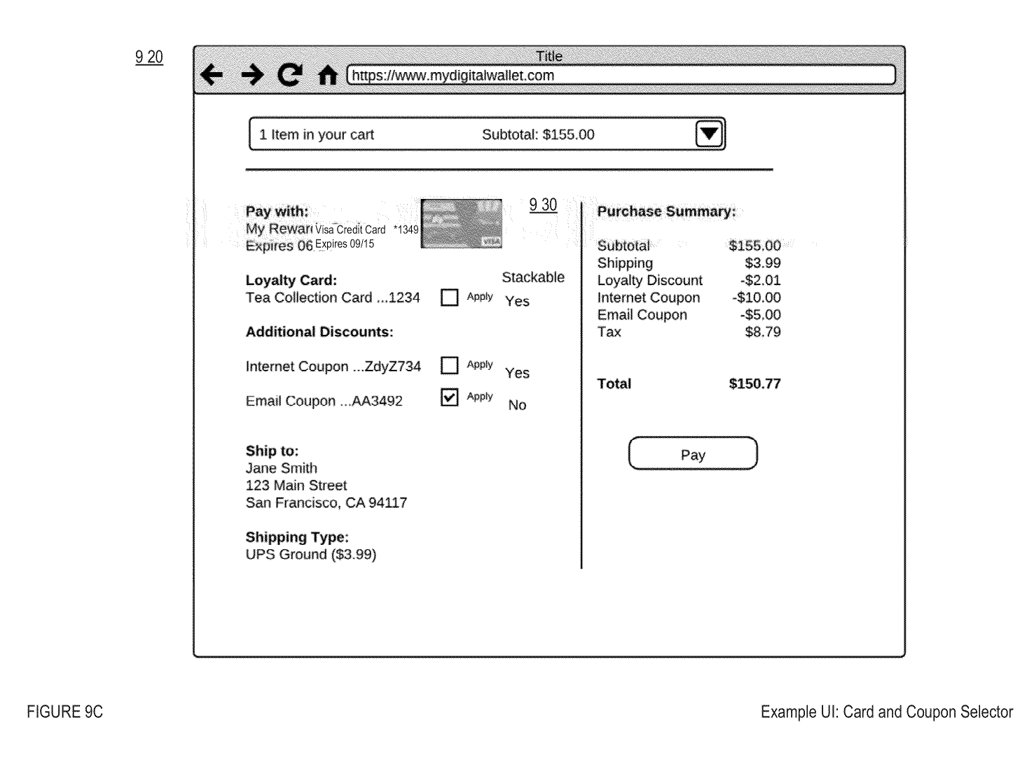

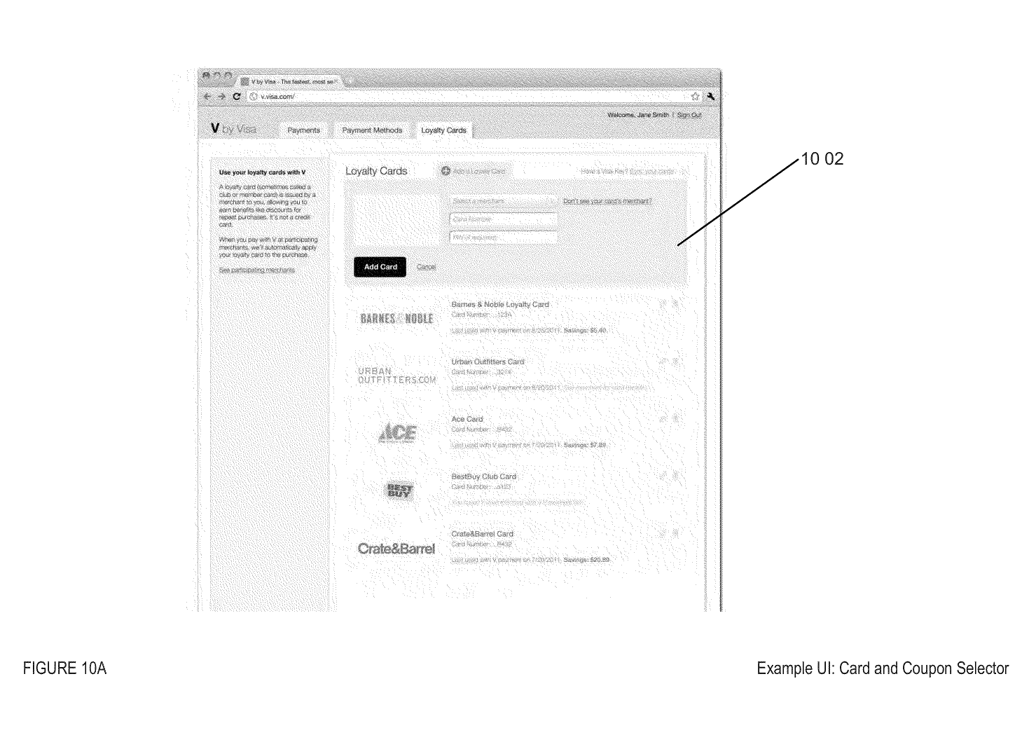

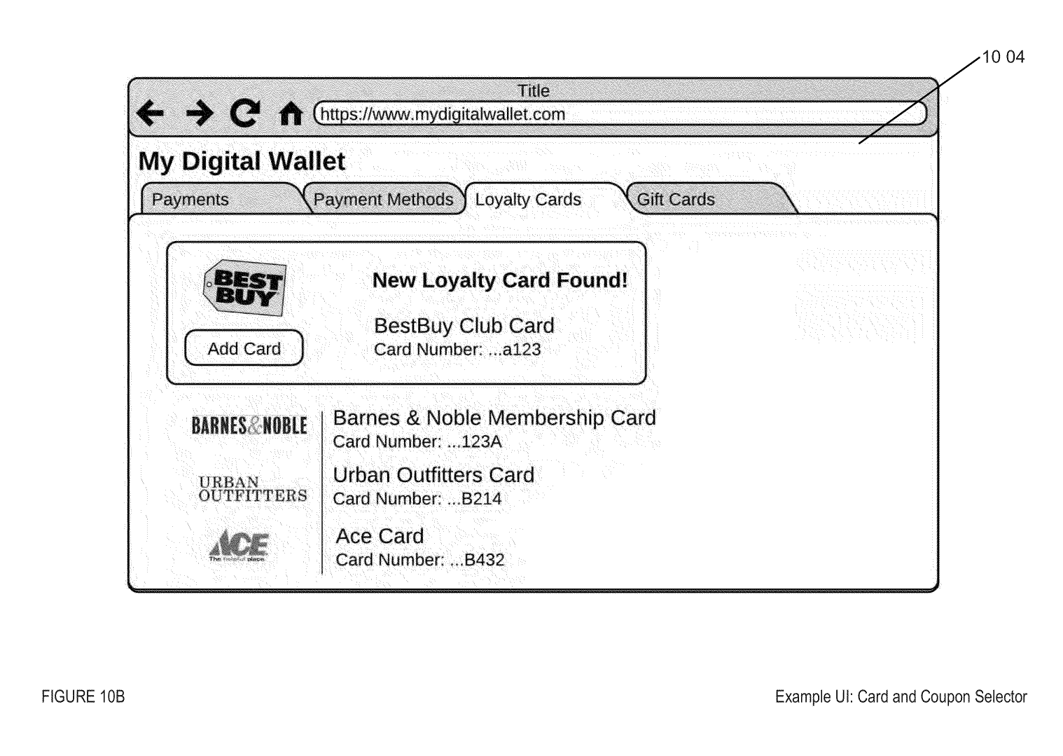

FIGS. 9A-9C show screen shots illustrating example user interface(s) of a EOOR coupon selector component and a EOOR card selector component. FIG. 9A illustrates an embodiment of a review and pay screen 901. The screen 901 may include information on additional discounts and coupons that may be applied to the transaction. EOOR may search the Internet to determine whether there are any additional coupons or discounts that can be applied to the transaction. These coupons or discounts will be automatically shown on screen 901, and the user will be able to choose whether the discount should be applied. The user may indicate their choice by checking a box next to the discount, for example. EOOR may also search a designated email account to determine if there are any additional coupons or discounts that the user may be entitled to. In one exemplary embodiment, the user may designate an email account by providing appropriate permission and authentication in the EOOR interface. EOOR will then search the email received by the user to determine whether any additional discounts can be applied to the transaction.

FIG. 9B illustrates an additional embodiment of a review and pay screen 910. In addition to the information presented in review and pay screen 901, screen 910 may include an indication of whether the displayed coupons and discounts are stackable or not. A coupon or discount is stackable if it can be used together with other coupons or discounts. In one exemplary embodiment, if a non-stackable coupon or discount is selected, all other coupons and discounts will be grayed out and unable to be selected by the user. As shown in FIG. 7, the discount offer options for user interface selection and the discount offer selection messages may include flags for stackability. In one exemplary embodiment, discounts may be stackable or non-stackable across individual items in a (virtual) shopping cart. In another exemplary embodiment, discounts may be stackable or nonstackable across the entire contents of the shopping cart.

FIG. 9C illustrates an additional embodiment of a review and pay screen 920 of a combined card and coupon selector feature of EOOR. The screen 920 may include an option of combining the selected optimized payment card 930 (details are provided in FIGS. 4A-5B) and the displayed coupons and discounts.

FIGS. 10A-10H illustrate exemplary embodiments of portions of a user interface for the secure digital wallet, which may be implemented on any suitable device connected to the Internet. FIG. 10A shows a loyalty card management screen 1002. Screen 1002 lists each of the loyalty cards associated with the user's digital wallet. Screen 1002 also provides a place for the user to manually enter information about additional loyalty cards that have not yet been included in the digital wallet.

FIG. 10B is another exemplary embodiment of a portion of a user interface for accessing the digital wallet. Screen 1004 shows a new card alert, and gives the user the option of adding the card's information to the information already included in the digital wallet. This alert will automatically appear after a user-captured image of the card has been transmitted to and processed by the payment network server.

FIG. 10C is an exemplary embodiment of a mobile new card alert screen 1006, which may appear on the user's smart phone within a dedicated digital wallet app. Alert screens like those shown in FIGS. 10A-10B may be configured to appear on any suitable user device.

FIG. 10D shows a sign-in screen 1008, which may be presented to a user after selecting the option for paying with their secure digital wallet, either online or at the physical location of a merchant. Sign-in screen 1008 allows the user to securely access their digital wallet by entering a username and password; other suitable methods of authentication may be used in other embodiments.

FIG. 10E shows an exemplary embodiment of a review and pay screen 1010. This screen may include information on the product being purchased by the user, the type of payment selected by the user, as well as the shipping address and costs for the transaction. Screen 1010 may also include a link 1012 that allows the user to add a loyalty card that can subsequently be used in the transaction. If the user has previously captured an image of the loyalty card, the card information may automatically be shown, or the user may be prompted to add the card information.

Selecting link 1012 will present a user with loyalty card addition screen 1014-1016, as shown in FIGS. 10F-10G. This screen allows the user to manually enter loyalty card information, which is then processed and entered into the user's digital wallet. A similar screen may also be presented to the user after capturing an image of a loyalty card, which can then either be automatically included in the user's digital wallet, or can be included in the digital wallet after the user approves of the addition.

FIG. 10H illustrates another exemplary review and pay screen, screen 1018, which may form a part of the user interface for the secure digital wallet. Review and pay screen 1018 may include information similar to what is shown in review and pay screen 1018, but may also include additional information about any loyalty discounts that are being applied to the transaction. For example, the user may be shown a purchase summary itemizing the subtotal, shipping costs, loyalty discount, and tax applied to the transaction. The user may also be shown a total for the transaction and may be presented with a button that allows the user to approve the transaction.

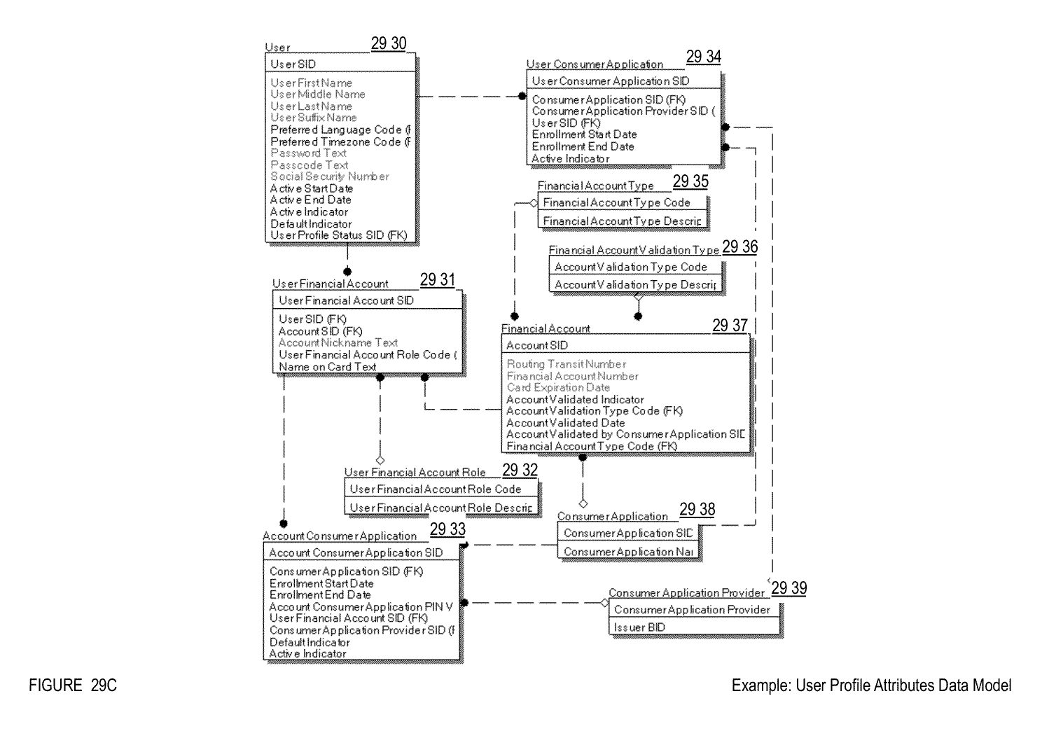

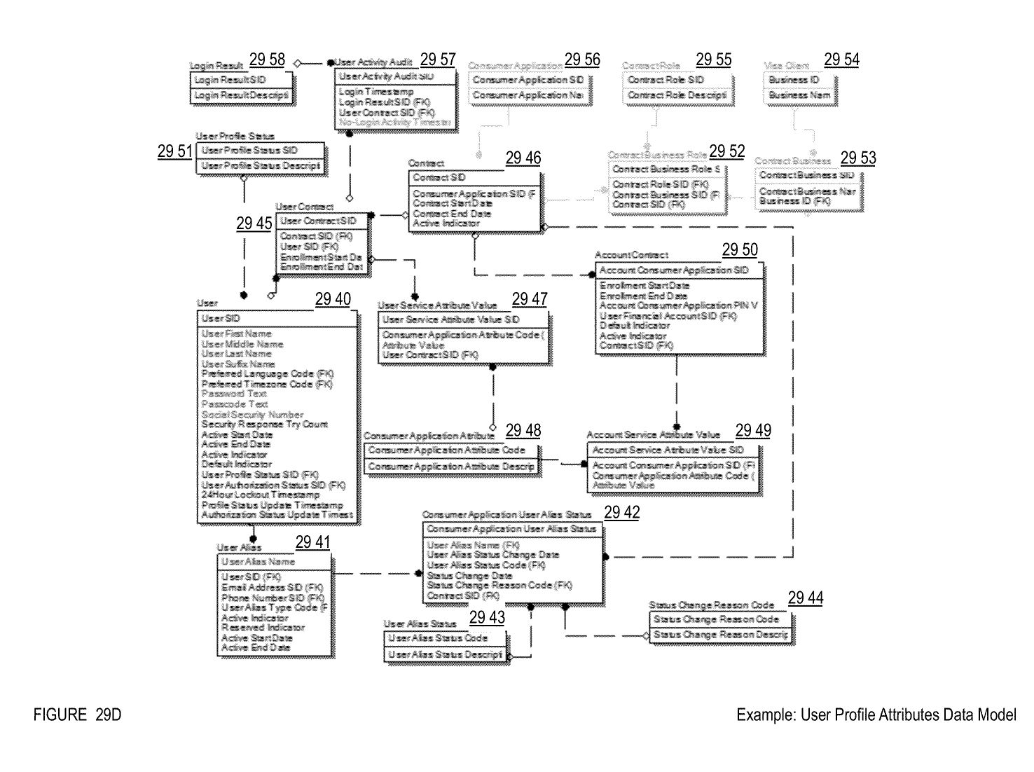

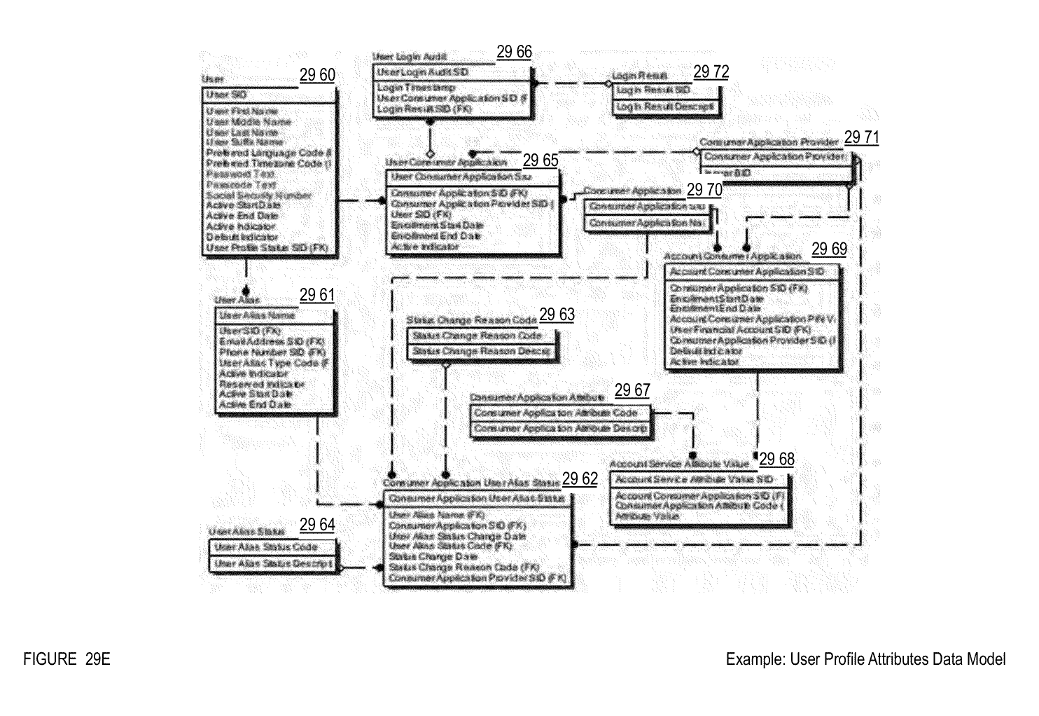

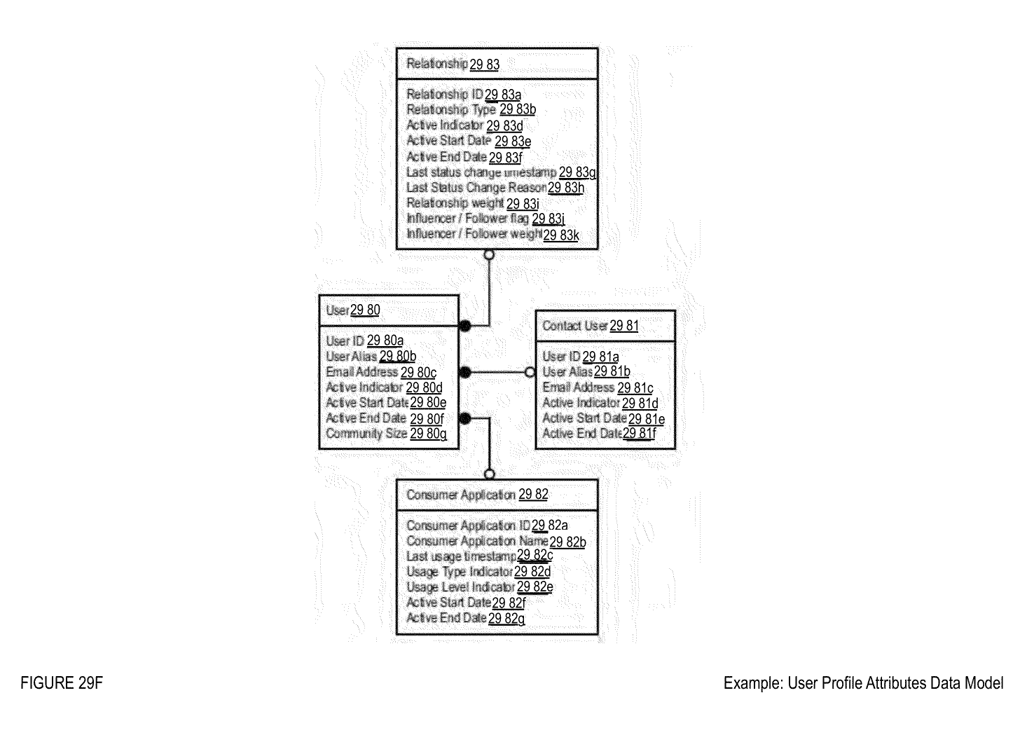

Within implementations, the EOOR may be integrated with an electronic mobile wallet, which may transform touchscreen inputs into a virtual wallet mobile application interface, via EOOR components, into purchase transaction triggers and receipt notices. FIG. 111 shows a block diagram illustrating example aspects of virtual mobile wallet purchasing in some embodiments of the EOOR. In some implementations, the EOOR may facilitate use of a virtual wallet, e.g., 1100, for conducting purchase transactions. For example, a user 1101 may utilize a mobile device 1102 (e.g., smartphone, tablet computer, etc.) to conduct a purchase transaction for contents of a cart 1103 (e.g., physical cart at a brick-and-mortar store, virtual cart at an online shopping site), optionally at a point-of-sale (PoS) client 1104 (e.g., legacy terminal at a brick-and-mortar store, computing device at an online shopping site, another user with a virtual wallet application, for person-to-person funds transfers, etc.). The user may be able to choose from one or more cards to utilize for a transactions, the cards chosen from a virtual wallet of cards stored within a virtual mobile wallet application executing on the mobile device. Upon selecting one or more of the card options, the mobile device may communicate (e.g., via one/two-way near-field communication [NFC], Bluetooth, Wi-Fi, cellular connection, creating and capturing images of QR codes, etc.) the card selection information to the PoS terminal for conducting the purchase transaction. In some embodiments, the mobile device may obtain a purchase receipt upon completion of authorization of the transaction. Various additional features may be provided to the user via the virtual mobile wallet application executing on the mobile device, as described further below in the discussion with reference to at least FIGS. 12-64.

FIGS. 2A-B shows user interface diagrams illustrating example aspects of a shopping mode of a virtual wallet application in some embodiments of the EOOR. With reference to FIG. 12A, in some embodiments, a user may utilize a virtual wallet application 1201 to engage in purchase transactions. In various embodiments described herein, the virtual wallet application may provide numerous features to facilitate the user's shopping experience 1202. For example, the virtual wallet application may allow a user to perform broad searches for products 1203, as discussed further below in the discussion with reference to FIG. 12B.

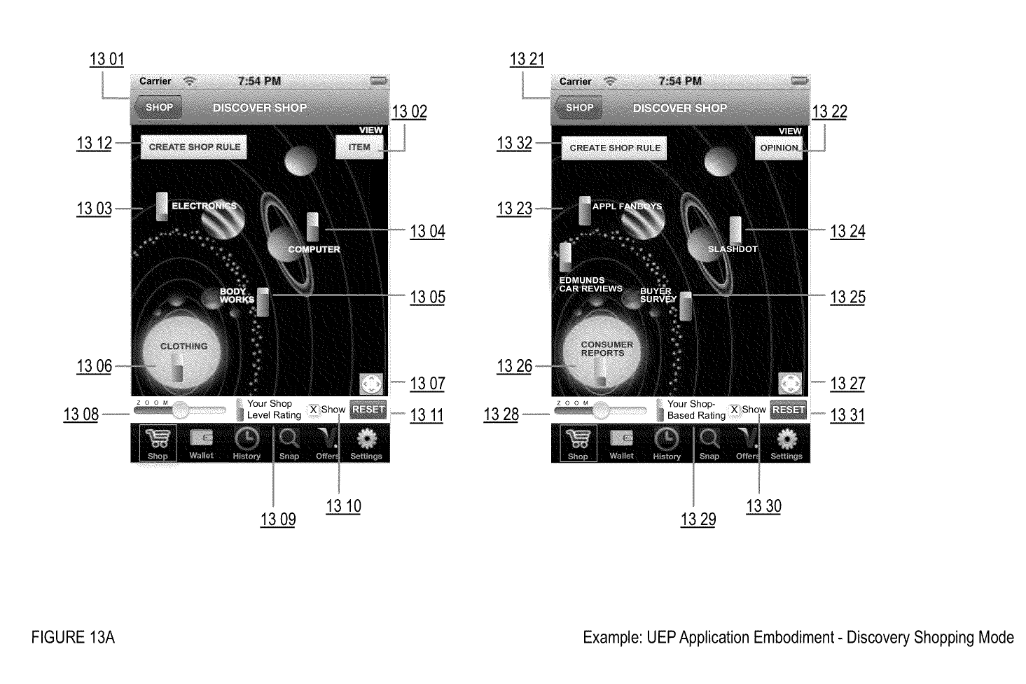

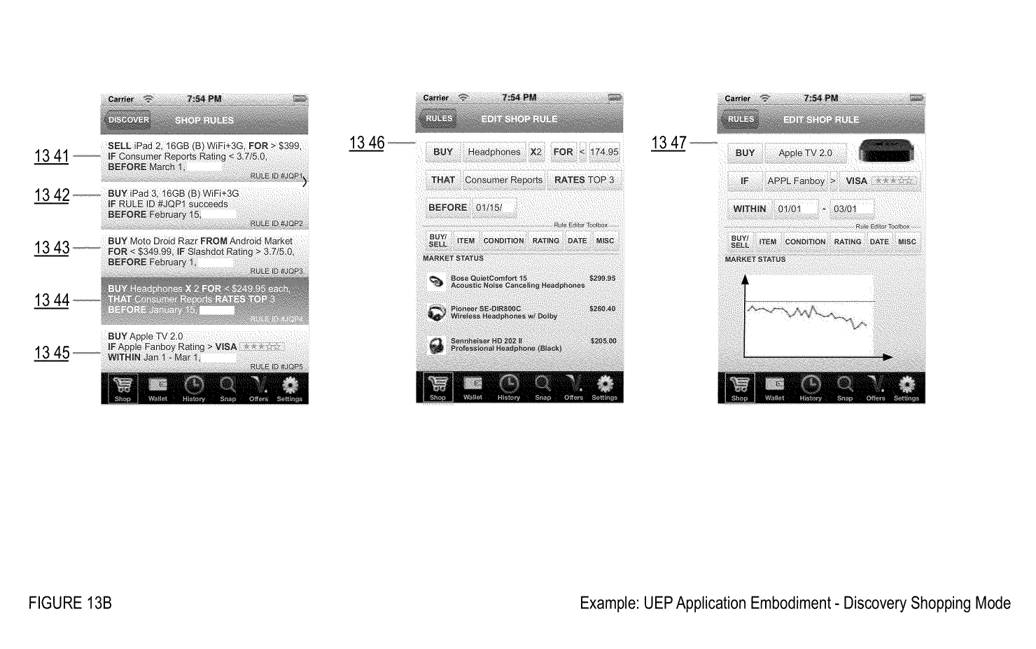

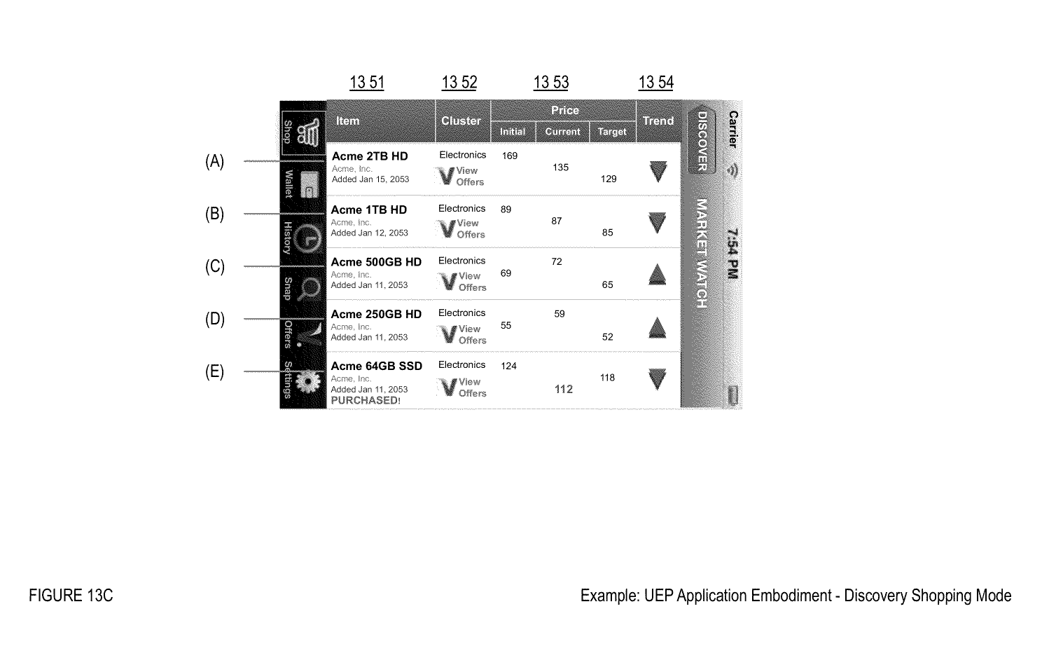

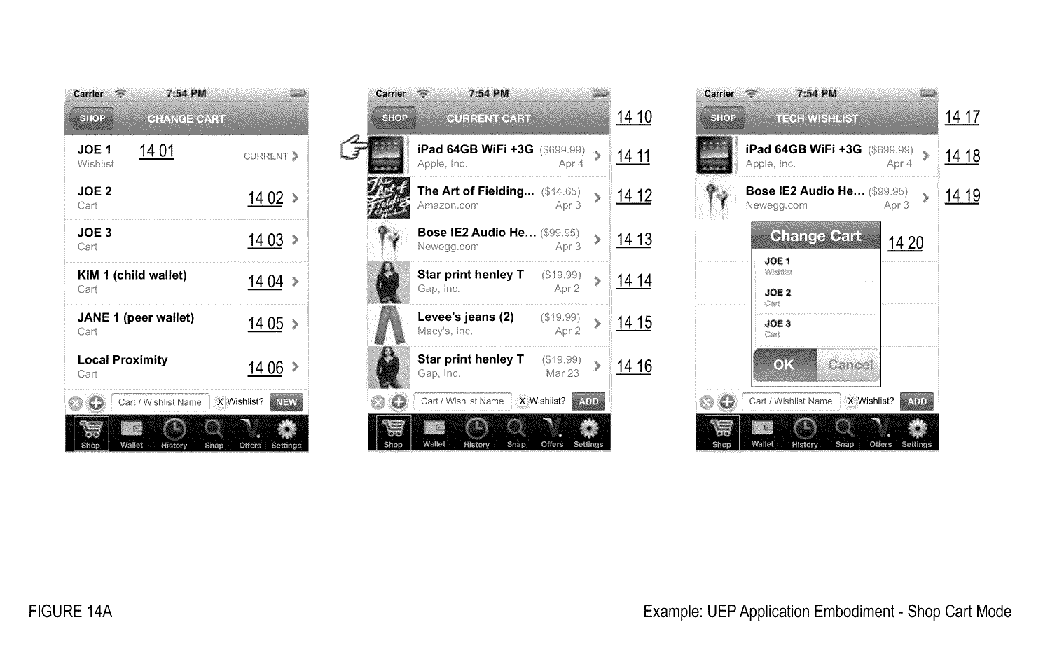

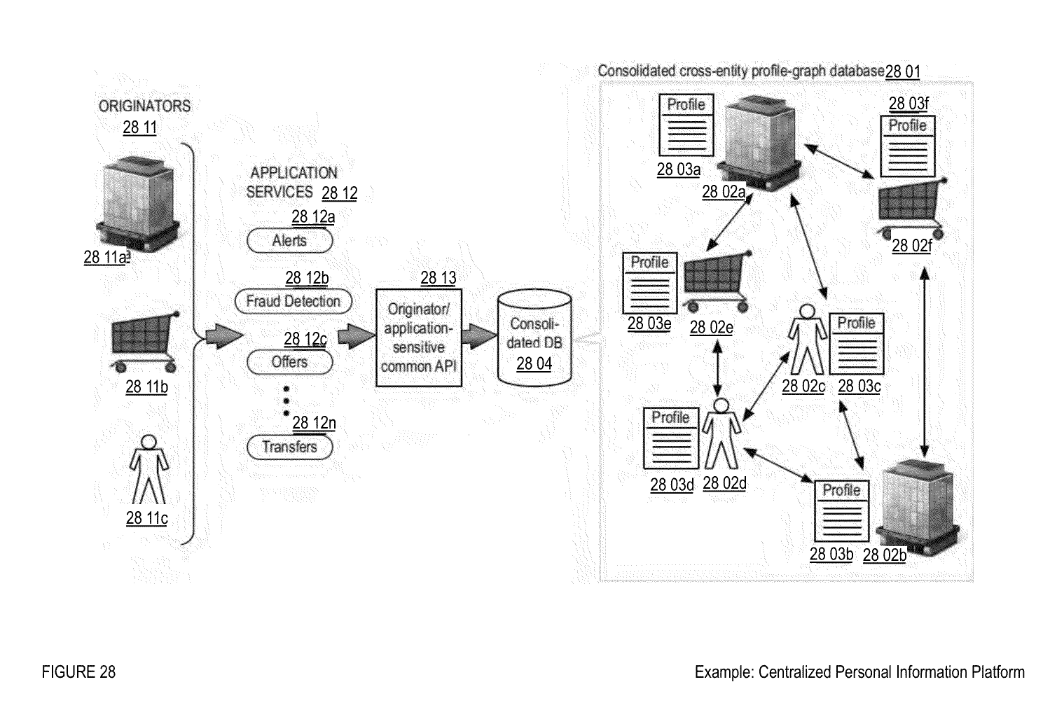

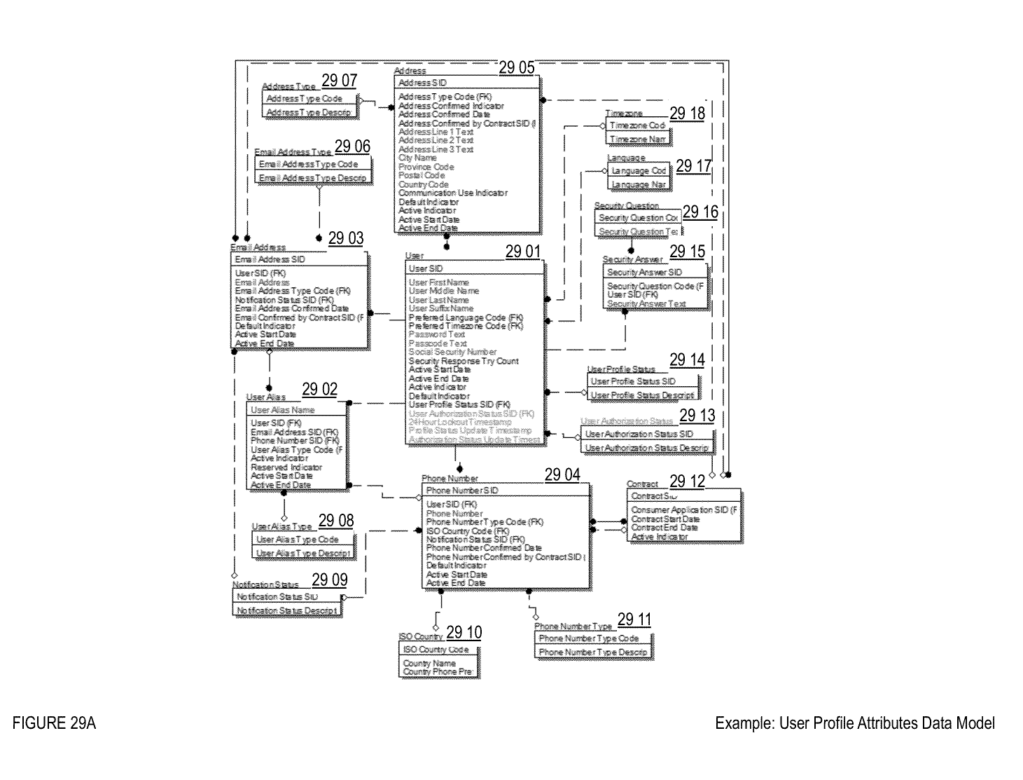

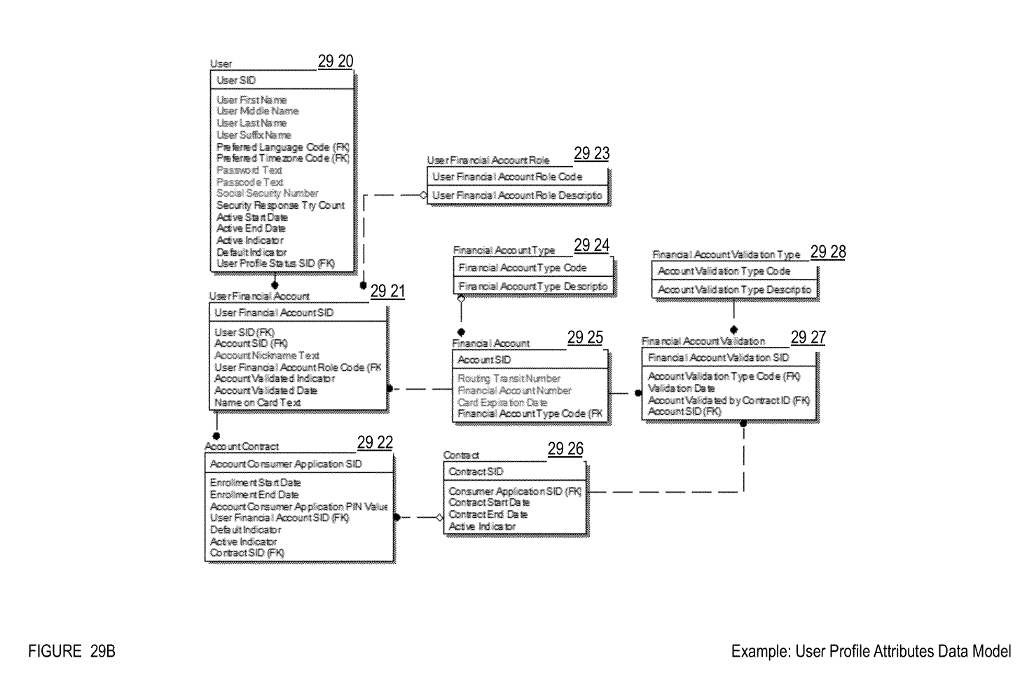

In some implementations, the virtual wallet application may provide a ‘discover shopping’ mode 1211. For example, the virtual wallet application executing on a user device may communicate with a server. The server may provide information to the virtual wallet on the consumer trends across a broad range of consumers in the aggregate. For example, the server may indicate what types of transactions consumers in the aggregate are engaging in, what they are buying, which reviews they pay attention to, and/or the like. In some implementations, the virtual wallet application may utilize such information to provide a graphical user interface to facilitate the user's navigation through such aggregate information, such as described in the discussion below with reference to FIGS. 13A-C. For example, such generation of aggregate information may be facilitate by the EOOR's use of centralized personal information platform components described below in the discussion with reference to FIGS. 28-47.

In some implementations, the virtual wallet application may allow the user to simultaneously maintain a plurality of shopping carts, e.g., 1212-1213. Such carts may, in some implementation, be purely virtual carts for an online website, but in alternate implementations, may reflect the contents of a physical cart in a merchant store. In some implementations, the virtual wallet application may allow the user to specify a current cart to which items the user desires will be placed in by default, unless the user specifies otherwise. In some implementations, the virtual wallet application may allow the user to change the current cart (e.g., 1213). In some implementations, the virtual wallet application may allow the user to create wishlists that may be published online or at social networks to spread to the user's friends. In some implementations, the virtual wallet application may allow the user to view, manage, and pay bills for the user, 1214. For example, the virtual wallet application may allow the user to import bills into the virtual wallet application interface by taking a snapshot of the bill, by entering information about the bill sufficient for the virtual wallet application to establish a communication with the merchant associated with the bill, etc.

In some implementations, the virtual wallet application may allow the user to shop within the inventories of merchants participating in the virtual wallet. For example, the inventories of the merchants may be provided within the virtual wallet application for the user to make purchases. In some implementations, the virtual wallet application may provide a virtual storefront for the user within the graphical user interface of the virtual wallet application. Thus, the user may be virtually injected into a store of the merchant participating in the EOOR's virtual wallet application.

In some implementations, the virtual wallet application may utilize the location coordinates of the user device (e.g., via GPS, IP address, cellular tower triangulation, etc.) to identify merchants that are in the vicinity of the user's current location. In some implementations, the virtual wallet application may utilize such information to provide information to the user on the inventories of the merchants in the locality, and or may inject the merchant store virtually into the user's virtual wallet application.

In some implementations, the virtual wallet application may provide a shopping assistant 1204. For example, a user may walk into a physical store of a merchant. The user may require assistance in the shopping experience. In some implementations, the virtual wallet application may allow the user to turn on the shop assistant (see 1217), and a store executive in the merchant store may be able to assist the user via another device. In some embodiments, a user may enter into a store (e.g., a physical brick-and-mortar store, virtual online store [via a computing device], etc.) to engage in a shopping experience. The user may have a user device. The user device 102 may have executing thereon a virtual wallet mobile app, including features such as those as described herein. Upon entering the store, the user device may communicate with a store management server. For example, the user device may communicate geographical location coordinates, user login information and/or like check-in information to check in automatically into the store. In some embodiments, the EOOR may inject the user into a virtual wallet store upon check in. For example, the virtual wallet app executing on the user device may provide features as described below to augment the user's in-store shopping experience. In some embodiments, the store management server may inform a customer service representative (“CSR”) of the user's arrival into the store. For example, the CSR may have a CSR device, and an app (“CSR app”) may be executing thereon. For example, the app may include features such as described below in the discussion herein. The CSR app may inform the CSR of the user's entry, including providing information about the user's profile, such as the user's identity, user's prior and recent purchases, the user's spending patterns at the current and/or other merchants, and/or the like. In some embodiments, the store management server may have access to the user's prior purchasing behavior, the user's real-time in-store behavior (e.g., which items' barcode did the user scan using the user device, how many times did the user scan the barcodes, did the user engage in comparison shopping by scanning barcodes of similar types of items, and/or the like), the user's spending patterns (e.g., resolved across time, merchants, stores, geographical locations, etc.), and/or like user profile information. The store management system may utilize this information to provide offers/coupons, recommendations and/or the like to the CSR and/or the user, via the CSR device and/or user device, respectively. In some embodiments, the CSR may assist the user in the shopping experience. For example, the CSR may convey offers, coupons, recommendations, price comparisons, and/or the like, and may perform actions on behalf of the user, such as adding/removing items to the user's physical/virtual cart, applying/removing coupons to the user's purchases, searching for offers, recommendations, providing store maps, or store 3D immersion views, and/or the like. In some embodiments, when the user is ready to checkout, the EOOR may provide a checkout notification to the user's device and/or CSR device. The user may checkout using the user's virtual wallet app executing on the user device, or may utilize a communication mechanism (e.g., near field communication, card swipe, QR code scan, etc.) to provide payment information to the CSR device. Using the payment information, the EOOR may initiate the purchase transaction(s) for the user, and provide an electronic receipt to the user device and/or CSR device. Using the electronic receipt, the user may exit the store with proof of purchase payment.

With reference to FIG. 12B, in some implementations, the virtual wallet application 1221 may provide a broad range of search results 1222 in response to a user providing search keywords and/or filters for a search query. For example, the in the illustration of FIG. 12B, a user searched for all items including “Acme” that were obtained by taking a snapshot of an item (as discussed further below in greater detail), and were dated in the year “2052” (see 1223). In some implementations the search results may include historical transactions of the user 1231, offers (235, for a new account, which the user can import into the virtual wallet application) and/or recommendations for the user based on the user's behavioral patterns, coupons 1232, bills 1234, discounts, person-2-person transfer requests 1236, etc., or offers based on merchant inventory availability, and/or the like. For example, the search results may be organized according to a type, date, description, or offers. In some implementations, the descriptions may include listings of previous prior (e.g., at the time of prior purchase), a current price at the same location where it was previously bought, and/or other offers related to the item (see, e.g., 1231). Some of the offerings may be stacked on top of each other, e.g., they may be applied to the same transaction. In some instances, such as, e.g., the payment of bills (see 1234), the items may be paid for by an auto-pay system. In further implementations, the user may be have the ability to pay manually, or schedule payments, snooze a payment (e.g., have the payment alerts show up after a predetermined amount of time, with an additional interest charge provided to account for the delayed payment), and/or modify other settings (see 1234). In some implementations, the user may add one or more of the items listed to a cart, 1224, 1237. For example, the user may add the items to the default current cart, or may enter the name of an alternate (or new cart/wishlist) to add the items, and submit the command by activating a graphical user interface (“GUI”) element 1237.

FIGS. 13A-C show user interface diagrams illustrating example aspects of a discovery shopping mode of a virtual wallet application in some embodiments of the EOOR. In some embodiments, the virtual wallet application may provide a ‘discovery shopping’ mode for the user. For example, the virtual wallet application may obtain information on aggregate purchasing behavior of a sample of a population relevant to the user, and may provide statistical/aggregate information on the purchasing behavior for the user as a guide to facilitate the user's shopping. For example, with reference to FIG. 13A, the discovery shopping mode 1301 may provide a view of aggregate consumer behavior, divided based on product category (see 1302). For example, the centralized personal information platform components described below in the discussion with reference to FIGS. 28-47 may facilitate providing such data for the virtual wallet application. Thus, the virtual wallet application may provide visualization of the magnitude of consumer expenditure in particular market segment, and generate visual depictions representative of those magnitudes of consumer expenditure (see 1303-1306). In some embodiments, the virtual wallet application may also provide an indicator (see 1309) of the relative expenditure of the user of the virtual wallet application (see blue bars); thus the user may be able to visualize the differences between the user's purchasing behavior and consumer behavior in the aggregate. The user may be able to turn off the user's purchasing behavior indicator (see 1310). In some embodiments, the virtual wallet application may allow the user to zoom in to and out of the visualization, so that the user may obtain a view with the appropriate amount of granularity as per the user's desire (see 1307-1308). At any time, the user may be able to reset the visualization to a default perspective (see 1311).

Similarly, the discovery shopping mode 1321 may provide a view of aggregate consumer response to opinions of experts, divided based on opinions of experts aggregated form across the web (see 1302). For example, the centralized personal information platform components described below in the discussion with reference to FIGS. 28-47 may facilitate providing such data for the virtual wallet application. Thus, the virtual wallet application may provide visualizations of how well consumers tend to agree with various expert opinion on various product categories, and whose opinions matter to consumers in the aggregate (see 1323-1326). In some embodiments, the virtual wallet application may also provide an indicator (see 1329) of the relative expenditure of the user of the virtual wallet application (see blue bars); thus the user may be able to visualize the differences between the user's purchasing behavior and consumer behavior in the aggregate. The user may be able to turn off the user's purchasing behavior indicator (see 1330). In some embodiments, the virtual wallet application may allow the user to zoom in to and out of the visualization, so that the user may obtain a view with the appropriate amount of granularity as per the user's desire (see 1327-1328). At any time, the user may be able to reset the visualization to a default perspective (see 1331).

With reference to FIG. 13B, in some implementations, the virtual wallet application may allow users to create targeted shopping rules for purchasing (see FIG. 13A, 1312, 1322). For example, the user may utilize the consumer aggregate behavior and the expert opinion data to craft rules on when to initiate purchases automatically. As an example, rule 1341 specifies that the virtual wallet should sell the users iPad2 if its consumer reports rating falls below 13.75/5.0, before March 1, provided a sale price of $399 can be obtained. As another example, rule 1342 specifies that the virtual wallet should buy an iPad3 if rule 1341 succeeds before February 15. As another example, rule 1343 specifies that the wallet should buy a Moto Droid Razr from the Android Market for less than $349.99 if its Slashdot rating is greater than 13.75 before February 1. Similarly, numerous rules with a wide variety of variations and dependencies may be generated for targeted shopping in the discovery mode. In some implementations, the virtual wallet user may allow the user to modify a rule. For example, the wallet may provide the user with an interface similar to 1346 or 1347. The user may utilize tools available in the rule editor toolbox to design the rule according to the user's desires. In some implementations, the wallet may also provide a market status for the items that are subject to the targeted shopping rules.

With reference to FIG. 13C, in some implementations, the virtual wallet application may provide a market watch feature, wherein the trends associated with items subject to targeted shopping rules may be tracked and visually represented for the user. For example, the visualization may take, in some implementations, the form of a ticker table, wherein against each item 1351(A)-(E) are listed a product category or cluster of expert opinions to which the product is related 1352, pricing indicators, including, but not limited to: price at the time of rule creation 1352, price at the time of viewing the market watch screen 1353, and a target price for the items (A)-(E). Based on the prices, the market watch screen may provide a trending symbol (e.g., up, down, no change, etc.) for each item that is subject to a targeted shopping rule. Where an item satisfied the targeted rule (see item (E)), the virtual wallet may automatically initiate a purchase transaction for that item once the target price is satisfied.

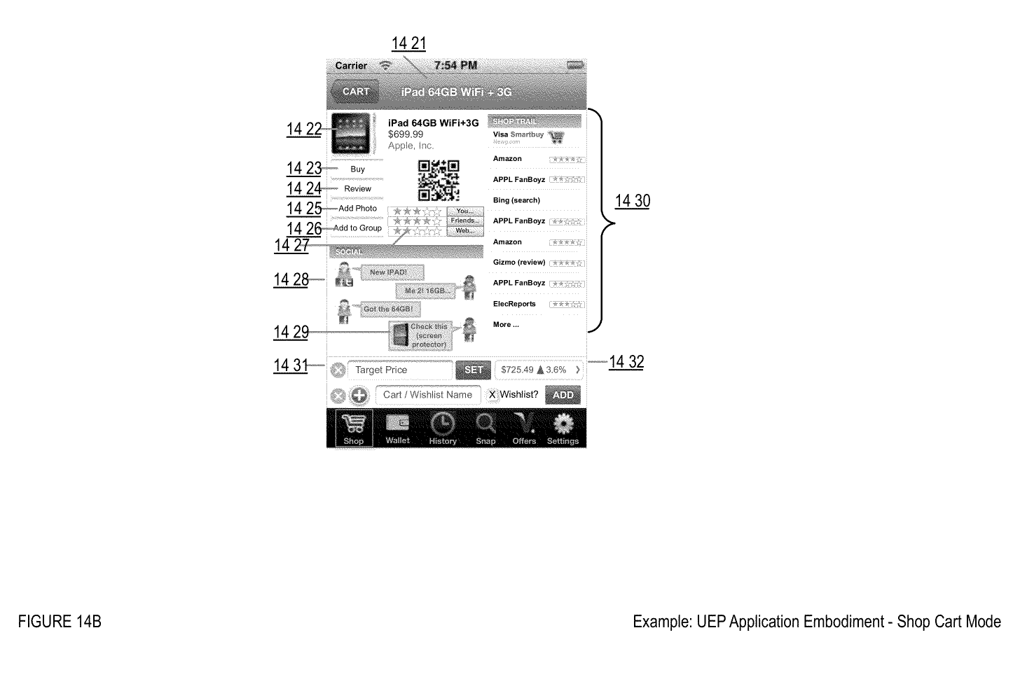

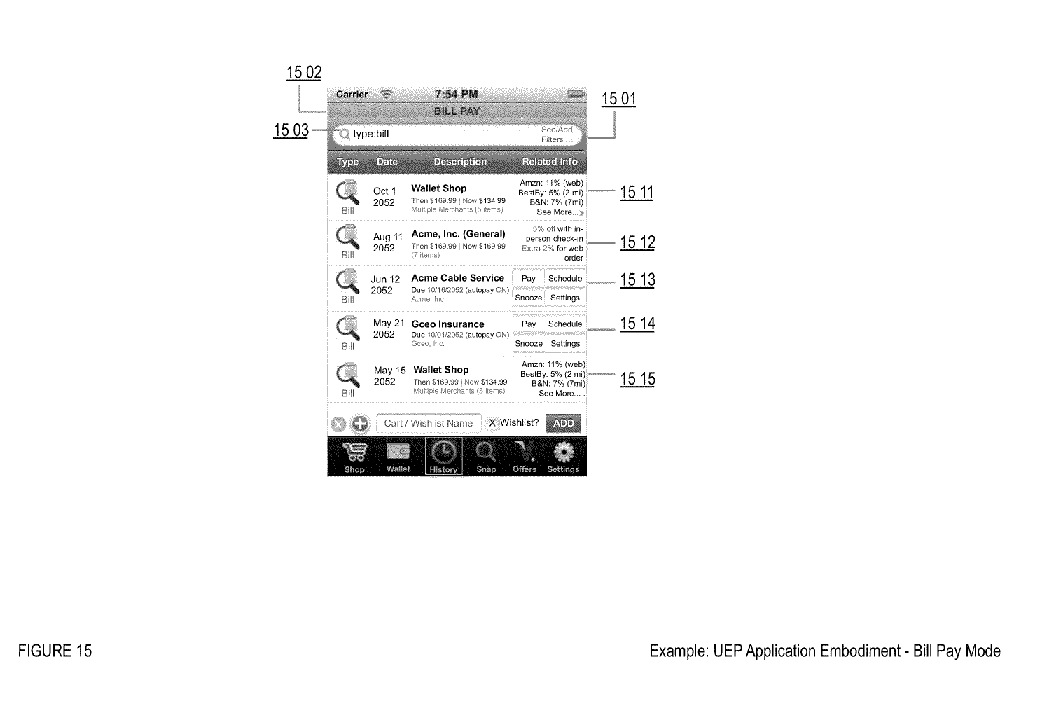

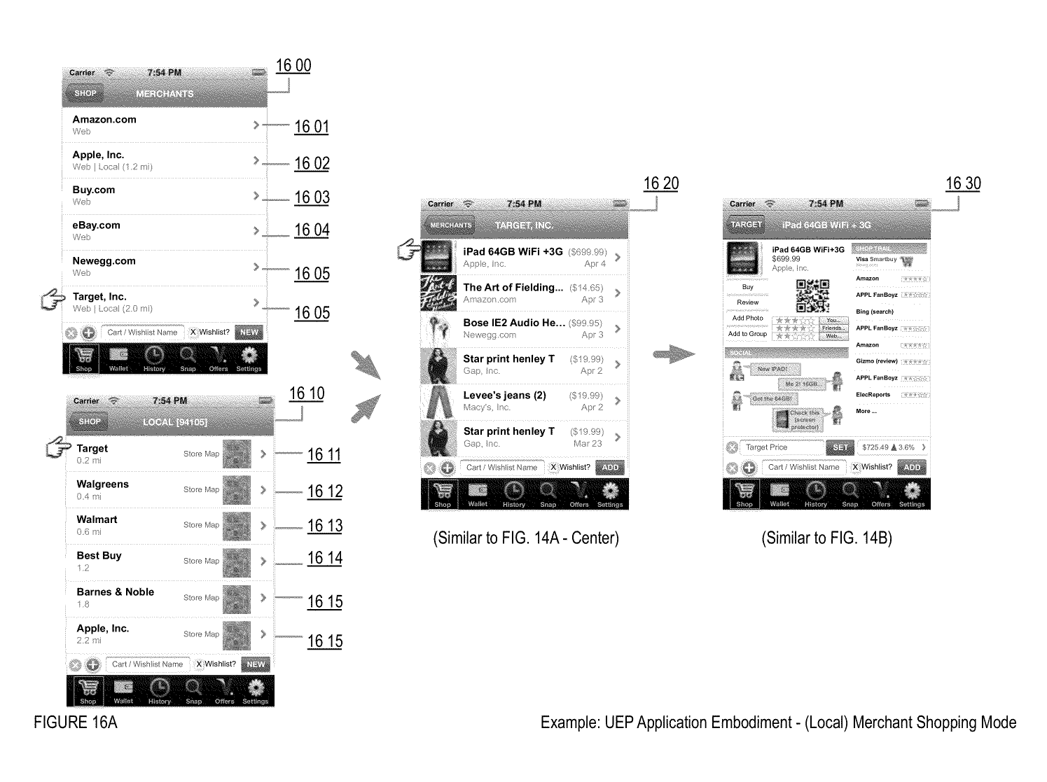

FIGS. 14A-B show user interface diagrams illustrating example aspects of a shopping cart mode of a virtual wallet application in some embodiments of the EOOR. With reference to FIG. 14A, in some implementations, the virtual wallet application may be able to store, maintain and manage a plurality of shopping carts and/or wishlists (401-406) for a user. The carts may be purely virtual, or they may represent the contents of a physical cart in a merchant store. The user may activate any of the carts listed to view the items currently stored in a cart (e.g., 1410-416). In some implementations, the virtual wallet application may also provide wishlists, e.g., tech wishlist 1417, with items that the user desires to be gifted (see 1418-419). In some implementations, the virtual wallet may allow the user to quickly change carts or wishlists from another cart or wishlist, using a pop-up menu, e.g., 1420.

With reference to FIG. 14B, in one implementation, the user may select a particular item to obtain a detailed view of the item, 1421. For example, the user may view the details of the items associated with the transaction and the amount(s) of each item, the merchant, etc., 1422. In various implementations, the user may be able to perform additional operations in this view. For example, the user may (re)buy the item 1423, obtain third-party reviews of the item, and write reviews of the item 1424, add a photo to the item so as to organize information related to the item along with the item 1425, add the item to a group of related items (e.g., a household), 1426, provide ratings 1427, or view quick ratings from the user's friends or from the web at large. For example, such systems may be implemented using the example centralized personal information platform components described below in the discussion with reference to FIGS. 28-47. The user may add a photo to the transaction. In a further implementation, if the user previously shared the purchase via social channels, a post including the photo may be generated and sent to the social channels for publishing. In one implementation, any sharing may be optional, and the user, who did not share the purchase via social channels, may still share the photo through one or more social channels of his or her choice directly from the history mode of the wallet application. In another implementation, the user may add the transaction to a group such as company expense, home expense, travel expense or other categories set up by the user. Such grouping may facilitate year-end accounting of expenses, submission of work expense reports, submission for value added tax (VAT) refunds, personal expenses, and/or the like. In yet another implementation, the user may buy one or more items purchased in the transaction. The user may then execute a transaction without going to the merchant catalog or site to find the items. In a further implementation, the user may also cart one or more items in the transaction for later purchase.

The virtual wallet, in another embodiment, may offer facilities for obtaining and displaying ratings 1427 of the items in the transaction. The source of the ratings may be the user, the user's friends (e.g., from social channels, contacts, etc.), reviews aggregated from the web, and/or the like. The user interface in some implementations may also allow the user to post messages to other users of social channels (e.g., TWITTER or FACEBOOK). For example, the display area 1428 shows FACEBOOK message exchanges between two users. In one implementation, a user may share a link via a message 1429. Selection of such a message having embedded link to a product may allow the user to view a description of the product and/or purchase the product directly from the history mode.

In some implementations, the wallet application may display a shop trail for the user, e.g., 1430. For example, a user may have reviewed a product at a number of websites (e.g., ElecReports, APPL FanBoys, Gizmo, Bing, Amazon, Visa Smartbuy feature (e.g., that checks various sources automatically for the best price available according to the user preferences, and provides the offer to the user), etc.), which may have led the user to a final merchant website where the user finally bought the product. In some implementations, the EOOR may identify the websites that the user visited, that contributed to the user deciding to buy the product, and may reward them with a share of the revenues obtained by the “point-of-sale” website for having contributed to the user going to the point-of-sale website and purchasing the product there. For example, the websites may have agreements with product manufacturers, wholesalers, retail outlets, payment service providers, payment networks, amongst themselves, and/or the like with regard to product placement, advertising, user redirection and/or the like.

Accordingly, the EOOR may calculate a revenue share for each of the websites in the user's shopping trail using a revenue sharing model, and provide revenue sharing for the websites.

In some implementations, the virtual wallet may provide a SmartBuy targeted shopping feature. For example, the user may set a target price 1431 for the product 1422 that the user wishes to buy. The virtual wallet may provide a real-time market watch status update 1432 for the product. When the market price available for the user falls below the user's target price 1431, the virtual wallet may automatically buy the product for the user, and provide a shipment/notification to the user.

FIG. 15 shows a user interface diagram illustrating example aspects of a bill payment mode of a virtual wallet application in some embodiments of the EOOR. In some implementations, the virtual wallet application may provide a list of search results for bills 1501-1503 in response to a user activating element 1214 in FIG. 12A. In some implementations the search results may include historical billing transactions of the user, as well as upcoming bills (e.g., 1511-1515). For example, the search results may be organized according to a type, date, description. In some implementations, the descriptions may include listings of previous prior (e.g., at the time of prior purchase), a current price at the same location where it was previously bought, and/or other offers related to the item (see, e.g., 1511). In some instances, such as, e.g., the payment of bills (see 1514), the items may be paid for by an auto-pay system. In further implementations, the user may be have the ability to pay manually, or schedule payments, snooze a payment (e.g., have the payment alerts show up after a predetermined amount of time, with an additional interest charge provided to account for the delayed payment), and/or modify other settings (see 1514).

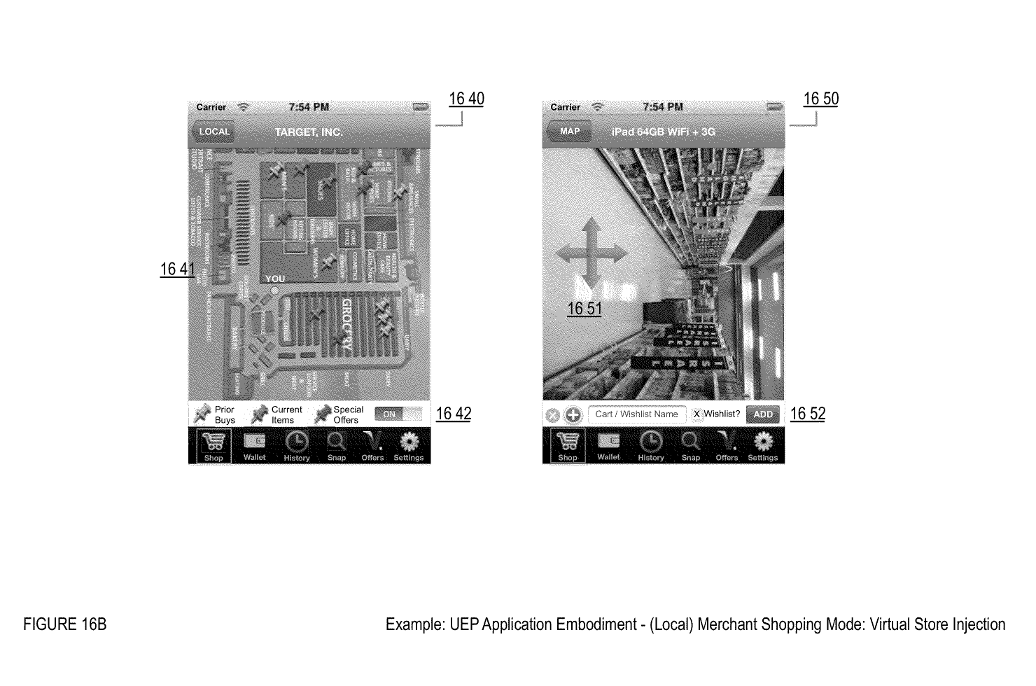

FIGS. 16A-B show user interface diagrams illustrating example aspects of a (local proximity) merchant shopping mode of a virtual wallet application in some embodiments of the EOOR. In some implementations, upon activating elements 1215 of 1216 in FIG. 12A, the virtual wallet application may presents screens 1600 and 1610, respectively, as depicted in FIG. 16A. In FIG. 16, 1600, the virtual wallet application displays a list of merchants participating in the virtual wallet of the EOOR, e.g., 1601-1605. Similarly, in FIG. 16, 1610, the virtual wallet application displays a list of merchants participating in the virtual wallet of the EOOR and at or nearby the approximate location of the user the user. The user may click on any of the merchants listed in the two screens 1600 and 1610, to be injected into the store inventory of the merchant. Upon injection, the user may be presented with a screen such as 1620, which is similar to the screen discussed above in the description with reference to FIG. 14A (center). Also, in some implementation, if a user clicks on any of the items listed on screen 1620, the user may be taken to a screen 1630, similar to the screen discussed above in the description with reference to FIG. 14B. With reference to FIG. 16B, in some embodiments, the user may be injected into a virtual reality 2D/3D storefront of the merchant. For example, the user may be presented with a plan map view of the store 1641. In some map views, the user may provided with the user's location (e.g., using GPS, or if not available, then using a coarse approximation using a cellular signal). In some implementations, the locations of the user's prior and current purchases may be provided for the user, if the user wishes (see 1642, the user can turn the indications off, in some implementations). In some implementations, the user may be provided with a 3D aisle view of an aisle within the virtual storefront. The user may point the view direction at any of the objects to obtain virtual tools to obtain items from off the “virtual shelf,” and place them in the user's virtual cart.

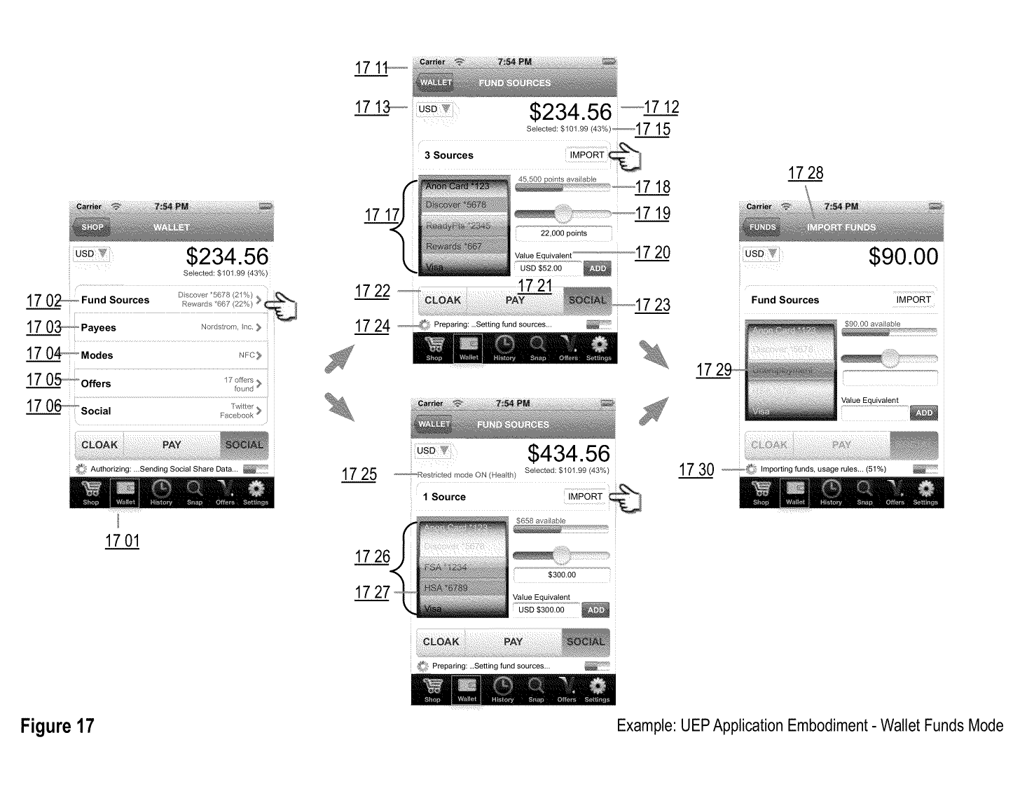

FIG. 17 shows user interface diagrams illustrating example aspects of allocating funds for a purchase payment within a virtual wallet application in some embodiments of the EOOR. In one embodiment, the wallet mobile application may provide a user with a number of options for paying for a transaction via the wallet mode 1701. The wallet mode may facilitate a user to set preferences for a payment transaction, including settings funds sources 1702, payee 1703, transaction modes 1704, applying real-time offers to the transaction 1705, and publishing the transaction details socially 1706, as described in further detail below.

In one implementation, an example user interface 1711 for making a payment is shown. The user interface may clearly identify the amount 1712 and the currency 1713 for the transaction. The amount may be the amount payable and the currency may include real currencies such as dollars and euros, as well as virtual currencies such as reward points. The user may select the funds tab 1702 to select one or more forms of payment 1717, which may include various credit, debit, gift, rewards and/or prepaid cards. The user may also have the option of paying, wholly or in part, with reward points. For example, the graphical indicator 1718 on the user interface shows the number of points available, the graphical indicator 1719 shows the number of points to be used towards the amount due 234.56 and the equivalent 1720 of the number of points in a selected currency (USD, for example).

In one implementation, the user may combine funds from multiple sources to pay for the transaction. The amount 1715 displayed on the user interface may provide an indication of the amount of total funds covered so far by the selected forms of payment (e.g., Discover card and rewards points). The user may choose another form of payment or adjust the amount to be debited from one or more forms of payment until the amount 1715 matches the amount payable 1714. Once the amounts to be debited from one or more forms of payment are finalized by the user, payment authorization may begin.

In one implementation, the user may select a secure authorization of the transaction by selecting the cloak button 1722 to effectively cloak or anonymize some (e.g., pre-configured) or all identifying information such that when the user selects pay button 1721, the transaction authorization is conducted in a secure and anonymous manner. In another implementation, the user may select the pay button 1721 which may use standard authorization techniques for transaction processing. In yet another implementation, when the user selects the social button 1723, a message regarding the transaction may be communicated to one of more social networks (set up by the user), which may post or announce the purchase transaction in a social forum such as a wall post or a tweet. In one implementation, the user may select a social payment processing option 1723. The indicator 1724 may show the authorizing and sending social share data in progress.

In another implementation, a restricted payment mode 1725 may be activated for certain purchase activities such as prescription purchases. The mode may be activated in accordance with rules defined by issuers, insurers, merchants, payment processor and/or other entities to facilitate processing of specialized goods and services. In this mode, the user may scroll down the list of forms of payments 1726 under the funds tab to select specialized accounts such as a flexible spending account (FSA), health savings account (HAS) 1727, and/or the like and amounts to be debited to the selected accounts. In one implementation, such restricted payment mode 1725 processing may disable social sharing of purchase information.

In one embodiment, the wallet mobile application may facilitate importing of funds via the import funds user interface 1728. For example, a user who is unemployed may obtain unemployment benefit fund 1729 via the wallet mobile application. In one implementation, the entity providing the funds may also configure rules for using the fund as shown by the processing indicator message 1730. The wallet may read and apply the rules prior, and may reject any purchases with the unemployment funds that fail to meet the criteria set by the rules. Example criteria may include, for example, merchant category code (MCC), time of transaction, location of transaction, and/or the like. As an example, a transaction with a grocery merchant having MCC 5411 may be approved, while a transaction with a bar merchant having an MCC 5813 may be refused.

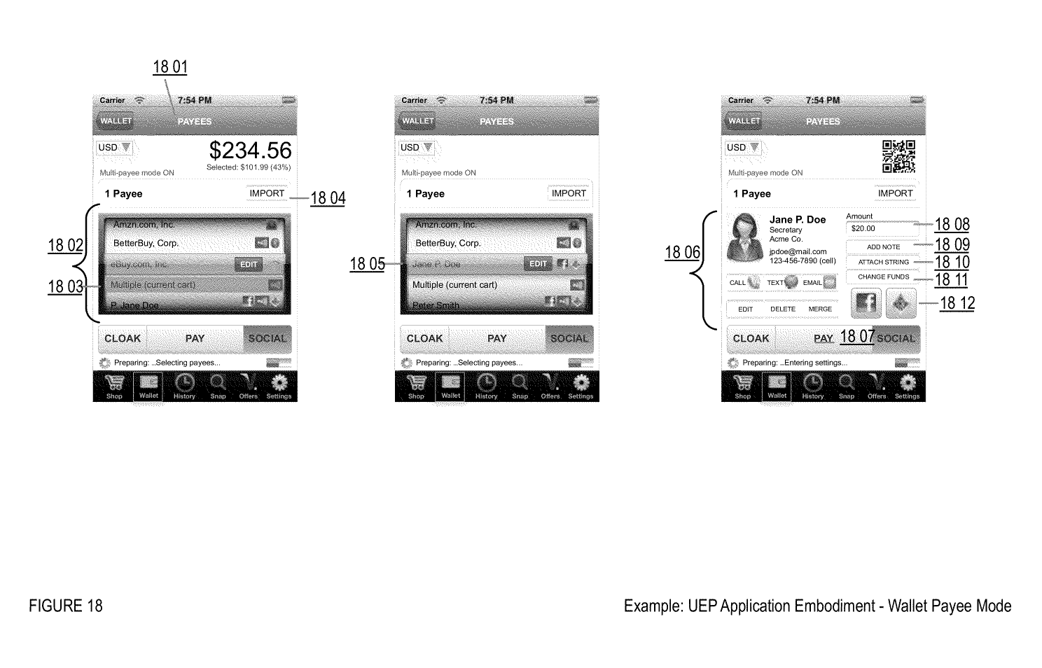

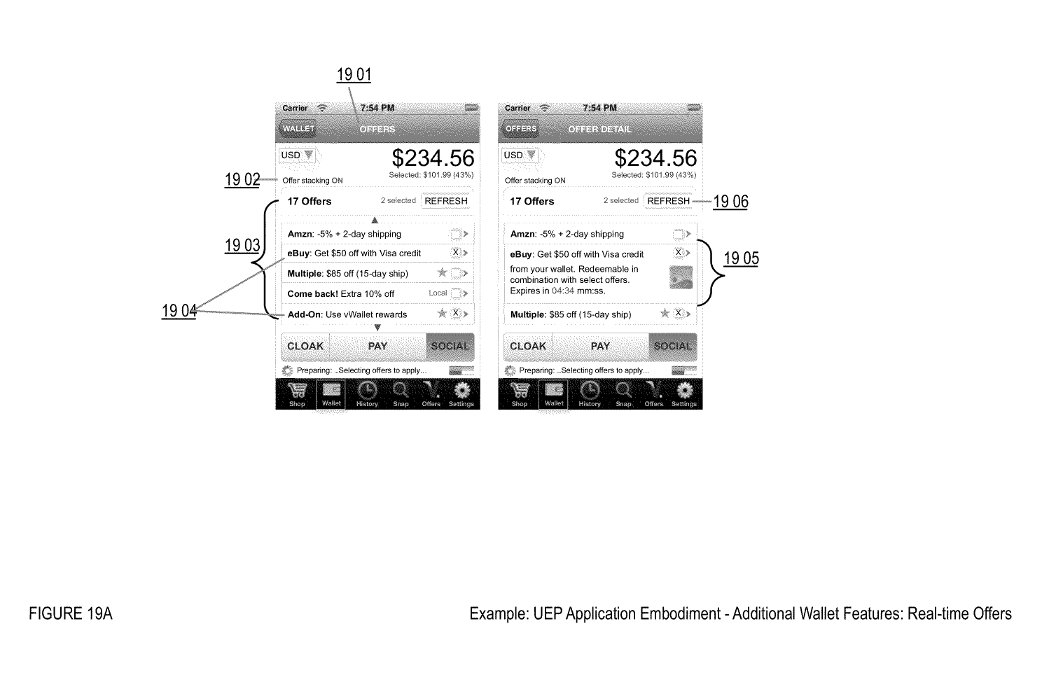

FIG. 18 shows user interface diagrams illustrating example aspects of selecting payees for funds transfers within a virtual wallet application in some embodiments of the EOOR. In one embodiment, the payee screen 1801 in the wallet mobile application user interface may facilitate user selection of one or more payees receiving the funds selected in the funds tab. In one implementation, the user interface may show a list of all payees 1802 with whom the user has previously transacted or available to transact. The user may then select one or more payees, 1803. For example, a selection may include a multiple-merchant entry—this may be the case when a user is paying for products in a cart, wherein the products themselves are from multiple merchants. In another example, the user may be paying for the products placed in a plurality of cart, each cart including products from one or more merchants. The payees 1803 may include larger merchants such as Amazon.com Inc., and individuals such as Jane P. Doe. Next to each payee name, a list of accepted payment modes for the payee may be displayed. In some implementations, the user may import 1804 additional names into the address book included within the user interface 1802.

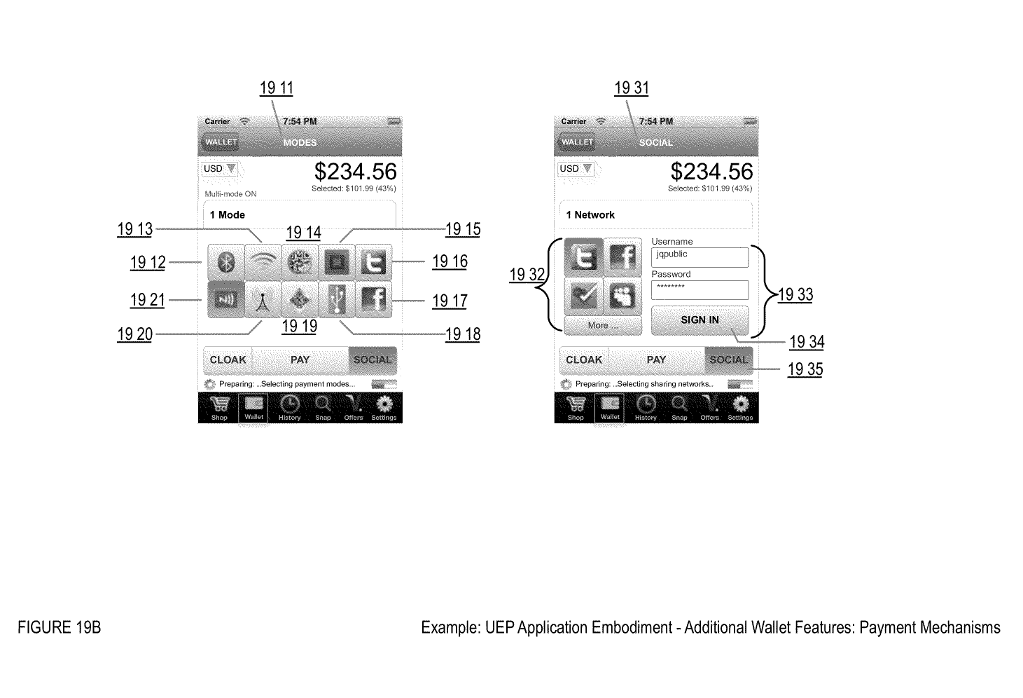

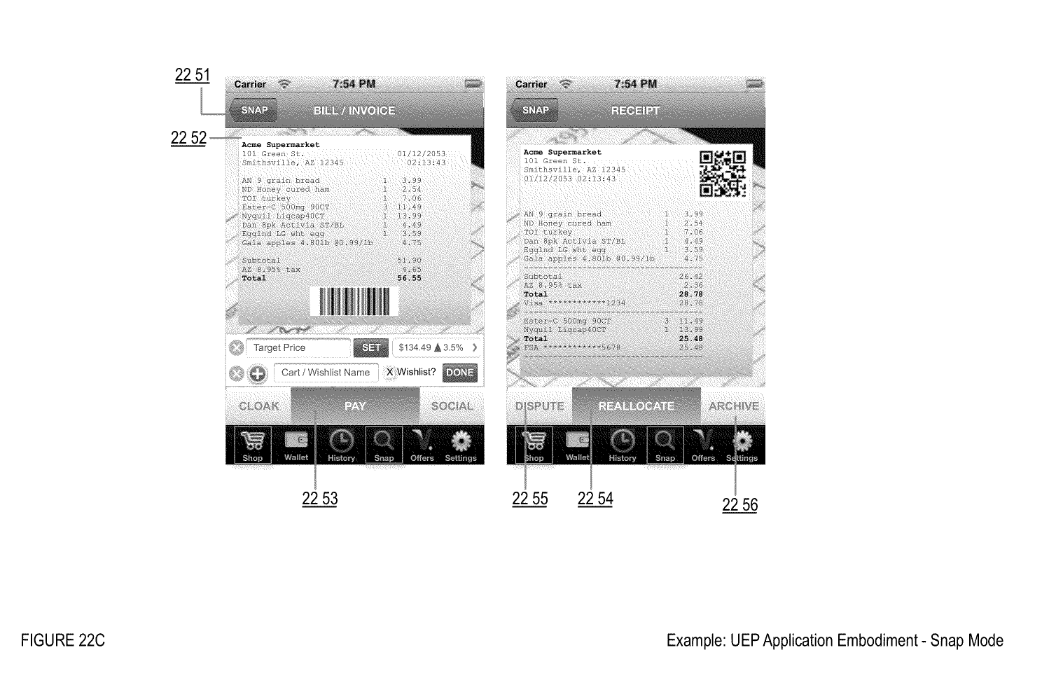

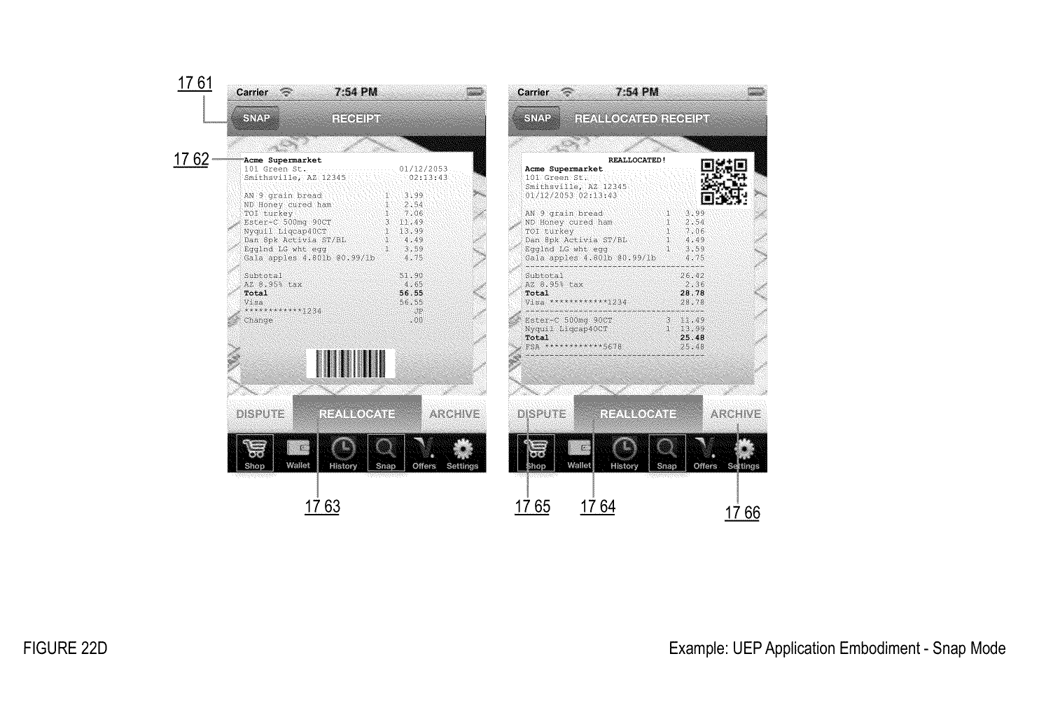

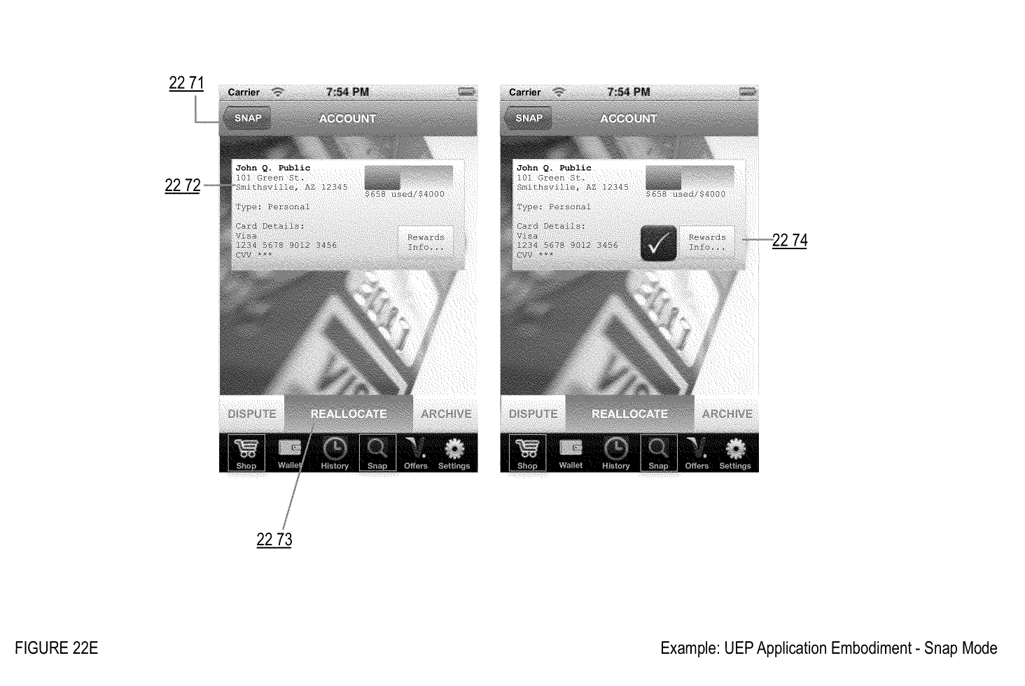

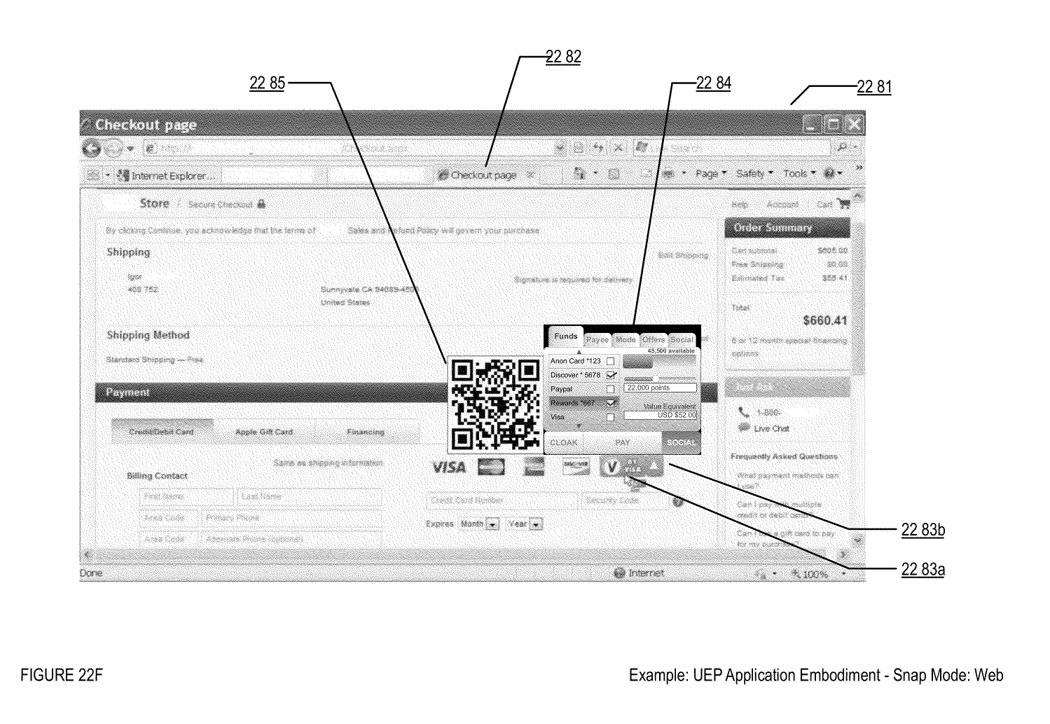

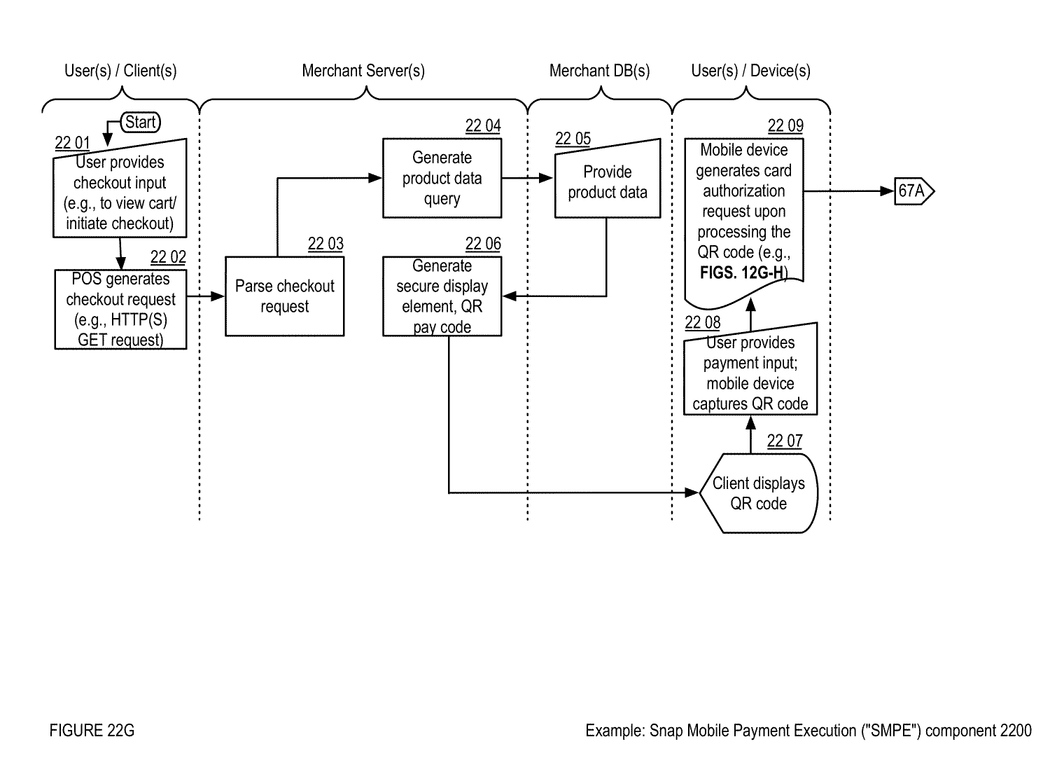

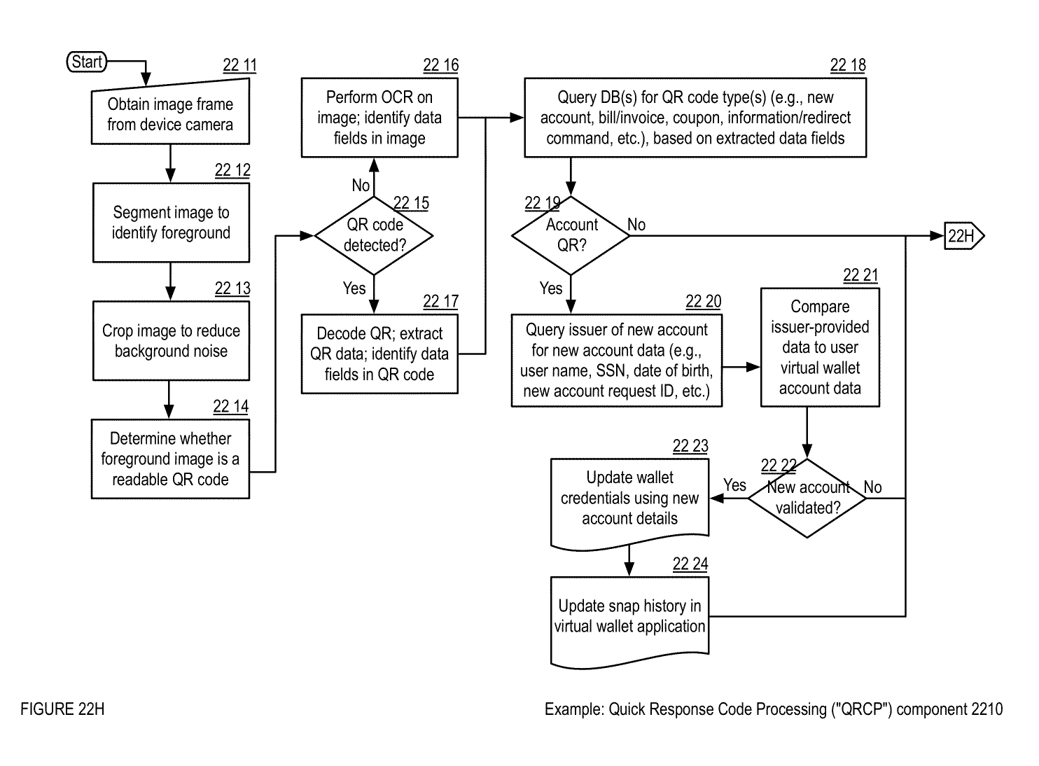

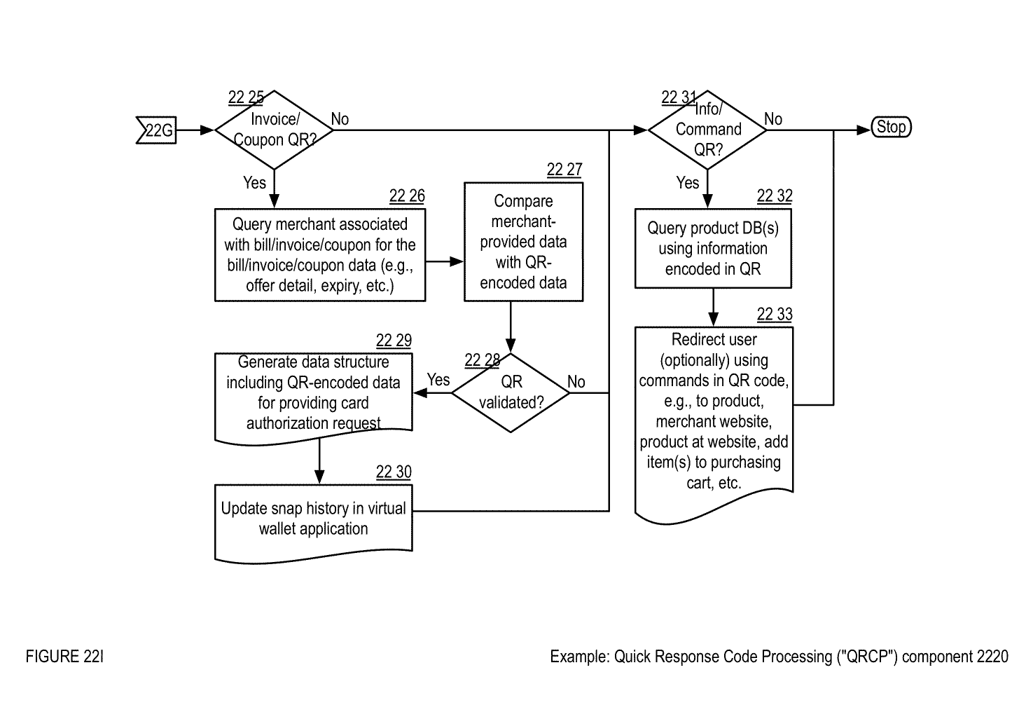

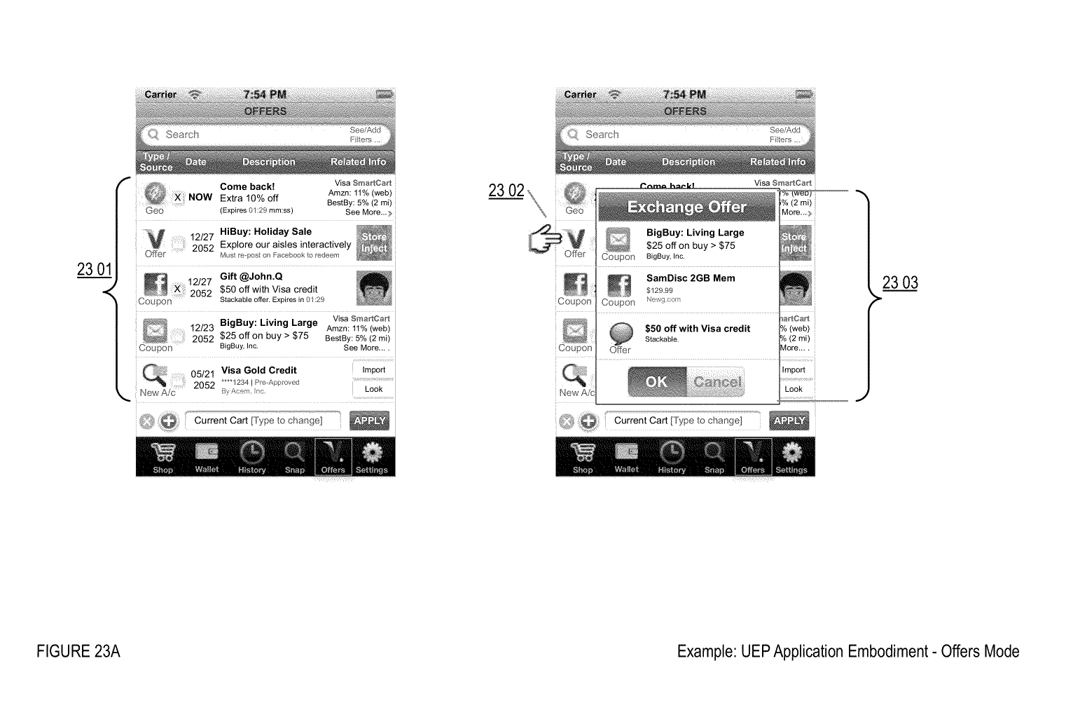

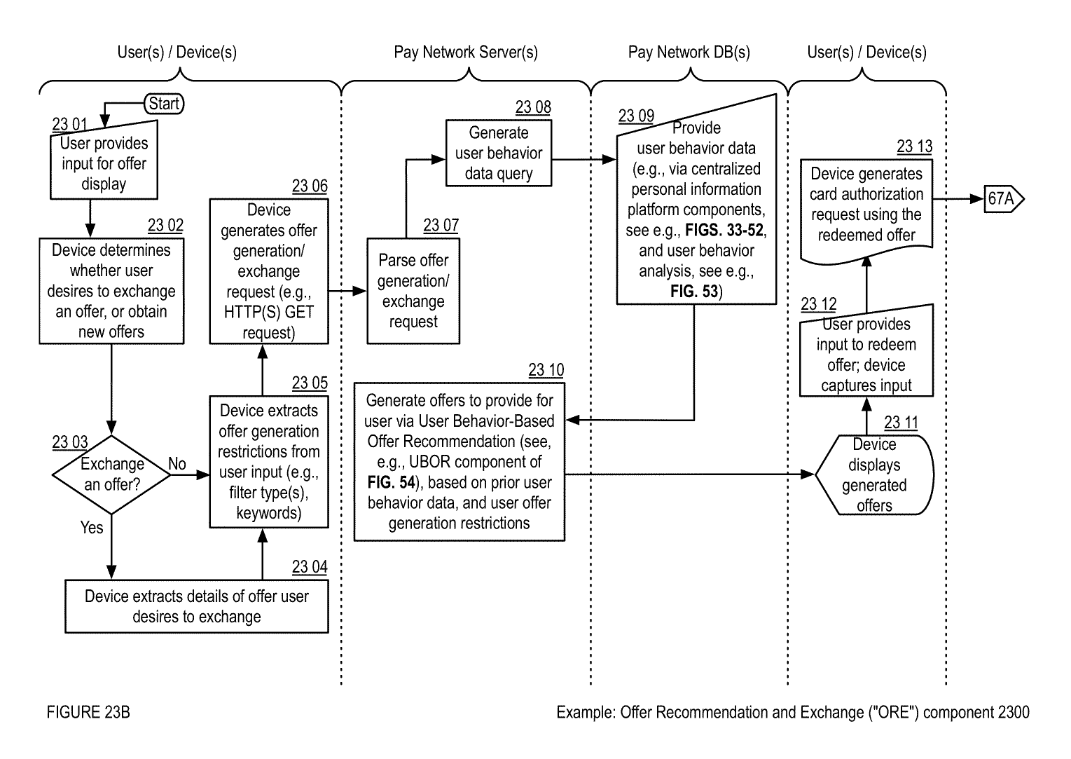

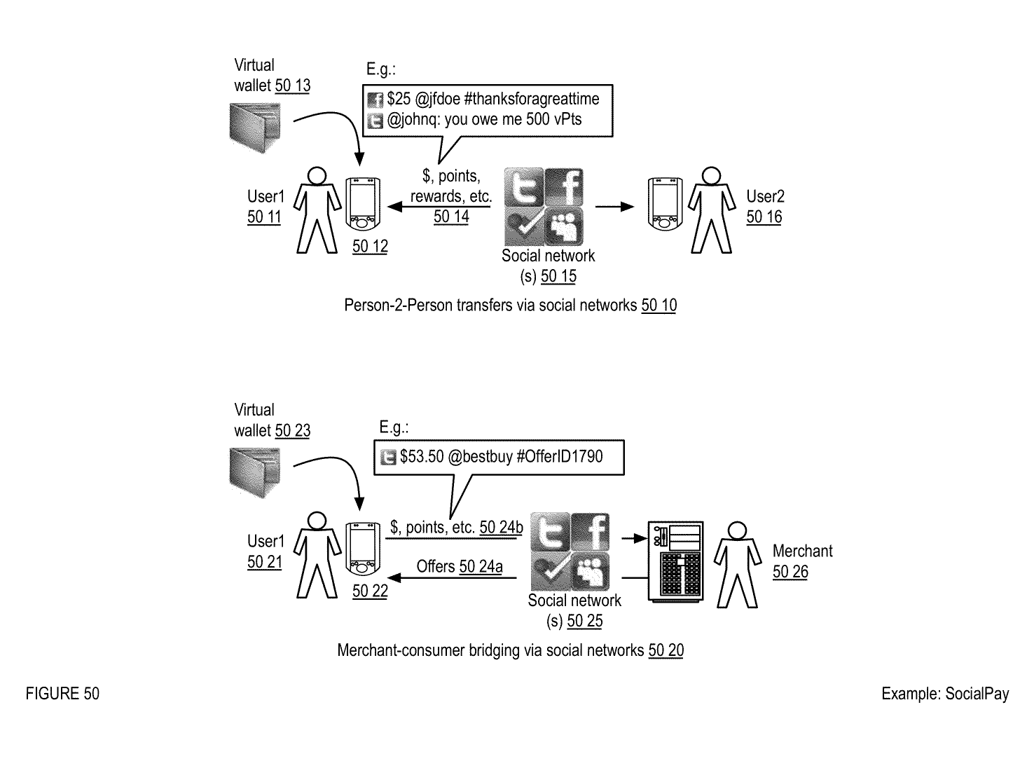

In one implementation, the user may select the payee Jane P. Doe 1805 for receiving payment. Upon selection, the user interface may display additional identifying information 1806 relating to the payee. The user interface may allow the user to contact the payee (e.g., call, text, email), modify the entry of the payee in the address book (e.g., edit, delete, merge with another contact), or make a payment to the payee 1807. For example, the user can enter an amount 1808 to be paid to the payee. The user can include a note for the payee (or for the user self) related to the payment, 1809. The user can also include strings attached to the payment. For example, the user can provide that the payment processing should occur only if the payee re-posts the user's note on a social networking site, 1810. The user can, at any time, modify the funding sources to utilize in the payment, 1811. Also, the user can utilize a number of different payment modes for each user, 1812. For example, additional modes such as those described in the discussion with reference to FIG. 19B may be used for the person-to-person payment. For example, a social payment mechanism may be employed for the person-to-person payment. Additional description on the social payment mechanism may be found in the discussion with reference to FIGS. 50-57 and 59D. As another example, person-to-person payment may be made via a snap mobile mechanism, as described further below in the discussion with reference to FIG. 22A.

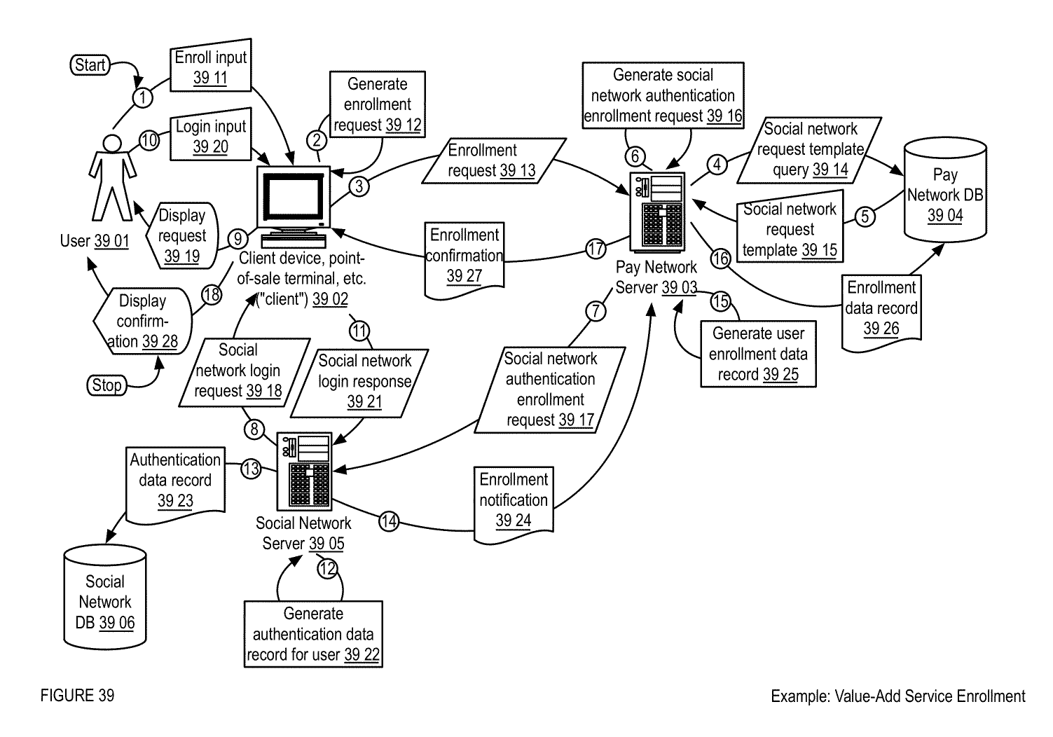

FIGS. 19A-B show user interface diagrams illustrating example additional aspects of the virtual wallet application in some embodiments of the EOOR. With reference to FIG. 19A, in some implementations, an offers screen 1901 may provide real-time offers that are relevant to items in a user's cart for selection by the user. The user may select one or more offers (see 1902) from the list of applicable offers 1903 for redemption. In one implementation, some offers may be combined (see, e.g., 1904), while others may not (optionally). When the user selects an offer that may not be combined with another offer, the unselected offers may be disabled. In a further implementation, offers that are recommended by the wallet application's recommendation engine may be identified by an indicator, such as the one shown by 1905. An example offer recommendation engine is described further below in the discussion with reference to FIG. 39. In a further implementation, the user may read the details of the offer by expanding the offer row as shown by 1905 in the user interface. The user may refresh offers displayed in the real-time offers screen at any time (see 1906).

With reference to FIG. 19B, in some implementations, the mode tab 1911 may facilitate selection of a payment mode accepted by the payee. A number of payment modes may be available for selection. Example modes include, Bluetooth 1912, wireless 1913, snap mobile by user-obtained QR code 1914, secure chip 1915, TWITTER 1916, near-field communication (NFC) 1921, cellular 1920, snap mobile by user-provided QR code 1919, USB 1918 and FACEBOOK 1917, among others. In one implementation, only the payment modes that are accepted by the payee may be selectable by the user. Other non-accepted payment modes may be disabled.

In one embodiment, the social tab 1931 may facilitate integration of the wallet application with social channels 1932. In one implementation, a user may select one or more social channels 1932 and may sign in to the selected social channel from the wallet application by providing to the wallet application the social channel user name and password 1933 and signing in 1934. The user may then use the social button 1935 to send or receive money through the integrated social channels. In a further implementation, the user may send social share data such as purchase information or links through integrated social channels. In another embodiment, the user supplied login credentials may allow EOOR to engage in interception parsing.

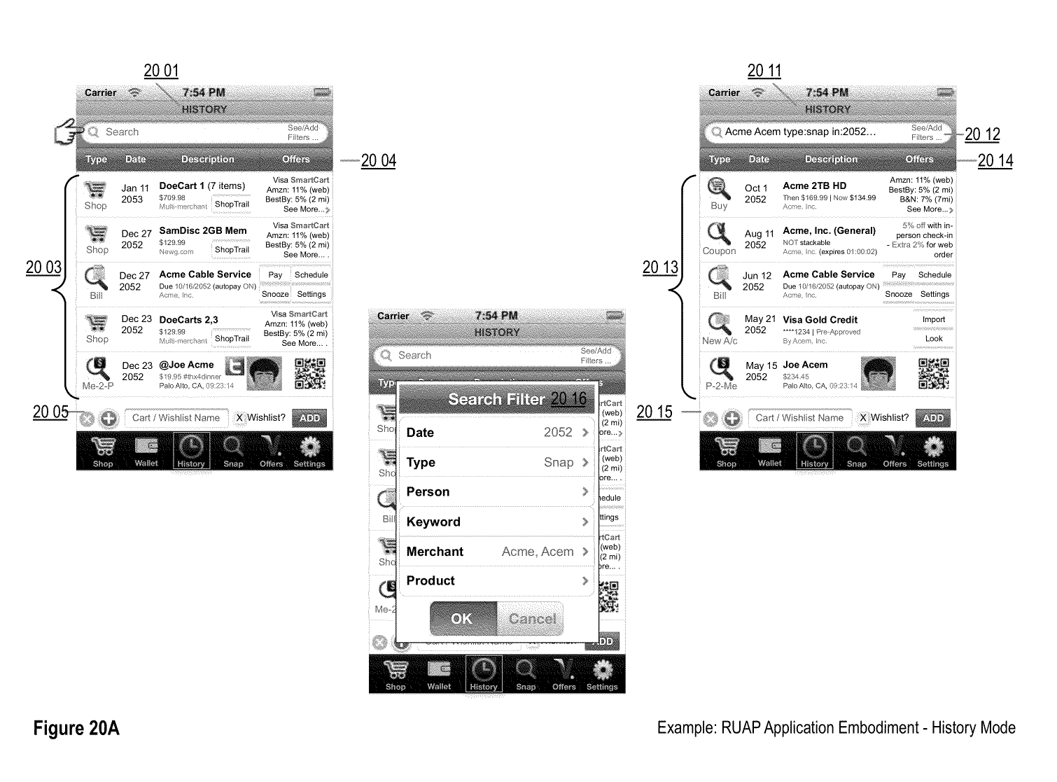

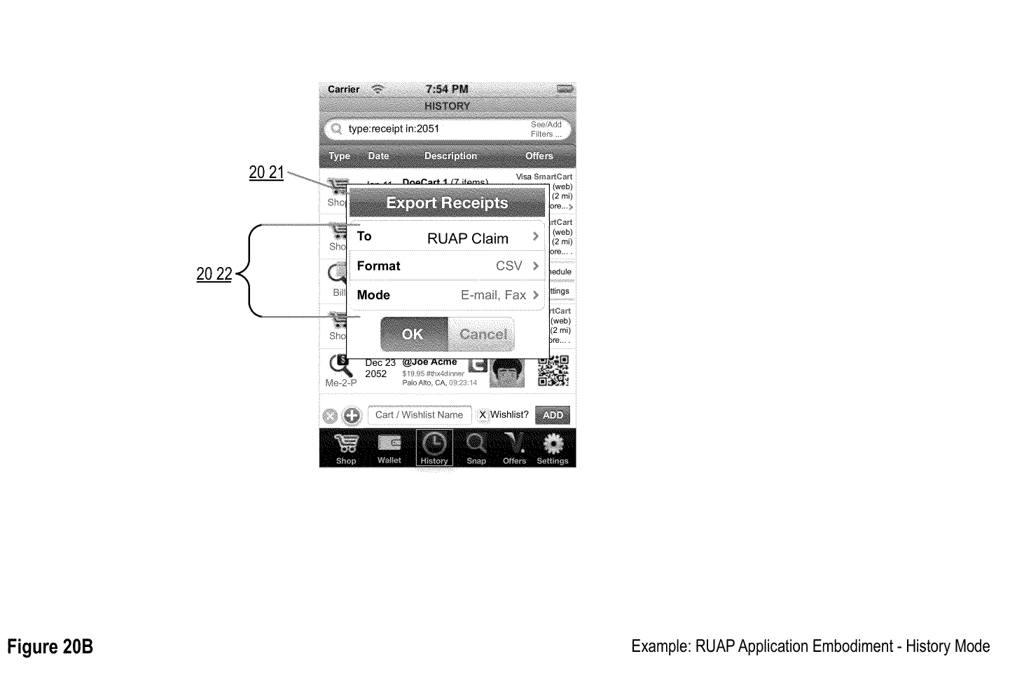

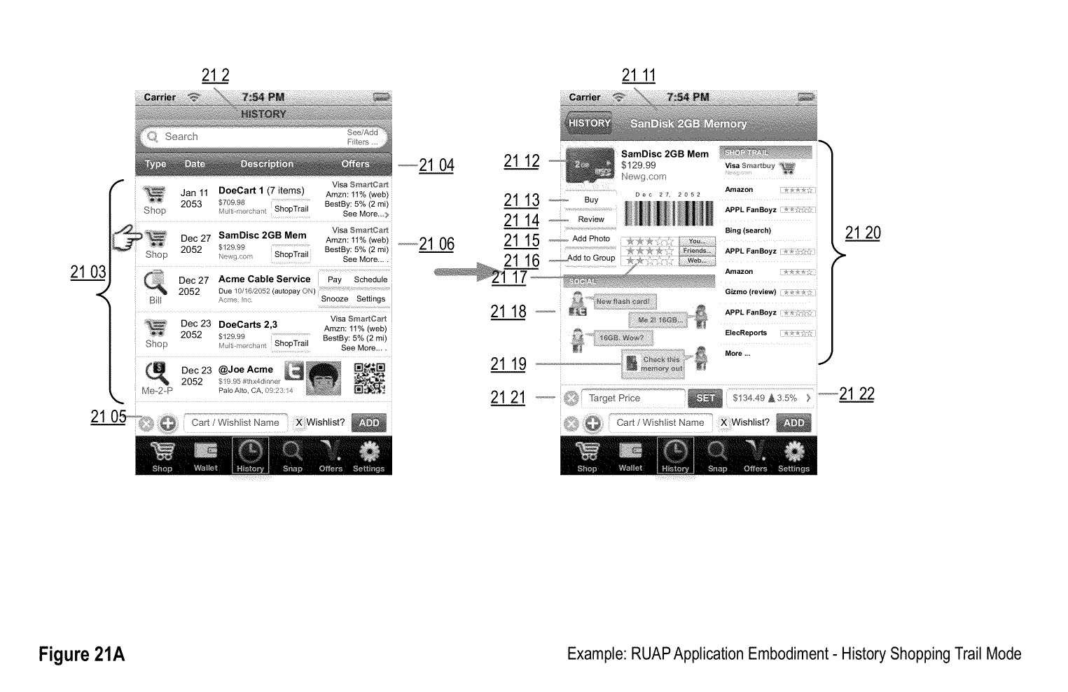

FIGS. 20A-B show user interface diagrams illustrating example aspects of a history mode of a virtual wallet application in some embodiments of the EOOR. In one embodiment, a user may select the history mode 2001 to view a history of prior purchases and perform various actions on those prior purchases. The wallet application may query the storage areas in the mobile device or elsewhere (e.g., one or more databases and/or tables remote from the mobile device) for prior transactions. The user interface may then display the results of the query such as transactions 2003. The user interface may identify 2004: a type of the transaction (e.g., previously shopped for items, bills that have been captured by camera in a snap mode, a person-to-person transfer [e.g., via social payment mechanism as described below in the discussion with reference to FIGS. 50-57], etc.); the date of the transaction; a description of the transaction, including but not limited to: a cart name, cart contents indicator, total cost, merchant(s) involved in the transaction; a link to obtain a shoptrail (explained further below in greater detail), offers relating to the transaction, and any other relevant information. In some implementation, any displayed transaction, coupon, bill, etc. may be added to a cart for (re)purchase, 2005.

In one embodiment, a user may select the history mode 2011 to view a history of filtered prior purchases and perform various actions on those prior purchases. For example, a user may enter a merchant identifying information such as name, product, MCC, and/or the like in the search bar 2012. In another implementation, the user may use voice activated search feature to search the history. In another implementations, the wallet application may display a pop up screen 2016, in which the user may enter advanced search filters, keywords, and/or the like. The wallet application may query the storage areas in the mobile device or elsewhere (e.g., one or more databases and/or tables remote from the mobile device) for transactions matching the search keywords. The user interface may then display the results of the query such as transactions 2003. The user interface may identify 2014: a type of the transaction (e.g., previously shopped for items, bills that have been captured by camera in a snap mode, a person-to-person transfer [e.g., via social payment mechanism as described below in the discussion with reference to FIGS. 50-57], etc.); the date of the transaction; a description of the transaction, including but not limited to: a cart name, cart contents indicator, total cost, merchant(s) involved in the transaction; a link to obtain a shoptrail (explained further below in greater detail), offers relating to the transaction, and any other relevant information. In some implementation, any displayed transaction, coupon, bill, etc. may be added to a cart for (re)purchase, 2015.

With reference to FIG. 20B, in one embodiment, the history mode may also include facilities for exporting receipts. The export receipts pop up 2021 may provide a number of options for exporting the receipts of transactions in the history. For example, a user may use one or more of the options 2022, which include save (to local mobile memory, to server, to a cloud account, and/or the like), print to a printer, fax, email, and/or the like. The user may utilize his or her address book to look up email or fax number for exporting. The user may also specify format options for exporting receipts. Example format options may include, without limitation, text files (.doc, .txt, .rtf, iif, etc.), spreadsheet (.csv, .xls, etc.), image files (.jpg, .tff, .png, etc.), portable document format (.pdf), postscript (.ps), and/or the like. The user may then click or tap the export button to initiate export of receipts.

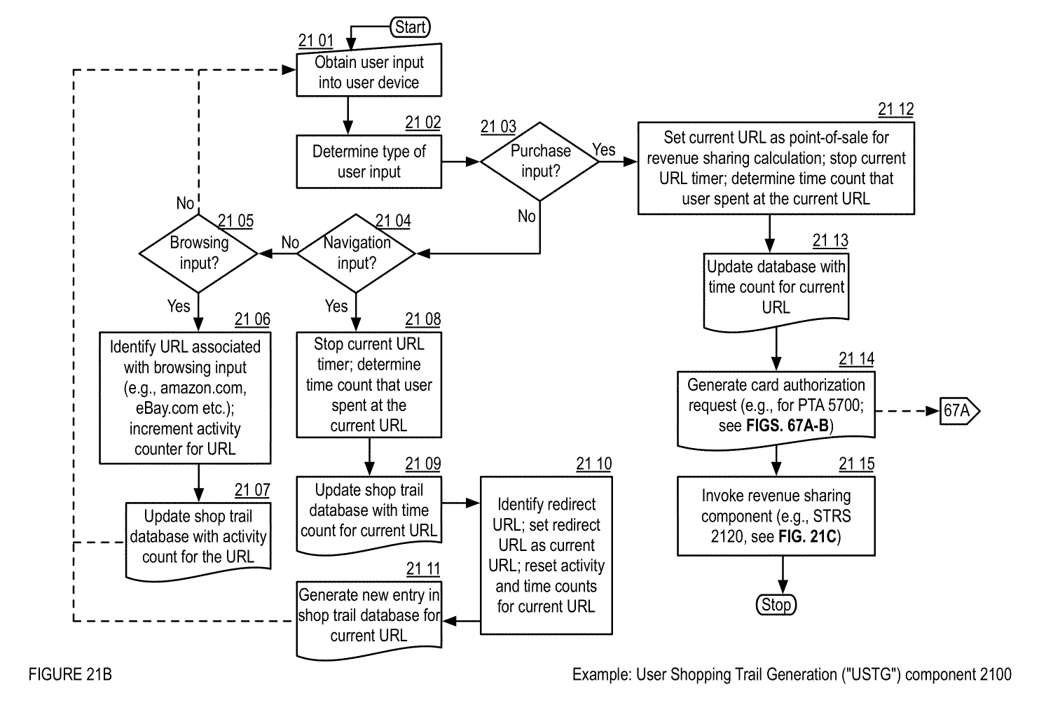

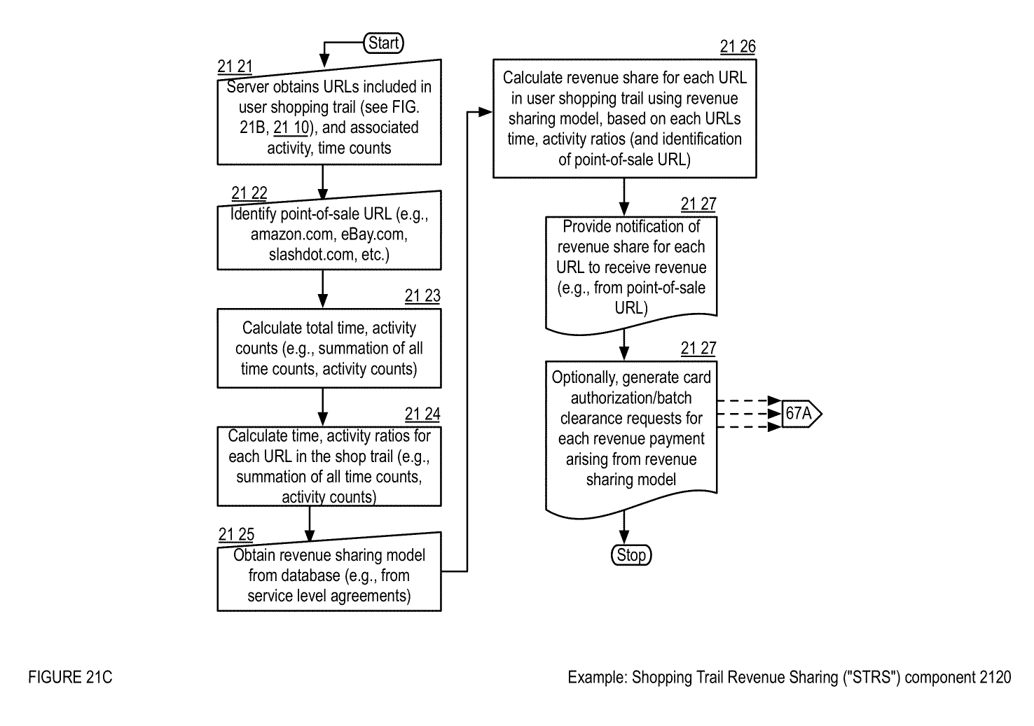

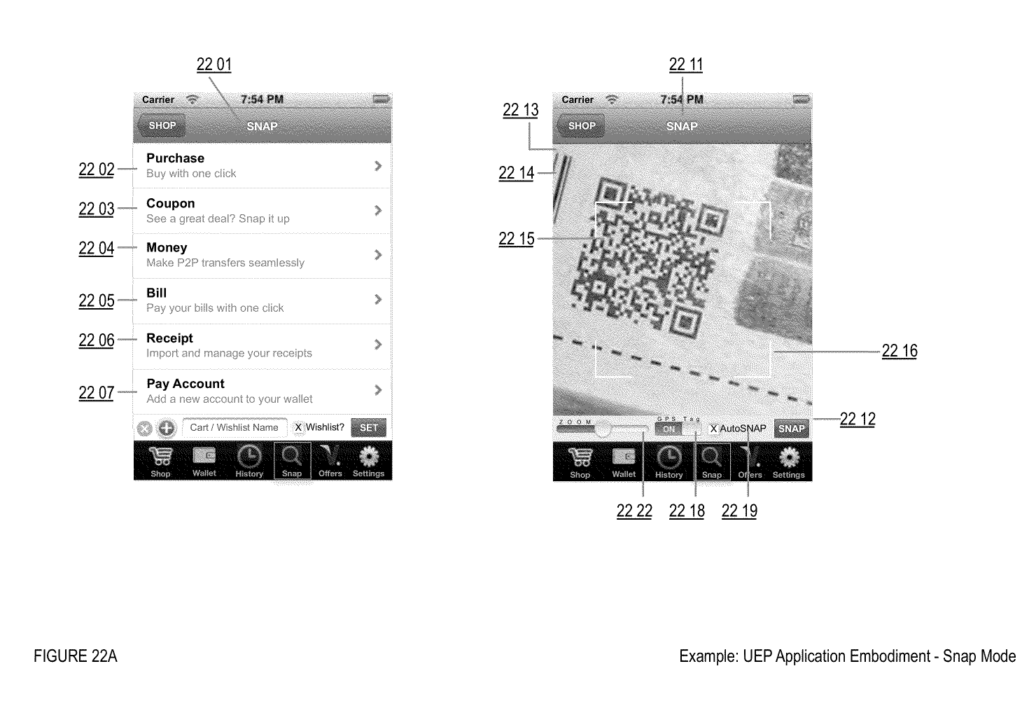

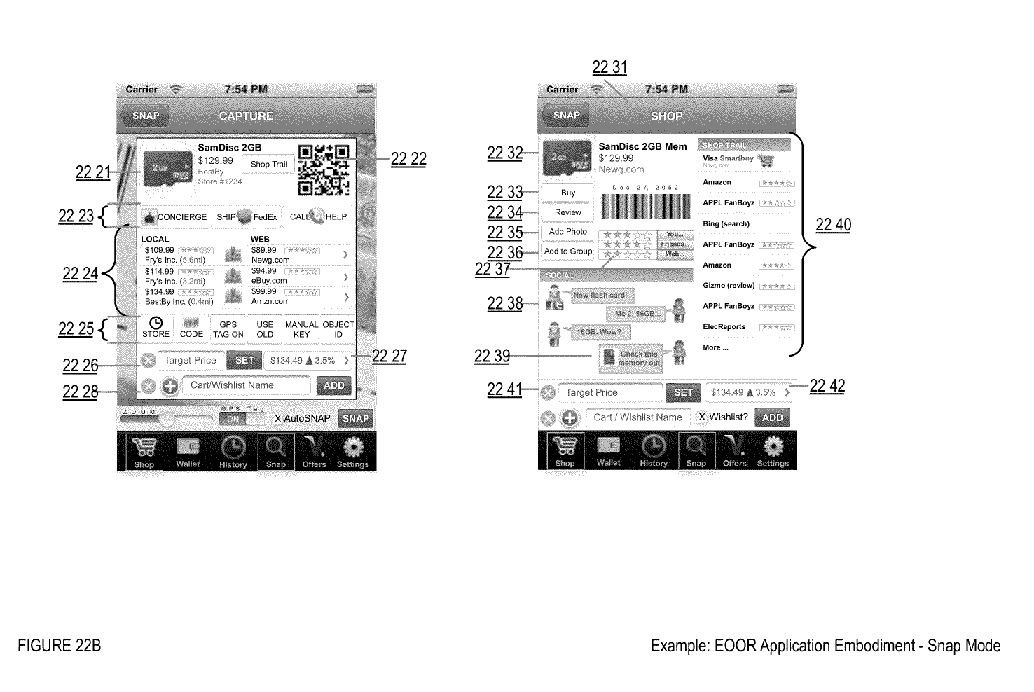

FIGS. 21A-C show user interface and logic flow diagrams illustrating example aspects of creating a user shopping trail within a virtual wallet application and associated revenue sharing scheme in some embodiments of the EOOR. With reference to FIG. 21A, in some implementations, a user may select the history mode 2101 to view a history of prior purchases and perform various actions on those prior purchases. The wallet application may query the storage areas in the mobile device or elsewhere (e.g., one or more databases and/or tables remote from the mobile device) for prior transactions. The user interface may then display the results of the query such as transactions 2103. The user interface may identify 2104: a type of the transaction (e.g., previously shopped for items, bills that have been captured by camera in a snap mode, a person-to-person transfer [e.g., via social payment mechanism as described below in the discussion with reference to FIGS. 50-57], etc.); the date of the transaction; a description of the transaction, including but not limited to: a cart name, cart contents indicator, total cost, merchant(s) involved in the transaction; a link to obtain a shoptrail (explained further below in greater detail), offers relating to the transaction, and any other relevant information. In some implementation, any displayed transaction, coupon, bill, etc. may be added to a cart for (re)purchase, 2105.

In one implementation, the user may select a transaction, for example transaction 2106, to view the details of the transaction. For example, the user may view the details of the items associated with the transaction and the amount(s) of each item, the merchant, etc., 2112. In various implementations, the user may be able to perform additional operations in this view. For example, the user may (re)buy the item 2113, obtain third-party reviews of the item, and write reviews of the item 2114, add a photo to the item so as to organize information related to the item along with the item 2115, add the item to a group of related items (e.g., a household), provide ratings 2117, or view quick ratings from the user's friends or from the web at large. For example, such systems may be implemented using the example centralized personal information platform components described below in the discussion with reference to FIGS. 28-47. The user may add a photo to the transaction. In a further implementation, if the user previously shared the purchase via social channels, a post including the photo may be generated and sent to the social channels for publishing. In one implementation, any sharing may be optional, and the user, who did not share the purchase via social channels, may still share the photo through one or more social channels of his or her choice directly from the history mode of the wallet application. In another implementation, the user may add the transaction to a group such as company expense, home expense, travel expense or other categories set up by the user. Such grouping may facilitate year-end accounting of expenses, submission of work expense reports, submission for value added tax (VAT) refunds, personal expenses, and/or the like. In yet another implementation, the user may buy one or more items purchased in the transaction. The user may then execute a transaction without going to the merchant catalog or site to find the items. In a further implementation, the user may also cart one or more items in the transaction for later purchase.

The history mode, in another embodiment, may offer facilities for obtaining and displaying ratings 2117 of the items in the transaction. The source of the ratings may be the user, the user's friends (e.g., from social channels, contacts, etc.), reviews aggregated from the web, and/or the like. The user interface in some implementations may also allow the user to post messages to other users of social channels (e.g., TWITTER or FACEBOOK). For example, the display area 2118 shows FACEBOOK message exchanges between two users. In one implementation, a user may share a link via a message 2119. Selection of such a message having embedded link to a product may allow the user to view a description of the product and/or purchase the product directly from the history mode.

In some implementations, the wallet application may display a shop trail for the user, e.g., 2120. For example, a user may have reviewed a product at a number of websites (e.g., ElecReports, APPL FanBoys, Gizmo, Bing, Amazon, Visa Smartbuy feature (e.g., that checks various sources automatically for the best price available according to the user preferences, and provides the offer to the user), etc.), which may have led the user to a final merchant website where the user finally bought the product. In some implementations, the EOOR may identify the websites that the user visited, that contributed to the user deciding to buy the product, and may reward them with a share of the revenues obtained by the “point-of-sale” website for having contributed to the user going to the point-of-sale website and purchasing the product there. For example, the websites may have agreements with product manufacturers, wholesalers, retail outlets, payment service providers, payment networks, amongst themselves, and/or the like with regard to product placement, advertising, user redirection and/or the like. Accordingly, the EOOR may calculate a revenue share for each of the websites in the user's shopping trail using a revenue sharing model, and provide revenue sharing for the websites.

In some implementations, the virtual wallet may provide a SmartBuy targeted shopping feature. For example, the user may set a target price 2121 for the product 2112 that the user wishes to buy. The virtual wallet may provide a real-time market watch status update 2122 for the product. When the market price available for the user falls below the user's target price 2121, the virtual wallet may automatically buy the product for the user, and provide a shipment/notification to the user.

FIG. 21B shows a logic flow diagram illustrating example aspects of generating a virtual wallet user shopping trail in some embodiments of the EOOR, e.g., a User Shopping Trail Generation (“USTG”) component 2100. In some implementations, a user device of a user, executing a virtual wallet application for the user, may track the shopping activities of a user for later retrieval and/or analysis. The device may obta a user's input, 2101, and determine a type of user input, 2102. If the user engages in either browsing activity at a website of a merchant, or is navigating between websites (e.g., sometime when 2103, option “No”), the device may track such activities. For example, the device may determine that the user's input is a navigational input (1104, option “Yes”). The device may stop a timer associated with the current URL (e.g., of a merchant such as amazon.com, ebay.com, newegg.com, etc., or a review website such as shlashdot.org, cnet.com, etc.) that the user is located at, and determine a time count that the user spent at the URL, 2108. The device may update a shop trail database (e.g., a local database, a cloud database, etc.) with the time count for the current URL, 2109. The device may also identify a redirect URL to which the user will be navigating as a result of the user's navigation input, 2110. The device may set the redict URL as the current URL, and reset activity and time counters for the current URL. The device may generate a new entry in the shop trail database for the URL that has been made current by the user's navigational input, 2111.

If the user engaged in browsing activity at a current URL (1105, option “Yes”), the device may identify the URL associated with the browsing activity (e.g., if the browsing can be performed on the device across multiple windows or tabs, etc.). The device may increment an activity counter to determine a level of user activity of the user at the URL where the browsing activity is occurring, 2106. The device may update the shop trail database with the activity count for the URL, 2107.

If the user desires to engage in a purchase transaction, e.g., after visiting a number of URLs about the product (e.g., after reading reviews about a product at a number of consumer report websites, the user navigates to amazon.com to buy the product), see 2103, option “Yes,” the device may set the current URL as the “point-of-sale” URL (e.g., the merchant at which the user finally bought the product—e.g., amazon.com), 2112. The device may stop the time for the current URL, and update the shop trail database for the current URL, 2113. The device may generate a card authorization request to initiate the purchase transaction, 2114, and provide the card authorization request for transaction processing (see, e.g., PTA 6700 component described below in the discussion with reference to FIG. 6A-B).

In some implementations, the device may also invoke a revenue sharing component, such as the example STRS 2120 component described below in the discussion with reference to FIG. 21C.

FIG. 21C shows a logic flow diagram illustrating example aspects of implementing a user shopping trail-based revenue sharing model in some embodiments of the EOOR, e.g., a Shopping Trail Revenue Sharing (“STRS”) component 2120. In some implementations, a user may have reviewed a product at a number of websites, which may have led the user to a final merchant website where the user finally bought the product. In some implementations, the EOOR may identify the websites that the user visited, that contributed to the user deciding to buy the product, and may reward them with a share of the revenues obtained by the “point-of-sale” website for having contributed to the user going to the point-of-sale website and purchasing the product there. For example, the websites may have agreements with product manufacturers, wholesalers, retail outlets, payment service providers, payment networks, amongst themselves, and/or the like with regard to product placement, advertising, user redirection and/or the like. For example, a server may have stored a table of revenue sharing ratios, that provides a predetermined revenue sharing scheme according to which contributing websites will receive revenue for the user's purchase.

Accordingly, in some implementations, a server may obtain a list of URLs included in a suer's shopping trail, and their associated activity and time counts, 2121. The server may identify a point-of-sale URL where the user made the purchase for which revenue is being shared among the URLs in the shopping trail, 2122. The server may calculate a total activity count, and a total time count, by summing up activity and time counts, respectively, of all the URLs in the user's shopping trail, 2123. The server may calculate activity and time ratios of each of the URLs, 2124. The server may obtain a revenue sharing model (e.g., a database table/matrix of weighting values) for converting activity and time ratios for each URL into a revenue ratio for that URL, 2125. The server may calculate a revenue share, 2126, for each of the URLs in the user's shopping trail using the revenue sharing model and the revenue ratios calculated for each URL. The server may provide a notification of the revenue for each URL (e.g., to each of the URLs and/or the point-of-sale URL from whom revenue will be obtained to pay the revenue shares of the other URLs in the user's shopping trail), 2127. In some implementations, the server may generate card authorization requests and/or batch clearance requests for each of the revenue payments due to the URLs in the user's shopping trail, to process those transactions for revenue sharing.

FIGS. 22A-H show user interface and logic flow diagrams illustrating example aspects of a snap mode of a virtual wallet application in some embodiments of the EOOR. With reference to FIG. 22A, in some implementations, a user may select the snap mode 2201 to access its snap features. The snap mode may handle any machine-readable representation of data. Examples of such data may include linear and 2D bar codes such as UPC code and QR codes. These codes may be found on receipts 2206, product packaging 2202, coupons 2203, payment notes 2204, invoices 2205, credit cards and/or other payment account plastic cards or equivalent 2207, and/or the like. The snap mode may process and handle pictures of receipts, products, offers, credit cards or other payment devices, and/or the like. An example user interface 2211 in snap mode is shown in FIG. 22A. A user may use his or her mobile phone to take a picture of a QR code 2215 and/or a barcode 2214. In one implementation, the bar 2216 and snap frame 2213 may assist the user in snapping codes properly. For example, the snap frame 2213, as shown, does not capture the entirety of the code 2214. As such, the code captured in this view may not be resolvable as information in the code may be incomplete. When the code 2215 is completely framed by the snap frame 5215, the device may automatically snap a picture of the code, 2219. Upon finding the code, in one implementation, the user may initiate code capture using the mobile device camera, 2212. In some implementations, the user may adjust the zoom level of the camera to assist in captureing the code, 2217. In some implementations, the user may add a GPS tag to the captured code, 2218.

With reference to FIG. 22B, in some implementations, where the user has not yet interacted with an item, the user may view details of the item designed to facilitate the user to purchase the item at the best possible terms for the user. For example, the virtual wallet application may provide a detailed view of the item at the point where it was snapped by the user using the user device, 2221, including an item description, price, merchant name, etc. The view may also provide a QR code 2222, which the user may tap to save to the wallet for later use, or to show to other users who may snap the QR code to purchase the item. In some implementations, the view may provide additional services for the user, including but not limited to: concierge service; shipment services, helpline, and/or the like, 2223. In some implementations, the view may provide prices from competing merchants locally or on the web, 2224. Such pricing data may be facilitated by the centralized personal information platform components described further below in the discussion with reference to FIGS. 28-47. In some implementations, the view may provide the user with the option to (see 2225): store the snapped code for later, start over and generate a new code, turn on or off a GPS tagging feature, use a previously snapped QR code, enter keywords associated with the QR code, associated the items related to the QR code to an object, and/or the like. In some implementations, the virtual wallet may provide a SmartBuy targeted shopping feature. For example, the user may set a target price 2226 for the product 2221 that the user wishes to buy. The virtual wallet may provide a real-time market watch status update 2227 for the product. When the market price available for the user falls below the user's target price 2226, the virtual wallet may automatically buy the product for the user, and provide a shipment/notification to the user. The user may at any time add the item to one of the user's carts or wishlists (see 2228).

In one implementation, in particular when the user has previously interacted with the item that is snapped, the user may view the details of the items 2232 and the amount(s) of each item, the merchant, etc., 2232. In various implementations, the user may be able to perform additional operations in this view. For example, the user may (re)buy the item 2233, obtain third-party reviews of the item, and write reviews of the item 2234, add a photo to the item so as to organize information related to the item along with the item 2235, add the item to a group of related items (e.g., a household), provide ratings 2237, or view quick ratings from the user's friends or from the web at large. For example, such systems may be implemented using the example centralized personal information platform components described below in the discussion with reference to FIGS. 28-47. The user may add a photo to the transaction. In a further implementation, if the user previously shared the purchase via social channels, a post including the photo may be generated and sent to the social channels for publishing. In one implementation, any sharing may be optional, and the user, who did not share the purchase via social channels, may still share the photo through one or more social channels of his or her choice directly from the history mode of the wallet application. In another implementation, the user may add the transaction to a group such as company expense, home expense, travel expense or other categories set up by the user. Such grouping may facilitate year-end accounting of expenses, submission of work expense reports, submission for value added tax (VAT) refunds, personal expenses, and/or the like. In yet another implementation, the user may buy one or more items purchased in the transaction. The user may then execute a transaction without going to the merchant catalog or site to find the items. In a further implementation, the user may also cart one or more items in the transaction for later purchase.

The history mode, in another embodiment, may offer facilities for obtaining and displaying ratings 2237 of the items in the transaction. The source of the ratings may be the user, the user's friends (e.g., from social channels, contacts, etc.), reviews aggregated from the web, and/or the like. The user interface in some implementations may also allow the user to post messages to other users of social channels (e.g., TWITTER or FACEBOOK). For example, the display area 2238 shows FACEBOOK message exchanges between two users. In one implementation, a user may share a link via a message 2239. Selection of such a message having embedded link to a product may allow the user to view a description of the product and/or purchase the product directly from the history mode.

In some implementations, the wallet application may display a shop trail for the user, e.g., 2240. For example, a user may have reviewed a product at a number of websites (e.g., ElecReports, APPL FanBoys, Gizmo, Bing, Amazon, Visa Smartbuy feature (e.g., that checks various sources automatically for the best price available according to the user preferences, and provides the offer to the user), etc.), which may have led the user to a final merchant website where the user finally bought the product. In some implementations, the EOOR may identify the websites that the user visited, that contributed to the user deciding to buy the product, and may reward them with a share of the revenues obtained by the “point-of-sale” website for having contributed to the user going to the point-of-sale website and purchasing the product there. For example, the websites may have agreements with product manufacturers, wholesalers, retail outlets, payment service providers, payment networks, amongst themselves, and/or the like with regard to product placement, advertising, user redirection and/or the like. Accordingly, the EOOR may calculate a revenue share for each of the websites in the user's shopping trail using a revenue sharing model, and provide revenue sharing for the websites.

In some implementations, the virtual wallet may provide a SmartBuy targeted shopping feature. For example, the user may set a target price 2241 for the product 2232 that the user wishes to buy. The virtual wallet may provide a real-time market watch status update 2242 for the product. When the market price available for the user falls below the user's target price 2241, the virtual wallet may automatically buy the product for the user, and provide a shipment/notification to the user.

With reference to FIGS. 22C-D, in one embodiment, the snap mode may facilitate payment reallocation for a previously completed transaction (FIG. 22C), or a transaction to performed at present (FIG. 22D). For example, a user may buy grocery and prescription items from a retailer Acme Supermarket. The user may, inadvertently or for ease of checkout for example, have already used his or her traditional payment card to pay for both grocery and prescription items, and obtained a receipt. However, the user may have an FSA account that could have been used to pay for prescription items, and which would have provided the user a better price or other economic benefits. In such a situation, the user may use the snap mode to initiate transaction reallocation.

As shown, the user may snap 2251, 2261 a picture of a barcode on an receipt 2253, 2263, upon which the virtual wallet application may present the receipt data 2252, 2262 using information from the pay code. The user may now reallocate expenses to their optimum accounts 2254, 2264. In some implementations, the user may also dispute the transaction 2255, 2265 or archive the receipt 2256, 2266.

In one implementation, when the reallocate button is selected, the wallet application may perform optical character recognition (OCR) of the receipt. Each of the items in the receipt may then be examined to identify one or more items which could be charged to which payment device or account for tax or other benefits such as cash back, reward points, etc. In this example, there is a tax benefit if the prescription medication charged to the user's Visa card is charged to the user's FSA. The wallet application may then perform the reallocation as the back end. The reallocation process may include the wallet contacting the payment processor to credit the amount of the prescription medication to the Visa card and debit the same amount to the user's FSA account. In an alternate implementation, the payment processor (e.g., Visa or MasterCard) may obtain and OCR the receipt, identify items and payment accounts for reallocation and perform the reallocation. In one implementation, the wallet application may request the user to confirm reallocation of charges for the selected items to another payment account. The receipt may be generated after the completion of the reallocation process. As discussed, the receipt shows that some charges have been moved from the Visa account to the FSA.

With reference to FIG. 22E, in one embodiment, the snap mode may also facilitate offer identification, application and storage for future use. For example, in one implementation, a user may snap an account code, an offer code 2271 (e.g., a bar code, a QR code, and/or the like). The wallet application may then generate an account card text, coupon text, offer text 2272 from the information encoded in the offer code. The user may perform a number of actions on the offer code. For example, the user may use the reallocate button 2273 to reallocate prior purchases that would have been better made using the imported card, coupon, offer, etc., and the virtual wallet application may provide a notification of reallocation upon modifying the accounts charged for the previous transactions of the user.

In one embodiment, the snap mode may also offer facilities for adding a funding source to the wallet application. In one implementation, a pay card such as a credit card, debit card, pre-paid card, smart card and other pay accounts may have an associated code such as a bar code or QR code. Such a code may have encoded therein pay card information including, but not limited to, name, address, pay card type, pay card account details, balance amount, spending limit, rewards balance, and/or the like. In one implementation, the code may be found on a face of the physical pay card. In another implementation, the code may be obtained by accessing an associated online account or another secure location. In yet another implementation, the code may be printed on a letter accompanying the pay card. A user, in one implementation, may snap a picture of the code. The wallet application may identify the pay card and may display the textual information encoded in the pay card. The user may then perform verification of the information by selecting a verify button. In one implementation, the verification may include contacting the issuer of the pay card for confirmation of the decoded information and any other relevant information. In one implementation, the user may add the pay card to the wallet by selecting a ‘add to wallet’ button. The instruction to add the pay card to the wallet may cause the pay card to appear as one of the forms of payment under the funds tab discussed above.

With reference to FIG. 22F, in some implementations, a user may be advantageously able to provide user settings into a device producing a QR code for a purchase transaction, and then capture the QR code using the user's mobile device. For example, a display device of a point-of-sale terminal may be displaying a checkout screen, such as a web browser executing on a client, e.g., 2281, displaying a checkout webpage of an online shopping website, e.g., 2282. In some implementations, the checkout screen may provide a user interface element, e.g., 2283a-b, whereby the user can indicate the desire to utilize snap mobile payment. For example, if the user activates element 2281a, the website may generate a QR code using default settings of the user, and display the QR code, e.g., 2285, on the screen of the client for the user to capture using the user's mobile device. In some implementations, the user may be able to activate a user interface element, e.g., 2283b, whereby the client may display a pop-up menu, e.g., 2284, with additional options that the user may select from. In some implementations, the website may modify the QR code 2285 in real-time as the user modifies settings provided by activating the user interface element 2283b. Once the user has modified the settings using the pop-up menu, the user may capture a snapshot of the QR code to initiate purchase transaction processing.

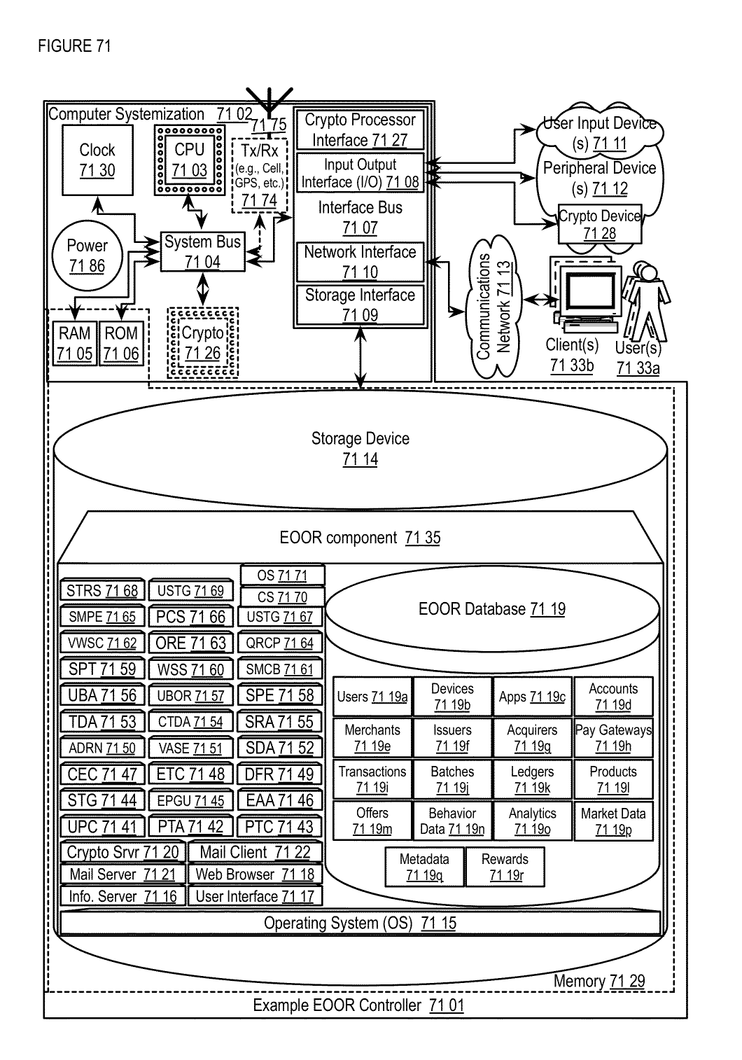

FIG. 22G shows a logic flow diagram illustrating example aspects of executing a snap mobile payment in some embodiments of the EOOR, e.g., a Snap Mobile Payment Execution (“SMPE”) component 2200. In some implementations, a user may desire to purchase a product, service, offering, and/or the like (“product”), from a merchant via a merchant online site or in the merchant's store. The user may communicate with a merchant server via a client. For example, the user may provide user input, e.g., 2201, into the client indicating the user's desire to checkout shopping items in a (virtual) shopping cart. The client may generate a checkout request, e.g., 2202, and provide the checkout request to the merchant server. The merchant server may obtain the checkout request from the client, and extract the checkout detail (e.g., XML data) from the checkout request, e.g., 2203. For example, the merchant server may utilize a parser such as the example parsers described below in the discussion with reference to FIG. 71. The merchant server may extract the product data, as well as the client data from the checkout request. In some implementations, the merchant server may query, e.g., 2204, a merchant database to obtain product data, e.g., 2205, such as product pricing, sales tax, offers, discounts, rewards, and/or other information to process the purchase transaction.

In response to obtaining the product data, the merchant server may generate, e.g., 2206, a QR pay code, and/or secure display element according to the security settings of the user. For example, the merchant server may generate a QR code embodying the product information, as well as merchant information required by a payment network to process the purchase transaction. For example, the merchant server may first generate in real-time, a custom, user-specific merchant-product XML data structure having a time-limited validity period, such as the example ‘QR_data’ XML data structure provided below:

```
<QR_data>
  <session_ID>4NFU4RG94</session_ID>
  <timestamp>2011-02-22 15:22:43</timestamp>
  <expiry_lapse>00:00:30</expiry_lapse>
  <transaction_cost>$34.78</transaction_cost>
  <user_ID>john.q.public@gmail.com</user_ID>
  <client_details>
      <client_IP>192.168.23.126</client_IP>
      <client_type>smartphone</client_type>
      <client_model>HTC Hero</client_model>
      <OS>Android 2.2</OS>
      <app_installed_flag>true</app_installed_flag>
  </client_details>
  <secure_element>www.merchant.com/securedyn/0394733/123.png
  </secure_element>
  <purchase_details>
      <num_products>1</num_products>
      <product>
          <product_type>book</product_type>
          <product_params>
              <product_title>XML for dummies</product_title>
              <ISBN>938-2-14-168710-0</ISBN>
              <edition>2nd ed.</edition>
              <cover>hardbound</cover>
              <seller>bestbuybooks</seller>
          </product_params>
          <quantity>1</quantity>
      </product>
  </purchase_details>
  <merchant_params>
      <merchant_id>3FBCR4INC</merchant_id>
      <merchant_name>Books & Things, Inc.</merchant_name>
      <merchant_auth_key>1NNF484MCP59CHB27365
      </merchant_auth_key>
  </merchant_params>
<QR_data>
```

In some implementations, the merchant may generate QR code using the XML data. For example, the merchant server may utilize the PHP QR Code open-source (LGPL) library for generating QR Code, 2-dimensional barcode, available at http://phpqrcode.sourceforge.net/. For example, the merchant server may issue PHP commands similar to the example commands provided below:

<?PHP
header(‘Content-Type: text/plain’);
// Create QR code image using data stored in $data variable
QRcode::png($data, ‘qrcodeimg.png’);
?>

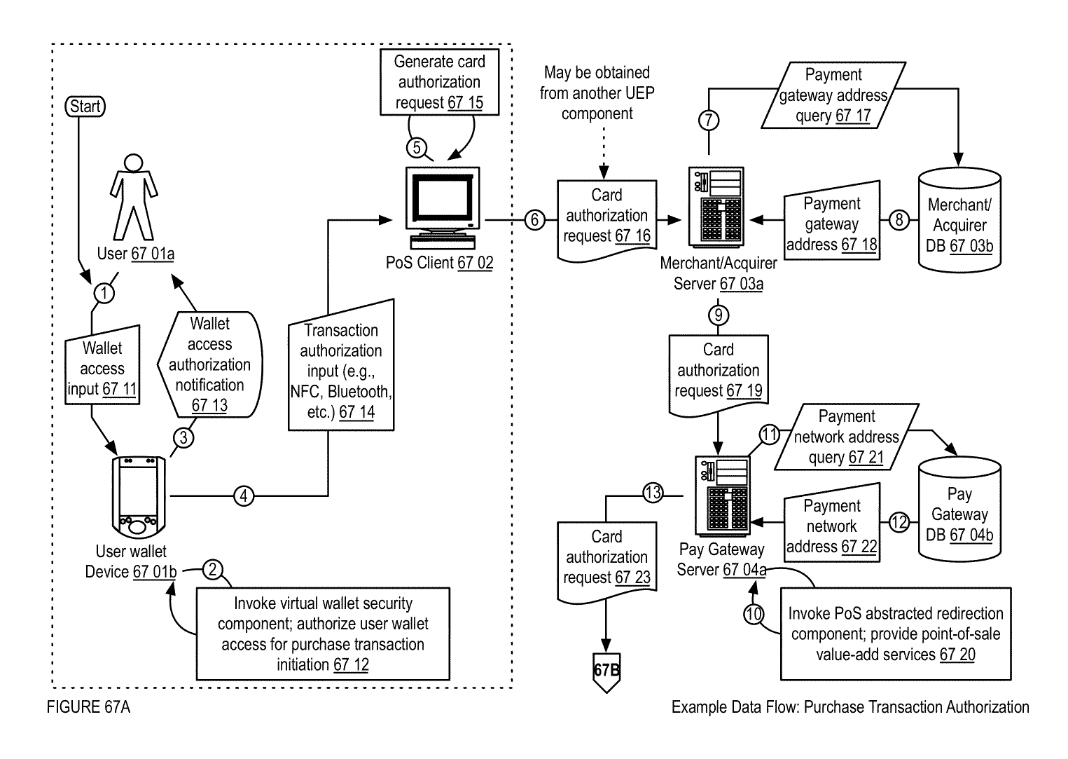

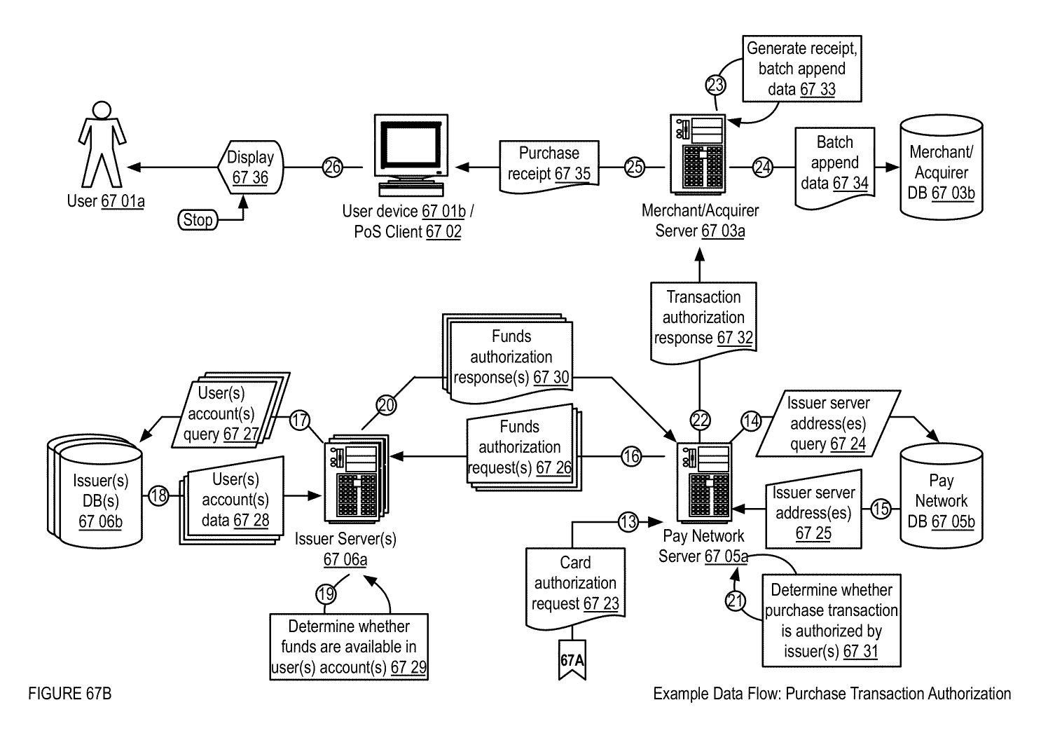

The merchant server may provide the QR pay code to the client, e.g., 2206. The client may obtain the QR pay code, and display the QR code, e.g., 2207 on a display screen associated with the client device. In some implementations, the user may utilize a user device, e.g., 2209, to capture the QR code presented by the client device for payment processing. The client device may decode the QR code to extract the information embedded in the QR code. For example, the client device may utilize an application such as the ZXing multi-format 1D/2D barcode image processing library, available at http://code.google.com/p/zxing/ to extract the information from the QR code. In some implementations, the user may provide payment input into the user device, e.g., 2208. Upon obtaining the user purchase input, the user device may generate a card authorization request, e.g., 2209, and provide the card authorization request to a pay network server (see, e.g., FIG. 67A).

FIGS. 22H-I show logic flow diagrams illustrating example aspects of processing a Quick Response code in some embodiments of the EOOR, e.g., a Quick Response Code Processing (“QRCP”) component 2210. With reference to FIG. 22G, in some implementations, a virtual wallet application executing on a user device may determine whether a QR code has been captured in an image frame obtained by a camera operatively connected to the user device, and may also determine the type, contents of the QR code. Using such information, the virtual wallet application may redirect the user experience of the user and/or initiating purchases, update aspects of the virtual wallet application, etc. For example, the virtual wallet application may trigger the capture of an image frame by a camera operatively connected to the user device, 2211. The virtual wallet application may utilize an image segmentation algorithm to identify a foreground in the image, 2212, and may crop the rest of the image to reduce background noise in the image, 2213. The virtual wallet application may determine whether the foreground image includes a QR code from which data can be reliably read (e.g., this may not be so if the image does not include a QR code, or the QR code is partially cropped, blurred, etc.), 2214. For example, the virtual wallet application may utilize a code library such as the ZXing multi-format 1D/2D barcode image processing library, available at http://code.google.com/p/zxing/ to try and extract the information from the QR code. If the virtual wallet application is able to detect a QR code (1215, option “Yes”), the virtual wallet application may decode the QR code, and extract data from the QR code, 2217. If the virtual wallet application is unable to detect a QR code (1215, option “No”), the virtual wallet application may attempt to perform Optical Character Recognition on the image. For example, the virtual wallet application may utilize the Tesseract C++ open source OCR engine, available at www.pixel-technology.com/freewarw/tessnet2, to perform the optical character recognition, 2216. Thus, the virtual wallet application may obtain the data encoded into the image, and may continue if the data can be processed by the virtual wallet application. The virtual wallet application may query a database using fields identified in the extracted data, for a type of the QR code, 2218. For example, the QR code could include an invoice/bill, a coupon, a money order (e.g., in a P2P transfer), a new account information packet, product information, purchase commands, URL navigation instructions, browser automation scripts, combinations thereof, and/or the like.

In some embodiments, the QR code may include data on a new account to be added to the virtual wallet application (see 2219). The virtual wallet application may query an issuer of the new account (as obtained from the extracted data), for the data associated with the new account, 2220. The virtual wallet application may compare the issuer-provided data to the data extracted from the QR code, 611. If the new account is validated (1221, option “Yes”), the virtual wallet application may update the wallet credentials with the details of the new account, 2223, and update the snap history of the virtual wallet application using the data from the QR code, 2224.

With reference to FIG. 22H, in some embodiments, the QR code may include data on a bill, invoice, or coupon for a purchase using the virtual wallet application (see 2225). The virtual wallet application may query merchant(s) associated with the purchase (as obtained from the extracted data), for the data associated with the bill, invoice, or coupon for a purchase (e.g., offer details, offer ID, expiry time, etc.), 2226. The virtual wallet application may compare the merchant-provided data to the data extracted from the QR code, 2227. If the bill, invoice, or coupon for a purchase is validated (1228, option “Yes”), the virtual wallet application may generate a data structure (see e.g., XML QR_data structure in description above with reference to FIG. 22F) including the QR-encoded data for generating and providing a card authorization request, 2229, and update the snap history of the virtual wallet application using the data from the QR code, 2230.

In some embodiments, the QR code may include product information, commands, user navigation instructions, etc. for the virtual wallet application (see 2231). The virtual wallet application may query a product database using the information encoded in the QR. The virtual wallet application may provide various features including, without limitation, displaying product information, redirecting the user to: a product page, a merchant website, a product page on a merchant website, add item(s) to a user shopping cart at a merchant website, etc. In some implementations, the virtual wallet application may perform a procedure such as described above for any image frame pending to be processed, and/or selected for processing by the user (e.g., from the snap history).

FIGS. 23A-B show user interface and logic flow diagrams illustrating example aspects of an offers mode of a virtual wallet application in some embodiments of the EOOR. With reference to FIG. 23A, in some implementations, a user may desire to obtain new offers in the user's virtual wallet application, or may desire to exchange an existing offer for a new one (or a plurality of offers) (e.g., offers 2301 may be replaced at the user's command). For example, the user may provide an input indicating a desire to replace offer 2302. In response, the virtual wallet application may provide a set of replacement offers 2303, from which the user may choose one or more offers to replace the offer 2302.

FIG. 23B shows a logic flow diagram illustrating example aspects of generating and exchanging offer recommendations in some embodiments of the EOOR, e.g., an Offer Recommendation and Exchange (“ORE”) component 2310. In some implementations, a user may desire to obtain new offers in the user's virtual wallet application, or may desire to exchange an existing offer for a new one (or a plurality of offers). The user may provide an input for display of such offers, 2301. The user's device may obtain the user's input, and determine whether the user desires to obtain a new offer, or obtain offers in exchange for an offer currently stored within the user's virtual wallet application executing on the device, 2302. If the device determines that the user desires to exchange a pre-existing offer, e.g., 2303, option “Yes,” the device may extract details of the offer that the user desires to exchange. For example, the device may correlate the position of the user's touchscreen input (e.g., where the device has a touchscreen interface) to an offer displayed on the screen. The device may also determine that the user utilized a gesture associated with the offer displayed on the screen that indicates the user's desire to exchange the offer with which the user gesture is associated. The device may query its database for an offer corresponding to the displayed offer, and may extract the details of the offer, 2304, by parsing the database-returned offer using a parser, such as the example parsers described below in the discussion with reference to FIG. 71. In some implementations, the device may extract any user-input offer generation restrictions (e.g., such as types of filters the user may have applied to offers the user desires, keywords related to the kinds of offers the user may desire, etc.) provided by the user as input, 2305. The device may generate an offer generation/exchange request for a pay network server using the extracted data on the offer to be exchanged (if any), and the user preferences for types of offers desired (if any), e.g., as a HTTP(S) POST request similar to the examples provided in the discussions below.

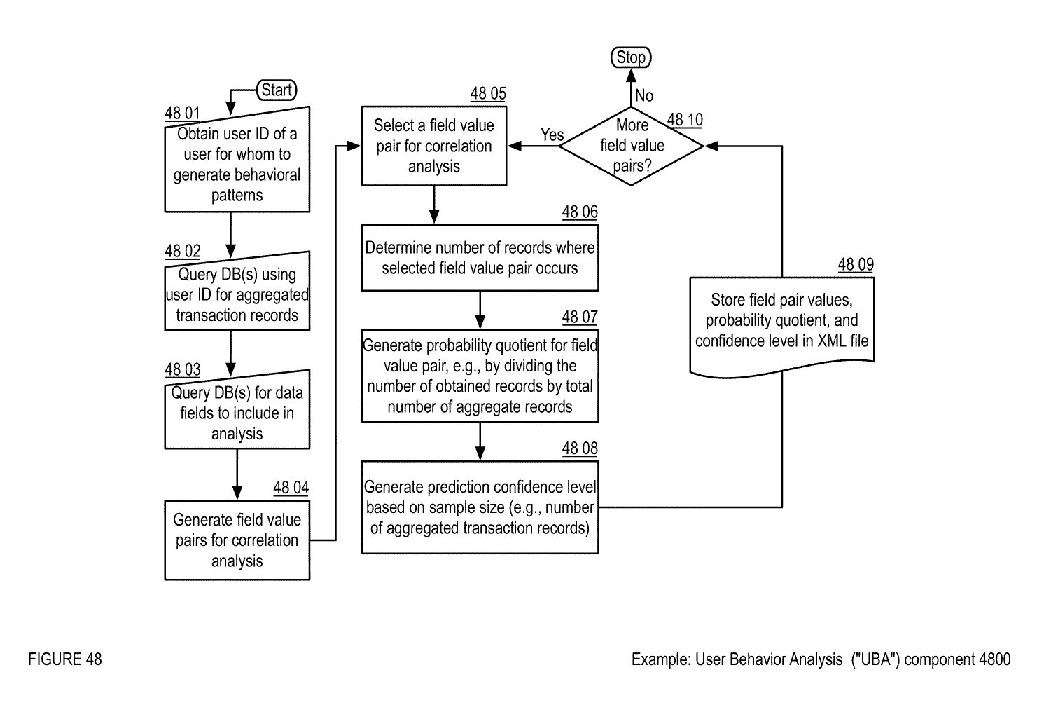

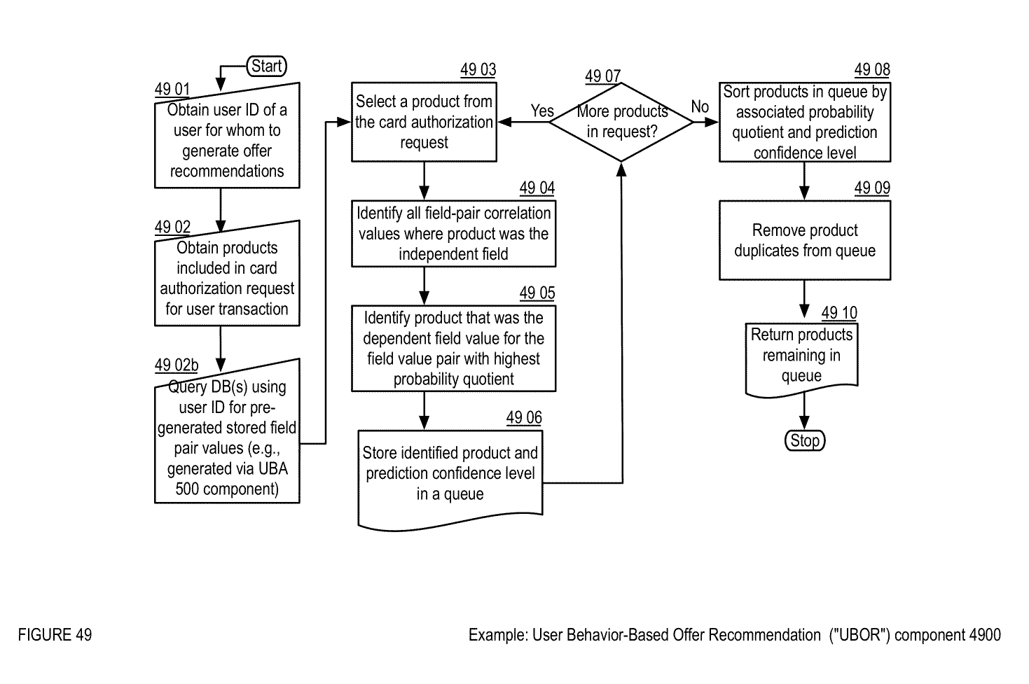

In some implementations, the pay network server may parse the offer generation/exchange request, 2307, using parsers such as the example parser described below in the discussion with reference to FIG. 71. The pay network server may generate a user behavior data query, 2308. For example, the server may utilize PHP/SQL commands to query a relational pay network database for user prior behavior data. For example, the pay network server may obain such data generated using centralized personal information platform components, such as those described in the discussion below with reference to FIGS. 28-47, as well as a user behavior analysis component, such as the example UBA component described below in the discussion with reference to FIG. 48. The database may provide such user behavior data and analysis thereof to the pay network server, 2309. Using the prior user behavior data and/or analysis thereof, and using the details of the exchanged offer and/or user offer generation restrictions, the pay network server may generate offers to provide for the user. For example, the pay network server may utilize a user behavior-based offer recommendation component such as the example UBOR component described in the discussion below with reference to FIG. 49. The server may provide the generated offers to the device, which may display the received offers to the user, 2311. In some implementations, the user may provide an input indicating a desire to redeem one of the offers provided by the pay network server, 2312. In response, the device may generate a card authorization request incorporating the details of the offer chosen for redemption by the user, 2313, and provide the generated card authorization request for purchase transaction processing (e.g., as an input to the example PTA component described below in the discussion with reference to FIGS. 67A-B).

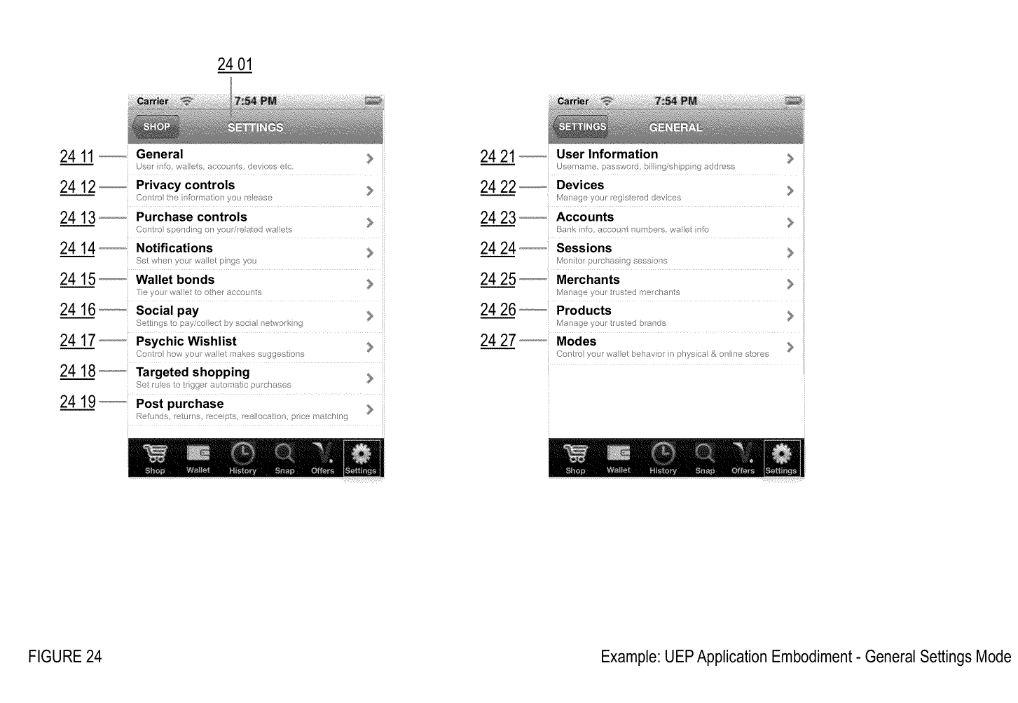

FIG. 24 shows user interface diagrams illustrating example aspects of a general settings mode of a virtual wallet application in some embodiments of the EOOR. In some implementations, the virtual wallet application may provide a user interface where the user can modify the settings of the wallet, 2401. For example, the user may modify settings such as, but not limited to: general settings 2411 (e.g., user information, wallet information, account information within the wallet, devices linked to the wallet, etc.); privacy controls 2412 (e.g., controlling information that is provided to merchants, payment networks, third-parties, etc.); purchase controls 2413 (e.g., placing specific spending restrictions, or proscribing particular type of transaction); notifications 2414; wallet bonds 2415 (e.g., relationship made with other virtual wallets, such that information, settings, (parental) controls, and/or funds may flow between the wallets seamlessly); 2416 social payment settings (see, e.g., FIGS. 50-57); psychic wishlists 2417 (e.g., controlling the type of user behaviors to consider in generating offers, recommendations—see, e.g., FIG. 49); targeted shopping 2418 (e.g., setting target prices at which buying of products is automatically triggered—see, e.g., FIGS. 21A, 22B-C); or post purchase settings 2419 (e.g., settings regarding refunds, returns, receipts, reallocation of expenses (e.g., to FSA or HSA accounts), price matching (e.g., if the price of the purchased item falls after the user buys it), etc.

In a category of general settings (2411), a user may be able to modify settings such as, but not limited to: user information 2421, user device 2422, user accounts 2423, shopping sessions 2424, merchants that are preferred 2425, preferred products and brand names, preferred modes (e.g., settings regarding use of NFC, Bluetooth, and/or the like), etc.

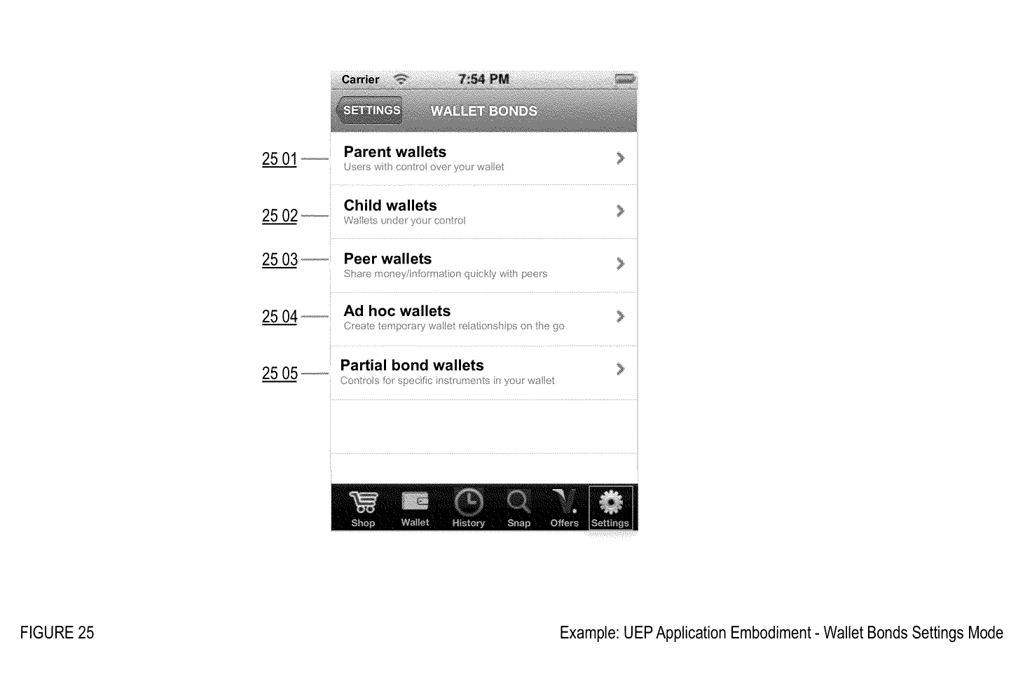

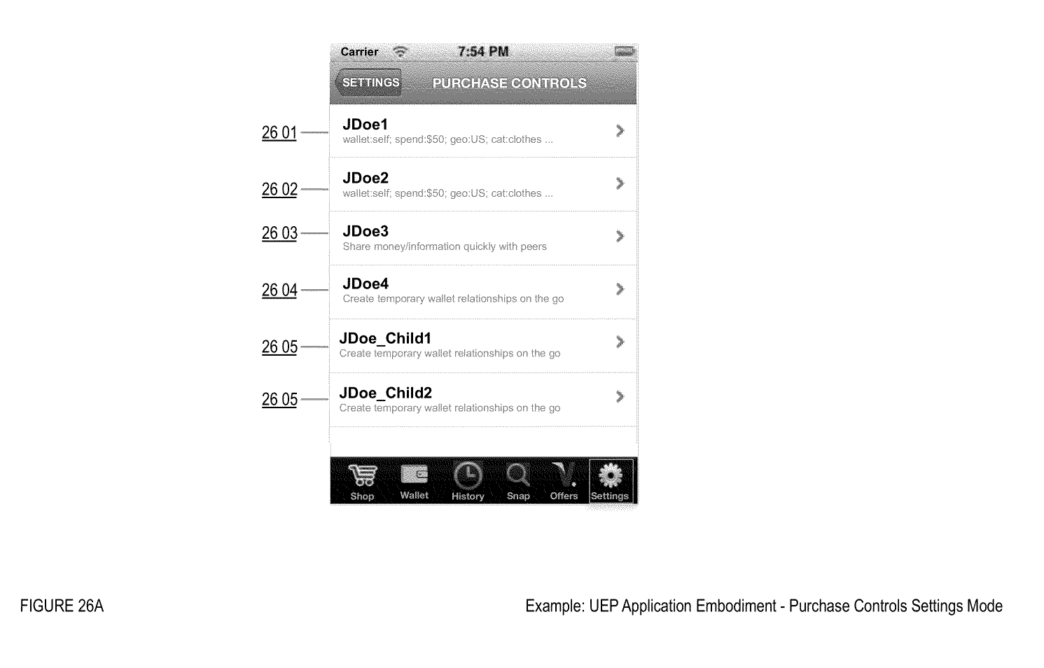

FIG. 25 shows a user interface diagram illustrating example aspects of a wallet bonds settings mode of a virtual wallet application in some embodiments of the EOOR. In a category of wallet bonds settings (see FIG. 24, 2415), a user may be able to modify settings such as, but not limited to, settings regarding: parent wallets 2501 (e.g., those that have authorization to place restriction on the user's wallet); child wallets 2502 (e.g., those wallets over which the user has authorization to place restrictions); peer wallets 2503 (e.g., those wallets that have a similar level of control and transparency); ad hoc wallets 2504 (e.g., those wallets that are connected temporarily in real-time, for example, for a one-time funds transfer); partial bond wallets (e.g., such as bonds between corporate employer virtual wallet and an employee's personal wallet, such that an employer wallet may provide limited funds with strings attached for the employee wallet to utilize for business purposes only), and/or the like.

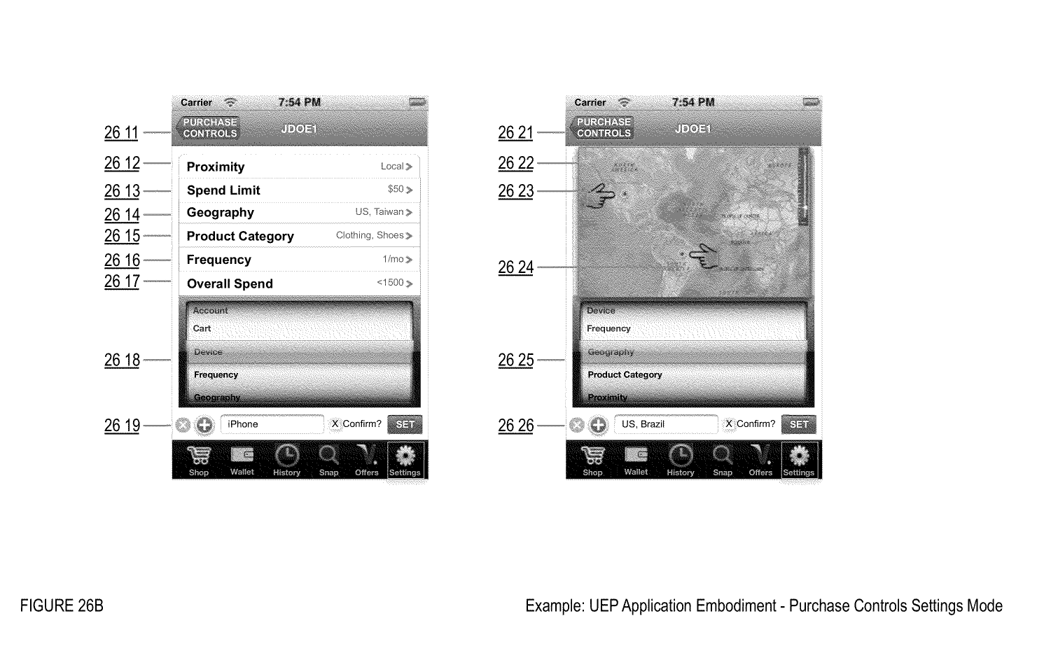

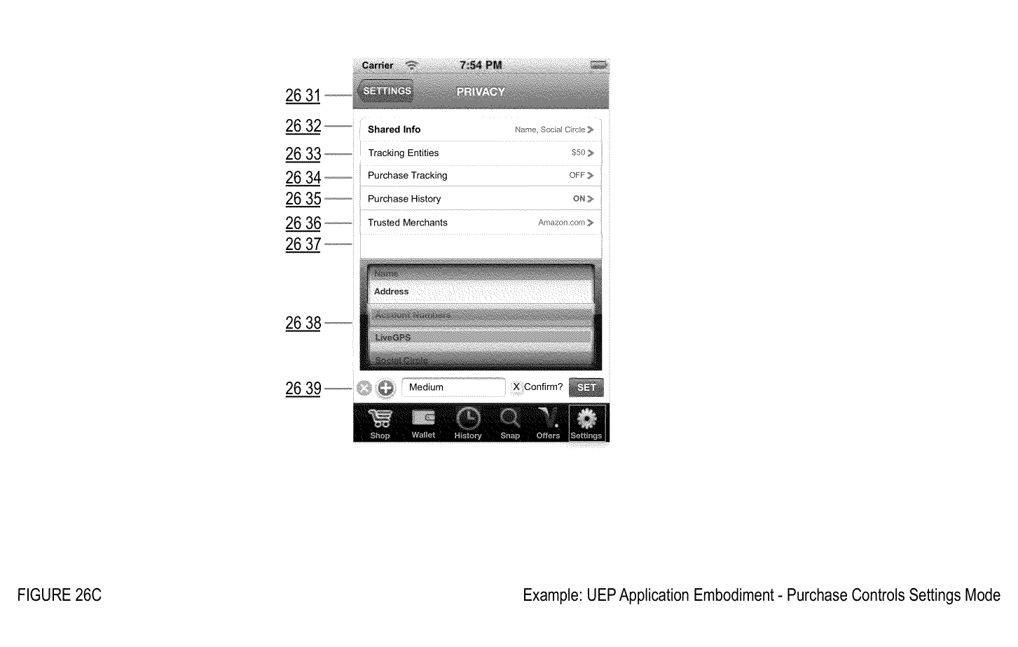

FIGS. 26A-C show user interface diagrams illustrating example aspects of a purchase controls settings mode of a virtual wallet application in some embodiments of the EOOR. With reference to FIG. 26A, in some implementations, a user may be able to view and/or modify purchase controls that allow only transaction that satisfy the purchase controls to be initiated from the wallet. In one implementation, a consumer may configure consumer-controlled fraud prevention parameters to restrict a purchase transaction via his electronic wallet, e.g., transaction time, maximum amount, type, number of transactions per day, and/or the like. For example, a consumer may enroll with an electronic wallet service (e.g., Visa V-Wallet) by creating an e-wallet account and adding a payment account to the e-wallet (e.g., a credit card, a debit card, a PayPal account, etc.). The consumer may configure parameters to restrict the wallet transactions. For example, the consumer may configure a maximum one-time transaction amount (e.g., $500.00, etc.). For another example, the consumer may specify a time range of transactions to be questionable (e.g., all transactions occurring between 2 am-6 am, etc.). For another example, the consumer may specify the maximum number of transactions per day (e.g., 20 per day, etc.). For further examples, the consumer may specify names and/or IDs of merchants with whom the transactions may be questionable (e.g., Internet spam sites, etc.).

In one implementation, the consumer may configure the purchase control settings to detect and block all susceptible transactions. For example, when an attempted transaction of an amount that exceeds the maximum specified transaction amount occurs, the electronic wallet may be configured to reject the transaction and send an alert to the consumer. The transaction may be resumed once the consumer approves the transaction. In another implementation, if the EOOR does not receive confirmation from the consumer to resume a susceptible transaction, the EOOR may send a notification to the merchant to cancel the transaction. In one implementation, the consumer may configure the time period of clearance (e.g., 12 hours, etc.). In another implementation, EOOR may determine a default maximum clearance period in compliance with regulatory requirements (e.g., 24 hours after soft posting, etc.).

In one implementation, the EOOR may provide the consumer with a universal payment platform, wherein a user may associated one or more payment accounts with a universal payment platform and pay with the universal payment platform. Within embodiments, the consumer may create an electronic wallet service account and enroll with the electronic wallet (e.g., Visa V-Wallet, etc.) via EOOR. In alternative embodiments, a consumer may associate a consumer bank account with an existing electronic wallet. For example, a consumer may provide payment information, such as bank account number, bank routing number, user profile information, to an electronic wallet management consumer onboarding user interface, to associate an account with the electronic wallet. In another implementation, a consumer may enroll with the electronic wallet during online checkout. For example, a merchant site may provide an electronic wallet button at the checkout page (e.g., a Visa V-Wallet logo, etc.), and upon consumer selection of the electronic wallet button, the consumer may be prompted to enter bank account information (e.g., card number, etc.) to register a payment card (e.g., a credit card, a debit card, etc.) with the electronic wallet via a pop-up window.

In one implementation, upon receiving consumer enrollment bank account data, the EOOR may generate an enrollment request to the electronic wallet platform (e.g., Visa V-Wallet payment network, etc.). In one implementation, an exemplary consumer enrollment data request in eXtensible Markup Language (XML). In further implementations, the consumer may be issued a EOOR electronic wallet device upon enrollment, e.g., a mobile application, a magnetic card, etc.

In one implementation, a user may configure transaction restriction parameters via a consumer enrollment user interface. For example, in one implementation, an electronic wallet user may receive an invitation from EOOR to sign up with EOOR service, and following a link provided in the invitation (e.g., an email, etc.), the user may provide registration information in a registration form.

In one implementation, a user may configure payment methods and alerts with EOOR. For example, the user may add a payment account to the wallet, and register for timely alerts with transactions associated with the payment account. In one implementation, the user may establish customized rules for triggers of a transaction alert. For example, an alert message may be triggered when a susceptible transaction occurs as the transaction amount exceeds a maximum one time transaction amount (e.g., $500.00, etc.). For another example, an alert may be triggered when a transaction occurs within a susceptible time range (e.g., all transactions occurring between 2 am-6 am, etc.). For another example, an alert may be triggered when the frequency of transactions exceeds a maximum number of transactions per day (e.g., 20 per day, etc.). For further examples, an alert may be triggered when the transacting merchant is one of a consumer specified susceptible merchants (e.g., Internet spam sites, etc.). For another example, an alert may be triggered when the type of the transaction is a blocked transaction type (e.g., a user may forbid wallet transactions at a gas station for gas fill, etc.).

In one implementation, the user may subscribe to EOOR alerts by selecting alert channels. For example, the user may providing his mobile number, email address, mailing address and/or the like to EOOR, and subscribe to alerts via email, text messages, consumer service calls, mail, and/or the like. In one implementation, the user may configure rules and subscription channels for different payment account associated with the electronic wallet.

In one implementation, upon receiving user configured parameters via a user interface, EOOR (e.g., a Visa Wallet network) may provide a (Secure) Hypertext Transfer Protocol (“HTTP(S)”) PUT message including the user leash parameters in the form of data formatted according to the eXtensible Markup Language (“XML”). Below is an example HTTP(S) PUT message including an XML-formatted user leash parameters for storage in a database:

```
PUT /leash.php HTTP/1.1
Host: www.leash.com
Content-Type: Application/XML
Content-Length: 718
<?XML version = “1.0” encoding = “UTF-8”?>
<UserLeashRule>
  <UserID> JDoe <\UserID>
  <WalletID> JD0001 </WalletID>
  <Rule1>
      <RuleID> 00001 </RuleID>
      <CardNo> 0000 0000 0000 </CardNo>
      <MaxAmount> 500.00 </MaxAmount>
      <MaxPerDay> 20 </MaxPerDay>
      <Subscription> Mobile 000-000-0000 </Subscription>
      <Channel> SMS </Channel>
      ...
  </Rule1>
  <Rule2>
      <RuleID> 00002 </RuleID>
      <CardNo> 0000 0000 0002 </CardNo>
      <MaxAmount> 100.00 </MaxAmount>
      <MaxPerDay> 10 </MaxPerDay>
      <BlackListMerchants>
          <Merchant1> abc.com </Merchant1>
          <Merchant2> xyz </Merchant2>
          ...
      </BlacklistMerchants>
      ...
      <Subscription> Email </Subscription>
      <Channel> jdoe@email.com </Channel>
      ...
  </Rule2>
  . .
<\UserLeashRule>
```

In one implementation, upon configuring the leash parameters, when a consumer shops with a merchant (e.g., a shopping site, etc.), the payment processor network may forward the purchasing request to Visa network, which may apply the consumer's EOOR enrollment with the electronic wallet (e.g., Visa wallet network, etc.). For example, in one implementation, the EOOR may retrieve the user leash parameters, and inspect the transaction amount, transaction type, transaction frequency, and/or the like of the received transaction request based on the leash parameters.

In one implementation, if the proposed transaction triggers an alert, EOOR may generate an alert message, e.g., by providing a (Secure) Hypertext Transfer Protocol (“HTTP(S)”) PUT message including the alert content in the form of data formatted according to the XML. Below is an example HTTP(S) PUT message including an XML-formatted alert:

```
PUT /alert.php HTTP/1.1
Host: www.leash.com
Content-Type: Application/XML
Content-Length: 718
<?XML version = “1.0” encoding = “UTF-8”?>
<Alert>
  <UserID> JDoe <\UserID>
  <WalletID> JD0001 </WalletID>
  <Time> 23:23:34 00-00-1900 <Time>
  <TransactionID> 000000 <TransactionID>
  <Trigger>
  MaxAmount>
  </Trigger>
  <AlertTemplateID> Tem00001 </AlertTemplateID>
  <Subscription> Email </Subscription>
  <Channel> jdoe@email.com </Channel>
  <Content>
      <Title> ″Transaction Alert: $1000.00 from Amazon.com </Title>
      <Greeting> ″Dear Joe″ </Greeting>
      <Body> ″We recently note that ...″ </Body>
      ...
  </Content>
  ...
<\Alert>
```

In one implementation, the EOOR may also generate a message and send it to the issuing bank, e.g., the user's bank that issues the payment account, etc., to alert the issuing bank not to credit funds to the merchant unless a clearance message is received subsequently.

With reference to FIG. 26B, in some implementations, the virtual wallet application may provide an interface via which user may efficiently set purchase controls for transactions. For example, the user may enter a purchase controls settings screen (“JDOE1”) 2611, wherein the user may add restriction parameters to the purchase control setting. For example, the user interface on the left of FIG. 26B shows a purchase control that only allows in-person (see 2612) transactions below $50 (see 2613) to be made from US or Taiwan (see 2614), when made for clothes or shoes (see 2615), and not more than once a month (see 2616), and given that the user's overall spend for the time frame (1 mo) is less than $1500 (see 2617). Such parametric restrictions may be imposed using the user interface elements 2618 (e.g., to select a parameter) and 2619 (e.g., to enter a value corresponding to the parameter). In some situations, the virtual wallet may provide a graphical user interface component (e.g., 2622) to facilitate user input entry. For example, the virtual wallet may display a map of the world when the user wishes to place a geographic restriction on a purchase control, and the user may touch the map at the appropriate sport (e.g., 2623, 2624) to set the locations from which transaction may be allowed (or alternatively, blocked). In some implementations the virtual wallet may also allow the user to manually enter the value (see 2626), instead of utilizing the visual touch-based GUI component provided by the virtual wallet application.

With reference to FIG. 26C, in some implementations, the virtual wallet application may allow a user to manage privacy settings 2631 associated with the users' use of the wallet. For example, the user may be able to specify the information (e.g., 2632-1637) about the user that may be shared during the course of a purchase transaction. For example, in the illustration, the user has allowed the virtual wallet application to share the user's name, and social circle (1632). The user has not yet set a preference for sharing the user's address; thus it may take a default value of medium (e.g., if the risk in the transaction is assessed by the EOOR as being above medium, then the EOOR may cloak the user's address during the transaction) depending on the type of transaction, in some implementations. The user has explicitly opted against sharing the user's account numbers (e.g., the user wishes for the payment network to cloak the user's account number during the transaction), and the user's live GPS location (see 2638).

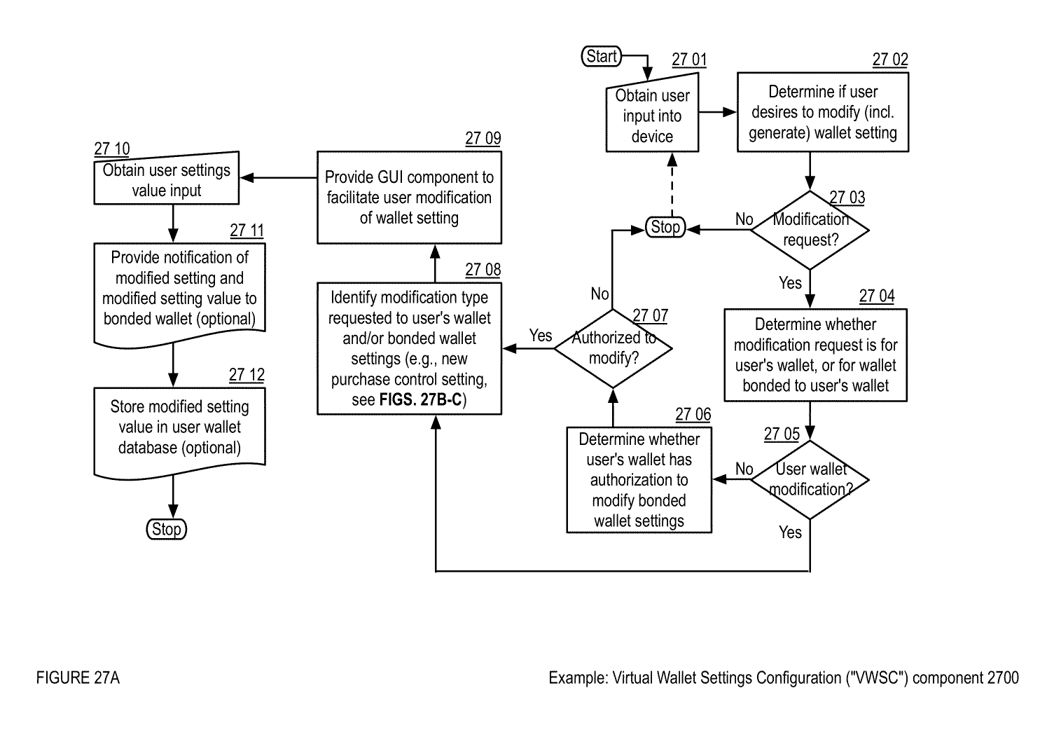

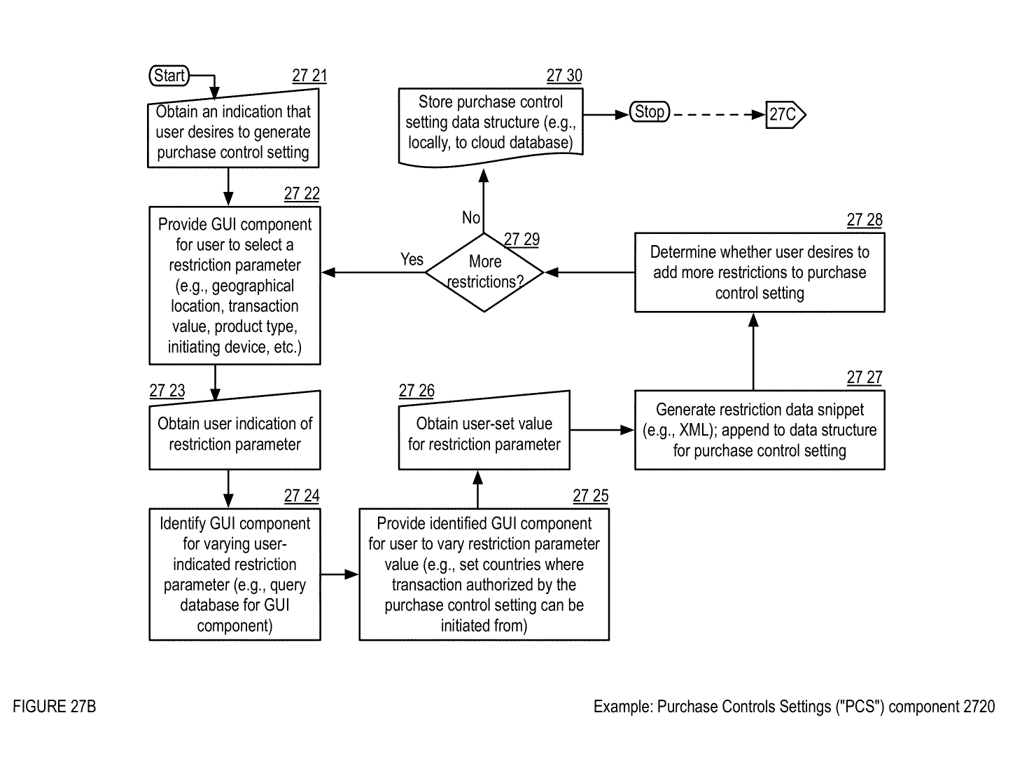

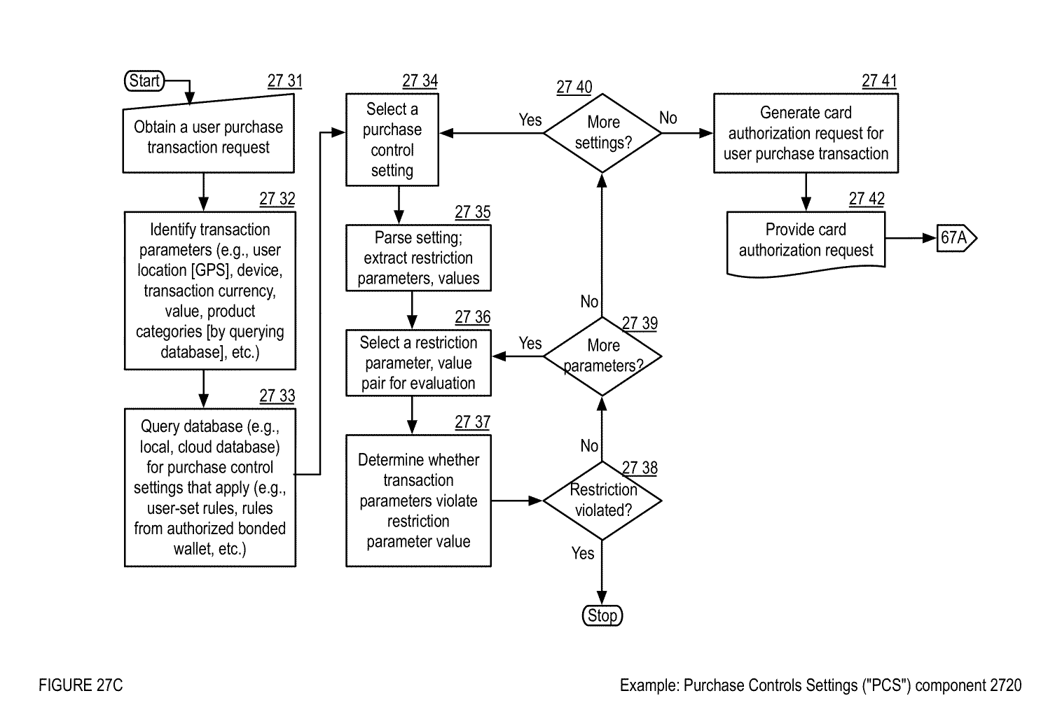

FIG. 27A shows a logic flow diagram illustrating example aspects of configuring virtual wallet application settings in some embodiments of the EOOR, e.g., a Virtual Wallet Settings Configuration (“VWSC”) component 2700. In some implementations, a user may desire to modify a setting within the user's virtual wallet application and/or within a virtual wallet application that has a relationship to the user's wallet (e.g., bonded wallet is a child wallet of the user's wallet). The user may provide input to a user device, 2701, indicating the desire to modify a wallet setting. Upon determining that the user desires to modify a wallet setting (see 2702-1703), the device may determine whether the user request is for modification of the user's wallet, or for modification of a wallet bonded to the user's wallet. In some implementations, the wallet application may require the user to enter a password or answer a challenge question successfully before allowing the user to modify a user setting. Further, in some implementations, the device may, if the user desires to modify the wallet settings of a bonded wallet (see 2705), the device may determine whether the user is authorized to do so, 2706. For example, the device may determine the type of relationship between the user's wallet and the bonded wallet; whether the bonded wallet (or its user) is required to provide permission before the wallet settings can be modified; and/or the like. In implementations requiring authorization from the bonded wallet user, the device may provide a request to a device of the bonded wallet user (e.g., via a server system storing network addresses for the devices of each user utilizing a virtual wallet). Upon determining that the user's wallet has authorization to modify the settings of the bonded wallet (see 2707), the device may identify a type of modification that the user desires to perform, 2708. In some implementations, whether the user is authorized to modify a wallet setting may depend on the wallet setting the user desires to modify, in which case the identification of the type of modification may be performed before determining whether the user is authorized to modify the wallet setting. Based on the type of modification requested by the user, the device may provide a graphical user interface (GUI) component (see, e.g., geographical map for marking countries from which transactions may be initiated for a particular purchase control setting, FIG. 16B [center]) to facilitate user entry of the modification to a wallet setting, 2709. The device may obtain the user setting value input via the GUI component, 2710. Where the modification involves a bonded wallet, the device may optionally provide a notification of modification of a setting involving the bonded wallet, 2711. The device may optionally store the modification of the wallet setting in a database, e.g., in a local database or a cloud storage database, 2712.

FIGS. 27B-C show logic flow diagrams illustrating example aspects of implementing purchase controls settings in some embodiments of the EOOR, e.g., a Purchase Controls Settings (“PCS”) component 2720. With reference to FIG. 27B, in some implementations, a user may desire to generate a purchase control setting to monitor and/or restrict transactions of a specific character from being processed by the EOOR. The user may provide such an indication into a user device executing a virtual wallet application for the user, 2721. In response, the device may provide a GUI component for the user to select a parameter according to which to restrict transactions initiated from the virtual wallet of the user, 2722 (see, e.g., scroll wheels of FIG. 16B). The user may utilize the GUI component to select a restriction parameter, 2723. Based on the restriction parameter selected (e.g., geographical location, transaction value, transaction card, product category, time, date, currency, account balance(s), etc.), the device may identify, e.g., by querying a database, a GUI component to provide the user for facilitate the user providing a value associated with the restriction parameter (see, e.g., world map of FIG. 26B [center]), 2724. The device may provide the identified GUI component to the user, 2725. Using the GUI component, the user may provide a value for the restriction parameter, 2726. In response, the device may generate a data snippet including an identification of a restriction parameter, and an associated value for the restriction parameter, 2727. For example, the data snippnet may be formatted as an XML data structure. In some implementations, the data structure may also include an indication of whether the restriction parameter value represents an upper bound or lower bound of the range of allowed values for that parameter. The device may append the data structure for the restriction parameter to a data structure for the overall purchase control setting, 2727. In some implementations, the device may determine whether the user desires to enter more such restriction parameters, and may facilitate the user entering such restriction parameters on top of any previously provided restriction parameters (see 2728-1729). Upon obtaining all restriction parameters for a given purchase control setting, the device may store the finalized purchase control setting to a database (e.g., a local database, a cloud storage database, etc.), 2730.

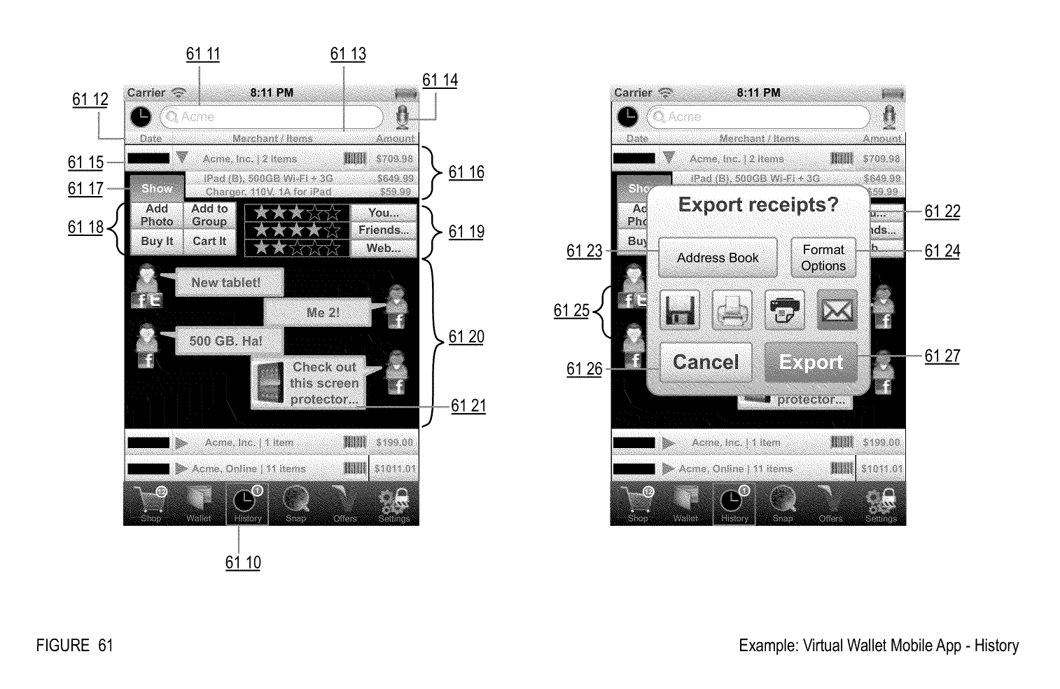

With reference to FIG. 27C, in some implementations, a user may desire to enter into a purchase transaction. The user may provide an input into user device executing a virtual wallet application indicative of the user's desire to enter into the purchase transaction, 2731. In response, the device may identify the parameters of the transaction (e.g., geographical location, transaction value, transaction card, product category, time, date, cart, wallet type [bonded, unbonded], currency, account balance(s) around the time of initiation of the transation, etc.), 2732. The device may query a database for purchase control settings that may apply to the purchase transaction request, 2733. For example, these could include rules set by a bonded wallet user who has authorization to set purchase controls on the user's wallet. The device may process each purchase control setting to ensure that no setting is violated. In alternative schemes, the device may process purchase control settings until at least one purchase control setting permits the purchase transaction to be performed (or the purchase transaction may be denied if no setting permits it), see 2734. The device may select a purchase control setting, and extract the restriction parameters and their associated value from the purchase control setting data structure. For example, the device may use a parser similar to the example parsers described below in the discussion with reference to FIG. 61. The device may select a restriction parameter-value pair, 2736, and determine whether the transaction parameters violate the restriction parameter value, 2737. If the restriction is violated (2738, option “Yes”), the device may deny the purchase transaction request. Otherwise, the device may check each restriction parameter in the purchase control setting (see 2739) in a similar procedure to that described above. If the purchase control setting does not restrict the transaction, the device may execute similar procedure for all the other purchase control settings, unless one of the settings is violated (or, in the alternative scheme, if at least one purchase control setting permits the purchase transaction) (see 2740). If the device determines that the purchase transaction is permitted by the purchase control settings of the user and/or bonded wallet users (1740, option “No”), the device may generate a card authorization request, 2741, and provide the card authorization request for purchase transaction authorization (see FIG. 67A).

FIG. 28 shows a block diagram illustrating example aspects of a centralized personal information platform in some embodiments of the EOOR. In various scenarios, originators 2811 such as merchants 2811b, consumers 2811c, account issuers, acquirers 2811a, and/or the like, desire to utilize information from payment network systems for enabling various features for consumers. Such features may include application services 2812 such as alerts 2812a, offers 2812c, money transfers 2812n, fraud detection 2812b, and/or the like. In some embodiments of the EOOR, such originators may request data to enable application services from a common, secure, centralized information platform including a consolidated, cross-entity profile-graph database 2801. For example, the originators may submit complex queries to the EOOR in a structure format, such as the example below. In this example, the query includes a query to determine a location (e.g., of a user), determine the weather associated with the location, perform analyses on the weather data, and provide an exploded graphical view of the results of the analysis:

```
<int
  Model_id =“1”
  environment_type=“RT”
  meta_data=“./fModels/robotExample.meta”
  tumblar_location=“./fModels/robotExample.tumblar.location”
  input_format=“JSON”
  pmmls=“AUTONOMOUS_AGENTS.PMML”
  Model_type =“AUTONOMOUS_AGENTS”
>
<vault >
<door:LOCATION>
      <lock name=“DETERMINE LOCATION”
        inkey=“INPUT” inkeyname=“lat”
        inkey2=“INPUT” inkeyname2=“long”
        function=“ROUND”
        fnct1-prec=“−2”
        function-1=“JOIN”
        fnct2-delim=“:”
        tumblar=‘LAT_LONG.key’
        outkey=“TEMP”C outkeyname=“location”
        type=“STRING”
      />
      <lock name=“DETERMINE WEATHER”
        inkey=“TEMP” inkeyname=“location”
        mesh=‘MESHRT.RECENTWEATHER’
        mesh-query=‘HASH’
        outkey=“TEMP”  outkeyname=“WEATHERDATA”
        type=“ARRAY”
      />
      <lock name=“EXPLODE DATA”
        inkey=“TEMP” inkeyname=“WEATHERDATA”
        function=“EXPLODE”
        fnct-delim=“:”
        outkey=“MODELDATA”  outkeystartindex=1
      />
      <lock name=“USER SETTINGS”
        inkey=“INPUT” inkeyname=“USERID”
        mesh=‘MESHRT.AUTONOMOUSAGENT.SETTINGS’
        mesh-query=‘HASH’
        outkey=“TEMP”  outkeyname=“USERSETTINGS”
        type=“ARRAY”
      />
      <lock name=“EXPLODE USER”
        inkey=“TEMP” inkeyname=“USERSETTINGS”
        function=“EXPLODE”
        fnct-delim=“:”
        outkey=“USERDATA”  outkeystartindex=1
      />
      <lock name=“RUN MODELE”
        inkey=“MODELDATA”
        inkey1=“USERDATA”
        function=“TREE”
        fnc-pmml=“AUTONOMOUS_AGENTS.PMML”
        outkey=“OUTPUT”  outkeyname=“WEATHER”
        type=“NUMERIC”
      />
</door>
</vault>
```

A non-limiting, example listing of data that the EOOR may return based on a query is provided below. In this example, a user may log into a website via a computing device. The computing device may provide a IP address, and a timestamp to the EOOR. In response, the EOOR may identify a profile of the user from its database, and based on the profile, return potential merchants for offers or coupons:

```
--------------------------------------------------
------------------ Use Case 3 -------------------
-- User log into a website
-- Only IP address, GMT and day of week is passed to Mesh
-- Mesh matches profile based on Affinity Group
-- Mesh returns potential Merchants for offers or coupons based on tempory
  model using suppression rules
--------------------------------------------------
-- Test case 1 IP:24:227:206 Hour:9 Day:3
-- Test case 2 IP:148:181:75 Hour:4 Day:5
--------------------------------------------------
-------  AffinityGroup Lookup ------------------
--------------------------------------------------
Look up test case 1
[OrderedDict([(‘ISACTIVE’, ‘True’), (‘ENTITYKEY’, ‘24:227:206:3:1’), (‘XML’,
  None), (‘AFFINITYGROUPNAME’, ‘24:227:206:3:1’), (‘DESCRIPTION’, None),
  (‘TYPEOF’, None), (‘UUID’, ‘5f8df970b9ff11e09ab9270cf67eca90’)]),
  OrderedDict([(‘ISACTIVE’, ‘True’), (‘BASEUUID’,
  ‘4fbea327b9ff11e094f433b5d7c45677’), (‘TOKENENTITYKEY’,
  ‘4fbea327b9ff11e094f433b5d7c45677:TOKEN:349:F’), (‘BASETYPE’,
  ‘MODEL_002_001_00’), (‘STATUS’, ‘ACTIVE’), (‘ISSUEDDATE’, None), (‘WEIGHT’,
  ‘349’), (‘CATEGORY’, ‘F’), (‘DOUBLELINKED’, None), (‘UUID’,
  ‘6b6aab39b9ff11e08d850dc270e3ea06’)]), OrderedDict([(‘ISACTIVE’, ‘True’),
  (‘BASEUUID’, ‘4fbea328b9ff11e0a5f833b5d7c45677’), (‘TOKENENTITYKEY’,
  ‘4fbea328b9ff11e0a5f833b5d7c45677:TOKEN:761:1’), (‘BASETYPE’,
  ‘MODEL_003_001_00’), (‘STATUS’, ‘ACTIVE’), (‘ISSUEDDATE’, None), (‘WEIGHT’,
  ‘761’), (‘CATEGORY’, ‘1’), (‘DOUBLELINKED’, None), (‘UUID’,
  ‘68aaca40b9ff11e0ac799fd4e415d9de’)]), OrderedDict([(‘ISACTIVE’, ‘True’),
  (‘BASEUUID’, ‘4fbea328b9ff11e0a5f833b5d7c45677’), (‘TOKENENTITYKEY’,
  ‘4fbea328b9ff11e0a5f833b5d7c45677:TOKEN:637:2’), (‘BASETYPE’,
  ‘MODEL_003_001_00’), (‘STATUS’, ‘ACTIVE’), (‘ISSUEDDATE’, None), (‘WEIGHT’,
  ‘637’), (‘CATEGORY’, ‘2’), (‘DOUBLELINKED’, None), (‘UUID’,
  ‘6b6d1c38b9ff11e08ce10dc270e3ea06’)]), OrderedDict([(‘ISACTIVE’, ‘True’),
  (‘BASEUUID’, ‘4fbea328b9ff11e0a5f833b5d7c45677’), (‘TOKENENTITYKEY’,
  ‘4fbea328b9ff11e0a5f833b5d7c45677:TOKEN:444:3’), (‘BASETYPE’,
  ‘MODEL_003_001_00’), (‘STATUS’, ‘ACTIVE’), (‘ISSUEDDATE’, None), (‘WEIGHT’,
  ‘444’), (‘CATEGORY’, ‘3’), (‘DOUBLELINKED’, None), (‘UUID’,
  ‘6342aa53b9ff11e0bcdb9fd4e415d9de’)]), OrderedDict([(‘ISACTIVE’, ‘True’),
  (‘BASEUUID’, ‘4fbea328b9ff11e0a5f833b5d7c45677’), (‘TOKENENTITYKEY’,
  ‘4fbea328b9ff11e0a5f833b5d7c45677:TOKEN:333:4’), (‘BASETYPE’,
  ‘MODEL_003_001_00’), (‘STATUS’, ‘ACTIVE’), (‘ISSUEDDATE’, None), (‘WEIGHT’,
  ‘333’), (‘CATEGORY’, ‘4’), (‘DOUBLELINKED’, None), (‘UUID’,
  ‘62bd26a2b9ff11e0bc239fd4e415d9de’)]), OrderedDict([(‘ISACTIVE’, ‘True’),
  (‘BASEUUID’, ‘4fbea328b9ff11e0a5f833b5d7c45677’), (‘TOKENENTITYKEY’,
  ‘4fbea328b9ff11e0a5f833b5d7c45677:TOKEN:307:5’), (‘BASETYPE’,
  ‘MODEL_003_001_00’), (‘STATUS’, ‘ACTIVE’), (‘ISSUEDDATE’, None), (‘WEIGHT’,
  ‘307’), (‘CATEGORY’, ‘5’), (‘DOUBLELINKED’, None), (‘UUID’,
  ‘6b6d1c39b9ff11e0986c0dc270e3ea06’)]), OrderedDict([(‘ISACTIVE’, ‘True’),
  (‘BASEUUID’, ‘4fbea32db9ff11e09f3e33b5d7c45677’), (‘TOKENENTITYKEY’,
  ‘4fbea32db9ff11e09f3e33b5d7c45677:TOKEN:801:Spend’), (‘BASETYPE’,
  ‘MODEL_008_001_00’), (‘STATUS’, ‘ACTIVE’), (‘ISSUEDDATE’, None), (‘WEIGHT’,
  ‘801’), (‘CATEGORY’, ‘Spend’), (‘DOUBLELINKED’, None), (‘UUID’,
  ‘6b6d1c3ab9ff11e0a4ec0dc270e3ea06’)]), OrderedDict([(‘ISACTIVE’, ‘True’),
  (‘BASEUUID’, ‘4fbea32eb9ff11e0b55133b5d7c45677’), (‘TOKENENTITYKEY’,
  ‘4fbea32eb9ff11e0b55133b5d7c45677:TOKEN:1:Volume’), (‘BASETYPE’,
  ‘MODEL_009_001_00’), (‘STATUS’, ‘ACTIVE’), (‘ISSUEDDATE’, None), (‘WEIGHT’,
  ‘1’), (‘CATEGORY’, ‘Volume’), (‘DOUBLELINKED’, None), (‘UUID’,
  ‘62a09df3b9ff11e090d79fd4e415d9de’)])]
Found a direct match
148:181:75:1:2
-- Failed to find a direct match
-- Try again with only IP address and hour
[OrderedDict([(‘ISACTIVE’, ‘True’), (‘ENTITYKEY’, ‘148:181:75:1:1’), (‘XML’,
  None), (‘AFFINITYGROUPNAME’, ‘148:181:75:1:1’), (‘DESCRIPTION’, None),
  (‘TYPEOF’, None)])]
-- Found match for case 2
-----------------------------------------------------------
------------------ Temporary model rules-------------------
----------------------------------------------------------
{1: {‘LOWER’: 10, ‘BASETYPE’: [‘MODEL_002_001_00’, ‘MODEL_003_001_00’],
  ‘attribute’: ‘WEIGHT’, ‘rule’: ‘NEAR’, ‘OP’: ‘PROX’, ‘type’: ‘TOKENENTITY’,
  ‘HIGHER’: 10}, 2: {‘type’: [‘MERCHANT’], ‘rule’: ‘FOLLOW’}, 3: {‘rule’:
  ‘RESTRICTSUBTYPE’, ‘BASETYPE’: [‘MODEL_002_001_00’, ‘MODEL_003_001_00’]}}
-----------------------------------------------------------
------------------ Temporary Model Output------------------
------------------- For Use Case 1  ---------------------
-----------------------------------------------------------
-- Number of Nodes:102
                LIVRARIASICILIAN
                                GDPCOLTD
            GOODWILLINDUSTRIES
                            DISCOUNTDE
                          BARELANCHOE
                      BLOOMINGDALES
                  PARCWORLDTENNIS
                STRIDERITEOUTLET
                            PARCCEANOR
                              PONTOFRIO
                        FNACPAULISTA
                            FINISHLINE
                    WALMARTCENTRAL
                BESNIINTERLARGOS
                PARCLOJASCOLOMBO
                      SHOPTIMEINTER
                      BEDBATHBEYOND
                            MACYSWEST
          PARCRIACHUELOFILIAL
                  JCPENNEYCORPINC
              PARCLOJASRENNERFL
          PARCPAQUETAESPORTES
                                MARISALJ
            PARCLEADERMAGAZINE
                            INTERFLORA
                              DECATHLON
                  PERNAMBUCANASFL
                            KARSTADTDE
                            PARCCEAMCO
                                    CHAMPS
                          ACCESSORIZE
              BLOOMINGDALESDVRS
          PARCLIVRARIACULTURA
                          PARCCEALOJA
                        ARQUIBANCADA
                                    KITBAG
                FREDERICKSOFHLWD
                              WALMART
          PARCLOJASINSINUANTE
                  WALMARTCONTAGEM
                            FOOTLOCKER
                    PARCSANTALOLLA
                      RICARDOELETRO
                      PARCPONTOFRIO
                    DOTPAYPLPOLSKA
                                  CAMICADO
                                  KARSTADT
                          PARCRAMSONS
                          PARCGREGORY
                            GREMIOFBPA
                            WALMARTSJC
            PRODIRECTSOCCERLTD
                          LAVIEENROSE
                        PARCMARISALJ
                                      ORDERS
              PARCNSNNATALNORTE
                  LOJASINSINUANTE
                                                B
                            CITYCOUNTY
                  WALMARTPACAEMBU
                                          SOHO
                      WALMARTOSASCO
                FOSSILSTORESIINC
                          MENARDSCLIO
                        PARCPEQUENTE
                                      BEALLS
                        THEHOMEDEPOT
                                      VIAMIA
            PARCLOJASRIACHUELO
                  PARCLOJASMILANO
                              NORDSTROM
            WAILANACOFFEEHOUSE
                        LANCHOEBELLA
                                        PUKET
                WALMARTSTORESINC
          PARCPERNAMBUCANASFL
                        SMARTSHOPPER
          PARCMAGAZINELUIZASP
        COLUMBIASPORTSWEARCO
                    BARELANCESTADA
                            DONATEEBAY
              PARCRICARDOELETRO
                    PARCDISANTINNI
                              SCHUHCOUK
                                    CEANOR
                      PARCCAMICADO
                  PARCCENTAUROCE
                PARCMARLUIJOIAS
                                  ALBADAH
                                MARTINEZ
                MONEYBOOKERSLTD
                                      MACYS
                    PARCRIOCENTER
                  PARCCASASBAHIA
            PARCSUBMARINOLOJA
                                        INC
                    SUBMARINOLOJA
                    LOJASRENNERFL
                RIACHUELOFILIAL
                PARCSONHODOSPES
                                PINKBIJU
                          PARCCEAMRB
-----------------------------------------------------------
------------------ Temporary model Output -----------------
------------------- For Use Case 2  ---------------------
-----------------------------------------------------------
-- Number of Nodes:3
                                    KITBAG
        COLUMBIASPORTSWEARCO
                          GREMIOFBPA
--------------------------------------------------------------
--------  End of Example Use Case  ---
--------------------------------------------------------------
```

In some embodiments, the EOOR may provide access to information on a need-to-know basis to ensure the security of data of entities on which the EOOR stores information. Thus, in some embodiments, access to information from the centralized platform may be restricted based on the originator as well as application services for which the data is requested. In some embodiments, the EOOR may thus allow a variety of flexible application services to be built on a common database infrastructure, while preserving the integrity, security, and accuracy of entity data. In some implementations, the EOOR may generate, update, maintain, store and/or provide profile information on entities, as well as a social graph that maintains and updates interrelationships between each of the entities stored within the EOOR. For example, the EOOR may store profile information on an issuer bank 2802a (see profile 2803a), a acquirer bank 2802b (see profile 2803b), a consumer 2802c (see profile 2803c), a user 2802d (see profile 2803d), a merchant 2802e (see profile 2803e), a second merchant 2802f (see profile 2803f). The EOOR may also store relationships between such entities. For example, the EOOR may store information on a relationship of the issuer bank 2802a to the consumer 2802c shopping at merchant 2802e, who in turn may be related to user 2802d, who might bank at the back 2802b that serves as acquirer for merchant 2802f.

FIGS. 20A-F show block diagrams illustrating example aspects of data models within a centralized personal information platform in some embodiments of the EOOR. In various embodiments, the EOOR may store a variety of attributes of entities according to various data models. A few non-limiting example data models are provided below. In some embodiments, the EOOR may store user profile attributes. For example, a user profile model may store user identifying information 2001, user aliases 2002, email addresses 2003, phone numbers 2004, addresses 2005, email address types 2006, address types 2007, user alias types 2008, notification statuses 2009, ISO country 2010, phone number types 2011, contract information with the EOOR 2012, user authorization status 2013, user profile status 2014, security answer 2015, security questions 2016, language 2017, time zone 2018, and/or the like, each of the above field types including one or more fields and field values. As another example, a user financial attributes model may store user identifying information 2020, user financial account information 2021, account contract information 2022, user financial account role 2023, financial account type 2024, financial account identifying information 2025, contract information 2026, financial account validation 2027, financial account validation type 2028, and/or the like. As another example, a user payment card attributes data model may include field types such s, but not limited to: user identifying information 2030, user financial account information 2031, user financial account role 2032, account consumer applications 2033, user consumer application 2034, financial account type 2035, financial account validation type 2036, financial account information 2037, consumer application information 2038, consumer application provider information 2039, and/or the like. As another example, a user services attributes data model may include field types such as, but not limited to: user identifying information 2040, user alias 2041, consumer application user alias status 2042, user alias status 2043, status change reason code 2044, user contract 2045, contract information 2046, user service attribute value 2047, consumer application attributes 2048, account service attribute value, account contract 2050, user profile status 2061, contract business role 2052, contract business 2053, client information 2054, contract role 2055, consumer application 2056, user activity audit 2057, login results 2058, and/or the like. As another example, a user services usage attributes data model may include field types such as, but not limited to: user identifying information 2060, user alias 2061, consumer application user alias status 2062, status change reason code 2063, user alias status 2064, user consumer application 2065, user login audit 2066, login result 2067, account service attribute value 2068, account consumer application 2069, consumer application 2070, consumer application provider 2071, login result 2072, and/or the like. As another example, a user graph attributes data model may include field types such as, but not limited to: user identifying information 2080, user contact 2081, consumer application user alias status 2082, relationship 2083, and/or the like. In some embodiments, the EOOR may store each object (e.g., user, merchant, issuer, acquirer, IP address, household, etc.) as a node in graph database, and store data with respect to each node in a format such as the example format provided below:

<Nodes Data>

```
ID,Nodes,Label
2fdc7e3fbd1c11e0be645528b00e8d0e,2fdc7e3fbd1c11e0be645528b00e8d0e,AFFINITYGROUP
    NAME:49:95:0:3:1
32b1d53ebd1c11e094172557fb829fdf,32b1d53ebd1c11e094172557fb829fdf,TOKENENTITYKEY:
    2b8494f0bd1c11e09c856d888c43f7c2:TOKEN:0:F
2e6381e4bd1c11e0b9ffc929a54bb0fd,2e6381e4bd1c11e0b9ffc929a54bb0fd,MERCHANTNAME:
                  MERCHANT_ABC
2fdc7e3dbd1c11e0a22d5528b00e8d0e,2fdc7e3dbd1c11e0a22d5528b00e8d0e,AFFINITYGROUP
    NAME:49:95:0:1:1
2e6381e7bd1c11e091b7c929a54bb0fd,2e6381e7bd1c11e091b7c929a54bb0fd,MERCHANTNAME:
                  MERCHANT_XYZ
2cf8cbabbd1c11e0894a5de4f9281135,2cf8cbabbd1c11e0894a5de4f9281135,USERNAME:0000
    60FF6557F103
2e6381debd1c11e0b336c929a54bb0fd,2e6381debd1c11e0b336c929a54bb0fd,MERCHANTNAME:
                  MERCHANT_123
2e6381e0bd1c11e0b4e8c929a54bb0fd,2e6381e0bd1c11e0b4e8c929a54bb0fd,MERCHANTNAME:
                  MERCHANT_FGH
2cf681c1bd1c11e0b8815de4f9281135,2cf681c1bd1c11e0b8815de4f9281135,USERNAME:0000
    30C57080FFE8
2b8494f1bd1c11e0acbd6d888c43f7c2,2b8494f1bd1c11e0acbd6d888c43f7c2,MODELNAME:MODEL
    _003_001_00
32b44638bd1c11e0b01c2557fb829fdf,32b44638bd1c11e0b01c2557fb829fdf,TOKENENTITYKEY:
    2b8494f1bd1c11e0acbd6d888c43f7c2:TOKEN:1000:1
2fdc7e40bd1c11e094675528b00e8d0e,2fdc7e40bd1c11e094675528b00e8d0e,AFFINITYGROUP
    NAME:49:95:0:4:1
2b8494f0bd1c11e09c856d888c43f7c2,2b8494f0bd1c11e09c856d888c43f7c2,MODELNAME:MODEL
    _002_001_00
32b44639bd1c11e0b15b2557fb829fdf,32b44639bd1c11e0b15b2557fb829fdf,TOKENENTITYKEY:
    2b8494f1bd1c11e0acbd6d888c43f7c2:TOKEN:0:2
32ce84febd1c11e0b0112557fb829fdf,32ce84febd1c11e0b0112557fb829fdf,TOKENENTITYKEY:
    2b8494f1bd1c11e0acbd6d888c43f7c2:TOKEN:1000:4
2e6381e3bd1c11e095b1c929a54bb0fd,2e6381e3bd1c11e095b1c929a54bb0fd,MERCHANTNAME:
                  MERCHANT_789
34582a87bd1c11e080820167449bc60f,34582a87bd1c11e080820167449bc60f,TOKENENTITYKEY:
    2b8494f1bd1c11e0acbd6d888c43f7c2:TOKEN:778:5
2e6381e5bd1c11e0b62cc929a54bb0fd,2e6381e5bd1c11e0b62cc929a54bb0fd,MERCHANTNAME:
                  MERCHANT_456
2fdc7e3ebd1c11e088b55528b00e8d0e,2fdc7e3ebd1c11e088b55528b00e8d0e,AFFINITYGROUP
    NAME:49:95:0:2:1
32c4e80dbd1c11e09e442557fb829fdf,32c4e80dbd1c11e09e442557fb829fdf,TOKENENTITYKEY:
    2b8494f1bd1c11e0acbd6d888c43f7c2:TOKEN:774:5
2e6381e1bd1c11e0bf28c929a54bb0fd,2e6381e1bd1c11e0bf28c929a54bb0fd,MERCHANTNAME:
                  MERCHANT_WER
2cf681b8bd1c11e08be85de4f9281135,2cf681b8bd1c11e08be85de4f9281135,USERNAME:0000
    2552FC930FF8
2cf8cba8bd1c11e09fbc5de4f9281135,2cf8cba8bd1c11e09fbc5de4f9281135,USERNAME:0000
    570FF1B46A24
32b4463abd1c11e0bdaa2557fb829fdf,32b4463abd1c11e0bdaa2557fb829fdf,TOKENENTITYKEY:
    2b8494f1bd1c11e0acbd6d888c43f7c2:TOKEN:0:3
2cf8cbaebd1c11e0b6515de4f9281135,2cf8cbaebd1c11e0b6515de4f9281135,USERNAME:0000
    64A20FF962D4
2e6381e6bd1c11e08087c929a54bb0fd,2e6381e6bd1c11e08087c929a54bb0fd,MERCHANTNAME:
                  MERCHANT_496
2e6381e2bd1c11e0941dc929a54bb0fd,2e6381e2bd1c11e0941dc929a54bb0fd,MERCHANTNAME:
                  MERCHANT_SDF
<Edge Data>Source,Target,Type,label, Weight
32ce84febd1c11e0b0112557fb829fdf,2e6381e6bd1c11e08087c929a54bb0fd,MODEL_003_001
    _00,2b8494f1bd1c11e0acbd6d888c43f7c2:TOKEN:1000:4,1000
2fdc7e3ebd1c11e088b55528b00e8d0e,32ce84febd1c11e0b0112557fb829fdf,MODEL_003_001
    _00,2b8494f1bd1c11e0acbd6d888c43f7c2:TOKEN:1000:4,1000
2e6381e2bd1c11e0941dc929a54bb0fd,34582a87bd1c11e080820167449bc60f,MODEL_003_001
    _00,2b8494f1bd1c11e0acbd6d888c43f7c2:TOKEN:778:5,778
2b8494f1bd1c11e0acbd6d888c43f7c2,34582a87bd1c11e080820167449bc60f,MODEL_003_001
    _00,2b8494f1bd1c11e0acbd6d888c43f7c2:TOKEN:778:5,778
2e6381e1bd1c11e0bf28c929a54bb0fd,32b44639bd1c11e0b15b2557fb829fdf,MODEL_003_001
    _00,2b8494f1bd1c11e0acbd6d888c43f7c2:TOKEN:0:2,0
2e6381e0bd1c11e0b4e8c929a54bb0fd,32ce84febd1c11e0b0112557fb829fdf,MODEL_003_001
    _00,2b8494f1bd1c11e0acbd6d888c43f7c2:TOKEN:1000:4,1000
32b44639bd1c11e0b15b2557fb829fdf,2e6381e6bd1c11e08087c929a54bb0fd,MODEL_003_001
    _00,2b8494f1bd1c11e0acbd6d888c43f7c2:TOKEN:0:2,0
2e6381e1bd1c11e0bf28c929a54bb0fd,32ce84febd1c11e0b0112557fb829fdf,MODEL_003_001
    _00,2b8494f1bd1c11e0acbd6d888c43f7c2:TOKEN:1000:4,1000
2e6381debd1c11e0b336c929a54bb0fd,32ce84febd1c11e0b0112557fb829fdf,MODEL_003_001
    _00,2b8494f1bd1c11e0acbd6d888c43f7c2:TOKEN:1000:4,1000
2e6381e3bd1c11e095b1c929a54bb0fd,34582a87bd1c11e080820167449bc60f,MODEL_003_001
    _00,2b8494f1bd1c11e0acbd6d888c43f7c2:TOKEN:778:5,778
2fdc7e40bd1c11e094675528b00e8d0e,32b44639bd1c11e0b15b2557fb829fdf,MODEL_003_001
    _00,2b8494f1bd1c11e0acbd6d888c43f7c2:TOKEN:0:2,0
2b8494f1bd1c11e0acbd6d888c43f7c2,32b4463abd1c11e0bdaa2557fb829fdf,MODEL_003_001
    _00,2b8494f1bd1c11e0acbd6d888c43f7c2:TOKEN:0:3,0
2e6381e3bd1c11e095b1c929a54bb0fd,32b4463abd1c11e0bdaa2557fb829fdf,MODEL_003_001
    _00,2b8494f1bd1c11e0acbd6d888c43f7c2:TOKEN:0:3,0
2e6381e3bd1c11e095b1c929a54bb0fd,32b1d53ebd1c11e094172557fb829fdf,MODEL_002_001
    _00,2b8494f0bd1c11e09c856d888c43f7c2:TOKEN:0:F,0
2e6381e5bd1c11e0b62cc929a54bb0fd,34582a87bd1c11e080820167449bc60f,MODEL_003_001
    _00,2b8494f1bd1c11e0acbd6d888c43f7c2:TOKEN:778:5,778
2cf8cbabbd1c11e0894a5de4f9281135,32b44638bd1c11e0b01c2557fb829fdf,MODEL_003_001
    _00,2b8494f1bd1c11e0acbd6d888c43f7c2:TOKEN:1000:1,1000
2cf681b8bd1c11e08be85de4f9281135,32b1d53ebd1c11e094172557fb829fdf,MODEL_002_001
    _00,2b8494f0bd1c11e09c856d888c43f7c2:TOKEN:0:F,0
32b4463abd1c11e0bdaa2557fb829fdf,2e6381e6bd1c11e08087c929a54bb0fd,MODEL_003_001
    _00,2b8494f1bd1c11e0acbd6d888c43f7c2:TOKEN:0:3,0
2e6381debd1c11e0b336c929a54bb0fd,32b44639bd1c11e0b15b2557fb829fdf,MODEL_003_001
    _00,2b8494f1bd1c11e0acbd6d888c43f7c2:TOKEN:0:2,0
2e6381e1bd1c11e0bf28c929a54bb0fd,32b44638bd1c11e0b01c2557fb829fdf,MODEL_003_001
    _00,2b8494f1bd1c11e0acbd6d888c43f7c2:TOKEN:1000:1,1000
2e6381e5bd1c11e0b62cc929a54bb0fd,32ce84febd1c11e0b0112557fb829fdf,MODEL_003_001
    _00,2b8494f1bd1c11e0acbd6d888c43f7c2:TOKEN:1000:4,1000
2e6381e1bd1c11e0bf28c929a54bb0fd,32b4463abd1c11e0bdaa2557fb829fdf,MODEL_003_001
    _00,2b8494f1bd1c11e0acbd6d888c43f7c2:TOKEN:0:3,0
2e6381e2bd1c11e0941dc929a54bb0fd,32b44639bd1c11e0b15b2557fb829fdf,MODEL_003_001
    _00,2b8494f1bd1c11e0acbd6d888c43f7c2:TOKEN:0:2,0
2b8494f1bd1c11e0acbd6d888c43f7c2,32c4e80dbd1c11e09e442557fb829fdf,MODEL_003_001
    _00,2b8494f1bd1c11e0acbd6d888c43f7c2:TOKEN:774:5,774
2e6381e2bd1c11e0941dc929a54bb0fd,32b1d53ebd1c11e094172557fb829fdf,MODEL_002_001
    _00,2b8494f0bd1c11e09c856d888c43f7c2:TOKEN:0:F,0
2e6381e4bd1c11e0b9ffc929a54bb0fd,32b4463abd1c11e0bdaa2557fb829fdf,MODEL_003_001
    _00,2b8494f1bd1c11e0acbd6d888c43f7c2:TOKEN:0:3,0
2fdc7e3fbd1c11e0be645528b00e8d0e,32b4463abd1c11e0bdaa2557fb829fdf,MODEL_003_001
    _00,2b8494f1bd1c11e0acbd6d888c43f7c2:TOKEN:0:3,0
2e6381e1bd1c11e0bf28c929a54bb0fd,32b1d53ebd1c11e094172557fb829fdf,MODEL_002_001
    _00,2b8494f0bd1c11e09c856d888c43f7c2:TOKEN:0:F,0
2fdc7e40bd1c11e094675528b00e8d0e,32ce84febd1c11e0b0112557fb829fdf,MODEL_003_001
    _00,2b8494f1bd1c11e0acbd6d888c43f7c2:TOKEN:1000:4,1000
2cf8cba8bd1c11e09fbc5de4f9281135,32c4e80dbd1c11e09e442557fb829fdf,MODEL_003_001
    _00,2b8494f1bd1c11e0acbd6d888c43f7c2:TOKEN:774:5,774
2e6381e2bd1c11e0941dc929a54bb0fd,32b44638bd1c11e0b01c2557fb829fdf,MODEL_003_001
    _00,2b8494f1bd1c11e0acbd6d888c43f7c2:TOKEN:1000:1,1000
2e6381e4bd1c11e0b9ffc929a54bb0fd,32b1d53ebd1c11e094172557fb829fdf,MODEL_002_001
    _00,2b8494f0bd1c11e09c856d888c43f7c2:TOKEN:0:F,0
2e6381e5bd1c11e0b62cc929a54bb0fd,32b44639bd1c11e0b15b2557fb829fdf,MODEL_003_001
    _00,2b8494f1bd1c11e0acbd6d888c43f7c2:TOKEN:0:2,0
32b1d53ebd1c11e094172557fb829fdf,2e6381e6bd1c11e08087c929a54bb0fd,MODEL_002_001
    _00,2b8494f0bd1c11e09c856d888c43f7c2:TOKEN:0:F,0
2b8494f1bd1c11e0acbd6d888c43f7c2,32b44639bd1c11e0b15b2557fb829fdf,MODEL_003_001
    _00,2b8494f1bd1c11e0acbd6d888c43f7c2:TOKEN:0:2,0
2e6381e3bd1c11e095b1c929a54bb0fd,32b44638bd1c11e0b01c2557fb829fdf,MODEL_003_001
    _00,2b8494f1bd1c11e0acbd6d888c43f7c2:TOKEN:1000:1,1000
2fdc7e3dbd1c11e0a22d5528b00e8d0e,32ce84febd1c11e0b0112557fb829fdf,MODEL_003_001
    _00,2b8494f1bd1c11e0acbd6d888c43f7c2:TOKEN:1000:4,1000
2cf681c1bd1c11e0b8815de4f9281135,32b44638bd1c11e0b01c2557fb829fdf,MODEL_003_001
    _00,2b8494f1bd1c11e0acbd6d888c43f7c2:TOKEN:1000:1,1000
2cf681c1bd1c11e0b8815de4f9281135,32b1d53ebd1c11e094172557fb829fdf,MODEL_002_001
    _00,2b8494f0bd1c11e09c856d888c43f7c2:TOKEN:0:F,0
2e6381e3bd1c11e095b1c929a54bb0fd,32b44639bd1c11e0b15b2557fb829fdf,MODEL_003_001
    _00,2b8494f1bd1c11e0acbd6d888c43f7c2:TOKEN:0:2,0
2fdc7e3fbd1c11e0be645528b00e8d0e,32b1d53ebd1c11e094172557fb829fdf,MODEL_002_001
    _00,2b8494f0bd1c11e09c856d888c43f7c2:TOKEN:0:F,0
32b44638bd1c11e0b01c2557fb829fdf,2e6381e6bd1c11e08087c929a54bb0fd,MODEL_003_001
    _00,2b8494f1bd1c11e0acbd6d888c43f7c2:TOKEN:1000:1,1000
2cf8cbaebd1c11e0b6515de4f9281135,32ce84febd1c11e0b0112557fb829fdf,MODEL_003_001
    _00,2b8494f1bd1c11e0acbd6d888c43f7c2:TOKEN:1000:4,1000
2e6381e6bd1c11e08087c929a54bb0fd,32b1d53ebd1c11e094172557fb829fdf,MODEL_002_001
    _00,2b8494f0bd1c11e09c856d888c43f7c2:TOKEN:0:F,0
2e6381e7bd1c11e091b7c929a54bb0fd,34582a87bd1c11e080820167449bc60f,MODEL_003_001
    _00,2b8494f1bd1c11e0acbd6d888c43f7c2:TOKEN:778:5,778
2e6381e1bd1c11e0bf28c929a54bb0fd,34582a87bd1c11e080820167449bc60f,MODEL_003_001
    _00,2b8494f1bd1c11e0acbd6d888c43f7c2:TOKEN:778:5,778
2e6381e5bd1c11e0b62cc929a54bb0fd,32b1d53ebd1c11e094172557fb829fdf,MODEL_002_001
    _00,2b8494f0bd1c11e09c856d888c43f7c2:TOKEN:0:F,0
2b8494f0bd1c11e09c856d888c43f7c2,32b1d53ebd1c11e094172557fb829fdf,MODEL_002_001
    _00,2b8494f0bd1c11e09c856d888c43f7c2:TOKEN:0:F,0
2b8494f1bd1c11e0acbd6d888c43f7c2,32b44638bd1c11e0b01c2557fb829fdf,MODEL_003_001
    _00,2b8494f1bd1c11e0acbd6d888c43f7c2:TOKEN:1000:1,1000
2e6381e6bd1c11e08087c929a54bb0fd,32b4463abd1c11e0bdaa2557fb829fdf,MODEL_003_001
    _00,2b8494f1bd1c11e0acbd6d888c43f7c2:TOKEN:0:3,0
2b8494f1bd1c11e0acbd6d888c43f7c2,32ce84febd1c11e0b0112557fb829fdf,MODEL_003_001
    _00,2b8494f1bd1c11e0acbd6d888c43f7c2:TOKEN:1000:4,1000
2cf681c1bd1c11e0b8815de4f9281135,32b44639bd1c11e0b15b2557fb829fdf,MODEL_003_001
    _00,2b8494f1bd1c11e0acbd6d888c43f7c2:TOKEN:0:2,0
2cf681c1bd1c11e0b8815de4f9281135,32b4463abd1c11e0bdaa2557fb829fdf,MODEL_003_001
    _00,2b8494f1bd1c11e0acbd6d888c43f7c2:TOKEN:0:3,0
2e6381e2bd1c11e0941dc929a54bb0fd,32b4463abd1c11e0bdaa2557fb829fdf,MODEL_003_001
    _00,2b8494f1bd1c11e0acbd6d888c43f7c2:TOKEN:0:3,0
2e6381e3bd1c11e095b1c929a54bb0fd,32ce84febd1c11e0b0112557fb829fdf,MODEL_003_001
    _00,2b8494f1bd1c11e0acbd6d888c43f7c2:TOKEN:1000:4,1000
2e6381e6bd1c11e08087c929a54bb0fd,32ce84febd1c11e0b0112557fb829fdf,MODEL_003_001
    _00,2b8494f1bd1c11e0acbd6d888c43f7c2:TOKEN:1000:4,1000
2e6381e6bd1c11e08087c929a54bb0fd,34582a87bd1c11e080820167449bc60f,MODEL_003_001
    _00,2b8494f1bd1c11e0acbd6d888c43f7c2:TOKEN:778:5,778
2e6381e6bd1c11e08087c929a54bb0fd,32b44638bd1c11e0b01c2557fb829fdf,MODEL_003_001
    _00,2b8494f1bd1c11e0acbd6d888c43f7c2:TOKEN:1000:1,1000
2fdc7e3ebd1c11e088b55528b00e8d0e,32b44639bd1c11e0b15b2557fb829fdf,MODEL_003_001
    _00,2b8494f1bd1c11e0acbd6d888c43f7c2:TOKEN:0:2,0
2e6381e5bd1c11e0b62cc929a54bb0fd,32b4463abd1c11e0bdaa2557fb829fdf,MODEL_003_001
    _00,2b8494f1bd1c11e0acbd6d888c43f7c2:TOKEN:0:3,0
2e6381e4bd1c11e0b9ffc929a54bb0fd,34582a87bd1c11e080820167449bc60f,MODEL_003_001
    _00,2b8494f1bd1c11e0acbd6d888c43f7c2:TOKEN:778:5,778
2e6381e4bd1c11e0b9ffc929a54bb0fd,32b44638bd1c11e0b01c2557fb829fdf,MODEL_003_001
    _00,2b8494f1bd1c11e0acbd6d888c43f7c2:TOKEN:1000:1,1000
34582a87bd1c11e080820167449bc60f,2e6381e6bd1c11e08087c929a54bb0fd,MODEL_003_001
    _00,2b8494f1bd1c11e0acbd6d888c43f7c2:TOKEN:778:5,778
2e6381e6bd1c11e08087c929a54bb0fd,32b44639bd1c11e0b15b2557fb829fdf,MODEL_003_001
    _00,2b8494f1bd1c11e0acbd6d888c43f7c2:TOKEN:0:2,0
2e6381e5bd1c11e0b62cc929a54bb0fd,32b44638bd1c11e0b01c2557fb829fdf,MODEL_003_001
    _00,2b8494f1bd1c11e0acbd6d888c43f7c2:TOKEN:1000:1,1000
2fdc7e3fbd1c11e0be645528b00e8d0e,32b44638bd1c11e0b01c2557fb829fdf,MODEL_003_001
    _00,2b8494f1bd1c11e0acbd6d888c43f7c2:TOKEN:1000:1,1000
2cf681b8bd1c11e08be85de4f9281135,32b44639bd1c11e0b15b2557fb829fdf,MODEL_003_001
    _00,2b8494f1bd1c11e0acbd6d888c43f7c2:TOKEN:0:2,0
2e6381e4bd1c11e0b9ffc929a54bb0fd,32b44639bd1c11e0b15b2557fb829fdf,MODEL_003_001
    _00,2b8494f1bd1c11e0acbd6d888c43f7c2:TOKEN:0:2,0
2cf681b8bd1c11e08be85de4f9281135,32b4463abd1c11e0bdaa2557fb829fdf,MODEL_003_001
    _00,2b8494f1bd1c11e0acbd6d888c43f7c2:TOKEN:0:3,0
2e6381e4bd1c11e0b9ffc929a54bb0fd,32ce84febd1c11e0b0112557fb829fdf,MODEL_003_001
    _00,2b8494f1bd1c11e0acbd6d888c43f7c2:TOKEN:1000:4,1000
2e6381e2bd1c11e0941dc929a54bb0fd,32ce84febd1c11e0b0112557fb829fdf,MODEL_003_001
    _00,2b8494f1bd1c11e0acbd6d888c43f7c2:TOKEN:1000:4,1000
2fdc7e3dbd1c11e0a22d5528b00e8d0e,32b44639bd1c11e0b15b2557fb829fdf,MODEL_003_001
    _00,2b8494f1bd1c11e0acbd6d888c43f7c2:TOKEN:0:2,0
2cf681b8bd1c11e08be85de4f9281135,32b44638bd1c11e0b01c2557fb829fdf,MODEL_003_001
    _00,2b8494f1bd1c11e0acbd6d888c43f7c2:TOKEN:1000:1,1000
```

In alternate examples, the EOOR may store data in a JavaScript Object Notation (“JSON”) format. The stored information may include data regarding the object, such as, but not limited to: commands, attributes, group information, payment information, account information, etc., such as in the example below:

```
{‘MERCHANT’: {‘TYPEOFTYPES’: [‘MERCHANTS’, ‘SYNTHETICNETWORKS’], ‘FUNCTIONS’:
    {‘ENTITYCREATION’: ‘putNetwork’}
, ‘UNIQUEATTIBUTES’: [‘MERCHANTNAME’], ‘TOKENENTITIESRELATIONSHIPS’: [ ],
    ‘ATTRIBUTES’: {‘MERCHANT’: (2, ‘STRING’, 0, ‘VALUE’), ‘MERCH_ZIP_CD’: (7,
    ‘STRING’, 0, ‘VALUE’), ‘MERCH_NAME’: (8, ‘STRING’, 0, ‘VALUE’),
    ‘MERCHANTNAME’: (3, ‘STRING’, 0, ‘VALUE’), ‘ACQ_CTRY_NUM’: (4, ‘STRING’, 0,
    ‘VALUE’), ‘ACQ_PCR’: (6, ‘STRING’, 0, ‘VALUE’), ‘ACQ_REGION_NUM’: (5,
    ‘STRING’, 0, ‘VALUE’), ‘ISACTIVE’: (0, ‘BOOL’, 1, ‘VALUE’), ‘ENTITYKEY’: (1,
    ‘STRING’, 0, ‘VALUE’)}
}
, ‘AFFINITYGROUP’: {‘TYPEOFTYPES’: [‘AFFINITYGROUPS’], ‘FUNCTIONS’:
    {‘ENTITYCREATION’: ‘putNetwork’}
, ‘UNIQUEATTIBUTES’: [‘AFFINITYGROUPNAME’], ‘TOKENENTITIESRELATIONSHIPS’: [ ],
    ‘ATTRIBUTES’: {‘XML’: (2, ‘STRING’, 0, ‘VALUE’), ‘DESCRIPTION’: (4, ‘STRING’,
    0, ‘VALUE’), ‘ENTITYKEY’: (1, ‘STRING’, 0, ‘VALUE’), ‘TYPEOF’: (5, ‘STRING’,
    0, ‘VALUE’), ‘AFFINITYGROUPNAME’: (3, ‘STRING’, 0, ‘VALUE’), ‘ISACTIVE’: (0,
    ‘BOOL’, 1, ‘VALUE’)}
}
, ‘CASCADINGPAYMENT’: {‘TYPEOFTYPES’: [‘CASCADINGPAYMENT’], ‘FUNCTIONS’:
    {‘ENTITYCREATION’: ‘putNetwork’}
, ‘UNIQUEATTIBUTES’: [‘CASCADINGPAYMENTNAME’], ‘TOKENENTITIESRELATIONSHIPS’:
    [‘GROUP’], ‘ATTRIBUTES’: {‘STATUS’: (2, ‘STRING’, 0, ‘VALUE’), ‘EXPDT’: (6,
    ‘DATETIME’, 0, ‘VALUE’), ‘GROUP’: (3, ‘STRING’, 0, ‘VALUE’), ‘RESTRICTIONS’:
    (7, ‘DICT’, 0, ‘VALUE’), ‘CASCADINGPAYMENTNAME’: (4, ‘STRING’, 0, ‘VALUE’),
    ‘STARTDT’: (5, ‘DATETIME’, 0, ‘VALUE’), ‘ISACTIVE’: (0, ‘BOOL’, 1, ‘VALUE’),
    ‘ENTITYKEY’: (1, ‘STRING’, 0, ‘VALUE’)}
}
, ‘GROUP’: {‘TYPEOFTYPES’: [ ], ‘FUNCTIONS’: {‘ENTITYCREATION’: ‘putNetwork’}
, ‘UNIQUEATTIBUTES’: [‘GROUPNAME’], ‘TOKENENTITIESRELATIONSHIPS’: { }
, ‘ATTRIBUTES’: {‘GROUPNAME’: (2, ‘STRING’, 0, ‘VALUE’), ‘DESCRIPTION’: (2,
    ‘STRING’, 0, ‘VALUE’), ‘ISACTIVE’: (0, ‘BOOL’, 1, ‘VALUE’), ‘ENTITYKEY’: (1,
    ‘STRING’, 0, ‘VALUE’)}
}
, ‘USERS’: {‘TYPEOFTYPES’: [ ], ‘FUNCTIONS’: {‘ENTITYCREATION’: ‘putNetwork’}
, ‘UNIQUEATTIBUTES’: [‘USERSID’], ‘TOKENENTITIESRELATIONSHIPS’: { }
, ‘ATTRIBUTES’: {‘USERSID’: (2, ‘STRING’, 0, ‘VALUE’), ‘ISACTIVE’: (0, ‘BOOL’,
    1, ‘VALUE’), ‘ENTITYKEY’: (1, ‘STRING’, 0, ‘VALUE’)}
}
, ‘TWITTERUSER’: {‘TYPEOFTYPES’: [‘TOKENENTITY’], ‘FUNCTIONS’:
    {‘ENTITYCREATION’: ‘putWGTNetwork’}
, ‘UNIQUEATTIBUTES’: [‘USERNAME’], ‘TOKENENTITIESRELATIONSHIPS’: [‘USER’],
    ‘ATTRIBUTES’: {‘USERNAME’: (2, ‘STRING’, 0, ‘VALUE’), ‘CITY’: (5, ‘STRING’,
    0, ‘VALUE’), ‘ENTITYKEY’: (1, ‘STRING’, 0, ‘VALUE’), ‘USERLINK’: (6,
    ‘STRING’, 0, ‘VALUE’), ‘FULLNAME’: (4, ‘STRING’, 0, ‘VALUE’), ‘USERTAG’: (3,
    ‘STRING’, 0, ‘VALUE’), ‘ISACTIVE’: (0, ‘BOOL’, 1, ‘VALUE’)}
}
, ‘COUPON’: {‘TYPEOFTYPES’: [‘COUPON’], ‘FUNCTIONS’: {‘ENTITYCREATION’:
    ‘putNetwork’}
, ‘UNIQUEATTIBUTES’: [‘COUPONNAME’], ‘TOKENENTITIESRELATIONSHIPS’: [‘MERCHANT’],
    ‘ATTRIBUTES’: {‘STATUS’: (2, ‘STRING’, 0, ‘VALUE’), ‘MERCHANT’: (3, ‘STRING’,
    0, ‘VALUE’), ‘TITLE’: (5, ‘STRING’, 0, ‘VALUE’), ‘NOTES’: (7, ‘STRING’, 0,
    ‘VALUE’), ‘UPDATEDBY’: (11, ‘STRING’, 0, ‘VALUE’), ‘ENTITYKEY’: (1, ‘STRING’,
    0, ‘VALUE’), ‘DECRIPTION’: (6, ‘STRING’, 0, ‘VALUE’), ‘CREATEDBY’: (10,
    ‘STRING’, 0, ‘VALUE’), ‘LASTUPDATEDT’: (9, ‘DATETIME’, 0, ‘VALUE’), ‘EXPDT’:
    (13, ‘DATETIME’, 0, ‘VALUE’), ‘RESTRICTIONS’: (14, ‘DICT’, 0, ‘VALUE’),
    ‘COUPONNAME’: (4, ‘STRING’, 0, ‘VALUE’), ‘CREATIONDT’: (8, ‘DATETIME’, 0,
    ‘VALUE’), ‘STARTDT’: (12, ‘DATETIME’, 0, ‘VALUE’), ‘ISACTIVE’: (0, ‘BOOL’, 1,
    ‘VALUE’)}
}
, ‘MEMBERSHIP’: {‘TYPEOFTYPES’: [‘MEMBERSHIPS’], ‘FUNCTIONS’: {‘ENTITYCREATION’:
    ‘putNetwork’}
, ‘UNIQUEATTIBUTES’: [‘MEMBERSHIPNAME’], ‘TOKENENTITIESRELATIONSHIPS’:
    [‘MERCHANT’], ‘ATTRIBUTES’: {‘STATUS’: (2, ‘STRING’, 0, ‘VALUE’), ‘MERCHANT’:
    (3, ‘STRING’, 0, ‘VALUE’), ‘RESTRICTIONS’: (7, ‘DICT’, 0, ‘VALUE’),
    ‘MEMBERSHIPNAME’: (4, ‘STRING’, 0, ‘VALUE’), ‘STARTDT’: (5, ‘DATETIME’, 0,
    ‘VALUE’), ‘EXPDT’: (6, ‘DATETIME’, 0, ‘VALUE’), ‘ISACTIVE’: (0, ‘BOOL’, 1,
    ‘VALUE’), ‘ENTITYKEY’: (1, ‘STRING’, 0, ‘VALUE’)}
}
, ‘USERSECURITY’: {‘TYPEOFTYPES’: [‘SECURITY’], ‘FUNCTIONS’: {‘ENTITYCREATION’:
    ‘putNetwork’}
, ‘UNIQUEATTIBUTES’: [‘USERSECURITYNAME’], ‘TOKENENTITIESRELATIONSHIPS’:
    [‘USER’], ‘ATTRIBUTES’: {‘STATUS’: (2, ‘STRING’, 0, ‘VALUE’), ‘EXPDT’: (6,
    ‘DATETIME’, 0, ‘VALUE’), ‘USERSECURITYNAME’: (4, ‘STRING’, 0, ‘VALUE’),
    ‘USER’: (3, ‘STRING’, 0, ‘VALUE’), ‘RESTRICTIONS’: (7, ‘DICT’, 0, ‘VALUE’),
    ‘STARTDT’: (5, ‘DATETIME’, 0, ‘VALUE’), ‘ISACTIVE’: (0, ‘BOOL’, 1, ‘VALUE’),
    ‘ENTITYKEY’: (1, ‘STRING’, 0, ‘VALUE’)}
}
, ‘MCC’: {‘TYPEOFTYPES’: [‘MCC’], ‘FUNCTIONS’: {‘ENTITYCREATION’:
    ‘putWGTNetwork’}
, ‘UNIQUEATTIBUTES’: [‘MCCNAME’, ‘MCC’], ‘TOKENENTITIESRELATIONSHIPS’:
    [‘MCCSEG’], ‘ATTRIBUTES’: {‘MCCSEG’: (4, ‘STRING’, 0, ‘VALUE’), ‘MCC’: (2,
    ‘STRING’, 0, ‘VALUE’), ‘MCCNAME’: (3, ‘STRING’, 0, ‘VALUE’), ‘ISACTIVE’: (0,
    ‘BOOL’, 1, ‘VALUE’), ‘ENTITYKEY’: (1, ‘STRING’, 0, ‘VALUE’)}
}
, ‘ZIPCODE’: {‘TYPEOFTYPES’: [‘LOCATION’], ‘FUNCTIONS’: {‘ENTITYCREATION’:
    ‘putNetwork’}
, ‘UNIQUEATTIBUTES’: [‘ZIPCODE’], ‘TOKENENTITIESRELATIONSHIPS’: [ ],
    ‘ATTRIBUTES’: {‘STATE’: (4, ‘STRING’, 0, ‘VALUE’), ‘POPULATION’: (3,
    ‘STRING’, 0, ‘VALUE’), ‘ZIPCODE’: (2, ‘STRING’, 0, ‘VALUE’), ‘ISACTIVE’: (0,
    ‘BOOL’, 1, ‘VALUE’), ‘ENTITYKEY’: (1, ‘STRING’, 0, ‘VALUE’)}
}
, ‘PAYMENTCARD’: {‘TYPEOFTYPES’: [‘PAYMENTCARDS’], ‘FUNCTIONS’:
    {‘ENTITYCREATION’: ‘putNetwork’}
, ‘UNIQUEATTIBUTES’: [‘CARDNUMBER’], ‘TOKENENTITIESRELATIONSHIPS’: [‘USER’],
    ‘ATTRIBUTES’: {‘EXPDATE’: (5, ‘DATETIME’, 0, ‘VALUE’), ‘ENTITYKEY’: (1,
    ‘STRING’, 0, ‘VALUE’), ‘CARDTYPE’: (4, ‘STRING’, 0, ‘VALUE’), ‘CARDNUMBER’:
    (2, ‘STRING’, 0, ‘VALUE’), ‘USER’: (3, ‘STRING’, 0, ‘VALUE’), ‘ISACTIVE’: (0,
    ‘BOOL’, 1, ‘VALUE’)}
}
, ‘GENERICTOKEN’: {‘TYPEOFTYPES’: [‘COUPON’], ‘FUNCTIONS’: {‘ENTITYCREATION’:
    ‘putNetwork’}
, ‘UNIQUEATTIBUTES’: [‘GENERICTOKENNAME’], ‘TOKENENTITIESRELATIONSHIPS’:
    [‘MERCHANT’], ‘ATTRIBUTES’: {‘STATUS’: (2, ‘STRING’, 0, ‘VALUE’), ‘MERCHANT’:
    (3, ‘STRING’, 0, ‘VALUE’), ‘TITLE’: (5, ‘STRING’, 0, ‘VALUE’), ‘NOTES’: (7,
    ‘STRING’, 0, ‘VALUE’), ‘UPDATEDBY’: (11, ‘STRING’, 0, ‘VALUE’), ‘ENTITYKEY’:
    (1, ‘STRING’, 0, ‘VALUE’), ‘DECRIPTION’: (6, ‘STRING’, 0, ‘VALUE’),
    ‘CREATEDBY’: (10, ‘STRING’, 0, ‘VALUE’), ‘LASTUPDATEDT’: (9, ‘DATETIME’, 0,
    ‘VALUE’), ‘EXPDT’: (13, ‘DATETIME’, 0, ‘VALUE’), ‘RESTRICTIONS’: (14, ‘DICT’,
    0, ‘VALUE’), ‘STARTDT’: (12, ‘DATETIME’, 0, ‘VALUE’), ‘CREATIONDT’: (8,
    ‘DATETIME’, 0, ‘VALUE’), ‘GENERICTOKENNAME’: (4, ‘STRING’, 0, ‘VALUE’),
    ‘ISACTIVE’: (0, ‘BOOL’, 1, ‘VALUE’)}
}
, ‘USER’: {‘TYPEOFTYPES’: [‘USERS’, ‘SYNTHETICNETWORKS’], ‘FUNCTIONS’:
    {‘ENTITYCREATION’: ‘putNetwork’}
, ‘UNIQUEATTIBUTES’: [‘USERNAME’], ‘TOKENENTITIESRELATIONSHIPS’: [‘USERS’],
    ‘ATTRIBUTES’: {‘USERNAME’: (5, ‘STRING’, 0, ‘VALUE’), ‘USERS’: (2, ‘STRING’,
    0, ‘VALUE’), ‘FIRSTNAME’: (3, ‘STRING’, 0, ‘VALUE’), ‘LASTNAME’: (4,
    ‘STRING’, 0, ‘VALUE’), ‘ENTITYKEY’: (1, ‘STRING’, 0, ‘VALUE’), ‘ISACTIVE’:
    (0, ‘BOOL’, 1, ‘VALUE’)}
}
, ‘TWEETS’: {‘TYPEOFTYPES’: [‘TOKENENTITY’], ‘FUNCTIONS’: {‘ENTITYCREATION’:
    ‘putWGTNetwork’}
, ‘UNIQUEATTIBUTES’: [‘TWEETID’], ‘TOKENENTITIESRELATIONSHIPS’: [‘TWITTERUSER’],
    ‘ATTRIBUTES’: {‘Title’: (4, ‘STRING’, 0, ‘VALUE’), ‘RawTweet’: (5, ‘STRING’,
    0, ‘VALUE’), ‘DATETIME’: (3, ‘STRING’, 0, ‘VALUE’), ‘CLEANEDTWEET’: (6,
    ‘STRING’, 0, ‘VALUE’), ‘ENTITYKEY’: (1, ‘STRING’, 0, ‘VALUE’), ‘TWEETID’: (2,
    ‘STRING’, 0, ‘VALUE’), ‘ISACTIVE’: (0, ‘BOOL’, 1, ‘VALUE’)}
}
, ‘MODEL’: {‘TYPEOFTYPES’: [‘MODELS’], ‘FUNCTIONS’: {‘ENTITYCREATION’:
    ‘putNetwork’}
, ‘UNIQUEATTIBUTES’: [‘MODELNAME’], ‘TOKENENTITIESRELATIONSHIPS’: [‘USER’,
    ‘MERCHANT’, ‘PAYMENTCARD’], ‘ATTRIBUTES’: {‘XML’: (2, ‘STRING’, 0, ‘VALUE’),
    ‘MODELNAME’: (3, ‘STRING’, 0, ‘VALUE’), ‘DESCRIPTION’: (4, ‘STRING’, 0,
    ‘VALUE’), ‘ENTITYKEY’: (1, ‘STRING’, 0, ‘VALUE’), ‘TYPEOF’: (5, ‘STRING’, 0,
    ‘VALUE’), ‘ISACTIVE’: (0, ‘BOOL’, 1, ‘VALUE’)}
}
, ‘MCCSEG’: {‘TYPEOFTYPES’: [‘MCCSEG’], ‘FUNCTIONS’: {‘ENTITYCREATION’:
    ‘putWGTNetwork’}
, ‘UNIQUEATTIBUTES’: [‘MCCSEGID’], ‘TOKENENTITIESRELATIONSHIPS’: { }
, ‘ATTRIBUTES’: {‘MCCSEGID’: (2, ‘STRING’, 0, ‘VALUE’), ‘MCCSEGNAME’: (3,
    ‘STRING’, 0, ‘VALUE’), ‘ISACTIVE’: (0, ‘BOOL’, 1, ‘VALUE’), ‘ENTITYKEY’: (1,
    ‘STRING’, 0, ‘VALUE’)}
}
, ‘TOKENENTITY’: {‘TYPEOFTYPES’: [‘TOKENENTITY’], ‘FUNCTIONS’:
    {‘ENTITYCREATION’: ‘putWGTNetwork’}
, ‘UNIQUEATTIBUTES’: [‘TOKENENTITYKEY’], ‘TOKENENTITIESRELATIONSHIPS’: { }
, ‘ATTRIBUTES’: {‘STATUS’: (4, ‘STRING’, 0, ‘VALUE’), ‘ISSUEDDATE’: (5,
    ‘STRING’, 0, ‘VALUE’), ‘DOUBLELINKED’: (8, ‘BOOL’, 1, ‘VALUE’), ‘BASEUUID’:
    (1, ‘STRING’, 0, ‘VALUE’), ‘WEIGHT’: (6, ‘STRING’, 0, ‘VALUE’), ‘BASETYPE’:
    (3, ‘STRING’, 0, ‘VALUE’), ‘CATEGORY’: (7, ‘STRING’, 0, ‘VALUE’), ‘ISACTIVE’:
    (0, ‘BOOL’, 1, ‘VALUE’), ‘TOKENENTITYKEY’: (2, ‘STRING’, 0, ‘VALUE’)}
}
}
```

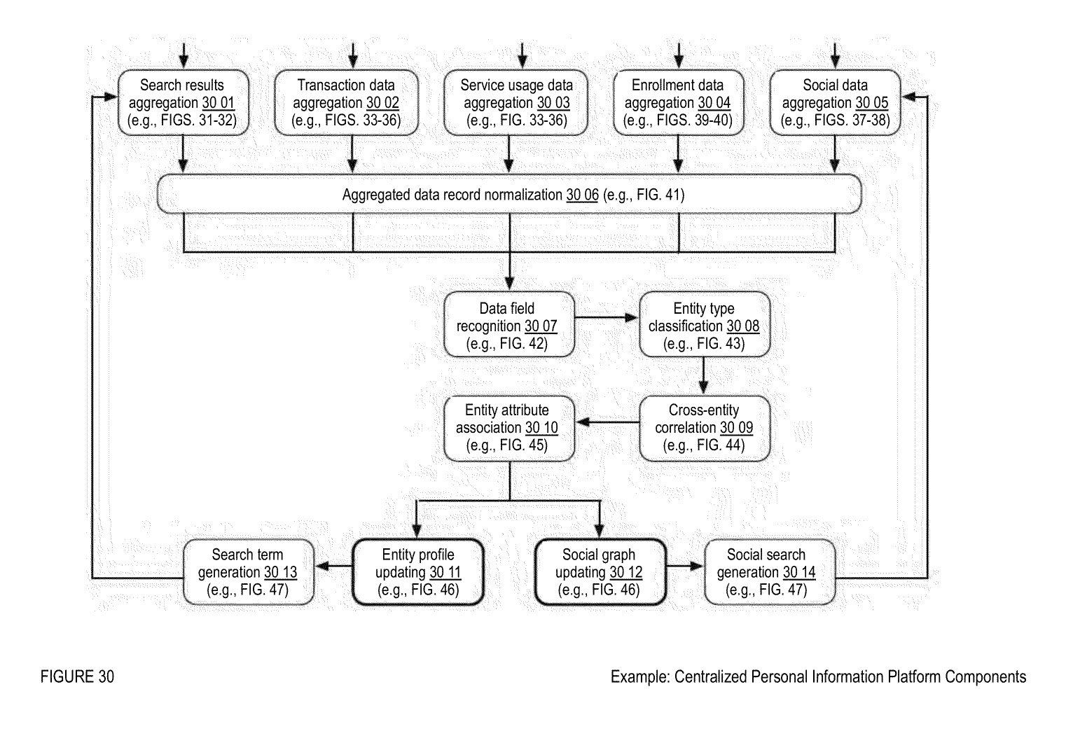

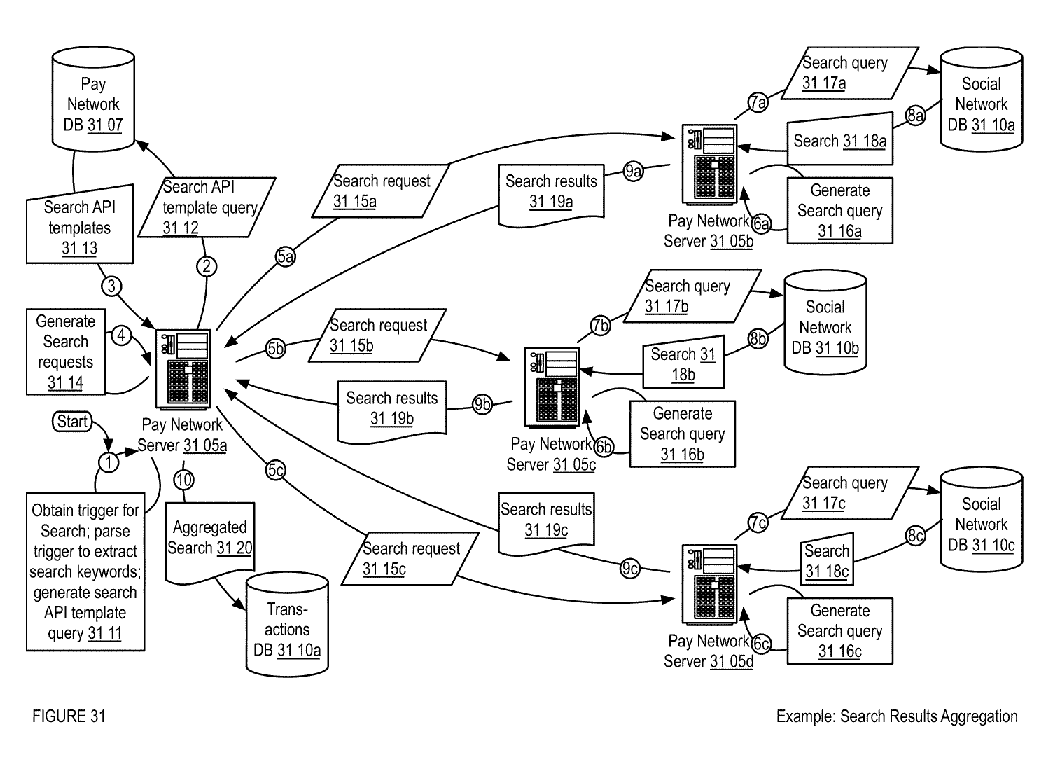

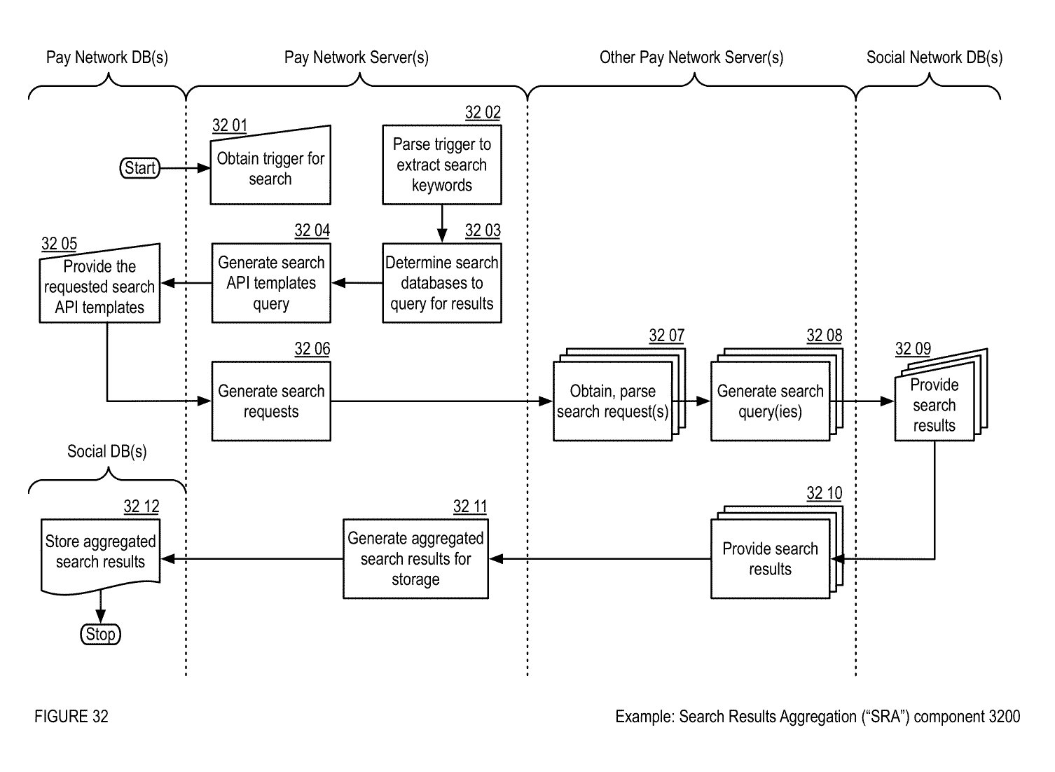

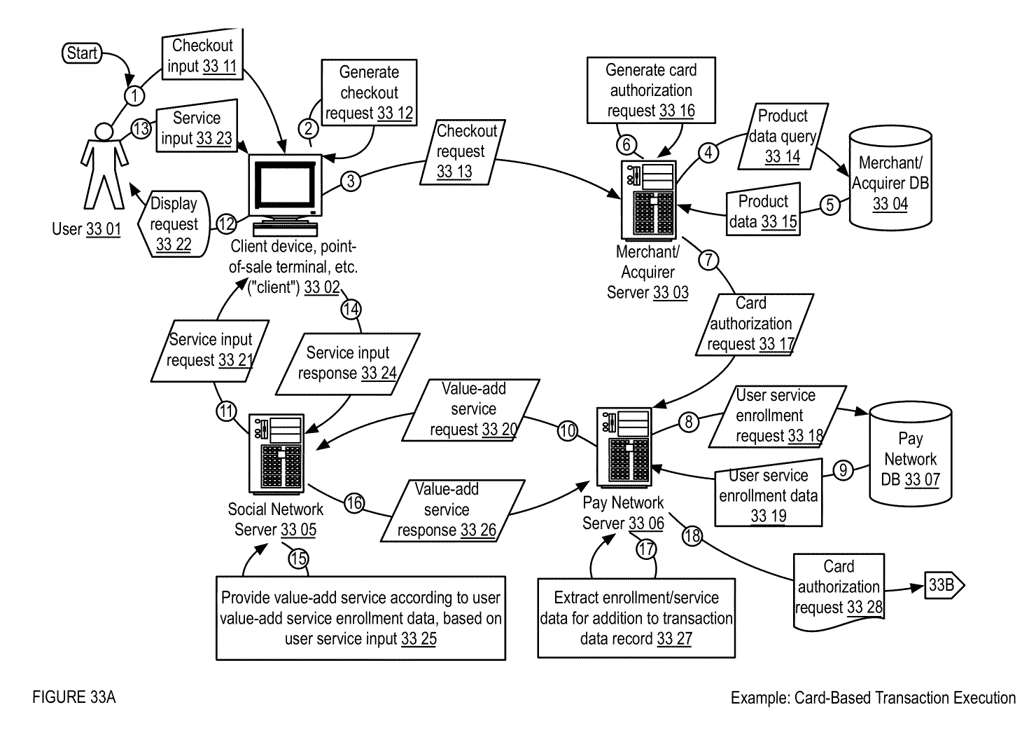

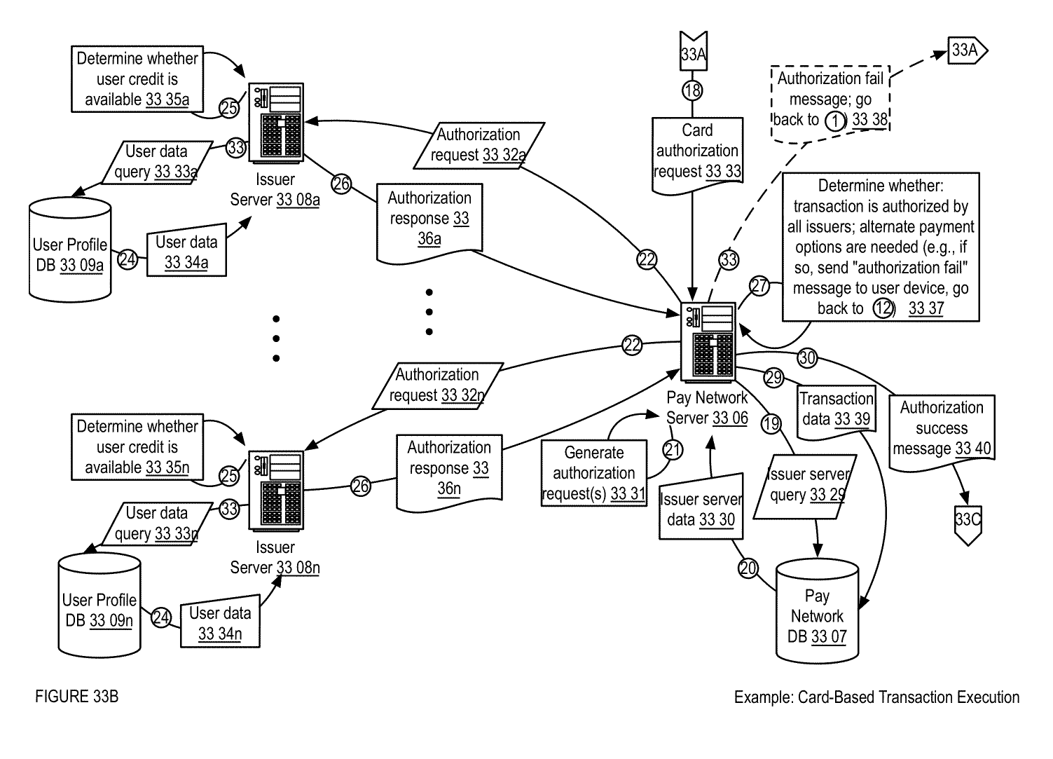

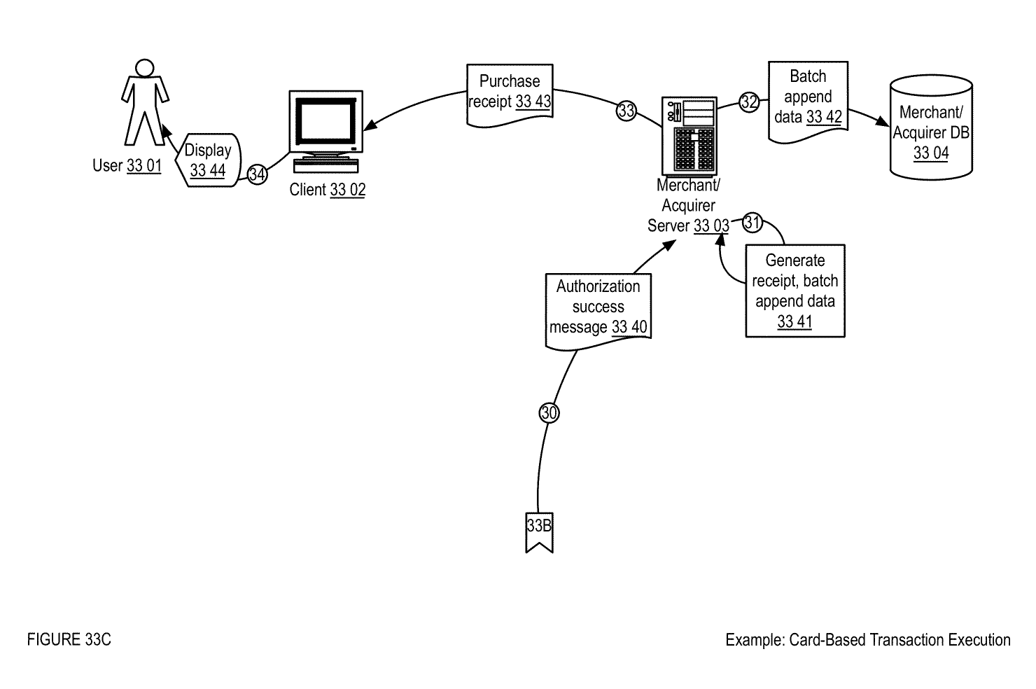

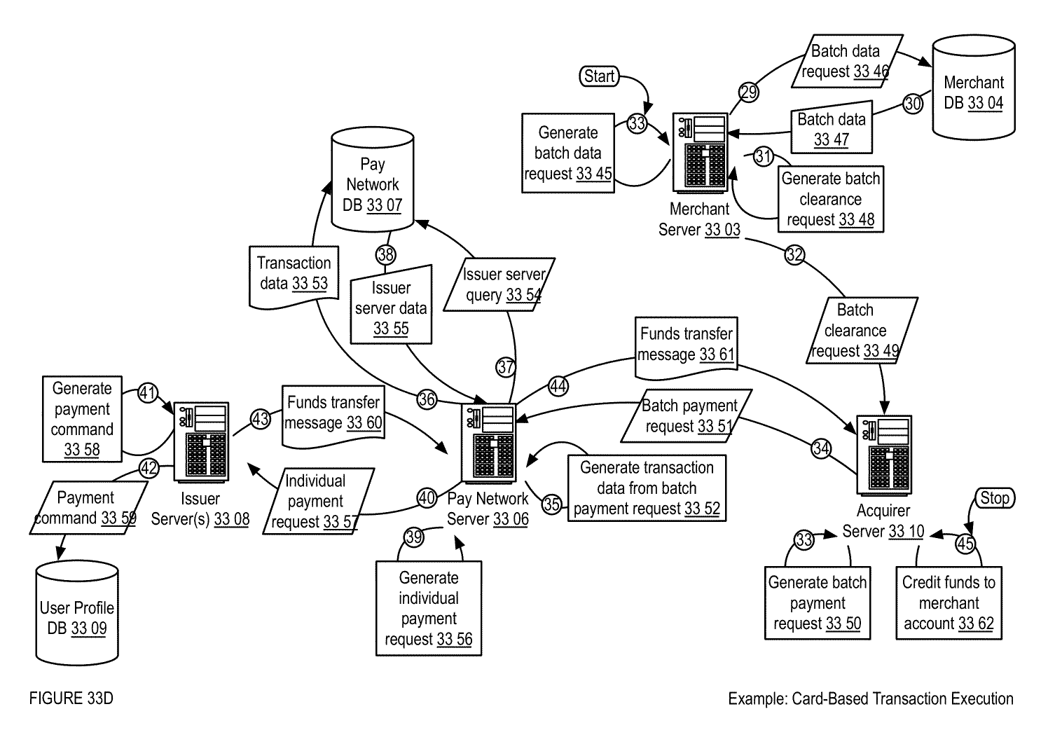

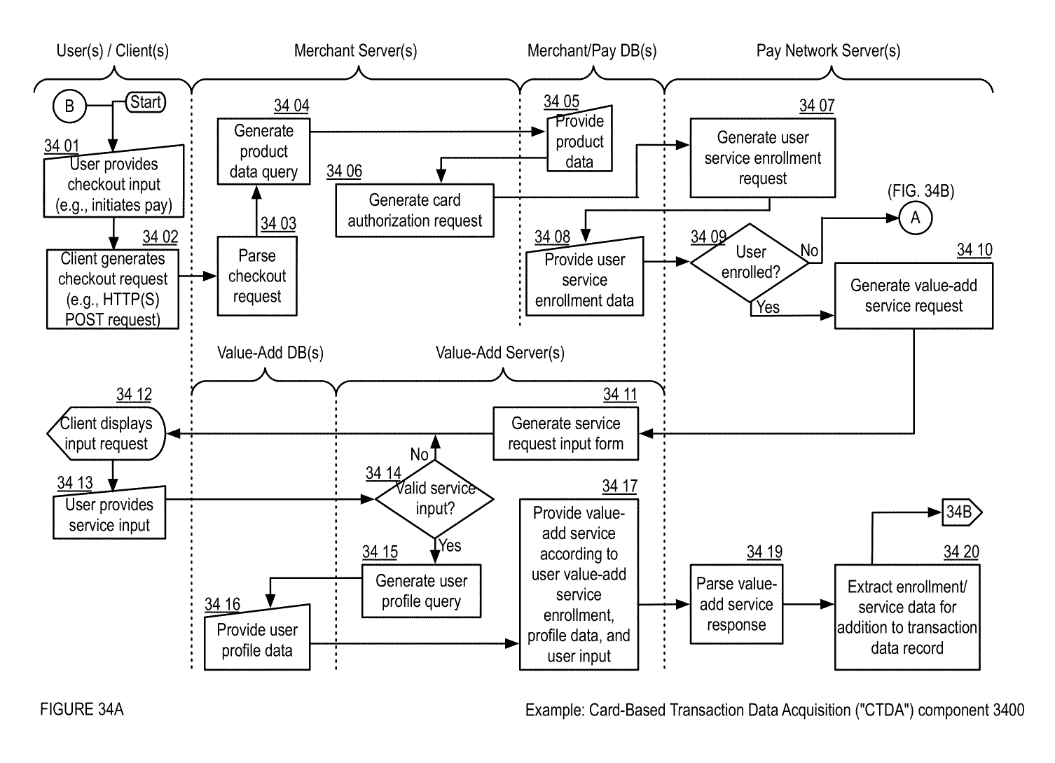

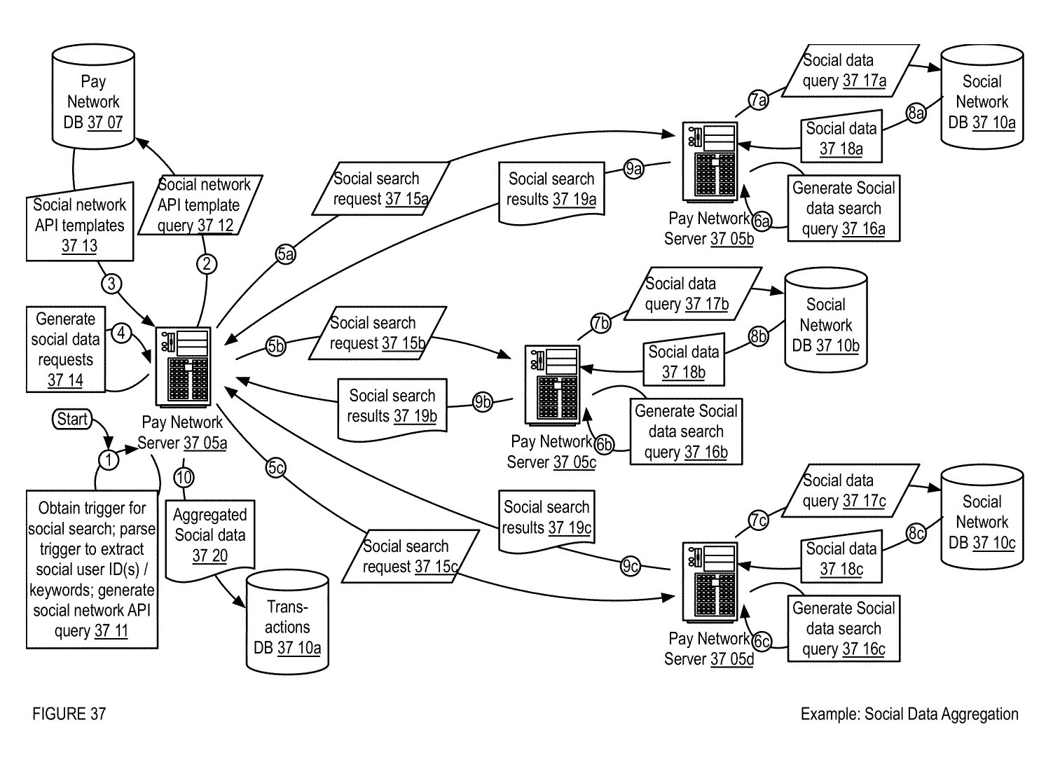

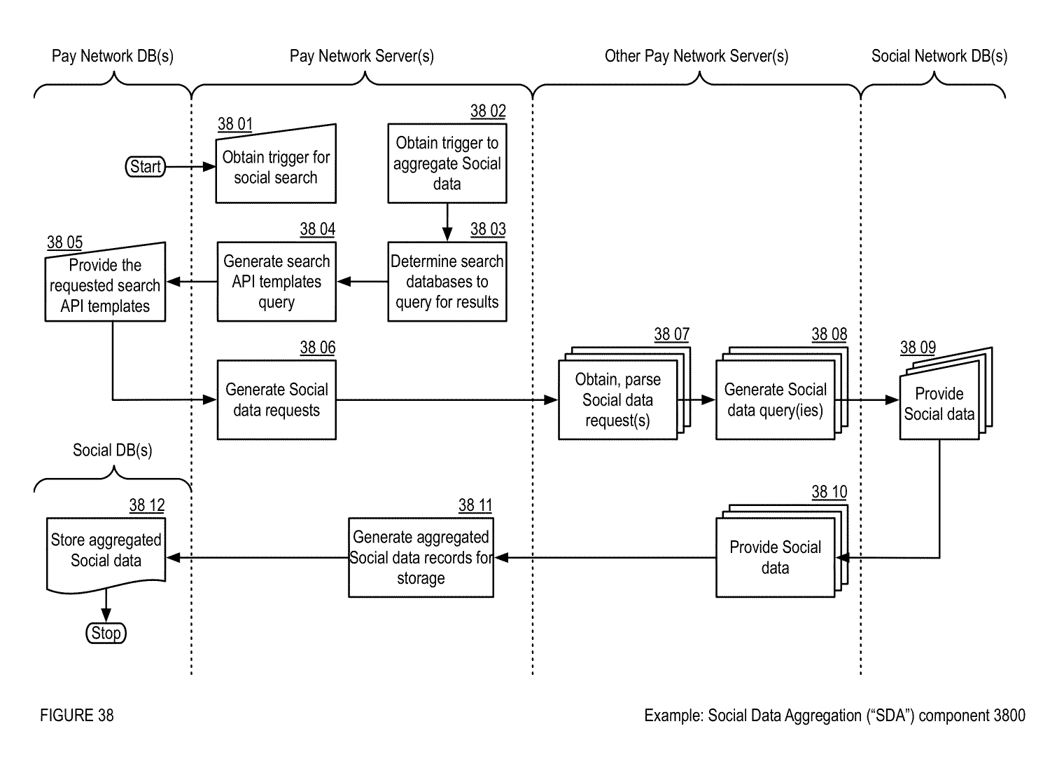

FIG. 30 shows a block diagram illustrating example EOOR component configurations in some embodiments of the EOOR. In some embodiments, the EOOR may aggregate data from a variety of sources to generate centralized personal information. The EOOR may also aggregate various types of data in order to generate the centralized personal information. For example, the EOOR may utilize search results aggregation component(s) 3001 (e.g., such as described in FIGS. 31-32) to aggregate search results from across a wide range of computer networked systems, e.g., the Internet. As another example, the EOOR may utilize transaction data aggregation component(s) 3002 (e.g., such as described in FIGS. 33-36) to aggregate transaction data, e.g., from transaction processing procedure by a payment network. As another example, the EOOR may utilize service usage data aggregation component(s) 3003 (e.g., such as described in FIGS. 33-36) to aggregate data on user's usage of various services associated with the EOOR. As another example, the EOOR may utilize enrollment data component(s) 3004 (e.g., such as described in FIGS. 33-36) to aggregate data on user's enrollment into various services associated with the EOOR. As another example, the EOOR may utilize social data aggregation component(s) 3003 (e.g., such as described in FIGS. 37-38) to aggregate data on user's usage of various social networking services accessible by the EOOR.

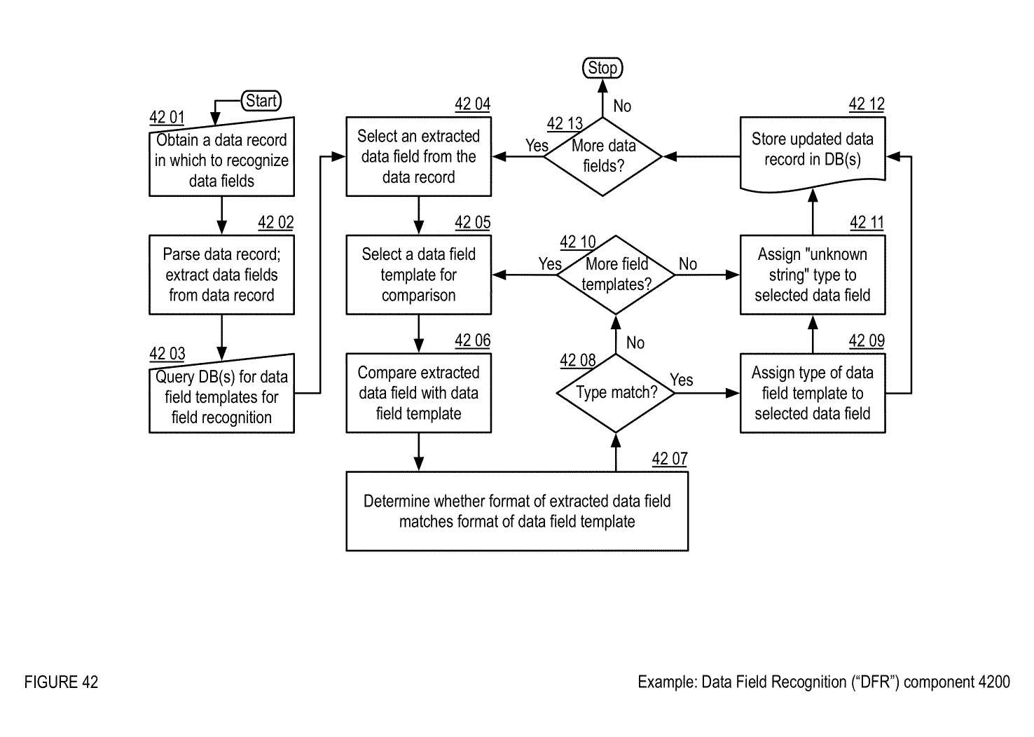

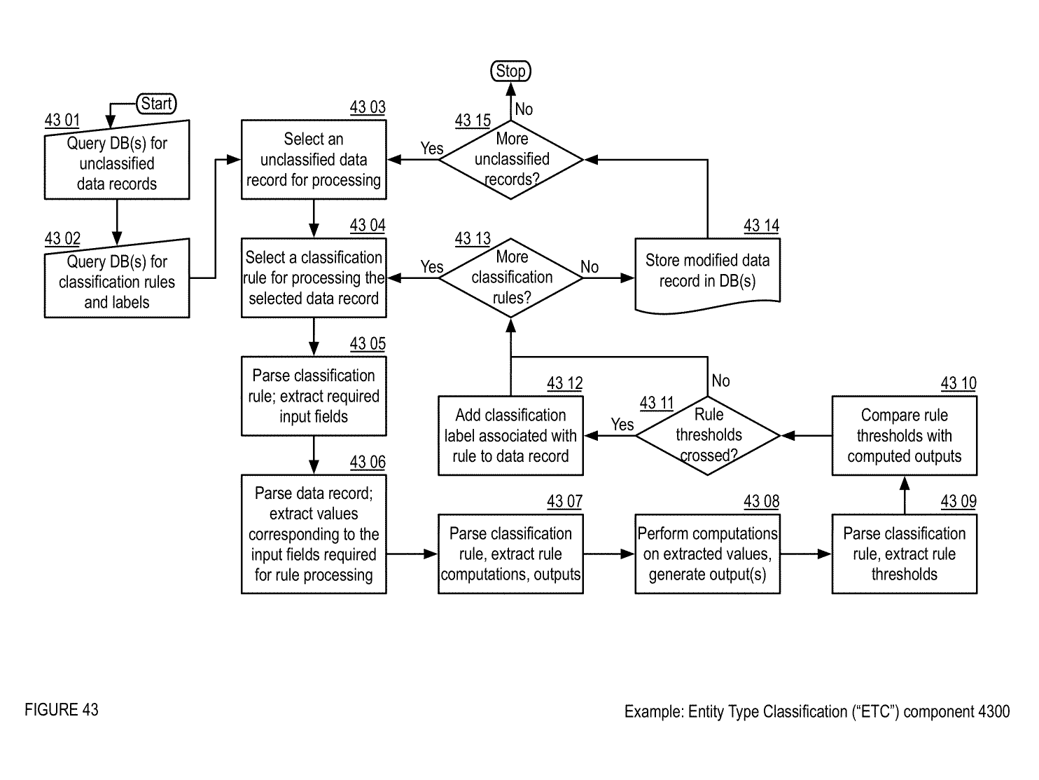

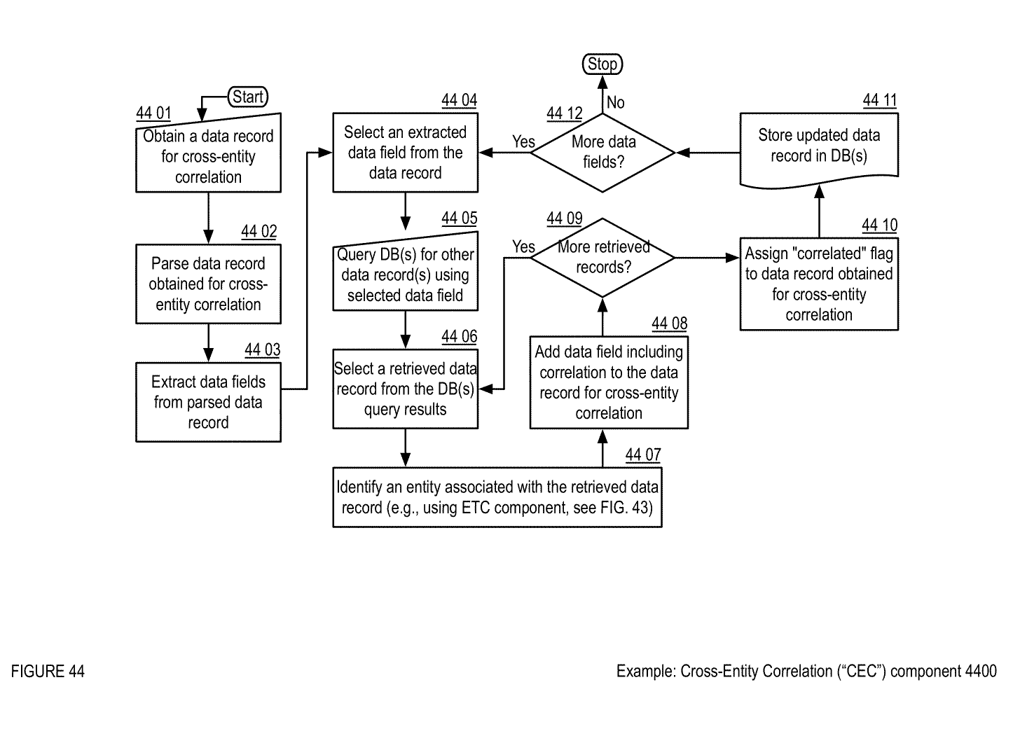

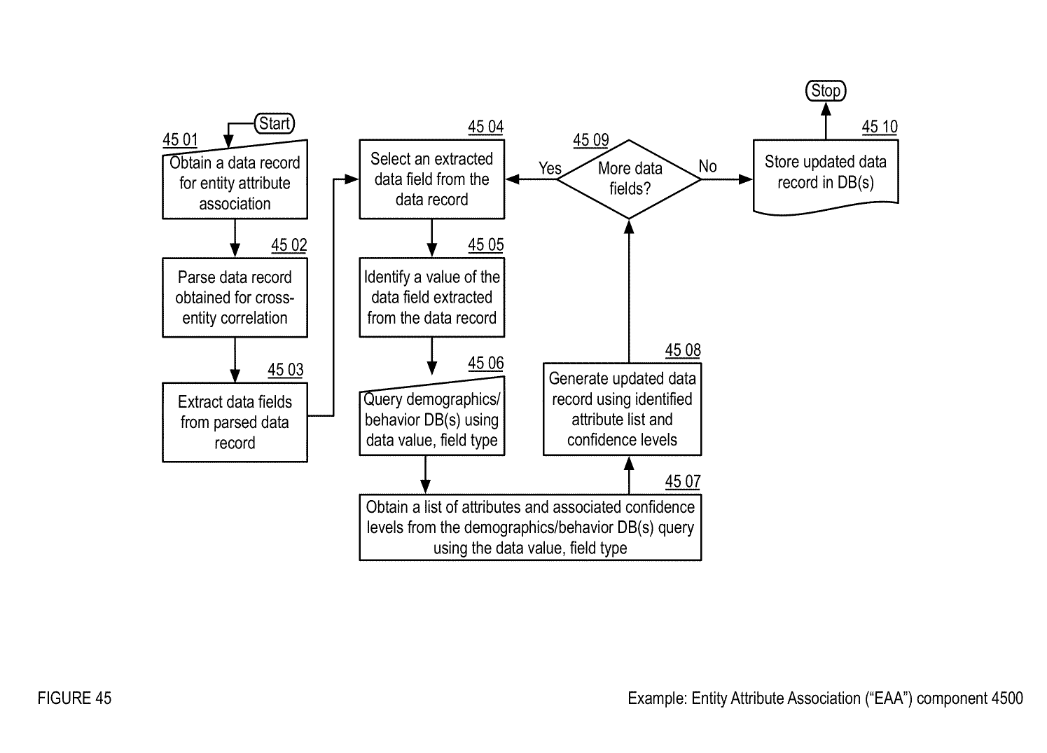

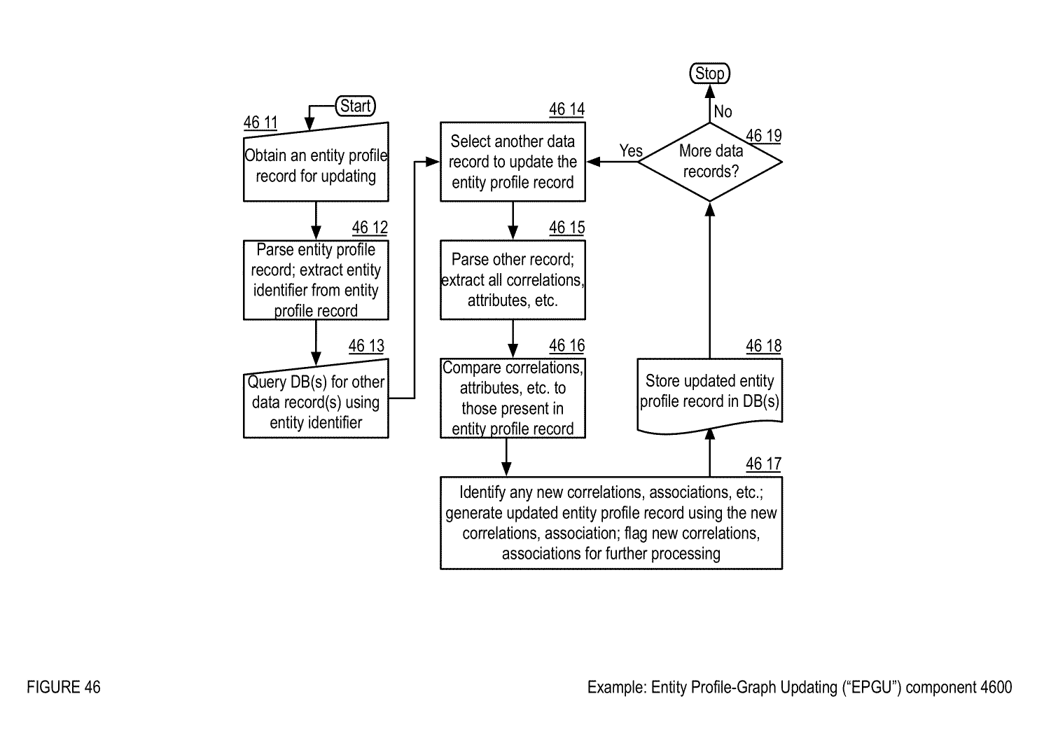

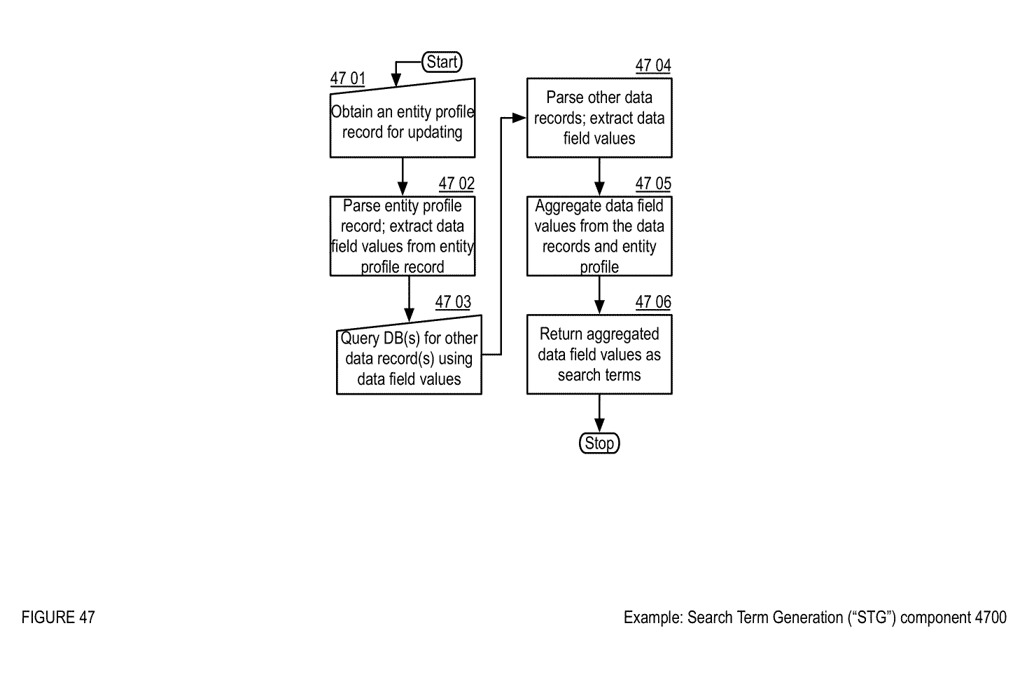

In some embodiments, the EOOR may acquire the aggregated data, and normalize the data into formats that are suitable for uniform storage, indexing, maintenance, and/or further processing via data record normalization component(s) 3006 (e.g., such as described in FIG. 41). The EOOR may extract data from the normalized data records, and recognize data fields, e.g., the EOOR may identify the attributes of each field of data included in the normalized data records via data field recognition component(s) 3007 (e.g., such as described in FIG. 42). For example, the EOOR may identify names, user ID(s), addresses, network addresses, comments and/or specific words within the comments, images, blog posts, video, content within the video, and/or the like from the aggregated data. In some embodiments, for each field of data, the EOOR may classify entity types associated with the field of data, as well as entity identifiers associated with the field of data, e.g., via component(s) 3008 (e.g., such as described in FIG. 43). For example, the EOOR may identify an Internet Protocol (IP) address data field to be associated with a user ID john.q.public (consumer entity type), a user John Q. Public (consumer entity type), a household (the Public household—a multi-consumer entity type/household entity type), a merchant entity type with identifier Acme Merchant Store, Inc. from which purchases are made from the IP address, an Issuer Bank type with identifier First National Bank associated with the purchases made from the IP address, and/or the like. In some embodiments, the EOOR may utilize the entity types and entity identifiers to correlate entities across each other, e.g., via cross-entity correlation component(s) 3009 (e.g., such as described in FIG. 44). For example, the EOOR may identify, from the aggregated data, that a household entity with identifier H123 may include a user entity with identifier John Q. Public and social identifier john.q.public@facebook.com, a second user entity with identifier Jane P. Doe with social identifier jpdoe@twitter.com, a computer entity with identifier IP address 192.168.4.5, a card account entity with identifier ****1234, a bank issuer entity with identifier AB23145, a merchant entity with identifier Acme Stores, Inc. where the household sub-entities make purchases, and/or the like. In some embodiments, the EOOR may utilize the entity identifiers, data associated with each entity and/or correlated entities to identify associations to other entities, e.g., via entity attribute association component(s) 3010 (e.g., such as described in FIG. 45). For example, the EOOR may identify specific purchases made via purchase transactions by members of the household, and thereby identify attributes of members of the household on the basis of the purchases in the purchase transactions made by members of the household. Based on such correlations and associations, the EOOR may update a profile for each entity identified from the aggregated data, as well as a social graph interrelating the entities identified in the aggregated data, e.g., via entity profile-graph updating component(s) 3011 (e.g., such as described in FIG. 46). In some embodiments, the updating of profile and/or social graphs for an entity may trigger a search for additional data that may be relevant to the newly identified correlations and associations for each entity, e.g., via search term generation component(s) 3013-2014 (e.g., such as described in FIG. 47). For example, the updating of a profile and/or social graph may trigger searches across the Internet, social networking websites, transaction data from payment networks, services enrolled into and/or utilized by the entities, and/or the like. In some embodiments, such updating of entity profiles and/or social graphs may be performed continuously, periodically, on-demand, and/or the like.

FIG. 31 shows a data flow diagram illustrating an example search result aggregation procedure in some embodiments of the EOOR. In some implementations, the pay network server may obtain a trigger to perform a search. For example, the pay network server may periodically perform a search update of its aggregated search database, e.g., 3110, with new information available from a variety of sources, such as the Internet. As another example, a request for on-demand search update may be obtained as a result of a user wishing to enroll in a service, for which the pay network server may facilitate data entry by providing an automated web form filling system using information about the user obtained from the search update. In some implementations, the pay network server may parse the trigger to extract keywords using which to perform an aggregated search. The pay network server may generate a query for application programming interface (API) templates for various search engines (e.g., Google™, Bing®, AskJeeves, market data search engines, etc.) from which to collect data for aggregation. The pay network server may query, e.g., 3112, a pay network database, e.g., 3107, for search API templates for the search engines. For example, the pay network server may utilize PHP/SQL commands similar to the examples provided above. The database may provide, e.g., 3113, a list of API templates in response. Based on the list of API templates, the pay network server may generate search requests, e.g., 3114. The pay network server may issue the generated search requests, e.g., 3115a-c, to the search engine servers, e.g., 3101a-c. For example, the pay network server may issue PHP commands to request the search engine for search results. An example listing of commands to issue search requests 3115a-c, substantially in the form of PHP commands, is provided below:

```
<?PHP
// API URL with access key
$url = [″https://ajax.googleapis.com/ajax/services/search/web?v=1.0&″
    . ″q=” $keywords “&key=1234567890987654&userip=
    datagraph.cpip.com″];
// Send Search Request
$ch = curl_init( );
curl_setopt($ch, CURLOPT_URL, $url);
curl_setopt($ch, CURLOPT_RETURNTRANSFER, 1);
curl_setopt($ch, CURLOPT_REFERER, “datagraph.cpip.com”);
$body = curl_exec($ch);
curl_close($ch);
// Obtain, parse search results
$json = json_decode($body);
?>
```

In some embodiments, the search engine servers may query, e.g., 3117a-c, their search databases, e.g., 3102a-c, for search results falling within the scope of the search keywords. In response to the search queries, the search databases may provide search results, e.g., 3118a-c, to the search engine servers. The search engine servers may return the search results obtained from the search databases, e.g., 3119a-c, to the pay network server making the search requests. An example listing of search results 3119a-c, substantially in the form of JavaScript Object Notation (JSON)-formatted data, is provided below:

```
{“responseData”: {
“results”: [
  {
    “GsearchResultClass”: “GwebSearch”,
    “unescapedUrl”: “http://en.wikipedia.org/wiki/John_Q_Public”,
    “url”: “http://en.wikipedia.org/wiki/John_Q_Public”,
    “visibleUrl”: “en.wikipedia.org”,
    “cacheUrl”:
    “http://www.google.com/search?q\u003dcache:TwrPfhd22hYJ:en.-
    wikipedia.org”,
    “title”: “\u003cb\u003eJohn Q.
    Public\u003c/b\u003e - Wikipedia, the free encyclopedia”,
    “titleNoFormatting”: “John Q. Public - Wikipedia, the free
    encyclopedia”,
    “content”: “\[1\] In 2006, he served as Chief Technology Officer...”
  },
  {
    “GsearchResultClass”: “GwebSearch”,
    “unescapedUrl”: “http://www.imdb.com/name/nm0385296/”,
    “url”: “http://www.imdb.com/name/nm0385296/”,
    “visibleUrl”: “www.imdb.com”,
    “cacheUrl”:
    “http://www.google.com/search?q\u003dcache:1i34KkqnsooJ:www.-
    imdb.com”,
    “title”: “\u003cb\u003eJohn Q. Public\u003c/b\u003e”,
    “titleNoFormatting”: “John Q. Public”,
    “content”: “Self: Zoolander. Socialite \u003cb\u003eJohn Q.
    Public\u003c/b\u003e...”
  },
  ...
  ],
  “cursor”: {
  “pages”: [
    { “start”: “0”, “label”: 1 },
    { “start”: “4”, “label”: 2 },
    { “start”: “8”, “label”: 3 },
    { “start”: “12”,“label”: 4 }
  ],
  “estimatedResultCount”: “59600000”,
  “currentPageIndex”: 0,
  “moreResultsUrl”:
    “http://www.google.com/search?oe\u003dutf8\u0026ie\u003dutf8...”
  }
}
, “responseDetails”: null, “responseStatus”: 200}
```

In some embodiments, the pay network server may store the aggregated search results, e.g., 3120, in an aggregated search database, e.g., 3110.

FIG. 32 shows a logic flow diagram illustrating example aspects of aggregating search results in some embodiments of the EOOR, e.g., a Search Results Aggregation (“SRA”) component 3200. In some implementations, the pay network server may obtain a trigger to perform a search, e.g., 3201. For example, the pay network server may periodically perform a search update of its aggregated search database with new information available from a variety of sources, such as the Internet. As another example, a request for on-demand search update may be obtained as a result of a user wishing to enroll in a service, for which the pay network server may facilitate data entry by providing an automated web form filling system using information about the user obtained from the search update. In some implementations, the pay network server may parse the trigger, e.g., 3202, to extract keywords using which to perform an aggregated search. The pay network server may determine the search engines to search, e.g., 3203, using the extracted keywords. Then, the pay network server may generate a query for application programming interface (API) templates for the various search engines (e.g., Google™, Bing®, AskJeeves, market data search engines, etc.) from which to collect data for aggregation, e.g., 3204. The pay network server may query, e.g., 3205, a pay network database for search API templates for the search engines. For example, the pay network server may utilize PHP/SQL commands similar to the examples provided above. The database may provide, e.g., 3205, a list of API templates in response. Based on the list of API templates, the pay network server may generate search requests, e.g., 3206. The pay network server may issue the generated search requests to the search engine servers. The search engine servers may parse the obtained search results(s), e.g., 3207, and query, e.g., 3208, their search databases for search results falling within the scope of the search keywords. In response to the search queries, the search databases may provide search results, e.g., 3209, to the search engine servers. The search engine servers may return the search results obtained from the search databases, e.g., 3210, to the pay network server making the search requests. The pay network server may generate, e.g., 3211, and store the aggregated search results, e.g., 3212, in an aggregated search database.

FIGS. 33A-D show data flow diagrams illustrating an example card-based transaction execution procedure in some embodiments of the EOOR. In some implementations, a user, e.g., 3301, may desire to purchase a product, service, offering, and/or the like (“product”), from a merchant. The user may communicate with a merchant server, e.g., 3303, via a client such as, but not limited to: a personal computer, mobile device, television, point-of-sale terminal, kiosk, ATM, and/or the like (e.g., 3302). For example, the user may provide user input, e.g., purchase input 3311, into the client indicating the user's desire to purchase the product. In various implementations, the user input may include, but not be limited to: keyboard entry, card swipe, activating a RFID/NFC enabled hardware device (e.g., electronic card having multiple accounts, smartphone, tablet, etc.), mouse clicks, depressing buttons on a joystick/game console, voice commands, single/multi-touch gestures on a touch-sensitive interface, touching user interface elements on a touch-sensitive display, and/or the like. For example, the user may direct a browser application executing on the client device to a website of the merchant, and may select a product from the website via clicking on a hyperlink presented to the user via the website. As another example, the client may obtain track 1 data from the user's card (e.g., credit card, debit card, prepaid card, charge card, etc.),

```
%B123456789012345\hat{ }PUBLIC/J.Q.\hat{ }99011200000000000000
**901******?* (wherein ‘123456789012345’ is the card number of ‘J.Q.
Public’ and has a CVV
  number of 901. ‘990112’ is a service code, and *** represents decimal
  digits which change randomly each time the card is used.)
```

In some implementations, the client may generate a purchase order message, e.g., 3312, and provide, e.g., 3313, the generated purchase order message to the merchant server. For example, a browser application executing on the client may provide, on behalf of the user, a (Secure) Hypertext Transfer Protocol (“HTTP(S)”) GET message including the product order details for the merchant server in the form of data formatted according to the eXtensible Markup Language (“XML”). Below is an example HTTP(S) GET message including an XML-formatted purchase order message for the merchant server:

```
GET /purchase.php HTTP/1.1
Host: www.merchant.com
Content-Type: Application/XML
Content-Length: 1306
<?XML version = “1.0” encoding = “UTF-8”?>
<purchase_order>
  <order_ID>4NFU4RG94</order_ID>
  <timestamp>2011-02-22 15:22:43</timestamp>
  <user_ID>john.q.public@gmail.com</user_ID>
  <client_details>
    <client_IP>192.168.23.126</client_IP>
    <client_type>smartphone</client_type>
    <client_model>HTC Hero</client_model>
    <OS>Android 2.2</OS>
    <app_installed_flag>true</app_installed_flag>
  </client_details>
  <purchase_details>
    <num_products>1</num_products>
    <product>
      <product_type>book</product_type>
      <product_params>
        <product_title>XML for dummies</product_title>
        <ISBN>938-2-14-168710-0</ISBN>
        <edition>2nd ed.</edition>
        <cover>hardbound</cover>
        <seller>bestbuybooks</seller>
      </product_params>
      <quantity>1</quantity>
    </product>
  </purchase_details>
  <account_params>
    <account_name>John Q. Public</account_name>
    <account_type>credit</account_type>
    <account_num>123456789012345</account_num>
    <billing_address>123 Green St., Norman,
    OK 98765</billing_address>
    <phone>123-456-7809</phone>
    <sign>/jqp/</sign>
    <confirm_type>email</confirm_type>
    <contact_info>john.q.public@gmail.com</contact_info>
  </account_params>
  <shipping_info>
    <shipping_adress>same as billing</shipping_address>
    <ship_type>expedited</ship_type>
    <ship_carrier>FedEx</ship_carrier>
    <ship_account>123-45-678</ship_account>
    <tracking_flag>true</tracking_flag>
    <sign_flag>false</sign_flag>
  </shipping_info>
</purchase_order>
```

In some implementations, the merchant server may obtain the purchase order message from the client, and may parse the purchase order message to extract details of the purchase order from the user. The merchant server may generate a card query request, e.g., 3314 to determine whether the transaction can be processed. For example, the merchant server may attempt to determine whether the user has sufficient funds to pay for the purchase in a card account provided with the purchase order. The merchant server may provide the generated card query request, e.g., 3315, to an acquirer server, e.g., 3304. For example, the acquirer server may be a server of an acquirer financial institution (“acquirer”) maintaining an account of the merchant. For example, the proceeds of transactions processed by the merchant may be deposited into an account maintained by the acquirer. In some implementations, the card query request may include details such as, but not limited to: the costs to the user involved in the transaction, card account details of the user, user billing and/or shipping information, and/or the like. For example, the merchant server may provide a HTTP(S) POST message including an XML-formatted card query request similar to the example listing provided below:

```
POST /cardquery.php HTTP/1.1
Host: www.acquirer.com
Content-Type: Application/XML
Content-Length: 624
<?XML version = “1.0” encoding = “UTF-8”?>
<card_query_request>
  <query_ID>VNEI39FK</query_ID>
  <timestamp>2011-02-22 15:22:44</timestamp>
  <purchase_summary>
    <num_products>1</num_products>
    <product>
      <product_summary>Book - XML for
      dummies</product_summary>
      <product_quantity>1</product_quantity?
    </product>
  </purchase_summary>
  <transaction_cost>$34.78</transaction_cost>
  <account_params>
    <account_name>John Q. Public</account_name>
    <account_type>credit</account_type>
    <account_num>123456789012345</account_num>
    <billing_address>123 Green St., Norman,
    OK 98765</billing_address>
    <phone>123-456-7809</phone>
    <sign>/jqp/</sign>
  </account_params>
  <merchant_params>
    <merchant_id>3FBCR4INC</merchant_id>
    <merchant_name>Books & Things, Inc.</merchant_name>
    <merchant_auth_key>1NNF484MCP59CHB27365
    </merchant_auth_key>
  </merchant_params>
</card_query_request>
```

In some implementations, the acquirer server may generate a card authorization request, e.g., 3316, using the obtained card query request, and provide the card authorization request, e.g., 3317, to a pay network server, e.g., 3305. For example, the acquirer server may redirect the HTTP(S) POST message in the example above from the merchant server to the pay network server.

In some implementations, the pay network server may determine whether the user has enrolled in value-added user services. For example, the pay network server may query 3318 a database, e.g., pay network database 3307, for user service enrollment data. For example, the server may utilize PHP/SQL commands similar to the example provided above to query the pay network database. In some implementations, the database may provide the user service enrollment data, e.g., 3319. The user enrollment data may include a flag indicating whether the user is enrolled or not, as well as instructions, data, login URL, login API call template and/or the like for facilitating access of the user-enrolled services. For example, in some implementations, the pay network server may redirect the client to a value-add server (e.g., such as a social network server where the value-add service is related to social networking) by providing a HTTP(S) REDIRECT 300 message, similar to the example below:

```
HTTP/1.1 300 Multiple Choices
Location:
    https://www.facebook.com/dialog/oauth?client_id=
    snpa_app_ID&redirect_uri=www.paynetwork.com/purchase.php
<html>
    <head><title>300 Multiple Choices</title></head>
    <body><h1>Multiple Choices</h1></body>
</html>
```

In some implementations, the pay network server may provide payment information extracted from the card authorization request to the value-add server as part of a value add service request, e.g., 3320. For example, the pay network server may provide a HTTP(S) POST message to the value-add server, similar to the example below:

```
POST /valueservices.php HTTP/1.1
Host: www.valueadd.com
Content-Type: Application/XML
Content-Length: 1306
<?XML version = “1.0” encoding = “UTF-8”?>
<service_request>
  <request_ID>4NFU4RG94</order_ID>
  <timestamp>2011-02-22 15:22:43</timestamp>
  <user_ID>john.q.public@gmail.com</user_ID>
  <client_details>
      <client_IP>192.168.23.126</client_IP>
      <client_type>smartphone</client_type>
      <client_model>HTC Hero</client_model>
      <OS>Android 2.2</OS>
      <app_installed_flag>true</app_installed_flag>
  </client_details>
  <account_params>
      <account_name>John Q. Public</account_name>
      <account_type>credit</account_type>
      <account_num>123456789012345</account_num>
      <billing_address>123 Green St., Norman,
      OK 98765</billing_address>
      <phone>123-456-7809</phone>
      <sign>/jqp/</sign>
      <confirm_type>email</confirm_type>
      <contact_info>john.q.public@gmail.com</contact_info>
  </account_params>
  <!--optional-->
  <merchant>
      <merchant_id>CQN3Y42N</merchant_id>
      <merchant_name>Acme Tech, Inc.</merchant_name>
      <user_name>john.q.public</user_name>
      <cardlist> www.acme.com/user/john.q.public/cclist.xml<cardlist>
      <user_account_preference>1 3 2 4 7 6 5
      <user_account_preference>
  </merchant>
</service_request>
```

In some implementations, the value-add server may provide a service input request, e.g., 3321, to the client. For example, the value-add server may provide a HTML input/login form to the client. The client may display, e.g., 3322, the login form for the user. In some implementations, the user may provide login input into the client, e.g., 3323, and the client may generate a service input response, e.g., 3324, for the value-add server. In some implementations, the value-add server may provide value-add services according to user value-add service enrollment data, user profile, etc., stored on the value-add server, and based on the user service input. Based on the provision of value-add services, the value-add server may generate a value-add service response, e.g., 3326, and provide the response to the pay network server. For example, the value-add server may provide a HTTP(S) POST message similar to the example below:

```
POST /serviceresponse.php HTTP/1.1
Host: www.paynet.com
Content-Type: Application/XML
Content-Length: 1306
<?XML version = “1.0” encoding = “UTF-8”?>
<service_response>
    <request_ID>4NFU4RG94</order_ID>
    <timestamp>2011-02-22 15:22:43</timestamp>
    <result>serviced</result>
    <servcode>943528976302-45569-003829-04</servcode>
</service_response>
```

In some implementations, upon receiving the value-add service response from the value-add server, the pay network server may extract the enrollment service data from the response for addition to a transaction data record. In some implementations, the pay network server may forward the card authorization request to an appropriate pay network server, e.g., 3328, which may parse the card authorization request to extract details of the request. Using the extracted fields and field values, the pay network server may generate a query, e.g., 3329, for an issuer server corresponding to the user's card account. For example, the user's card account, the details of which the user may have provided via the client-generated purchase order message, may be linked to an issuer financial institution (“issuer”), such as a banking institution, which issued the card account for the user. An issuer server, e.g., 3308a-n, of the issuer may maintain details of the user's card account. In some implementations, a database, e.g., pay network database 3307, may store details of the issuer servers and card account numbers associated with the issuer servers. For example, the database may be a relational database responsive to Structured Query Language (“SQL”) commands. The pay network server may execute a hypertext preprocessor (“PHP”) script including SQL commands to query the database for details of the issuer server. An example PHP/SQL command listing, illustrating substantive aspects of querying the database, is provided below:

```
<?PHP
header(‘Content-Type: text/plain’);
mysql_connect(“254.93.179.112”,$DBserver,$password); // access
database server
mysql_select_db(“ISSUERS.SQL”); // select database table to search
//create query for issuer server data
$query = “SELECT
issuer_name issuer_address issuer_id ip_address mac_address
    auth_key port_num security_settings_list FROM IssuerTable
    WHERE account_num LIKE ‘%’ $accountnum”;
$result = mysql_query($query); // perform the search query
mysql_close(“ISSUERS.SQL”); // close database access
?>
```

In response to obtaining the issuer server query, e.g., 3329, the pay network database may provide, e.g., 3330, the requested issuer server data to the pay network server. In some implementations, the pay network server may utilize the issuer server data to generate a forwarding card authorization request, e.g., 3331, to redirect the card authorization request from the acquirer server to the issuer server. The pay network server may provide the card authorization request, e.g., 3332a-n, to the issuer server. In some implementations, the issuer server, e.g., 3308a-n, may parse the card authorization request, and based on the request details may query 3333a-n database, e.g., user profile database 3309a-n, for data of the user's card account. For example, the issuer server may issue PHP/SQL commands similar to the example provided below:

<?PHP
header(‘Content-Type: text/plain’);
mysql_connect(“254.93.179.112”,$DBserver,$password); // access
database server
mysql_select_db(“USERS.SQL”); // select database table to search
//create query for user data
$query = “SELECT user_id user_name user_balance account_type
FROM UserTable
WHERE account_num LIKE ‘%’ $accountnum”;
$result = mysql_query($query); // perform the search query
mysql_close(“USERS.SQL”); // close database access
?>

In some implementations, on obtaining the user data, e.g., 3334a-n, the issuer server may determine whether the user can pay for the transaction using funds available in the account, e.g., 3335a-n. For example, the issuer server may determine whether the user has a sufficient balance remaining in the account, sufficient credit associated with the account, and/or the like. If the issuer server determines that the user can pay for the transaction using the funds available in the account, the server may provide an authorization message, e.g., 3336a-n, to the pay network server. For example, the server may provide a HTTP(S) POST message similar to the examples above.

In some implementations, the pay network server may obtain the authorization message, and parse the message to extract authorization details. Upon determining that the user possesses sufficient funds for the transaction, the pay network server may generate a transaction data record from the card authorization request it received, and store, e.g., 3339, the details of the transaction and authorization relating to the transaction in a database, e.g., pay network database 3307. For example, the pay network server may issue PHP/SQL commands similar to the example listing below to store the transaction data in a database:

```
<?PHP
header(‘Content-Type: text/plain’);
mysql_connect(“254.92.185.103”,$DBserver,$password); // access
database server
mysql_select(“TRANSACTIONS.SQL”); // select database to append
mysql_query(“INSERT INTO PurchasesTable (timestamp,
    purchase_summary_list, num_products, product_summary,
    product_quantity, transaction_cost, account_params_list,
    account_name, account_type, account_num, billing_addres,
    zipcode, phone, sign, merchant_params_list, merchant_id,
    merchant_name, merchant_auth_key)
VALUES (time( ), $purchase_summary_list, $num_products,
    $product_summary, $product_quantity, $transaction_cost,
    $account_params_list, $account_name, $account_type,
    $account_num, $billing_addres, $zipcode, $phone, $sign,
    $merchant_params_list, $merchant_id, $merchant_name,
    $merchant_auth_key)”);
    // add data to table in database
mysql_close(“TRANSACTIONS.SQL”); // close connection to database
?>
```

In some implementations, the pay network server may forward the authorization message, e.g., 3340, to the acquirer server, which may in turn forward the authorization message, e.g., 3340, to the merchant server. The merchant may obtain the authorization message, and determine from it that the user possesses sufficient funds in the card account to conduct the transaction. The merchant server may add a record of the transaction for the user to a batch of transaction data relating to authorized transactions. For example, the merchant may append the XML data pertaining to the user transaction to an XML data file comprising XML data for transactions that have been authorized for various users, e.g., 3341, and store the XML data file, e.g., 3342, in a database, e.g., merchant database 3304. For example, a batch XML data file may be structured similar to the example XML data structure template provided below:

```
<?XML version = “1.0” encoding = “UTF-8”?>
<merchant_data>
    <merchant_id>3FBCR4INC</merchant_id>
    <merchant_name>Books & Things, Inc.</merchant_name>
    <merchant_auth_key>1NNF484MCP59CHB27365
    </merchant_auth_key>
    <account_number>123456789</account_number>
</merchant_data>
<transaction_data>
    <transaction 1>
            ...
    </transaction 1>
    <transaction 2>
            ...
    </transaction 2>
            .
            .
            .
    <transaction n>
            ...
    </transaction n>
</transaction_data>
```

In some implementations, the server may also generate a purchase receipt, e.g., 3343, and provide the purchase receipt to the client. The client may render and display, e.g., 3344, the purchase receipt for the user. For example, the client may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

With reference to FIG. 33C, in some implementations, the merchant server may initiate clearance of a batch of authorized transactions. For example, the merchant server may generate a batch data request, e.g., 3345, and provide the request, e.g., 3346, to a database, e.g., merchant database 3304. For example, the merchant server may utilize PHP/SQL commands similar to the examples provided above to query a relational database. In response to the batch data request, the database may provide the requested batch data, e.g., 3347. The server may generate a batch clearance request, e.g., 3348, using the batch data obtained from the database, and provide, e.g., 3341, the batch clearance request to an acquirer server, e.g., 3310. For example, the merchant server may provide a HTTP(S) POST message including XML-formatted batch data in the message body for the acquirer server. The acquirer server may generate, e.g., 3350, a batch payment request using the obtained batch clearance request, and provide the batch payment request to the pay network server, e.g., 3351. The pay network server may parse the batch payment request, and extract the transaction data for each transaction stored in the batch payment request, e.g., 3352. The pay network server may store the transaction data, e.g., 3353, for each transaction in a database, e.g., pay network database 3307. For each extracted transaction, the pay network server may query, e.g., 3354-2355, a database, e.g., pay network database 3307, for an address of an issuer server. For example, the pay network server may utilize PHP/SQL commands similar to the examples provided above. The pay network server may generate an individual payment request, e.g., 3356, for each transaction for which it has extracted transaction data, and provide the individual payment request, e.g., 3357, to the issuer server, e.g., 3308. For example, the pay network server may provide a HTTP(S) POST request similar to the example below:

```
POST /requestpay.php HTTP/1.1
Host: www.issuer.com
Content-Type: Application/XML
Content-Length: 788
<?XML version = “1.0” encoding = “UTF-8”?>
<pay_request>
    <request_ID>CNI4ICNW2</request_ID>
    <timestamp>2011-02-22 17:00:01</timestamp>
    <pay_amount>$34.78</pay_amount>
    <account_params>
            <account_name>John Q. Public</account_name>
            <account_type>credit</account_type>
            <account_num>123456789012345</account_num>
            <billing_address>123 Green St., Norman,
            OK 98765</billing_address>
            <phone>123-456-7809</phone>
            <sign>/jqp/</sign>
    </account_params>
    <merchant_params>
            <merchant_id>3FBCR4INC</merchant_id>
            <merchant_name>Books & Things,
            Inc.</merchant_name>
            <merchant_auth_key>1NNF484MCP59CHB27365
            </merchant_auth_key>
    </merchant_params>
    <purchase_summary>
            <num_products>1</num_products>
            <product>
                    <product_summary>Book - XML
                    for dummies</product_summary>
                    <product_quantity>1</product_quantity?
            </product>
    </purchase_summary>
</pay_request>
```

In some implementations, the issuer server may generate a payment command, e.g., 3358. For example, the issuer server may issue a command to deduct funds from the user's account (or add a charge to the user's credit card account). The issuer server may issue a payment command, e.g., 3359, to a database storing the user's account information, e.g., user profile database 3308. The issuer server may provide a funds transfer message, e.g., 3360, to the pay network server, which may forward, e.g., 3361, the funds transfer message to the acquirer server. An example HTTP(S) POST funds transfer message is provided below:

```
POST /clearance.php HTTP/1.1
Host: www.acquirer.com
Content-Type: Application/XML
Content-Length: 206
<?XML version = “1.0” encoding = “UTF-8”?>
<deposit_ack>
    <request_ID>CNI4ICNW2</request_ID>
    <clear_flag>true</clear_flag>
    <timestamp>2011-02-22 17:00:02</timestamp>
    <deposit_amount>$34.78</deposit_amount>
</deposit_ack>
```

In some implementations, the acquirer server may parse the funds transfer message, and correlate the transaction (e.g., using the request_ID field in the example above) to the merchant. The acquirer server may then transfer the funds specified in the funds transfer message to an account of the merchant, e.g., 3362.

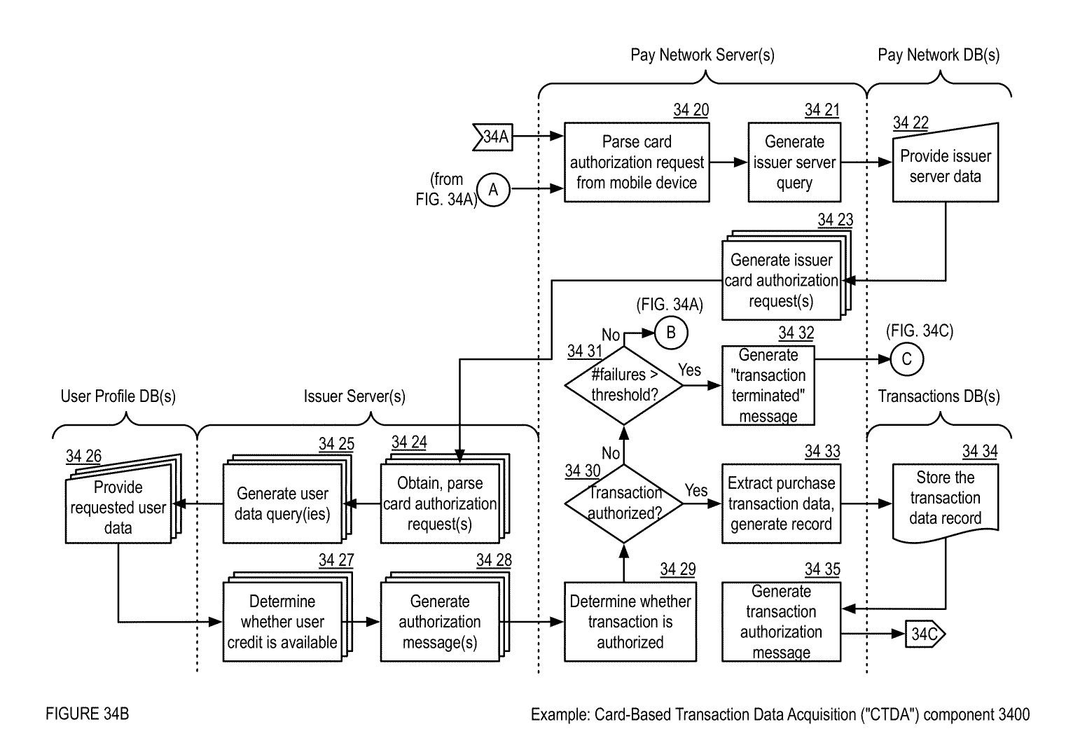

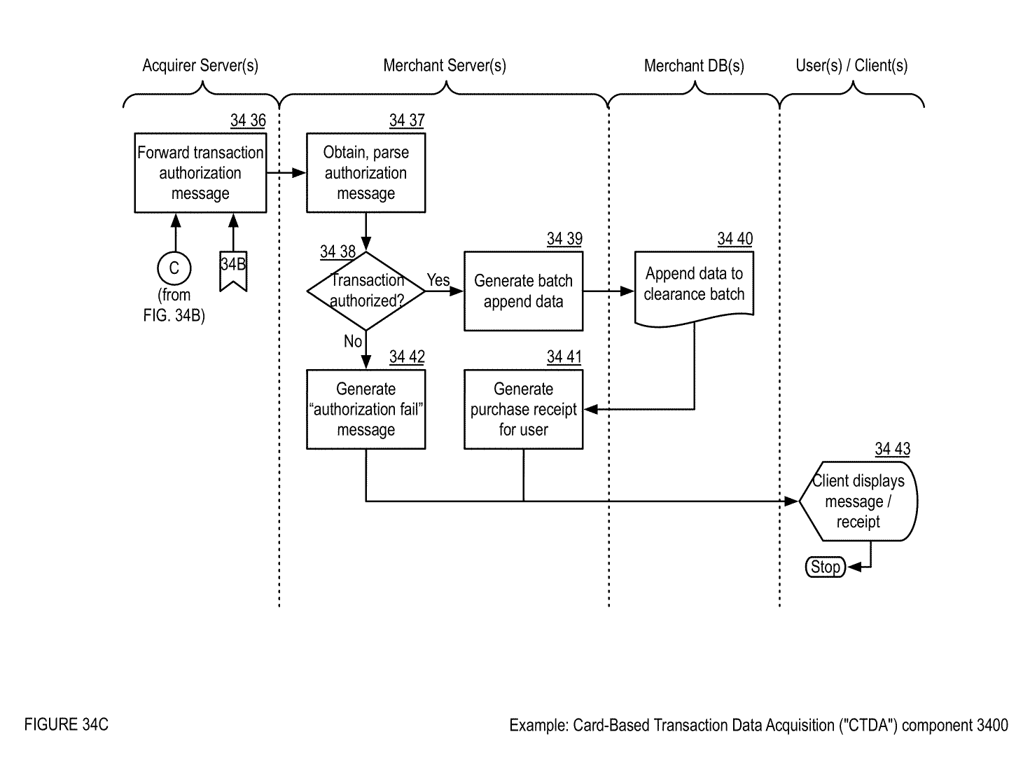

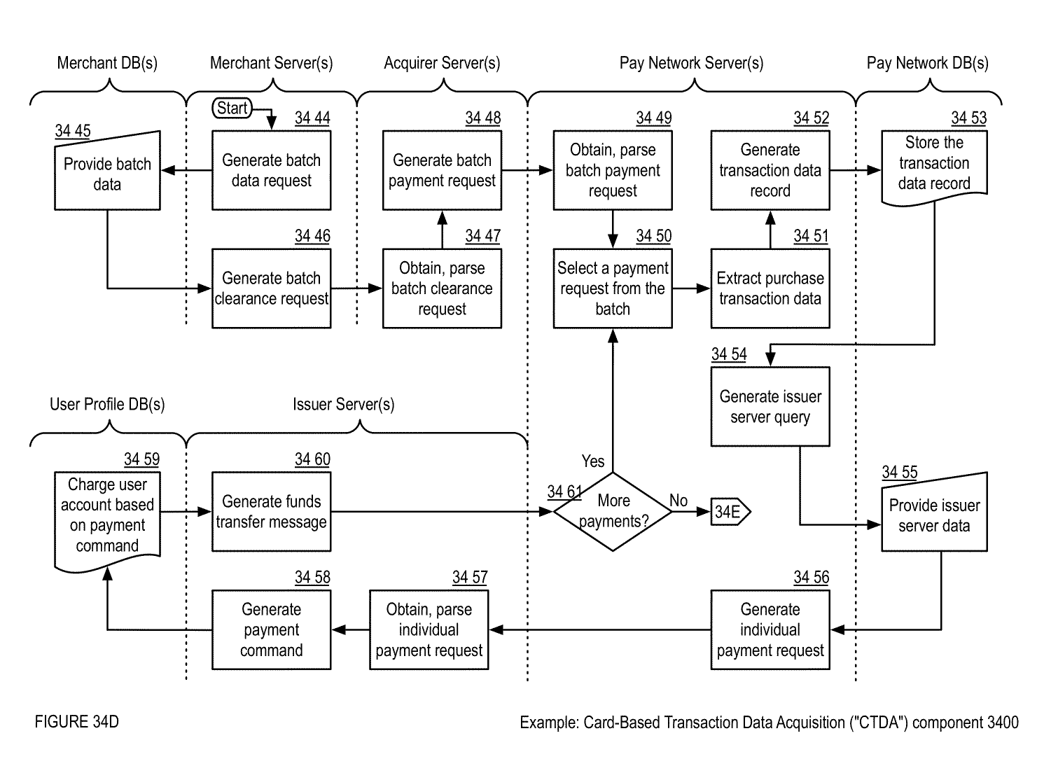

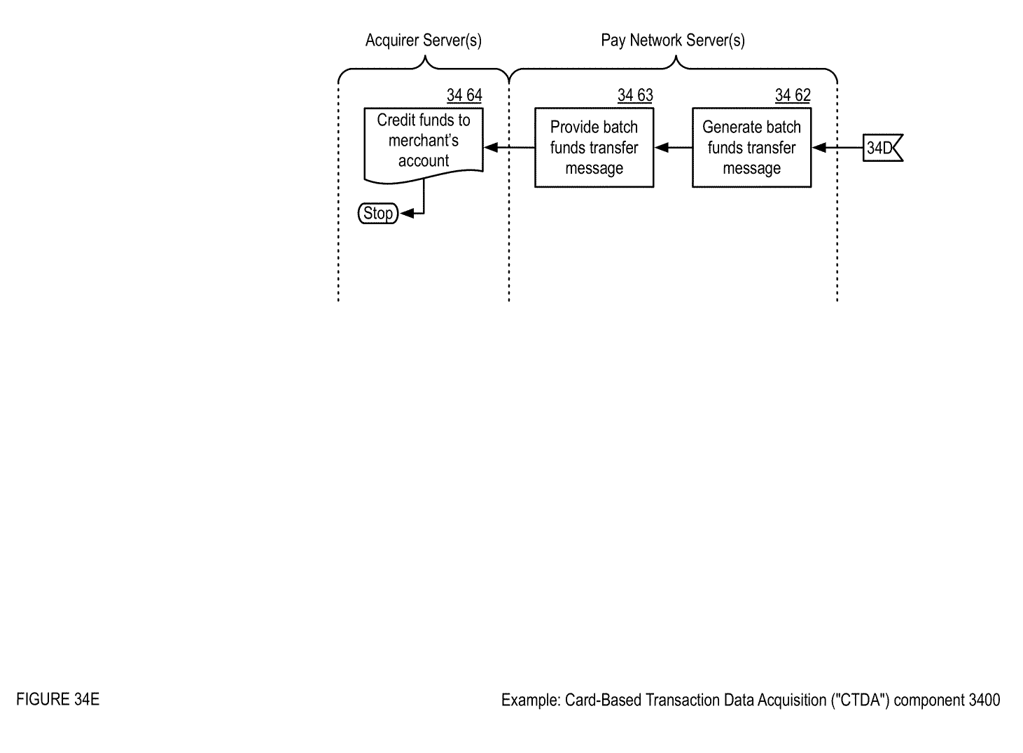

FIGS. 34A-E show logic flow diagrams illustrating example aspects of card-based transaction execution, resulting in generation of card-based transaction data and service usage data, in some embodiments of the EOOR, e.g., a Card-Based Transaction Execution (“CTE”) component 3400. In some implementations, a user may provide user input, e.g., 3401, into a client indicating the user's desire to purchase a product from a merchant. The client may generate a purchase order message, e.g., 3402, and provide the generated purchase order message to the merchant server. In some implementations, the merchant server may obtain, e.g., 3403, the purchase order message from the client, and may parse the purchase order message to extract details of the purchase order from the user. Example parsers that the merchant client may utilize are discussed further below with reference to FIG. 71. The merchant may generate a product data query, e.g., 3404, for a merchant database, which may in response provide the requested product data, e.g., 3405. The merchant server may generate a card query request using the product data, e.g., 3404, to determine whether the transaction can be processed. For example, the merchant server may process the transaction only if the user has sufficient funds to pay for the purchase in a card account provided with the purchase order. The merchant server may optionally provide the generated card query request to an acquirer server. The acquirer server may generate a card authorization request using the obtained card query request, and provide the card authorization request to a pay network server.

In some implementations, the pay network server may determine whether the user has enrolled in value-added user services. For example, the pay network server may query a database, e.g., 3407, for user service enrollment data. For example, the server may utilize PHP/SQL commands similar to the example provided above to query the pay network database. In some implementations, the database may provide the user service enrollment data, e.g., 3408. The user enrollment data may include a flag indicating whether the user is enrolled or not, as well as instructions, data, login URL, login API call template and/or the like for facilitating access of the user-enrolled services. For example, in some implementations, the pay network server may redirect the client to a value-add server (e.g., such as a social network server where the value-add service is related to social networking) by providing a HTTP(S) REDIRECT 300 message. In some implementations, the pay network server may provide payment information extracted from the card authorization request to the value-add server as part of a value add service request, e.g., 3410.

In some implementations, the value-add server may provide a service input request, e.g., 3411, to the client. The client may display, e.g., 3412, the input request for the user. In some implementations, the user may provide input into the client, e.g., 3413, and the client may generate a service input response for the value-add server. In some implementations, the value-add server may provide value-add services according to user value-add service enrollment data, user profile, etc., stored on the value-add server, and based on the user service input. Based on the provision of value-add services, the value-add server may generate a value-add service response, e.g., 3417, and provide the response to the pay network server. In some implementations, upon receiving the value-add service response from the value-add server, the pay network server may extract the enrollment service data from the response for addition to a transaction data record, e.g., 3419-3420.

With reference to FIG. 34B, in some implementations, the pay network server may obtain the card authorization request from the acquirer server, and may parse the card authorization request to extract details of the request, e.g., 3420. Using the extracted fields and field values, the pay network server may generate a query, e.g., 3421-2422, for an issuer server corresponding to the user's card account. In response to obtaining the issuer server query the pay network database may provide, e.g., 3422, the requested issuer server data to the pay network server. In some implementations, the pay network server may utilize the issuer server data to generate a forwarding card authorization request, e.g., 3423, to redirect the card authorization request from the acquirer server to the issuer server. The pay network server may provide the card authorization request to the issuer server. In some implementations, the issuer server may parse, e.g., 3424, the card authorization request, and based on the request details may query a database, e.g., 3425, for data of the user's card account. In response, the database may provide the requested user data. On obtaining the user data, the issuer server may determine whether the user can pay for the transaction using funds available in the account, e.g., 3426. For example, the issuer server may determine whether the user has a sufficient balance remaining in the account, sufficient credit associated with the account, and/or the like, but comparing the data from the database with the transaction cost obtained from the card authorization request. If the issuer server determines that the user can pay for the transaction using the funds available in the account, the server may provide an authorization message, e.g., 3427, to the pay network server.

In some implementations, the pay network server may obtain the authorization message, and parse the message to extract authorization details. Upon determining that the user possesses sufficient funds for the transaction (e.g., 3430, option “Yes”), the pay network server may extract the transaction card from the authorization message and/or card authorization request, e.g., 3433, and generate a transaction data record using the card transaction details. The pay network server may provide the transaction data record for storage, e.g., 3434, to a database. In some implementations, the pay network server may forward the authorization message, e.g., 3435, to the acquirer server, which may in turn forward the authorization message, e.g., 3436, to the merchant server. The merchant may obtain the authorization message, and parse the authorization message o extract its contents, e.g., 3437. The merchant server may determine whether the user possesses sufficient funds in the card account to conduct the transaction. If the merchant server determines that the user possess sufficient funds, e.g., 3438, option “Yes,” the merchant server may add the record of the transaction for the user to a batch of transaction data relating to authorized transactions, e.g., 3439-2440. The merchant server may also generate a purchase receipt, e.g., 3441, for the user. If the merchant server determines that the user does not possess sufficient funds, e.g., 3438, option “No,” the merchant server may generate an “authorization fail” message, e.g., 3442. The merchant server may provide the purchase receipt or the “authorization fail” message to the client. The client may render and display, e.g., 3443, the purchase receipt for the user.

In some implementations, the merchant server may initiate clearance of a batch of authorized transactions by generating a batch data request, e.g., 3444, and providing the request to a database. In response to the batch data request, the database may provide the requested batch data, e.g., 3445, to the merchant server. The server may generate a batch clearance request, e.g., 3446, using the batch data obtained from the database, and provide the batch clearance request to an acquirer server. The acquirer server may generate, e.g., 3448, a batch payment request using the obtained batch clearance request, and provide the batch payment request to a pay network server. The pay network server may parse, e.g., 3449, the batch payment request, select a transaction stored within the batch data, e.g., 3450, and extract the transaction data for the transaction stored in the batch payment request, e.g., 3451. The pay network server may generate a transaction data record, e.g., 3452, and store the transaction data, e.g., 3453, the transaction in a database. For the extracted transaction, the pay network server may generate an issuer server query, e.g., 3454, for an address of an issuer server maintaining the account of the user requesting the transaction. The pay network server may provide the query to a database. In response, the database may provide the issuer server data requested by the pay network server, e.g., 3455. The pay network server may generate an individual payment request, e.g., 3456, for the transaction for which it has extracted transaction data, and provide the individual payment request to the issuer server using the issuer server data from the database.

In some implementations, the issuer server may obtain the individual payment request, and parse, e.g., 3457, the individual payment request to extract details of the request. Based on the extracted data, the issuer server may generate a payment command, e.g., 3458. For example, the issuer server may issue a command to deduct funds from the user's account (or add a charge to the user's credit card account). The issuer server may issue a payment command, e.g., 3459, to a database storing the user's account information. In response, the database may update a data record corresponding to the user's account to reflect the debit/charge made to the user's account. The issuer server may provide a funds transfer message, e.g., 3460, to the pay network server after the payment command has been executed by the database.

In some implementations, the pay network server may check whether there are additional transactions in the batch that need to be cleared and funded. If there are additional transactions, e.g., 3461, option “Yes,” the pay network server may process each transaction according to the procedure described above. The pay network server may generate, e.g., 3462, an aggregated funds transfer message reflecting transfer of all transactions in the batch, and provide, e.g., 3463, the funds transfer message to the acquirer server. The acquirer server may, in response, transfer the funds specified in the funds transfer message to an account of the merchant, e.g., 3464.

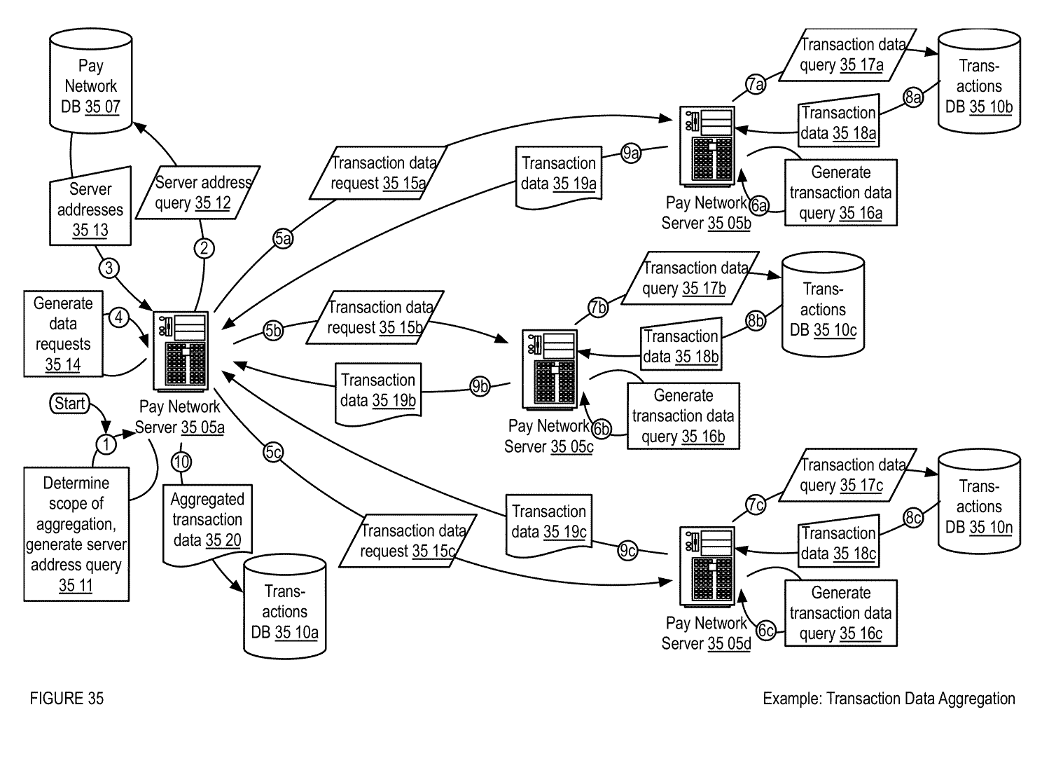

FIG. 35 shows a data flow diagram illustrating an example procedure to aggregate card-based transaction data in some embodiments of the EOOR. In some implementations, the pay network server may determine a scope of data aggregation required to perform the analysis, e.g., 3511. The pay network server may initiate data aggregation based on the determined scope. The pay network server may generate a query for addresses of server storing transaction data within the determined scope. The pay network server may query, e.g., 3512, a pay network database, e.g., 3507a, for addresses of pay network servers that may have stored transaction data within the determined scope of the data aggregation. For example, the pay network server may utilize PHP/SQL commands similar to the examples provided above. The database may provide, e.g., 3513, a list of server addresses in response to the pay network server's query. Based on the list of server addresses, the pay network server may generate transaction data requests, e.g., 3514. The pay network server may issue the generated transaction data requests, e.g., 3515a-c, to the other pay network servers, e.g., 3505b-d. The other pay network servers may query, e.g., 3517a-c, their pay network database, e.g., 3507a-d, for transaction data falling within the scope of the transaction data requests. In response to the transaction data queries, the pay network databases may provide transaction data, e.g., 3518a-c, to the other pay network servers. The other pay network servers may return the transaction data obtained from the pay network databases, e.g., 3519a-c, to the pay network server making the transaction data requests, e.g., 3505a.

The pay network server, e.g., 3505a, may store the aggregated transaction data, e.g., 3520, in an aggregated transactions database, e.g., 3510a.

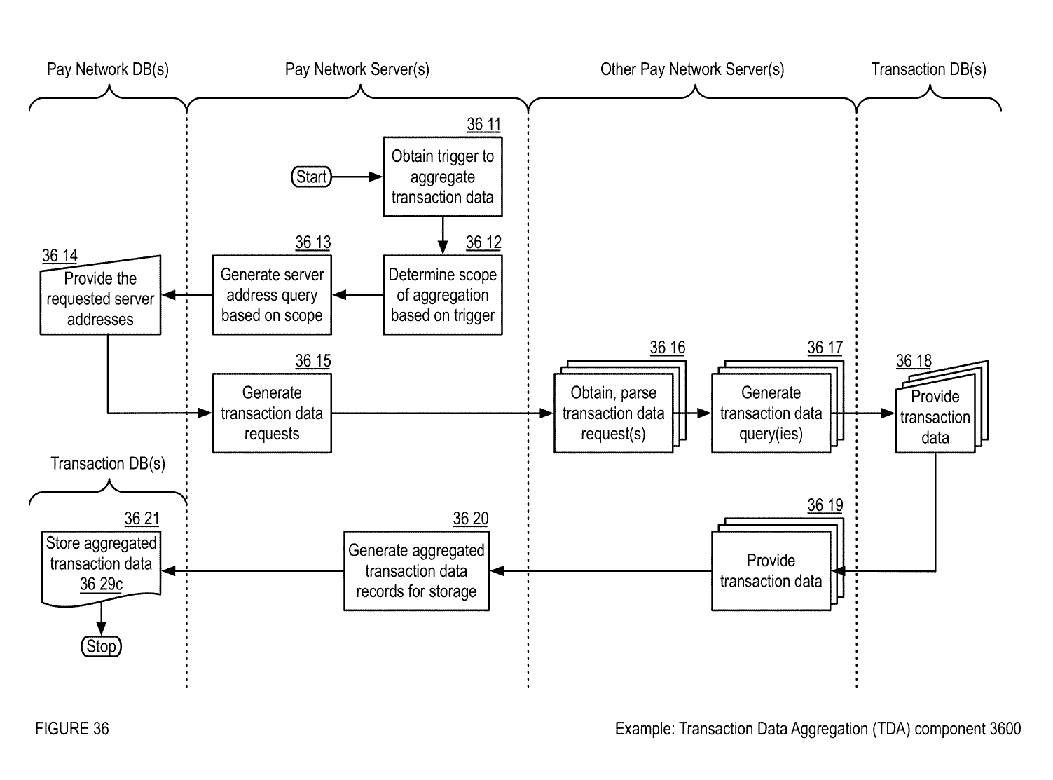

FIG. 36 shows a logic flow diagram illustrating example aspects of aggregating card-based transaction data in some embodiments of the EOOR, e.g., a Transaction Data Aggregation (“TDA”) component 3600. In some implementations, a pay network server may obtain a trigger to aggregate transaction data, e.g., 3601. For example, the server may be configured to initiate transaction data aggregation on a regular, periodic, basis (e.g., hourly, daily, weekly, monthly, quarterly, semi-annually, annually, etc.). As another example, the server may be configured to initiate transaction data aggregation on obtaining information that the U.S. Government (e.g., Department of Commerce, Office of Management and Budget, etc) has released new statistical data related to the U.S. business economy. As another example, the server may be configured to initiate transaction data aggregation on-demand, upon obtaining a user investment strategy analysis request for processing. The pay network server may determine a scope of data aggregation required to perform the analysis, e.g., 3602. For example, the scope of data aggregation may be pre-determined. As another example, the scope of data aggregation may be determined based on a received user investment strategy analysis request. The pay network server may initiate data aggregation based on the determined scope. The pay network server may generate a query for addresses of server storing transaction data within the determined scope, e.g., 3603. The pay network server may query a database for addresses of pay network servers that may have stored transaction data within the determined scope of the data aggregation. The database may provide, e.g., 3604, a list of server addresses in response to the pay network server's query. Based on the list of server addresses, the pay network server may generate transaction data requests, e.g., 3605. The pay network server may issue the generated transaction data requests to the other pay network servers. The other pay network servers may obtain and parse the transaction data requests, e.g., 3606. Based on parsing the data requests, the other pay network servers may generate transaction data queries, e.g., 3607, and provide the transaction data queries to their pay network databases. In response to the transaction data queries, the pay network databases may provide transaction data, e.g., 3608, to the other pay network servers. The other pay network servers may return, e.g., 3609, the transaction data obtained from the pay network databases to the pay network server making the transaction data requests. The pay network server may generate aggregated transaction data records from the transaction data received from the other pay network servers, e.g., 3610, and store the aggregated transaction data in a database, e.g., 3611.

FIG. 37 shows a data flow diagram illustrating an example social data aggregation procedure in some embodiments of the EOOR. In some implementations, the pay network server may obtain a trigger to perform a social data search. For example, the pay network server may periodically perform an update of its aggregated social database, e.g., 3710, with new information available from a variety of sources, such as the social networking services operating on the Internet. As another example, a request for on-demand social data update may be obtained as a result of a user wishing to enroll in a service, for which the pay network server may facilitate data entry by providing an automated web form filling system using information about the user obtained from the social data update. In some implementations, the pay network server may parse the trigger to extract keywords using which to perform an aggregated social data update. The pay network server may generate a query for application programming interface (API) templates for various social networking services (e.g., Facebook®, Twitter™, etc.) from which to collect social data for aggregation. The pay network server may query, e.g., 3712, a pay network database, e.g., 3707, for social network API templates for the social networking services. For example, the pay network server may utilize PHP/SQL commands similar to the examples provided above. The database may provide, e.g., 3713, a list of API templates in response. Based on the list of API templates, the pay network server may generate social data requests, e.g., 3714. The pay network server may issue the generated social data requests, e.g., 3715a-c, to the social network servers, e.g., 3701a-c. For example, the pay network server may issue PHP commands to request the social network servers for social data. An example listing of commands to issue social data requests 3715a-c, substantially in the form of PHP commands, is provided below:

```
<?PHP
header(‘Content-Type: text/plain’);
// Obtain user ID(s) of friends of the logged-in user
$friends =
    json_decode(file_get_contents(‘https://graph.facebook.com/me/
    friends?accesstoken=’$cookie[‘oauth_access_token’]), true);
$friend_ids = array_keys($friends);
// Obtain message feed associated with the profile of the logged-in user
$feed =
    json_decode(file_get_contents(‘https:llgraph.facebook.com/me/
    feed?access_token=’$cookie[‘oauth_access_token’]), true);
// Obtain messages by the user's friends
$result = mysql_query(‘SELECT * FROM content WHERE uid IN
    (‘.implode($friend_ids, ‘,’) . ’)’);
$friend_content = array( );
while ($row = mysql_fetch_assoc($result))
$friend_content [ ] $row;
?>
```

In some embodiments, the social network servers may query, e.g., 3717a-c, their databases, e.g., 3702a-c, for social data results falling within the scope of the social keywords. In response to the queries, the databases may provide social data, e.g., 3718a-c, to the search engine servers. The social network servers may return the social data obtained from the databases, e.g., 3719a-c, to the pay network server making the social data requests. An example listing of social data 3719a-c, substantially in the form of JavaScript Object Notation (JSON)-formatted data, is provided below:

| | | |
|---|---|---|
| [ “data”: | [ | |
| | { | “name”: “Tabatha Orloff”, |
| | | “id”: “483722”}, |
| | { | “name”: “Darren Kinnaman”, |
| | | “id”: “86S743”}, |
| | { | “name”: “Sharron Jutras”, |
| | | “id”: “O91274”} |
| ] } | | |

In some embodiments, the pay network server may store the aggregated search results, e.g., 3720, in an aggregated search database, e.g., 3710.

FIG. 38 shows a logic flow diagram illustrating example aspects of aggregating social data in some embodiments of the EOOR, e.g., a Social Data Aggregation (“SDA”) component 3800. In some implementations, the pay network server may obtain a trigger to perform a social search, e.g., 3801. For example, the pay network server may periodically perform an update of its aggregated social database with new information available from a variety of sources, such as the Internet. As another example, a request for on-demand social data update may be obtained as a result of a user wishing to enroll in a service, for which the pay network server may facilitate data entry by providing an automated web form filling system using information about the user obtained from the social data update. In some implementations, the pay network server may parse the trigger, e.g., 3802, to extract keywords and/or user ID(s) using which to perform an aggregated search for social data. The pay network server may determine the social networking services to search, e.g., 3803, using the extracted keywords and/or user ID(s). Then, the pay network server may generate a query for application programming interface (API) templates for the various social networking services (e.g., Facebook®, Twitter™, etc.) from which to collect social data for aggregation, e.g., 3804. The pay network server may query, e.g., 3805, a pay network database for search API templates for the social networking services. For example, the pay network server may utilize PHP/SQL commands similar to the examples provided above. The database may provide, e.g., 3805, a list of API templates in response. Based on the list of API templates, the pay network server may generate social data requests, e.g., 3806. The pay network server may issue the generated social data requests to the social networking services. The social network servers may parse the obtained search results(s), e.g., 3807, and query, e.g., 3808, their databases for social data falling within the scope of the search keywords. In response to the social data queries, the databases may provide social data, e.g., 3809, to the social networking servers. The social networking servers may return the social data obtained from the databases, e.g., 3810, to the pay network server making the social data requests. The pay network server may generate, e.g., 3811, and store the aggregated social data, e.g., 3812, in an aggregated social database.

FIG. 39 shows a data flow diagram illustrating an example procedure for enrollment in value-add services in some embodiments of the EOOR. In some implementations, a user, e.g., 3901, may desire to enroll in a value-added service. Let us consider an example wherein the user desires to enroll in social network authenticated purchase payment as a value-added service. It is to be understood that any other value-added service may take the place of the below-described value-added service. The user may communicate with a pay network server, e.g., 3903, via a client such as, but not limited to: a personal computer, mobile device, television, point-of-sale terminal, kiosk, ATM, and/or the like (e.g., 3902). For example, the user may provide user input, e.g., enroll input 3911, into the client indicating the user's desire to enroll in social network authenticated purchase payment. In various implementations, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. For example, the user may swipe a payment card at the client 3902. In some implementations, the client may obtain track 1 data from the user's card as enroll input 3911 (e.g., credit card, debit card, prepaid card, charge card, etc.), such as the example track 1 data provided below:

```
%B123456789012345\hat{ }PUBLIC/
J.Q.\hat{ }99011200000000000000**901******?*
(wherein ‘123456789012345’ is the card number of ‘J.Q. Public’ and
    has a CVV number of 901. ‘990112’ is a service code, and ***
    represents decimal digits which change randomly each time the
    card is used.)
```

In some implementations, using the user's input, the client may generate an enrollment request, e.g., 3912, and provide the enrollment request, e.g., 3913, to the pay network server. For example, the client may provide a (Secure) Hypertext Transfer Protocol (“HTTP(S)”) POST message including data formatted according to the eXtensible Markup Language (“XML”). Below is an example HTTP(S) POST message including an XML-formatted enrollment request for the pay network server:

```
POST /enroll.php HTTP/1.1
Host: www.merchant.com
Content-Type: Application/XML
Content-Length: 718
<?XML version = “1.0” encoding = “UTF-8”?>
<enrollment_request>
    <cart_ID>4NFU4RG94</order_ID>
    <timestamp>2011-02-22 15:22:43</timestamp>
    <user_ID>john.q.public@gmail.com</user_ID>
    <client_details>
            <client_IP>192.168.23.126</client_IP>
            <client_type>smartphone</client_type>
            <client_model>HTC Hero</client_model>
            <OS>Android 2.2</OS>
            <app_installed_flag>true</app_installed_flag>
    </client_details>
    <!--account_params> <optional>
            <account_name>John Q. Public</account_name>
            <account_type>credit</account_type>
            <account_num>123456789012345</account_num>
            <billing_address>123 Green St., Norman,
            OK 98765</billing_address>
            <phone>123-456-7809</phone>
            <sign>/jqp/</sign>
            <confirm_type>email</confirm_type>
            <contact_info>john.q.public@gmail.com</contact_info>
    </account_params-->
    <checkout_purchase_details>
            <num_products>1</num_products>
            <product>
                    <product_type>book</product_type>
                    <product_params>
                            <product_title>XML for
                            dummies</product_title>
                            <ISBN>938-2-14-168710-0</ISBN>
                            <edition>2nd ed.</edition>
                            <cover>hardbound</cover>
                            <seller>bestbuybooks</seller>
                    </product_params>
                    <quantity>1</quantity>
            </product>
    </checkout_purchase_details>
</enrollment_request>
```

In some implementations, the pay network server may obtain the enrollment request from the client, and extract the user's payment detail (e.g., XML data) from the enrollment request. For example, the pay network server may utilize a parser such as the example parsers described below in the discussion with reference to FIG. 61. In some implementations, the pay network server may query, e.g., 3914, a pay network database, e.g., 3904, to obtain a social network request template, e.g., 3915, to process the enrollment request. The social network request template may include instructions, data, login URL, login API call template and/or the like for facilitating social network authentication. For example, the database may be a relational database responsive to Structured Query Language (“SQL”) commands. The merchant server may execute a hypertext preprocessor (“PHP”) script including SQL commands to query the database for product data. An example PHP/SQL command listing, illustrating substantive aspects of querying the database, e.g., 3914-2915, is provided below:

<?PHP
header(‘Content-Type: text/plain’);
mysql_connect(“254.93.179.112”,$DBserver,$password); // access
database server
mysql_select_db(“SOCIALAUTH.SQL”); // select database table to
search
//create query
$query = “SELECT template FROM EnrollTable WHERE network LIKE
‘%’ $socialnet”;
$result = mysql_query($query); // perform the search query
mysql_close(“SOCIALAUTH.SQL”); // close database access
?>

In some implementations, the pay network server may redirect the client to a social network server by providing a HTTP(S) REDIRECT 300 message, similar to the example below:

```
HTTP/1.1 300 Multiple Choices
Location:
    https://www.facebook.com/dialog/oauth?client_id=
    snpa_app_ID&redirect_uri=www.paynetwork.com/enroll.php
<html>
    <head><title>300 Multiple Choices</title></head>
    <body><h1>Multiple Choices</h1></body>
</html>
```

In some implementations, the pay network server may provide payment information extracted from the card authorization request to the social network server as part of a social network authentication enrollment request, e.g., 3917. For example, the pay network server may provide a HTTP(S) POST message to the social network server, similar to the example below:

```
POST /authenticate_enroll.php HTTP/1.1
Host: www.socialnet.com
Content-Type: Application/XML
Content-Length: 1306
<?XML version = “1.0” encoding = “UTF-8”?>
<authenticate_enrollment_request>
    <request_ID>4NFU4RG94</order_ID>
    <timestamp>2011-02-22 15:22:43</timestamp>
    <user_ID>john.q.public@gmail.com</user_ID>
    <client_details>
            <client_IP>192.168.23.126</client_IP>
            <client_type>smartphone</client_type>
            <client_model>HTC Hero</client_model>
            <OS>Android 2.2</OS>
            <app_installed_flag>true</app_installed_flag>
    </client_details>
    <account_params>
            <account_name>John Q. Public</account_name>
            <account_type>credit</account_type>
            <account_num>123456789012345</account_num>
            <billing_address>123 Green St., Norman,
            OK 98765</billing_address>
            <phone>123-456-7809</phone>
            <sign>/jqp/</sign>
            <confirm_type>email</confirm_type>
            <contact_info>john.q.public@gmail.com</contact_info>
    </account_params>
</authenticate_enrollment_request>
```

In some implementations, the social network server may provide a social network login request, e.g., 3918, to the client. For example, the social network server may provide a HTML input form to the client. The client may display, e.g., 3919, the login form for the user. In some implementations, the user may provide login input into the client, e.g., 3920, and the client may generate a social network login response, e.g., 3921, for the social network server. In some implementations, the social network server may authenticate the login credentials of the user, and access payment account information of the user stored within the social network, e.g., in a social network database. Upon authentication, the social network server may generate an authentication data record for the user, e.g., 3922, and provide an enrollment notification, e.g., 3924, to the pay network server. For example, the social network server may provide a HTTP(S) POST message similar to the example below:

```
POST /enrollnotification.php HTTP/1.1
Host: www.paynet.com
Content-Type: Application/XML
Content-Length: 1306
<?XML version = “1.0” encoding = “UTF-8”?>
<enroll_notification>
    <request_ID>4NFU4RG94</order_ID>
    <timestamp>2011-02-22 15:22:43</timestamp>
    <result>enrolled</result>
</enroll_notification>
```

Upon receiving notification of enrollment from the social network server, the pay network server may generate, e.g., 3925, a user enrollment data record, and store the enrollment data record in a pay network database, e.g., 3926, to complete enrollment. In some implementations, the enrollment data record may include the information from the enrollment notification 3924.

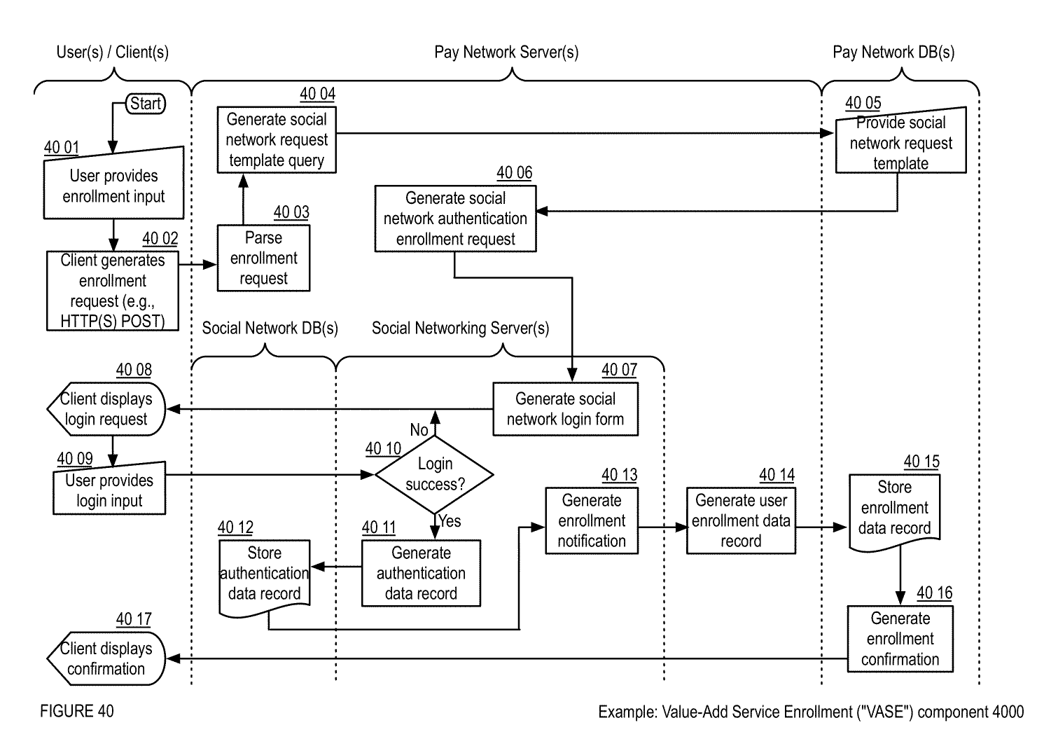

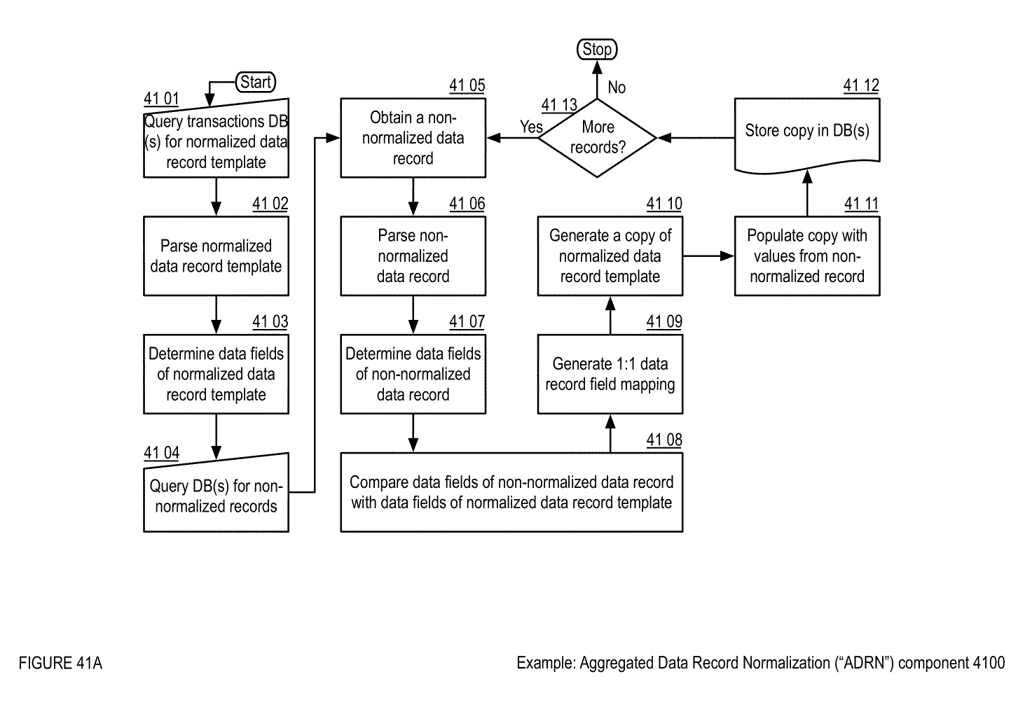

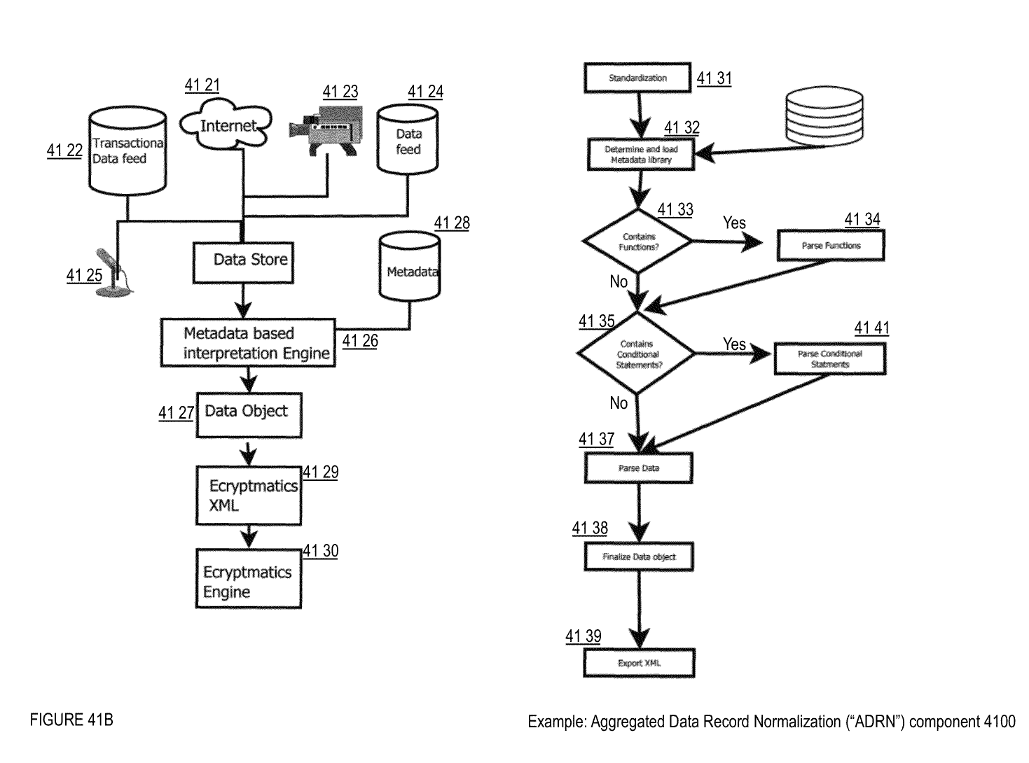

FIG. 40 shows a logic flow diagram illustrating example aspects of enrollment in a value-added service in some embodiments of the EOOR, e.g., a Value-Add Service Enrollment (“VASE”) component 4000. In some implementations, a user, e.g., 2901, may desire to enroll in a value-added service. Let us consider an example wherein the user desires to enroll in social network authenticated purchase payment as a value-added service. It is to be understood that any other value-added service may take the place of the below-described value-added service. The user may communicate with a pay network server via a client. For example, the user may provide user input, e.g., 4001, into the client indicating the user's desire to enroll in social network authenticated purchase payment. In various implementations, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. In some implementations, using the user's input, the client may generate an enrollment request, e.g., 4002, and provide the enrollment request to the pay network server. In some implementations, the SNPA may provide an enrollment button that may take the user to an enrollment webpage where account info may be entered into web form fields. In some implementations, the pay network server may obtain the enrollment request from the client, and extract the user's payment detail from the enrollment request. For example, the pay network server may utilize a parser such as the example parsers described below in the discussion with reference to FIG. 71. In some implementations, the pay network server may query, e.g., 4004, a pay network database to obtain a social network request template, e.g., 4005, to process the enrollment request. The social network request template may include instructions, data, login URL, login API call template and/or the like for facilitating social network authentication. In some implementations, the pay network server may provide payment information extracted from the card authorization request to the social network server as part of a social network authentication enrollment request, e.g., 4006. In some implementations, the social network server may provide a social network login request, e.g., 4007, to the client. For example, the social network server may provide a HTML input form to the client. The client may display, e.g., 4008, the login form for the user. In some implementations, the user may provide login input into the client, e.g., 4009, and the client may generate a social network login response for the social network server. In some implementations, the social network server may authenticate the login credentials of the user, and access payment account information of the user stored within the social network, e.g., in a social network database. Upon authentication, the social network server may generate an authentication data record for the user, e.g., 4011, and provide an enrollment notification to the pay network server, e.g., 4013. Upon receiving notification of enrollment from the social network server, the pay network server may generate, e.g., 4014, a user enrollment data record, and store the enrollment data record in a pay network database, e.g., 4015, to complete enrollment. The pay network server may provide an enrollment confirmation, and provide the enrollment confirmation to the client, which may display, e.g., 4017, the confirmation for the user.

FIGS. 41A-B show flow diagrams illustrating example aspects of normalizing aggregated search, enrolled, service usage, transaction and/or other aggregated data into a standardized data format in some embodiments of the EOOR, e.g., a Aggregated Data Record Normalization (“ADRN”) component 4100. With reference to FIG. 41A, in some implementations, a pay network server (“server”) may attempt to convert any aggregated data records stored in an aggregated records database it has access to in a normalized data format. For example, the database may have a transaction data record template with predetermined, standard fields that may store data in pre-defined formats (e.g., long integer/double float/4 digits of precision, etc.) in a pre-determined data structure. A sample XML transaction data record template is provided below:

```
<?XML version = “1.0” encoding = “UTF-8”?>
<transaction_record>
  <record_ID>00000000</record_ID>
  <norm_flag>false</norm_flag>
  <timestamp>yyyy-mm-dd hh:mm:ss</timestamp>
  <transaction_cost>$0,000,000,00</transaction_cost>
  <merchant_params>
    <merchant_id>00000000</merchant_id>
    <merchant_name>TBD</merchant_name>
    <merchant_auth_key>0000000000000000</merchant_auth_key>
  </merchant_params>
  <merchant_products>
    <num_products>000</num_products>
    <product>
      <product_type>TBD</product_type>
      <product_name>TBD</product_name>
      <class_labels_list>TBD<class_labels_list>
      <product_quantity>000</product_quantity>
      <unit_value>$0,000,000.00</unit_value>
      <sub_total>$0,000,000.00</sub_total>
      <comment>normalized transaction data record template</
      comment>
    </product>
  </merchant_products>
  <user_account_params>
    <account_name>JTBD</account_name>
    <account_type>TBD</account_type>
    <account_num>0000000000000000</account_num>
    <billing_line1>TBD</billing_line1>
    <billing_line2>TBD</billing_line2>
    <zipcode>TBD</zipcode>
    <state>TBD</state>
    <country>TBD</country>
    <phone>00-00-000-000-0000</phone>
    <sign>TBD</sign>
  </user_account_params>
</transaction_record>
```

In some implementations, the server may query a database for a normalized data record template, e.g., 4101. The server may parse the normalized data record template, e.g., 4102. Based on parsing the normalized data record template, the server may determine the data fields included in the normalized data record template, and the format of the data stored in the fields of the data record template, e.g., 4103. The server may obtain transaction data records for normalization. The server may query a database, e.g., 4104, for non-normalized records. For example, the server may issue PHP/SQL commands to retrieve records that do not have the ‘norm_flag’ field from the example template above, or those where the value of the ‘norm_flag’ field is ‘false’. Upon obtaining the non-normalized transaction data records, the server may select one of the non-normalized transaction data records, e.g., 4105. The server may parse the non-normalized transaction data record, e.g., 4106, and determine the fields present in the non-normalized transaction data record, e.g., 4107. For example, the server may utilize a procedure similar to one described below with reference to FIG. 32. The server may compare the fields from the non-normalized transaction data record with the fields extracted from the normalized transaction data record template. For example, the server may determine whether the field identifiers of fields in the non-normalized transaction data record match those of the normalized transaction data record template, (e.g., via a dictionary, thesaurus, etc.), are identical, are synonymous, are related, and/or the like. Based on the comparison, the server may generate a 1:1 mapping between fields of the non-normalized transaction data record match those of the normalized transaction data record template, e.g., 4109. The server may generate a copy of the normalized transaction data record template, e.g., 4110, and populate the fields of the template using values from the non-normalized transaction data record, e.g., 4111. The server may also change the value of the ‘norm_flag’ field to ‘true’ in the example above. The server may store the populated record in a database (for example, replacing the original version), e.g., 4112. The server may repeat the above procedure for each non-normalized transaction data record (see e.g., 4113), until all the non-normalized transaction data records have been normalized.

With reference to FIG. 41B, in some embodiments, the server may utilize metadata (e.g., easily configurable data) to drive an analytics and rule engine that may convert any structured data into a standardized XML format (“encryptmatics” XML). The encryptmatics XML may then be processed by an encryptmatics engine that is capable of parsing, transforming and analyzing data to generate decisions based on the results of the analysis. Accordingly, in some embodiments, the server may implement a metadata-based interpretation engine that parses structured data, including, but not limited to: web content (see e.g., 4121), graph databases (see e.g., 4122), micro blogs, images or software code (see e.g., 4124), and converts the structured data into commands in the encryptmatics XML file format. For example, the structured data may include, without limitation, software code, images, free text, relational database queries, graph queries, sensory inputs (see e.g., 4123, 4125), and/or the like. A metadata based interpretation engine, e.g., 4126, may populate a data/command object, e.g., 4127, based on a given record using configurable metadata, e.g., 4128. The configurable metadata may define an action for a given glyph or keyword contained within a data record. The engine may then process the object to export its data structure as a collection of encryptmatics vaults in a standard encryptmatics XML file format, e.g., 4129. The encryptmatics XML file may then be processed to provide various features by an encryptmatics engine, e.g., 4130.

In some embodiments, the server may obtain the structured data, and perform a standardization routine using the structured data as input (e.g., including script commands, for illustration). For example, the server may remove extra line breaks, spaces, tab spaces, etc. from the structured data, e.g. 4131. The server may determine and load a metadata library, e.g., 4132, using which the server may parse subroutines or functions within the script, based on the metadata, e.g., 4133-4134. In some embodiments, the server may pre-parse conditional statements based on the metadata, e.g., 4135-4136. The server may also parse data 4137 to populate a data/command object based on the metadata and prior parsing, e.g., 4138. Upon finalizing the data/command object, the server may export 4139 the data/command object as XML in standardized encryptmatics format.

FIG. 42 shows a logic flow diagram illustrating example aspects of recognizing data fields in normalized aggregated data records in some embodiments of the EOOR, e.g., a Data Field Recognition (“DFR”) component 4200. In some implementations, a server may recognize the type of data fields included in a data record, e.g, date, address, zipcode, name, user ID, email address, payment account number (PAN), CVV2 numbers, and/or the like. The server may select an unprocessed data record for processing, e.g., 4201. The server may parse the data record rule, and extract data fields from the data record, e.g., 4202. The server may query a database for data field templates, e.g., 4203. For example, the server may compare the format of the fields from the data record to the data record templates to identify a match between one of the data field templates and each field within the data record, thus identifying the type of each field within the data record. The server may thus select an extracted data field from the data record, e.g., 4204. The server may select a data field template for comparison with the selected data field, e.g., 4205, and compare the data field template with the selected data field, e.g., 4206, to determine whether format of extracted data field matches format of data field template, e.g., 4207. If the format of the selected extracted data field matches the format of the data field template, e.g., 4208, option “Yes,” the server may assign the type of data field template to the selected data field, e.g., 4209. If the format of the extracted data field does not match the format of the data field template, e.g., 4208, option “No,” the server may try another data field template until no more data field templates are available for comparison, see e.g., 4210. If no match is found, the server may assign “unknown” string as the type of the data field, e.g., 4211. The server may store the updated data record in the database, e.g., 4212. The server may perform such data field recognition for each data field in the data record (and also for each data record in the database), see e.g., 4213.

FIG. 43 shows a logic flow diagram illustrating example aspects of classifying entity types in some embodiments of the EOOR, e.g., an Entity Type Classification (“ETC”) component 4300. In some implementations, a server may apply one or more classification labels to each of the data records. For example, the server may classify the data records according to entity type, according to criteria such as, but not limited to: geo-political area, number of items purchased, and/or the like. The server may obtain transactions from a database that are unclassified, e.g., 4301, and obtain rules and labels for classifying the records, e.g., 4302. For example, the database may store classification rules, such as the exemplary illustrative XML-encoded classification rule provided below:

```
<rule>
  <id>PURCHASE_44_45</id>
  <name>Number of purchasers</name>
  <inputs>num_purchasers</inputs>
  <operations>
    <1>label = ‘null’</1>
    <2>IF (num_purchasers > 1) label = ‘household’</2>
  </operations>
  <outputs>label</outputs>
</rule>
```

The server may select an unclassified data record for processing, e.g., 4303. The server may also select a classification rule for processing the unclassified data record, e.g., 4304. The server may parse the classification rule, and determine the inputs required for the rule, e.g., 4305. Based on parsing the classification rule, the server may parse the normalized data record template, e.g., 4306, and extract the values for the fields required to be provided as inputs to the classification rule. The server may parse the classification rule, and extract the operations to be performed on the inputs provided for the rule processing, e.g., 4307. Upon determining the operations to be performed, the server may perform the rule-specified operations on the inputs provided for the classification rule, e.g., 4308. In some implementations, the rule may provide threshold values. For example, the rule may specify that if the number of products in the transaction, total value of the transaction, average luxury rating of the products sold in the transaction, etc. may need to cross a threshold in order for the label(s) associated with the rule to be applied to the transaction data record. The server may parse the classification rule to extract any threshold values required for the rule to apply, e.g., 4309. The server may compare the computed values with the rule thresholds, e.g., 4310. If the rule threshold(s) is crossed, e.g., 4311, option “Yes,” the server may apply one or more labels to the transaction data record as specified by the classification rule, e.g., 4312. For example, the server may apply a classification rule to an individual product within the transaction, and/or to the transaction as a whole. In some implementations, the server may process the transaction data record using each rule (see, e.g., 4313). Once all classification rules have been processed for the transaction record, e.g., 4313, option “No,” the server may store the transaction data record in a database, e.g., 4314. The server may perform such processing for each transaction data record until all transaction data records have been classified (see, e.g., 4315).

FIG. 44 shows a logic flow diagram illustrating example aspects of identifying cross-entity correlation in some embodiments of the EOOR, e.g., a Cross-Entity Correlation (“CEC”) component 4400. In some implementations, a server may recognize that two entites in the EOOR share common or related data fields, e.g, date, address, zipcode, name, user ID, email address, payment account number (PAN), CVV2 numbers, and/or the like, and thus identify the entities as being correlated. The server may select a data record for cross-entity correlation, e.g., 4401. The server may parse the data record rule, and extract data fields from the data record, e.g., 4402-3403. The server may select an extracted data field from the data record, e.g., 4404, and query a database for other data records having the same data field as the extracted data field, e.g., 4405. From the list of retrieved data records from the database query, the server may select a record for further analysis. The server may identify, e.g., 4407, an entity associated with the retrieved data record, e.g., using the ETC 4300 component discussed above in the description with reference to FIG. 43. The server may add a data field to the data record obtained for cross-entity correlation specifying the correlation to the retrieved selected data record, e.g., 4408. In some embodiments, the server may utilize each data field in the data record obtained for cross-entity correlation to identify correlated entities, see e.g., 4409. The server may add, once complete, a “correlated” flag to the data record obtained for cross-entity correlation, e.g., 4410, e.g., along with as timestamp specifying the time at which the cross-entity correlation was performed. For example, such a timestamp may be used to determine at a later time whether the data record should be processed again for cross-entity correlation. The server may store the updated data record in a database.

FIG. 45 shows a logic flow diagram illustrating example aspects of associating attributes to entities in some embodiments of the EOOR, e.g., an Entity Attribute Association (“EAA”) component 4500. In some implementations, a server may associate attributes to an entity, e.g., if the entity id a person, the server may identify a demographic (e.g., male/female), a spend character, a purchase preferences list, a merchants preference list, and/or the like, based on field values of data fields in data records that are related to the entity. In some implementations, a server may obtain a data record for entity attribute association, e.g., 4501. The server may parse the data record rule, and extract data fields from the data record, e.g., 4502-3503. The server may select an extracted data field from the data record, e.g., 4504, and identify a field value for the selected extracted data field from the data record, e.g., 4505. The server may query a database for demographic data, behavioral data, and/or the like, e.g., 4506, using the field value and field type. In response, the database may provide a list of potential attributes, as well as a confidence level in those attribute associations to the entity, see e.g., 4507. The server may add data fields to the data record obtained for entity attribute association specifying the potentially associated attributes and their associated confidence levels, e.g., 4508. In some embodiments, the server may utilize each data field in the data record obtained for cross-entity correlation to identify correlated entities, see e.g., 4509. The server may store the updated data record in a database, e.g., 4510.

FIG. 46 shows a logic flow diagram illustrating example aspects of updating entity profile-graphs in some embodiments of the EOOR, e.g., an Entity Profile-Graph Updating (“EPGU”) component 4600. In some implementations, a server may generate/update a profile for an entity whose data is stored within the EOOR. The server may obtain an entity profile record for updating, e.g., 4601. The server may parse the entity profile record, and extract an entity identifier data field from the data record, e.g., 4602. The server may query a database for other data records that are related to the same entity, e.g., 4603, using the value for the entity identifier data field. In response, the database may provide a list of other data records for further processing. The server may select one of the other data records to update the entity profile record, e.g., 4604. The server may parse the data record, and extract all correlations, associations, and new data from the other record, e.g., 4605. The server may compare the correlations, attributes, associations, etc., from the other data record with the correlations, associations and attributes from the entity profile. Based on this comparison, the server may identify any new correlations, associations, etc., and generate an updated entity profile record using the new correlations, associations; flag new correlations, associations for further processing, e.g., 4607. In some embodiments, the server may utilize each data record obtained for updating the entity profile record as well as its social graph (e.g., as given by the correlations and associations for the entity), see e.g., 4609. The server may store the updated entity profile record in a database, e.g., 4608.

FIG. 47 shows a logic flow diagram illustrating example aspects of generating search terms for profile-graph updating in some embodiments of the EOOR, e.g., a Search Term Generation (“STG”) component 4700. In some implementations, a server may generate/update a profile for an entity whose data is stored within the EOOR, by performing search for new data, e.g., across the Internet and social networking services. The server may obtain an entity profile record for updating, e.g., 4701. The server may parse the entity profile record, and extract data field types and field values from the entity profile record, e.g., 4702. The server may query a database for other data records that are related to the same entity, e.g., 4703, using the values for the extracted data fields. In response, the database may provide a list of other data records for further processing. The server may parse the data records, and extract all correlations, associations, and data from the data records, e.g., 4704. The server may aggregate all the data values from all the records and the entity profile record, e.g., 4705. Based on this, the server may return the aggregated data values as search terms to trigger search processes (see e.g., FIG. 30, 3001-3005), e.g., 4706.

FIG. 48 shows a logic flow diagram illustrating example aspects of analyzing a user's behavior based on aggregated purchase transaction data in some embodiments of the EOOR, e.g., a User Behavior Analysis (“UBA”) component 4800. In some implementations, a pay network server (“server”) may obtain a user ID of a user for whom the server is required to generate user behavioral patterns, e.g., 4801. The server may query a database, e.g., a pay network database, for aggregated card transaction data records of the user, e.g., 4802. The server may also query, e.g., 4803, the pay network database for all possible field value that can be taken by each of the field values (e.g., AM/PM, zipcode, merchant_ID, merchant_name, transaction cost brackets, etc.). Using the field values of all the fields in the transaction data records, the server may generate field value pairs, for performing a correlation analysis on the field value pairs, e.g., 4804. An example field value pair is: ‘time’ is ‘AM’ and ‘merchant’ is ‘Walmart’. The server may then generate probability estimates for each field value pair occurring in the aggregated transaction data records. For example, the server may select a field value pair, e.g., 4805. The server may determine the number of records within the aggregated transaction data records where the field value pair occurs, e.g., 4806. The server may then calculate a probability quotient for the field value pair by dividing the number determined for the occurrences of the field value pair by the total number of aggregate transaction data records, e.g., 4807. The server may also assign a confidence level for the probability quotient based on the sample size, e.g., total number of records in the aggregated transaction data records, e.g., 4808. The server may generate and store an XML snippet, including the field value pair, the probability quotient, and the confidence level associated with the probability quotient, e.g., 4809. The server may perform such a computation for each field value pair (see 4810) generated in 4804.

FIG. 49 shows a logic flow diagram illustrating example aspects of generating recommendations for a user based on the user's prior aggregate purchase transaction behavior in some embodiments of the EOOR, e.g., a User Behavior-Based Offer Recommendations (“UBOR”) component 4900. In some implementations, a pay network server (“server”) may obtain a user ID of a user for whom the server is required to generate offer recommendations, e.g., 4901. The server may obtain a list of products included in a card authorization request for processing the purchase transaction for the user, e.g., 4902. The server may also query a database for pre-generated pair-wise correlations of various user transaction-related variables, e.g., 4902b, such as those generated by the UBA 4800 component described above with reference to FIG. 38. The server may select a product from the list of products included in the card authorization request, e.g., 4903. The server may identify all field pair-correlation values where the selected product was the independent field into the field-pair correlation, e.g., 4904. The server may, e.g., 4905, from among the identified field-pair values, identify the product that was the dependent field value for the field value pair having the highest probability quotient (e.g., product most likely to be bought together with the product selected from the product list included in the card authorization request). The server may store the identified product, along with its associated prediction confidence level, in a queue of products for recommendation, e.g., 4906. The server may perform the analysis for each product included in the product list from the card authorization request, see e.g., 4907.

In some implementations, upon completing such an analysis for all the products in the card authorization request, the server may sort the queue according to their associated probability quotient and prediction confidence level, e.g., 4908. For example, if the prediction confidence level of a product is higher than a threshold, then it may be retained in the queue, but not if the prediction confidence level is lower than the threshold. Also, the retained products may be sorted in descending order of their associated probability quotients. In some implementations, the server may eliminate any duplicated products form the queue, e.g., 4909. The server may return the sorted queue of products for product offer recommendation, e.g., 4910.

FIG. 50 shows a block diagram illustrating example aspects of payment transactions via social networks in some embodiments of the EOOR. In some embodiments, the EOOR may facilitate per-2-person transfers 5010 of money via social networks. For example, a user (user1 5011) may wish to provide funds (dollars, rewards, points, miles, etc. 5014) to another user (user2 5016). The user may utilize a virtual wallet to provide a source of funds. In some embodiments, the user may utilize a device 5012 (such as a smartphone, mobile device, laptop computer, desktop computer, and/or the like) to send a social post message via the social network 5015. In some embodiments, the social post message may include information on an amount of funds to be transferred and an identity of another user to whom the funds should be transferred. The EOOR may intercept the message before it is sent to the social networking service, or it may obtain the message from the social networking service. Using the social post message, the EOOR may resolve the identities of a payor and payee in the transaction. The EOOR may identify accounts of the payor and payee to/from which funds need be credited or debited, and an amount of credit/debit to apply to each of the accounts. The EOOR may, on the basis of resolving this information, execute a transaction to transfer funds from the payor to the payee. For example, the EOOR may allow a payor, by sending a tweet on Twitter™ such as “$25 @jfdoe #ackpls” to transfer funds to a payee (user ID @jfdoe), and request an acknowledgement from EOOR of receipt of funds. In another example, the EOOR may allow a potential payee to request funds from another user by sending a tweet on Twitter™ such as “@johnq, you owe me 50000 Visa rewards points #id1234”; the EOOR may automatically provide an alert within a virtual wallet application of the user with user ID johnq to provide the funds to the potential payee user. The user johnq may respond by sending a tweet in response, referencing the id (#id1234), such as “50000 vpts @jfdoe #id1234”; the EOOR may transfer the funds and recognize transaction request #id1234 as being fulfilled. In some embodiments, the EOOR may generate transaction/request ID numbers for the users to prevent coinciding transaction/request ID numbers for different transaction/requests.

In some embodiments, the EOOR may utilize one or more social networking services (e.g., Facebook®, Twitter™, MySpace™, etc.). In some embodiments, the EOOR may allow users across different social networks to transact with each other. For example, a user may make a request for payment on one social network. As an example, a Twitter™ user may tweet “@johnq@facebook.com, you owe me 500 vpts #ID7890”). The EOOR may provide an alert to the user with ID johnq@facebook.com either via the other social networking or via the user's virtual wallet. In response, the payee may social post to Facebook® a message “@jfdoe: here's your 500 vpts #ID7890”, and the EOOR may facilitate the payment transaction and provide a receipt/acknowledgment to the two users on their respective social networks or virtual wallets.

In some embodiments, the EOOR may facilitate transfers of funds to more than one payee by a payor via a single social post message. In some embodiments, the EOOR may facilitate use of more than one source of funds of a payee to fund payment of funds to one or more payors via a single post message. For example, the EOOR may utilize default settings or customized rules, stored within a virtual wallet of a payor, to determine which funding sources to utilize to fund a payment transaction to one or more payees via a social post message.

In some implementations, the EOOR may facilitate merchants to make offers of products and/or services to consumers via social networks 5020. For example, a merchant 5026 may sign up to participate in the EOOR. The EOOR may aggregate transactions of a user, and determine any products or services that may relevant for offering to the user. The EOOR may determine whether any participating merchants are available to provide the products or services for the users. If so, the EOOR may provide social post messages via a social network 5025 on behalf of the merchants (or, alternatively, inform the merchants who may then send social post messages to the users) providing the offers 5024a to the user 5021. An example of an offer to the followers of a merchant on may be “@amazon offers the new Kindle™ at only $149.99-click here to buy.” In such an example, the offer posted on the social networking site may have a link embedded (e.g., “here”) that users can click to make the purchase (which may be automatically performed with one-click if they are currently logged into their virtual wallet accounts 5023). Another example of a merchant offer may be “@amazon offers the new Kindle™ at only $149.99—reply with #offerID123456 to buy.” In such an example, the hash tag value serves as an identifier of the offer, which the users can reference when making their purchase via their social post messages (e.g., “buy from @amazon #offerID123456”). In some embodiments, merchants may provide two or more offers via a single social post message. In some embodiments, users may reference two or more offers in the same social post message.

In some implementations, users and/or merchants may utilize alternate messaging modes. For example, a user may be able to utilize electronic mail, SMS messages, phone calls, etc., to communicate with the EOOR and the social networks. For example, a merchant may provide a social post message offer such as ““@amazon offers the new Kindle™ at only $149.99—text #offerID123456 to buy”. When a user utilize a mobile phone to send a text message to redeem the offer, the EOOR may utilize a user profile of the user store on the social networking service to identify an identifying attribute of the user's mobile phone (e.g., a phone number), using which the EOOR may correlate the text message to a particular user. Thus, the EOOR may be able to process a transaction with the merchant on behalf of the user, using user information from the user's virtual wallet. In some embodiments where a social network is incapable of handling a particular mode of communication, the EOOR may serve as an intermediary translator to convert the message to a form that can be utilized by the social network.

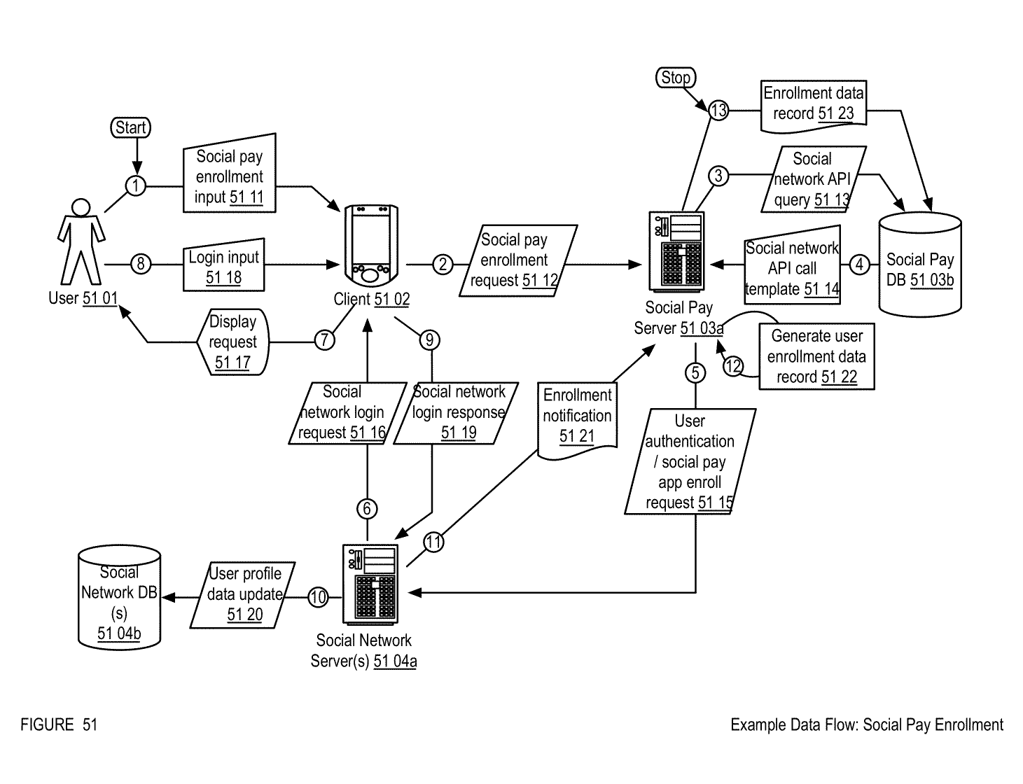

FIG. 51 shows a data flow diagram illustrating an example social pay enrollment procedure in some embodiments of the EOOR. In some embodiments, a user, e.g., 5101, may desire to enroll in EOOR. The user may communicate with a social pay server, e.g., 5103a, via a client such as, but not limited to: a personal computer, mobile device, television, point-of-sale terminal, kiosk, ATM, and/or the like (e.g., 5102). For example, the user may provide user input, e.g., social pay enrollment input 5111, into the client indicating the user's desire to enroll in social network authenticated purchase payment. In various implementations, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like.

In some implementations, using the user's input, the client may generate a social pay enrollment request, e.g., 5112, and provide the enrollment request to the social pay server 5103a. For example, the client may provide a (Secure) Hypertext Transfer Protocol (“HTTP(S)”) POST message including data formatted according to the eXtensible Markup Language (“XML”). Below is an example HTTP(S) POST message including an XML-formatted enrollment request for the social pay server:

```
POST /enroll.php HTTP/1.1
Host: www.socialpay.com
Content-Type: Application/XML
Content-Length: 484
<?XML version = “1.0” encoding = “UTF-8”?>
<enrollment_request>
  <request_ID>4NFU4RG94</request_ID>
  <timestamp>2011-02-22 15:22:43</timestamp>
  <user_ID>john.q.public@facebook.com</user_ID>
  <wallet_account_ID>7865493028712345</wallet_account_ID>
  <client_details>
    <client_IP>192.168.23.126</client_IP>
    <client_type>smartphone</client_type>
    <client_model>HTC Hero</client_model>
    <OS>Android 2.2</OS>
    <app_installed_flag>true</app_installed_flag>
  </client_details>
</enrollment_request>
```

In some embodiments, the social pay server may obtain the enrollment request from the client, and extract the user's payment detail (e.g., XML data) from the enrollment request. For example, the social pay server may utilize a parser such as the example parsers described below in the discussion with reference to FIG. 71. In some implementations, the social pay server may query, e.g., 5113, a social pay database, e.g., 5103b, to obtain a social network request template, e.g., 5114, to process the enrollment request. The social network request template may include instructions, data, login URL, login API call template and/or the like for facilitating social network authentication. For example, the database may be a relational database responsive to Structured Query Language (“SQL”) commands. The merchant server may execute a hypertext preprocessor (“PHP”) script including SQL commands to query the database for product data. An example PHP/SQL command listing, illustrating substantive aspects of querying the database, e.g., 5114-4115, is provided below:

<?PHP
header(‘Content-Type: text/plain’);
mysql_connect(“254.93.179.112”, $DBserver, $password); //
access database server
mysql_select_db(“SOCIALPAY.SQL”); // select database table
to search //create query
$query = “SELECT template FROM EnrollTable WHERE
network LIKE ‘%’ $socialnet”;
$result = mysql_query($query); // perform the search query
mysql_close(“SOCIALAUTH.SQL”); // close database access
?>

In some implementations, the social pay server may redirect the client to a social network server, e.g., 5104a, by providing a HTTP(S) REDIRECT 300 message, similar to the example below:

```
HTTP/1.1 300 Multiple Choices
Location:
  https://www.facebook.com/dialog/oauth?client_id=
  snpa_app_ID&redirect_uri=www.paynetwork.com/
  enroll.php
<html>
  <head><title>300 Multiple Choices</title></head>
  <body><h1>Multiple Choices</h1></body>
</html>
```

In some implementations, the social pay server may provide information extracted from the social pay enrollment request to the social network server as part of a user authentication/social pay app enroll request, e.g., 5115. For example, the social pay server may provide a HTTP(S) POST message to the social network server, similar to the example below:

```
POST /authenticate_enroll.php HTTP/1.1
Host: www.socialnet.com
Content-Type: Application/XML
Content-Length: 484
<?XML version = “1.0” encoding = “UTF-8”?>
<enrollment_request>
  <request_ID>4NFU4RG94</request_ID>
  <timestamp>2011-02-22 15:22:43</timestamp>
  <user_ID>john.q.public@facebook.com</user_ID>
  <wallet_account_ID>7865493028712345</wallet_account_ID>
  <client_details>
    <client_IP>192.168.23.126</client_IP>
    <client_type>smartphone</client_type>
    <client_model>HTC Hero</client_model>
    <OS>Android 2.2</OS>
    <app_installed_flag>true</app_installed_flag>
  </client_details>
</enrollment_request>
```

In some implementations, the social network server may provide a social network login request, e.g., 5116, to the client. For example, the social network server may provide a HTML input form to the client. The client may display, e.g., 5117, the login form for the user. In some implementations, the user may provide login input into the client, e.g., 5118, and the client may generate a social network login response, e.g., 5119, for the social network server. In some implementations, the social network server may authenticate the login credentials of the user, and upon doing so, update the profile of the user to indicate the user's enrollment in the social pay system. For example, in a social networking service such as Facebook®, the social network server may provide permission to a social pay third-party developer app to access the user's information stored within the social network. In some embodiments, such enrollment may allow a virtual wallet application installed on a user device of to access the user's social profile information stored within the social network. Upon authentication, the social network server may generate an updated data record for the user, e.g., 5120, and provide an enrollment notification, e.g., 5121, to the social pay server. For example, the social network server may provide a HTTP(S) POST message similar to the example below:

```
POST /enrollnotification.php HTTP/1.1
Host: www.socialpay.com
Content-Type: Application/XML
Content-Length: 1306
<?XML version = “1.0” encoding = “UTF-8”?>
<enroll_notification>
  <request_ID>4NFU4RG94</order_ID>
  <timestamp>2011-02-22 15:22:43</timestamp>
  <result>enrolled</result>
</enroll_notification>
```

Upon receiving notification of enrollment from the social network server, the social pay server may generate, e.g., 5122, a user enrollment data record, and store the enrollment data record in a social pay database, e.g., 5123, to complete enrollment. In some implementations, the enrollment data record may include the information from the enrollment notification 5121.

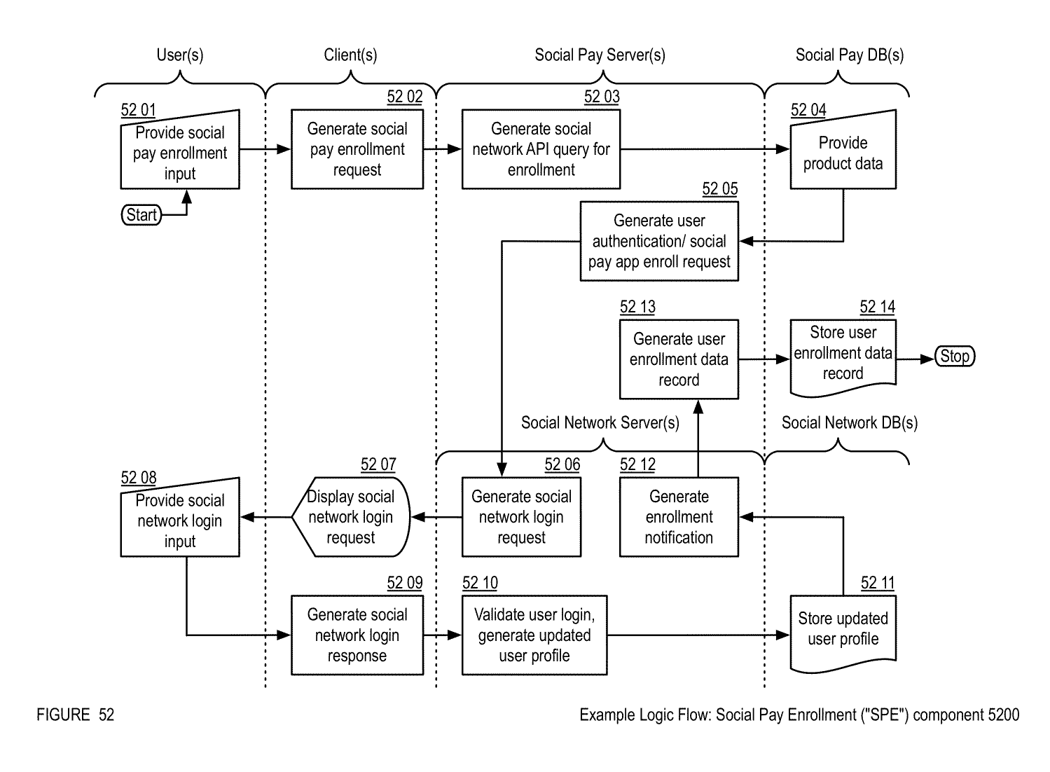

FIG. 52 shows a logic flow diagram illustrating example aspects of social pay enrollment in some embodiments of the EOOR, e.g., a Social Pay Enrollment (“SPE”) component 5200. In some embodiments, a user may desire to enroll in EOOR. The user may provide user input, e.g., social pay enrollment input 5201, into the client indicating the user's desire to enroll in social network authenticated purchase payment. In some implementations, using the user's input, the client may generate a social pay enrollment request, e.g., 5202, and provide the enrollment request to the social pay server. In some embodiments, the social pay server may obtain the enrollment request from the client, and extract the user's payment detail (e.g., XML data) from the enrollment request. For example, the social pay server may utilize a parser such as the example parsers described below in the discussion with reference to FIG. 71. In some implementations, the social pay server may query, e.g., 5203, a social pay database to obtain a social network request template to process the enrollment request. The social network request template may include instructions, data, login URL, login API call template and/or the like for facilitating social network authentication. In some implementations, the social pay server may redirect the client to a social network server. In some implementations, the social pay server may provide information extracted from the social pay enrollment request to the social network server as part of a user authentication/social pay app enroll request, e.g., 5205. In some implementations, the social network server may provide a social network login request, e.g., 5206, to the client. For example, the social network server may provide a HTML input form to the client. The client may display, e.g., 5207, the login form for the user. In some implementations, the user may provide login input into the client, e.g., 5208, and the client may generate a social network login response, e.g., 5209, for the social network server. In some implementations, the social network server may authenticate the login credentials of the user, and upon doing so, update the profile of the user to indicate the user's enrollment in the social pay system. For example, in a social networking service such as Facebook®, the social network server may provide permission to a social pay third-party developer app to access the user's information stored within the social network. In some embodiments, such enrollment may allow a virtual wallet application installed on a user device of to access the user's social profile information stored within the social network. Upon authentication, the social network server may generate an updated data record for the user, e.g., 5210-4211, and provide an enrollment notification, e.g., 5212 to the social pay server. Upon receiving notification of enrollment from the social network server, the social pay server may generate, e.g., 5213, a user enrollment data record, and store the enrollment data record in a social pay database, e.g., 314, to complete enrollment. In some implementations, the enrollment data record may include the information from the enrollment notification.

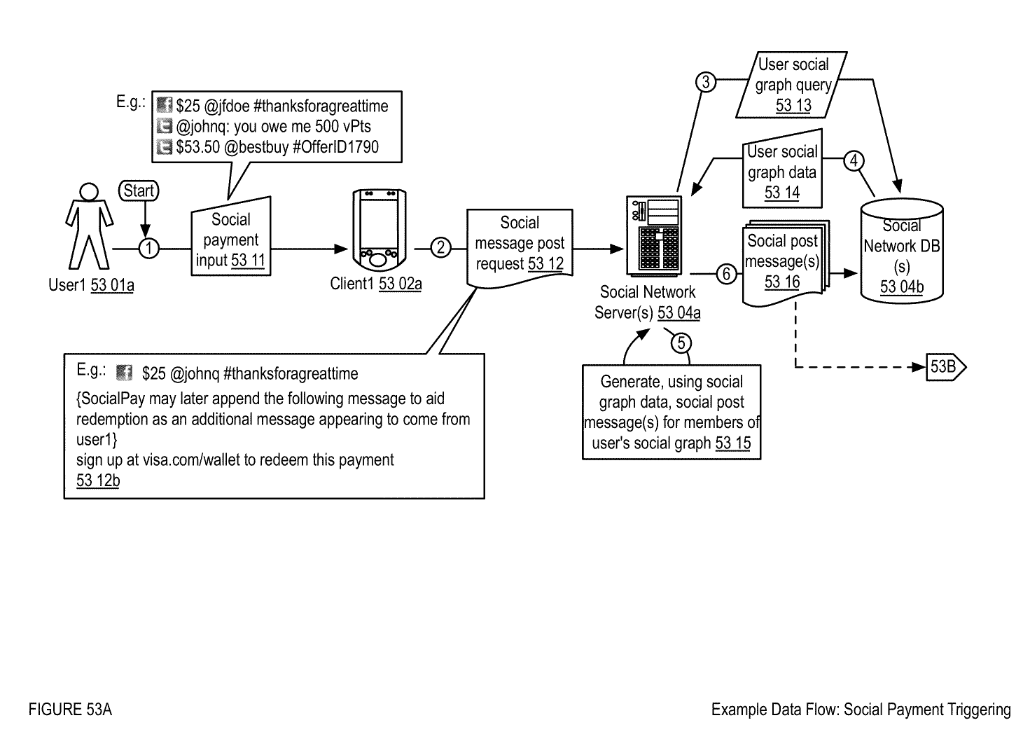

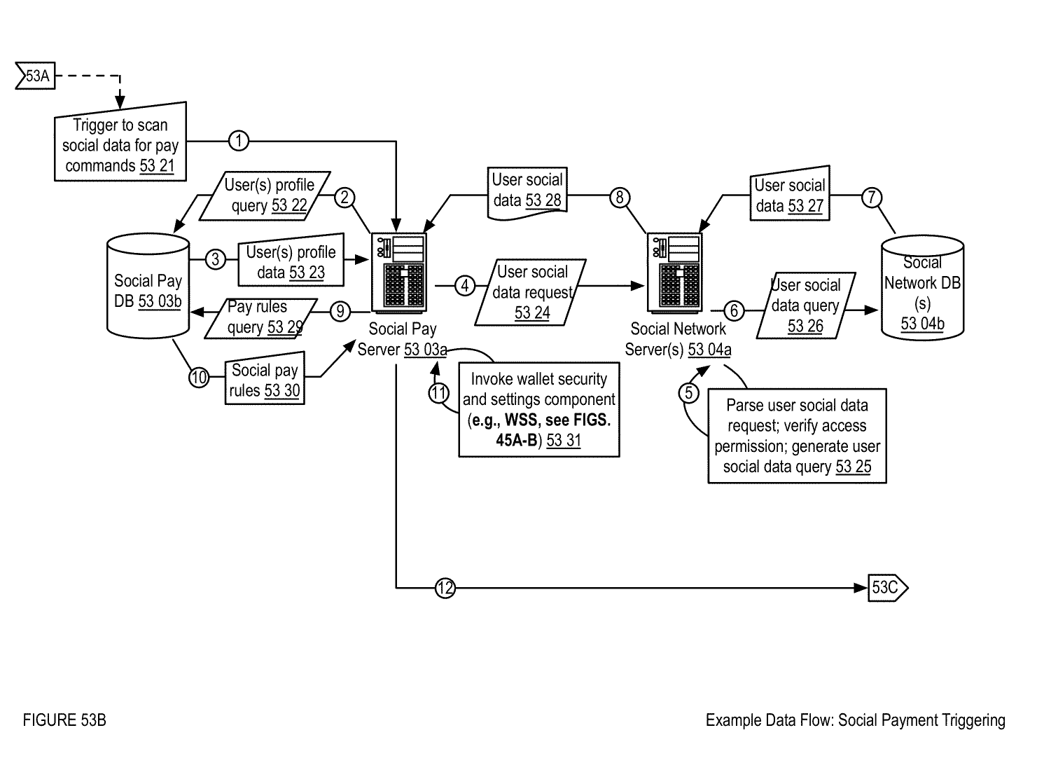

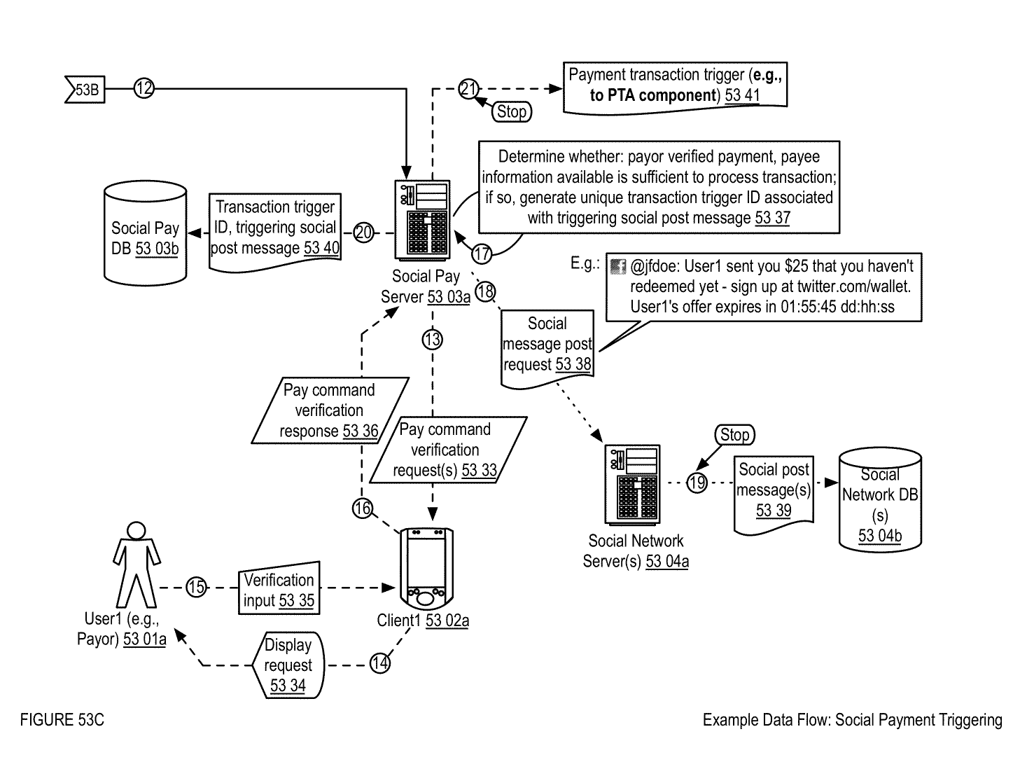

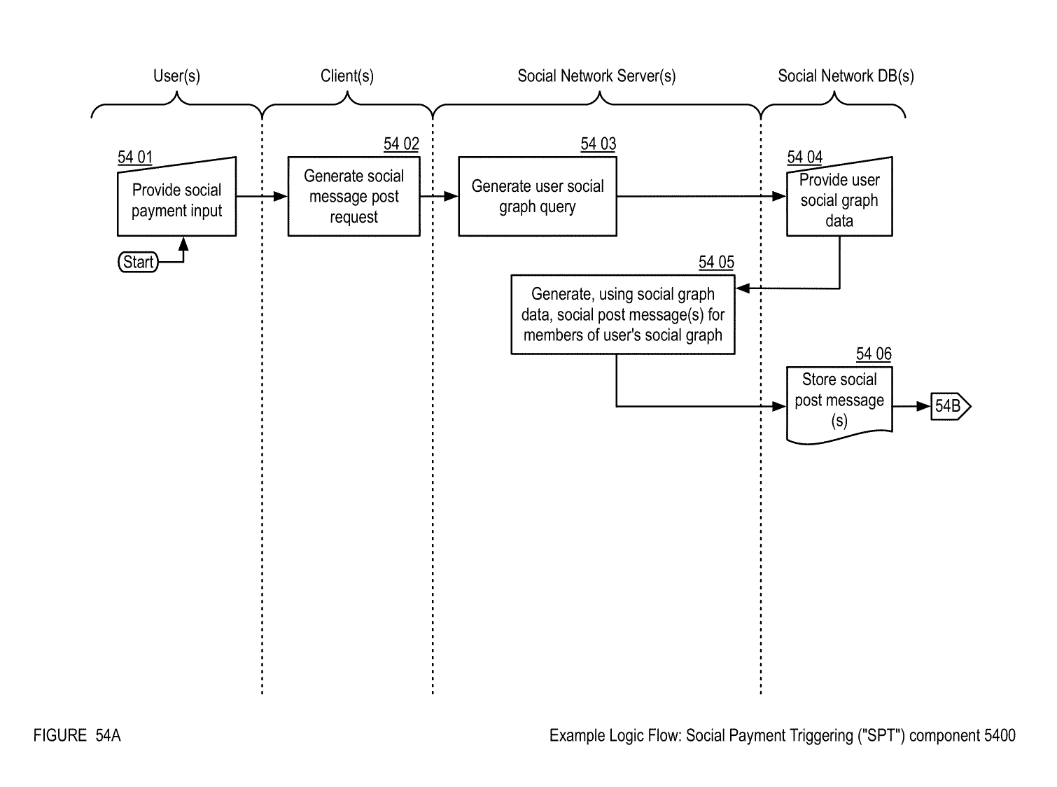

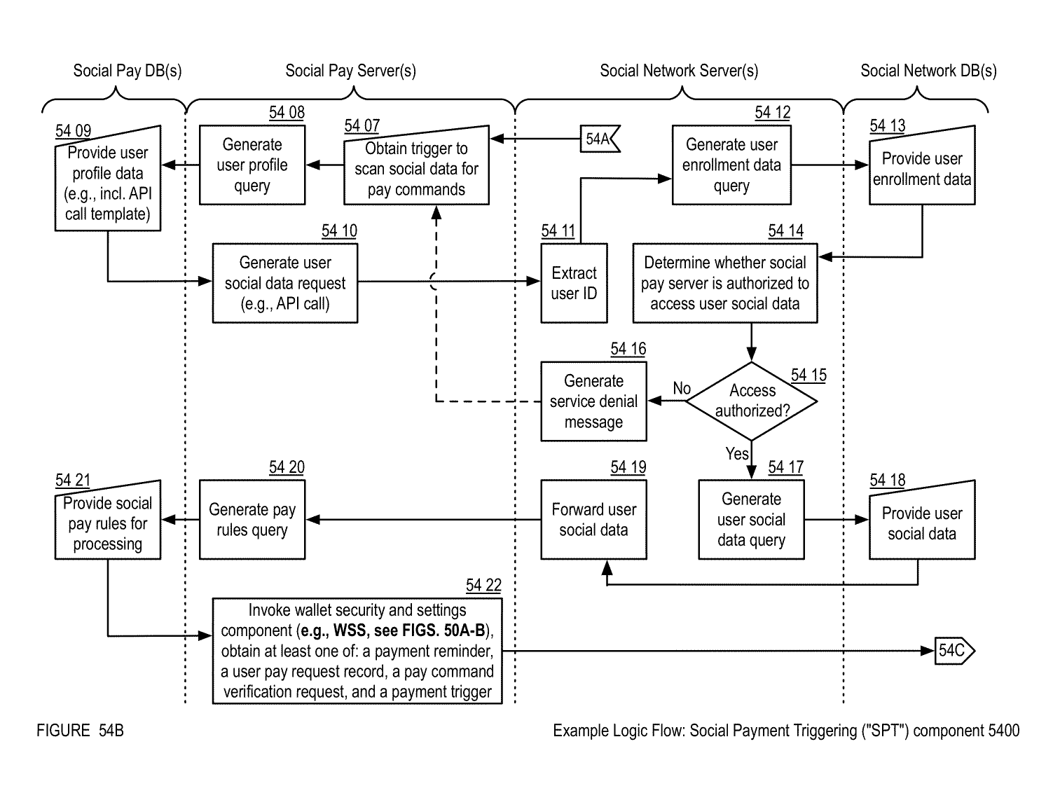

FIGS. 53A-C show data flow diagrams illustrating an example social payment triggering procedure in some embodiments of the EOOR. With reference to FIG. 53A, in some embodiments, a user, e.g., user1 5301a, may desire to provide or request funds from another (e.g., a user, a participating merchant, etc.). The user may communicate with a social network server, e.g., 5303a, via a client (client1 5302a) such as, but not limited to: a personal computer, mobile device, television, point-of-sale terminal, kiosk, ATM, and/or the like. For example, the user may provide social payment input 5311, into the client indicating the user's desire to provide or request funds from another. In various embodiments, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. In response, the client may provide a social message post request 5312 to the social network server. In some implementations, a virtual wallet application executing on the client may provide the user with an easy-to-use interface to generate and send the social message post request. In alternate implementations, the user may utilize other applications to provide the social message post request. For example, the client may provide a social message post request to the social network server server as a HTTP(S) POST message including XML-formatted data. An example listing of a social message post request 5312, substantially in the form of a HTTP(S) POST message including XML-formatted data, is provided below:

```
POST /socialpost.php HTTP/1.1
Host: www.socialnetwork.com
Content-Type: Application/XML
Content-Length: 310
<?XML version = “1.0” encoding = “UTF-8”?>
<message_post_request>
  <request_ID>value</request_ID>
  <timestamp>2011-02-02 03:04:05</timestamp>
  <sender_id>jfdoe@facebook.com</sender_id>
  <receiver_id>johnqp@facebook.com</receiver_id>
  <message>$25 @johnqp #thanksforagreattimelastnite</message>
</message_post_request>
```

In some embodiments, the social network server 5304a may query its social network database for a social graph of the user, e.g., 5313. For example, the social network server may issue PHP/SQL commands to query a database table (such as FIG. 71, Social Graph 7119p) for social graph data associated with the user. An example user social graph query 5313, substantially in the form of PHP/SQL commands, is provided below:

```
<?PHP
header(‘Content-Type: text/plain’);
mysql_connect(“254.93.179.112”,$DBserver,$password); // access
database server
mysql_select_db(“EOOR_DB.SQL”); // select database table to search
//create query
$query = “SELECT friend_name friend_type friend_weight message_
  params_list messaging_restrictions FROM SocialGraphTable WHERE
  user LIKE ‘%’ $user_id”;
$result = mysql_query($query); // perform the search query
mysql_close(“EOOR_DB.SQL”); // close database access
?>
```

In some embodiments, the social network database may provide the requested social graph data in response, e.g., 5314. Using the social graph data, the social network server may generate message(s) as appropriate for the user and/or members of the user's social graph, e.g., 5315, and store the messages 5316 for the user and/or social graph members.

With reference to FIG. 53B, in some embodiments, such posting of social messages may trigger EOOR actions. For example, a social pay server 5303a may be triggered to scan the social data for pay commands. In embodiments where every social post message originates from the virtual wallet application of a user, the EOOR may optionally obtain the pay commands from the virtual wallet applications, and skip scanning the social networks for pay commands associated with the user. In embodiments where a user is allowed to issue pay commands from any device (even those not linked to the user's virtual wallet), the EOOR may periodically, or even continuously scan the social networks for pay commands, e.g., 5321. In embodiments where the EOOR scans the social networks, the social pay server may query a social pay database for a profile of the user. For example, the social pay server may request a user ID and password for the social networks that the user provided to the social pay server during the enrollment phase (see, e.g., FIGS. 51-52). For example, the social pay server may issue PHP/SQL commands to query a database table (such as FIG. 71, Users 7119a) for user profile data. An example user profile data query 5322, substantially in the form of PHP/SQL commands, is provided below:

<?PHP
header(‘Content-Type: text/plain’);
mysql_connect(“254.93.179.112”,$DBserver,$password); // access
database server
mysql_select_db(“EOOR_DB.SQL”); // select database table to search
//create query
$query = “SELECT network_id network_name network_api user_login
user_pass FROM UsersTable WHERE userid LIKE ‘%’ $user_id”;
$result = mysql_query($query); // perform the search query
mysql_close(“EOOR_DB.SQL”); // close database access
?>

In response, the social pay database may provide the requested information, e.g., 5323. In some embodiments, the social pay server may provide a user social data request 5324 to the social network server. An example listing of commands to issue a user social data request 5324, substantially in the form of PHP commands, is provided below:

```
<?PHP
header(‘Content-Type: text/plain’);
// Obtain user ID(s) of friends of the logged-in user
$friends =
  json_decode(file_get_contents(‘https://graph.facebook.com/me/friends?
  access token=’$cookie[‘oauth_access_token’]), true);
$friend_ids = array_keys($friends);
// Obtain message feed associated with the profile of the logged-in user
$feed =
  json_decode(file_get_contents(‘https:llgraph.facebook.com/me/feed?
  access_token=’$cookie[‘oauth_access_token’]), true);
// Obtain messages by the user's friends
$result = mysql_query(‘SELECT * FROM content WHERE uid IN
  (’ .implode($friend_ids, ‘,’) . ‘)’);
$friend_content = array( );
while ($row = mysql_fetch_assoc($result))
$friend_content [ ] $row;
?>
```

In some embodiments, the social network server may query, e.g., 5326, it social network database 5304b for social data results falling within the scope of the request. In response to the query, the database may provide social data, e.g., 5327. The social network server may return the social data obtained from the databases, e.g., 5328, to the social pay server. An example listing of user social data 5328, substantially in the form of JavaScript Object Notation (JSON)-formatted data, is provided below:

| | |
|---|---|
| [ “data”: | [ |
| | { “name”: “Tabatha Orloff”, |
| | “id”: “483722”}, |
| | { “name”: “Darren Kinnaman”, |
| | “id”: “86S743”}, |
| | { “name”: “Sharron Jutras”, |
| | “id”: “091274”} |
| ] } | |

In some embodiments, the social pay server may query the social pay database for social pay rules, e.g., 5329. For example, the social pay server may issue PHP/SQL commands to query a database table (such as FIG. 71, Social Pay Rules 7119q) for the social pay rules 5330. An example pay rules query 5329, substantially in the form of PHP/SQL commands, is provided below:

<?PHP
header(‘Content-Type: text/plain’);
mysql_connect(“254.93.179.112”,$DBserver,$password); // access database
server
mysql_select_db(“EOOR_DB.SQL”); // select database table to search
//create query
$query = “SELECT rule_id rule_type rule_description rule_priority rule_
source FROM SocialPayRulesTable WHERE rule_type LIKE pay_rules”;
$result = mysql_query($query); // perform the search query
mysql_close(“EOOR_DB.SQL”); // close database access
?>

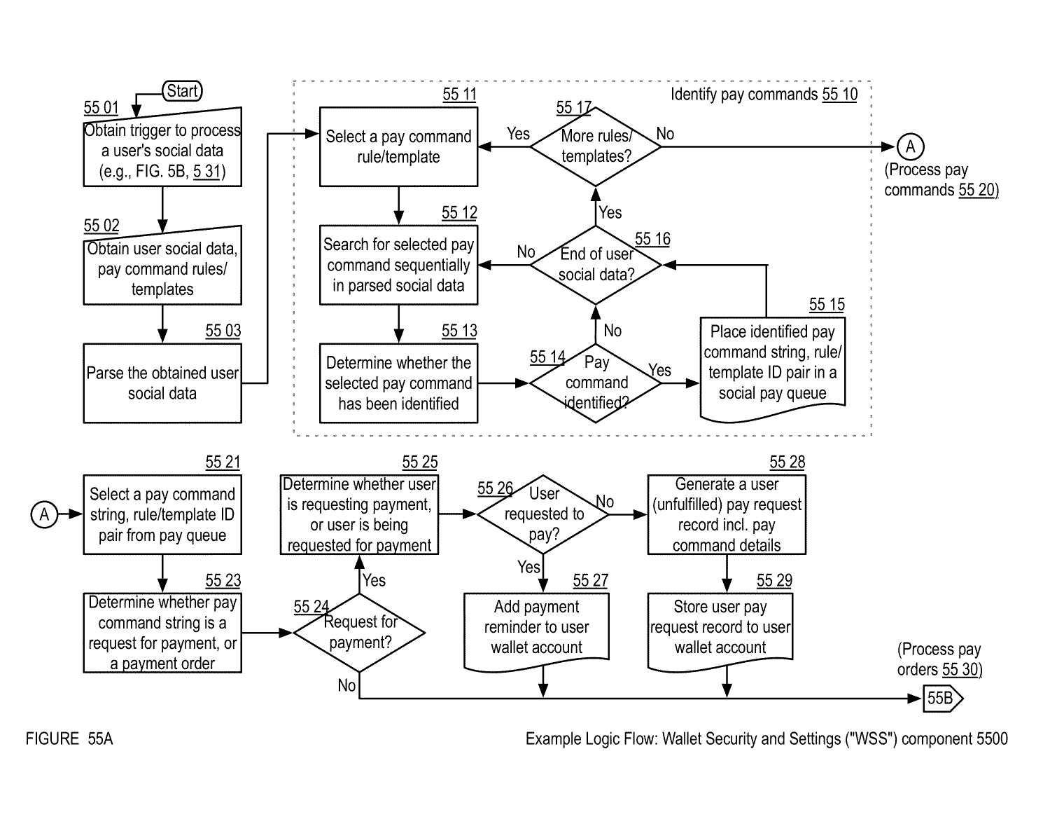

In some embodiments, the social pay server may process the user social data using the social pay rules to identify pay commands, pay requests, merchant offers, and/or like content of the user social data. In some embodiments, rules may be provided by the EOOR to ensure the privacy and security of the user's social data and virtual wallet. As another example, the rules may include procedures to detect fraudulent transaction attempts, and request user verification before proceeding, or cancel the transaction request entirely. In some embodiments, the social pay server may utilize a wallet security and settings component, such as the example WSS 5500 component described further below in the discussion with reference to FIGS. 55A-B.

With reference to FIG. 53C, in some embodiments, the social pay server may optionally determine that, based on processing of the rules, user verification is needed to process a transaction indicated in a pay command. For example, if the rules processing indicated that there is a probability of the pay command being an attempt at a fraudulent transaction attempt, the social pay server may determine that the user must be contacted for payment verification before the transaction can be processed. In such scenarios, the social pay server may provide a pay command verification request 5333 to the client, which the client may display, e.g., 5334, to the user. For example, the social pay server may provide a pay command verification request to the client 5302a as a HTTP(S) POST message including XML-formatted data. An example listing of a pay command verification request 5333, substantially in the form of a HTTP(S) POST message including XML-formatted data, is provided below:

```
POST /verifyrequest.php HTTP/1.1
Host: www.client.com
Content-Type: Application/XML
Content-Length: 256
<?XML version = “1.0” encoding = “UTF-8”?>
<verify_request>
  <transaction_ID>AE1234</transaction_ID>
  <timestamp>2011-02-02 03:04:05</timestamp>
  <amount>50000 vpts</amount>
  <message_string>5000000 vpts @jfdoe #thx</message_string>
</verify_request>
```

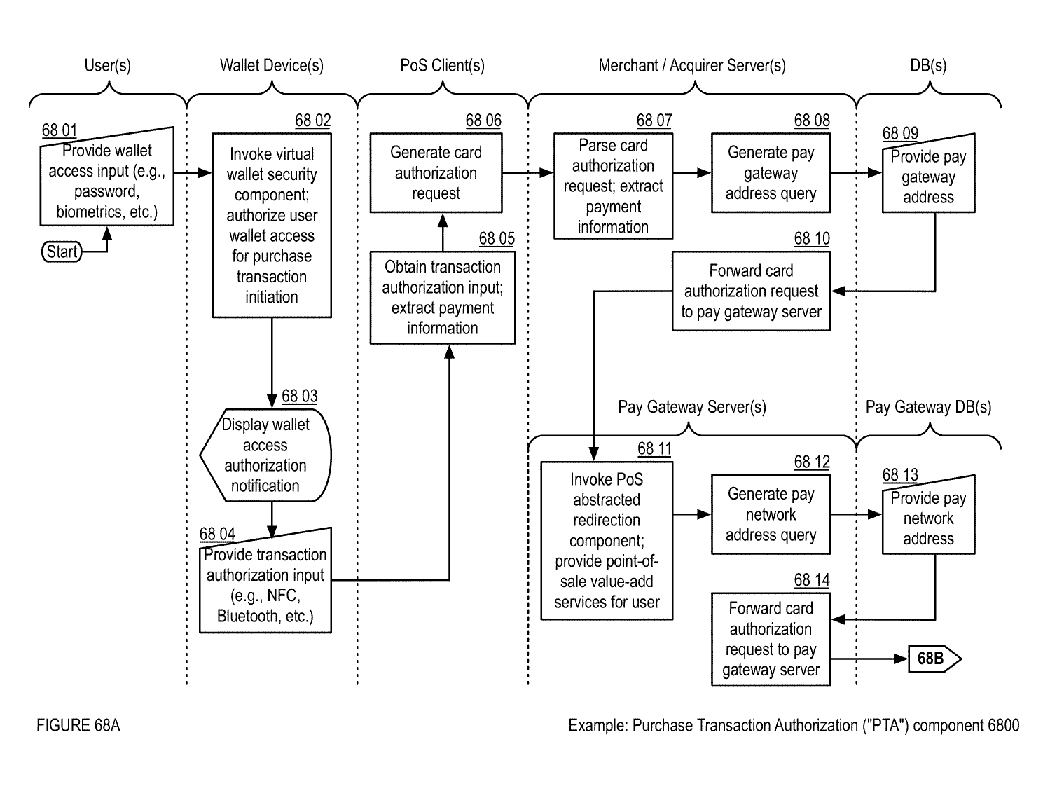

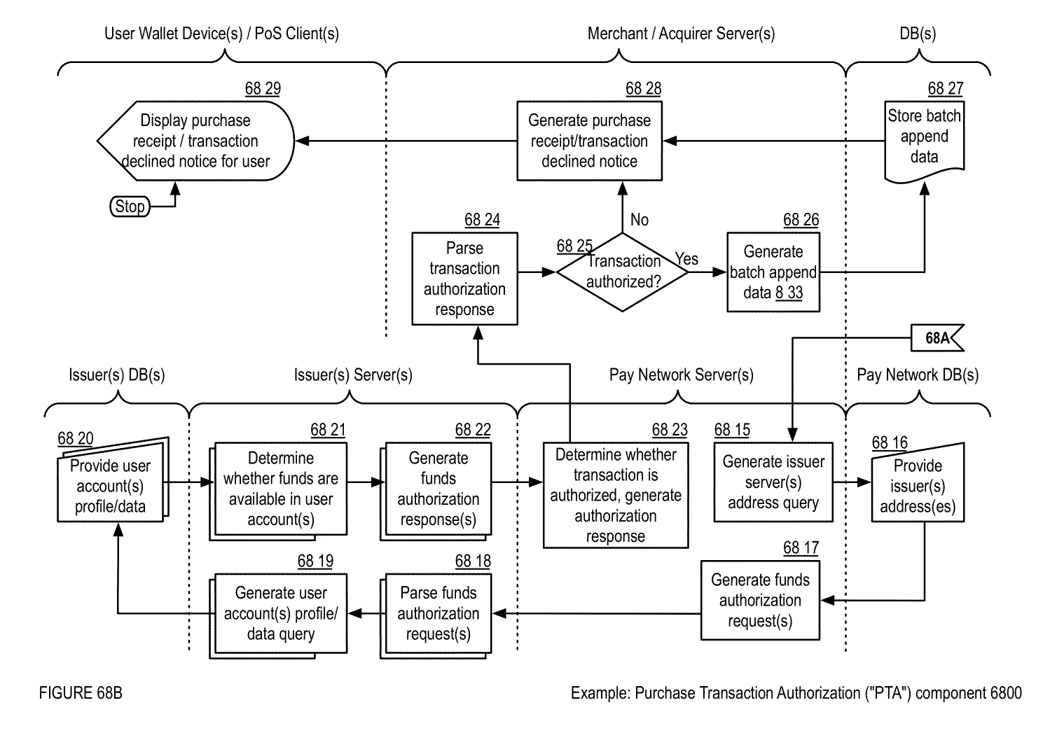

In some embodiments, the user may provide a verification input 5335 into the client, which may provide a pay command verification response to the social pay server. The social pay server may determine whether the payor verified payment, whether payee information available is sufficient to process the transaction, and/or the like. In scenarios where sufficient payee information is unavailable, the social pay server may optionally provide a social post message 5338 to a social networking service associated with the potential payee requesting the payee to enroll in social pay service (e.g., using the SPE 5200 component described above in the discussion with reference to FIGS. 51-52), which the social network server may post 5339 for the payee. If all the requirements are met for processing the transaction, the social pay server may generate a unique transaction trigger associated with the triggering social post message, e.g., 5337, and store a transaction trigger ID, triggering social post message, etc., for recordkeeping or analytics purposes, e.g., 5340. The social pay server may provide the transaction trigger to trigger a purchase transaction 5341, e.g., via a purchase transaction authorization such as the example PTA component described below in the discussion with reference to FIG. 68.

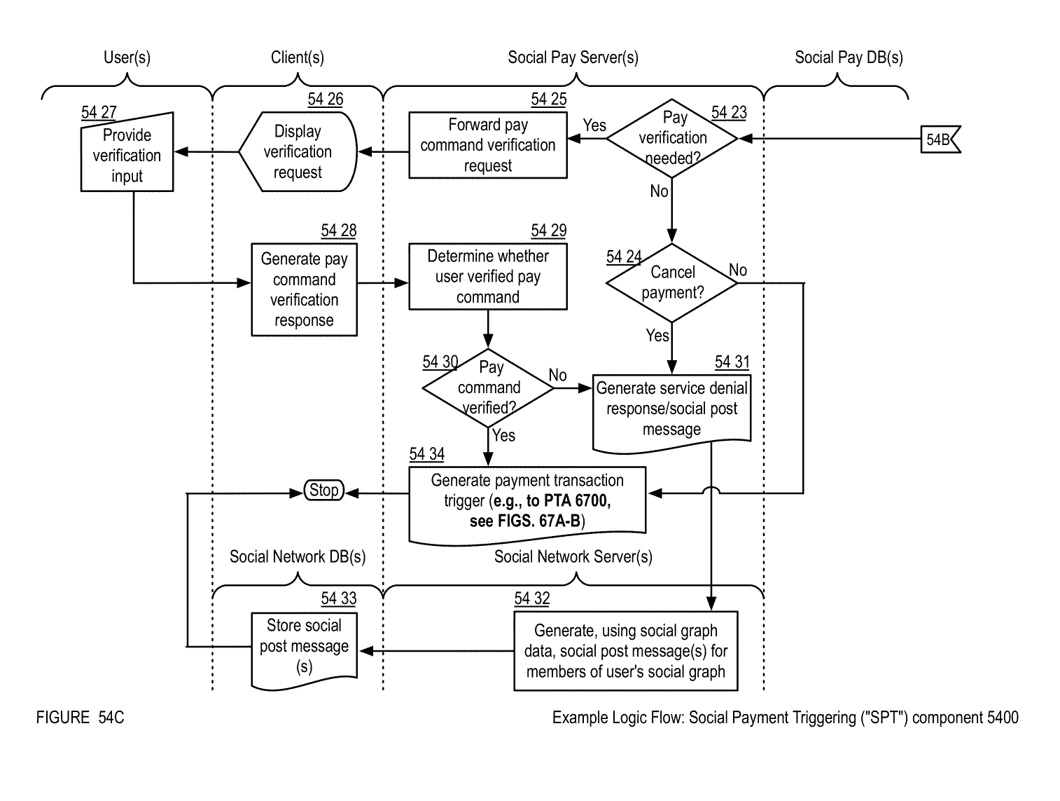

FIGS. 54A-C show logic flow diagrams illustrating example aspects of social payment triggering in some embodiments of the EOOR, e.g., a Social Payment Triggering (“SPT”) component 5400. With reference to FIG. 54A, in some embodiments, a user may desire to provide or request funds from another (e.g., a user, a participating merchant, etc.). The user may communicate with a social network server via a client. For example, the user may provide social payment input 5401, into the client indicating the user's desire to provide or request funds from another. In response, the client may generate and provide a social message post request 5402 to the social network server. In some implementations, a virtual wallet application executing on the client may provide the user with an easy-to-use interface to generate and send the social message post request. In alternate implementations, the user may utilize other applications to provide the social message post request. In some embodiments, the social network server may query its social network database for a social graph of the user, e.g., 5403. In response, the social network database may provide the requested social graph data, e.g., 5404. Using the social graph data, the social network server may generate message(s) as appropriate for the user and/or members of the user's social graph, e.g., 5405, and store the messages 5406 for the user and/or social graph members.

With reference to FIG. 54B, in some embodiments, such posting of social messages may trigger EOOR actions. For example, a social pay server may be triggered to scan the social data for pay commands, e.g., 5407. In embodiments where every social post message originates from the virtual wallet application of a user, the EOOR may optionally obtain the pay commands from the virtual wallet applications, and skip scanning the social networks for pay commands associated with the user. In embodiments where a user is allowed to issue pay commands from any device (even those not linked to the user's virtual wallet), the EOOR may periodically, or even continuously scan the social networks for pay commands. In embodiments where the EOOR scans the social networks, the social pay server may query a social pay database for a profile of the user, 5408. For example, the social pay server may request a user ID and password for the social networks that the user provided to the social pay server during the enrollment phase (see, e.g., FIGS. 41-42). In response, the social pay database may provide the requested information, e.g., 5409. In some embodiments, the social pay server may generate provide a user social data request 5410 to the social network server.

In some embodiments, the social network server may extract a user ID from the user social data request, e.g., 5411. The social network server may query, e.g., 5412, it social network database to determine whether the user is enrolled in EOOR with the social network (e.g., “did the user allow the EOOR Facebook® app to access user data?”). In response, the social network database may provide user enrollment data relating to EOOR. The social network server may determine whether the user is enrolled, and thus whether the social pay server is authorized to access the user social data, 5414. If the social network server determines that the social pay server is not authorized, 5415, option “No,” it may generate a service denial message, 5416, and provide the message to the social pay server. If the social network server determines that the social pay server is authorized to access the user social data, 5415, option “Yes,” the social network server may generate a user social data query 5417, and provide it to the social network database. In response, the social network database may provide the user social data requested, 5418. The social network server may provide the user social data 5419 to the social pay server.

In some embodiments, the social pay server may query the social pay database for social pay rules, e.g., 5420-5421. In some embodiments, the social pay server may process the user social data using the social pay rules to identify pay commands, pay requests, merchant offers, and/or like content of the user social data, 5422. In some embodiments, rules may be provided by the EOOR to ensure the privacy and security of the user's social data and virtual wallet. As another example, the rules may include procedures to detect fraudulent transaction attempts, and request user verification before proceeding, or cancel the transaction request entirely. In some embodiments, the social pay server may utilize a wallet security and settings component, such as the example WSS 5500 component described further below in the discussion with reference to FIGS. 55A-B.

With reference to FIG. 54C, in some embodiments, the social pay server may optionally determine that, based on processing of the rules, user verification is needed to process a transaction indicated in a pay command, 5423, option “Yes.” For example, if the rules processing indicated that there is a probability of the pay command being an attempt at a fraudulent transaction attempt, the social pay server may determine that the user must be contacted for payment verification before the transaction can be processed. In such scenarios, the social pay server may provide a pay command verification request 5425 to the client, which the client may display, e.g., 5426, to the user. In some embodiments, the user may provide a verification input 5427 into the client, which may provide a pay command verification response to the social pay server, 5428. The social pay server may determine whether the payor verified payment, whether payee information available is sufficient to process the transaction, and/or the like, 5429. In scenarios where sufficient payee information is unavailable or the payor needs to be contacted for payment verification, 5430, option “No,” the social pay server may optionally provide a social post message 5431 to a social networking service associated with the potential payee/payor requesting the payee to enroll in social pay service (e.g., using the SPE 5200 component described above in the discussion with reference to FIGS. 51-52) or provide verification, which the social network server may post 5432-4433 for the payee. If all the requirements are met for processing the transaction, 5430, option “Yes,” the social pay server may generate a unique transaction trigger associated with the triggering social post message, e.g., 5434, and may optionally store a transaction trigger ID, triggering social post message, etc., for recordkeeping or analytics purposes. The social pay server may provide the transaction trigger to trigger 11a purchase transaction, e.g., via a purchase transaction authorization component.

FIGS. 55A-B show logic flow diagrams illustrating example aspects of implementing wallet security and settings in some embodiments of the EOOR, e.g., a Something (“WSS”) component 5500. In some embodiments, the social pay server may process the user social data using the social pay rules to identify pay commands, pay requests, merchant offers, and/or like content of the user social data. In some embodiments, rules may be provided by the EOOR to ensure the privacy and security of the user's social data and virtual wallet. As another example, the rules may include procedures to detect fraudulent transaction attempts, and request user verification before proceeding, or cancel the transaction request entirely.

Accordingly, with reference to FIG. 55A, in some embodiments, the EOOR may obtain a trigger to process a user's social data (e.g., from FIG. 54B, element 5431), 5501. The EOOR may obtain user and/or user social graph member social data, as well as pay command rules and templates (e.g., for identifying standard pay commands), 5502. The EOOR may parse the obtained user social data in preparation for rules processing, 5503. For example, the EOOR may utilize parsers such as the example parsers described below in the discussion with reference to FIG. 71. The EOOR may select a pay command rule/template for processing. The EOOR may search through the parsed user social data, e.g., in a sequential manner, for the selected pay command, 5512, and determine whether the pay command is present in the user social data, 5513. If the pay command is identified, 5514, option “Yes,” the EOOR may place the identified pay command string, an identification of the rule/template, the actual listing of the rule/template, and/or the like in a queue for further processing, 5515. The EOOR may perform such a procedure until the entirety of the user's social data has been searched through (see 5516). In some embodiments, the EOOR may perform the above procedure for all available rules/templates, to identify all the pay command strings included in the user social data (see 5517).

In some embodiments, the EOOR may process each pay command identified from the user social data, 5520. For example, the EOOR may select a pay command string from the queue and its associated template/identification rule, 5521. Using the rule/template and pay command string, the EOOR may determine whether the string represents a request for payment, or an order to pay, 5523. If the pay command string represents a request for payment (e.g., “hey @jfdoe, you owe me 25 bucks #cashflowblues”), 5524, option “Yes,” the EOOR may determine whether the user for whom the WSS component is executing is the requested payor, or the payee, 5525. If the user has been requested to pay, 5526, option “Yes,” the EOOR may add a payment reminder to the user wallet account, 5527. Otherwise, the EOOR may generate a user pay request record including the pay command details, 5528, and store the pay request record in the user's wallet account for recordkeeping purposes or future analytics processing, 5529.

With reference to FIG. 55B, in some embodiments, the EOOR may extract an identification of a payor and payee in the transaction, 5531. The EOOR may query a database for payee account data for payment processing, 5532. If the payee data available is insufficient, 5533, option “Yes,” the EOOR may generate a social post message to the payee's social network account 5534, requesting that the payee either enroll in the EOOR (if not already), or provide additional information so that the EOOR may process the transaction. The EOOR may provide 5535 the social post message to the social networking service associated with the payee. If sufficient payee information is available, 5533, option “No,” the EOOR may query the payor's wallet account for security rules associated with utilizing the virtual wallet account, 5536. The EOOR may select a wallet security rule, 5537, and process the security rule using the pay command string as input data, 5538. Based on the processing, the EOOR may determine whether the pay command passes the security rule, or instead poses a security risk to the user wallet. If the security rule is not passed, 5540, option “No,” the EOOR may determine whether verification from the user can salvage the pay command string, 5541. If the EOOR determines that the risk is too great, the EOOR may directly terminate the transaction and remove the pay command string from the processing queue. Otherwise (4541, option “Yes”), the EOOR may generate a pay command verification request for the user, 5542, and provide the pay command verification request as an output of the component, 5543. If all security rules are passed for the pay command string, 5544, option “No,” the EOOR may generate a transaction trigger with a trigger ID (such as a card authorization request), and provide the transaction trigger for payment processing.

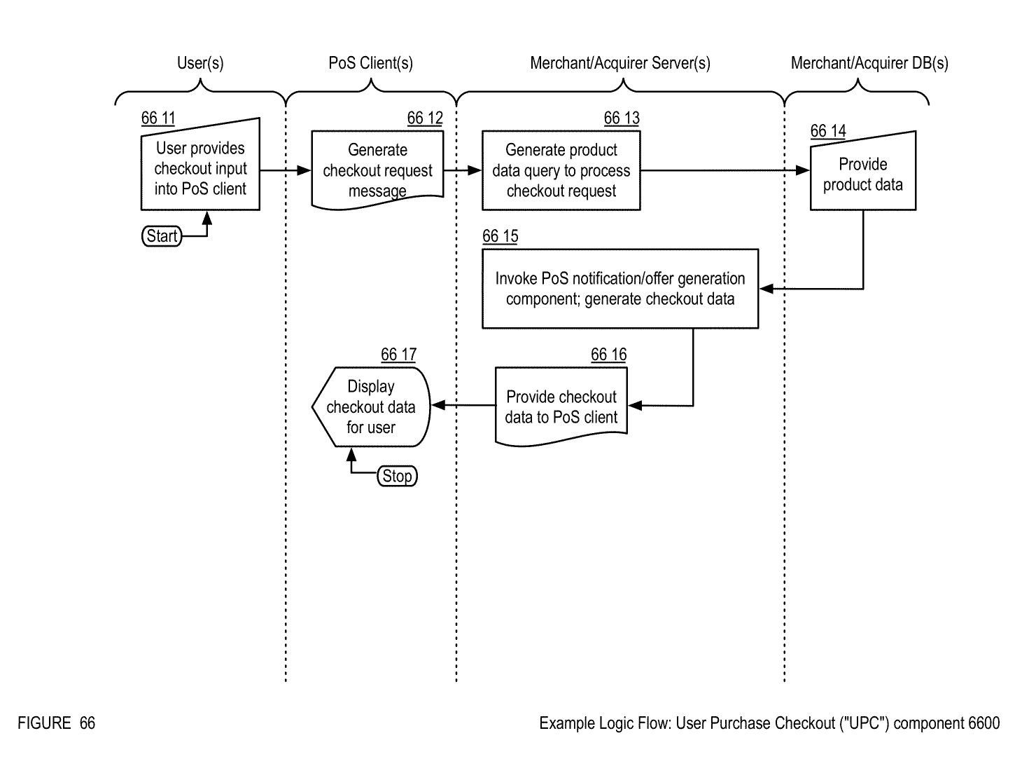

FIG. 56 shows a data flow diagram illustrating an example social merchant consumer bridging procedure in some embodiments of the EOOR. In some implementations, a social pay server 5603a may be triggered to provide services that bridge consumers and merchants over social networks. For example, the social pay server may identify a consumer is need of offers for products or services, and may identify merchants participating in EOOR that can provide the needed products or services. The social pay server may generate offers on behalf of the participating merchants, and provide the offers to consumers via social networks. In some embodiments, the social pay server may periodically initiate merchant-consumer bridging services for a user. In alternate embodiments, the social pay server may initiate merchant-consumer bridging upon notification of a consumer engaging in a transaction (e.g., a consumer may request checkout for a purchase via the user's virtual wallet; for illustration, see the example User Purchase Checkout (UPC) component 6600 described further below in the discussion with reference to FIG. 66), or when a authorization is requested for a purchase transaction (see the example Purchase Transaction Authorization (PTA) component 6800 described further below in the discussion with reference to FIG. 68). Upon obtaining a trigger to perform merchant-consumer bridging, the social pay server may invoke a transaction data aggregation component, e.g., the TDA component 2600 described further below in the discussion with reference to FIG. 26. The social pay server may query a social pay database 5603b for offer generation rules, e.g., 5613. For example, the social pay server may utilize PHP/SQL commands similar to the other examples described herein. In response, the database may provide the requested offer generation rules, e.g., 5614. Using the aggregated transaction data and the offer generation rules, the social pay server may generate merchant(s) offer social post messages for posting to profiles of the user on social networks, e.g., 5615. For example, the social pay server may invoke a transaction-based offer generation component, such as the example UBOR 3900 component described further below in the discussion with reference to FIG. 39. The social pay server may provide the generated social post messages 5616 to a social network server 5604a. The social network server may store the social post messages 5617 to a social network database 5604b for distribution to the user (e.g., when the user logs onto the social networking service provided by the social network server).

FIG. 57 shows a logic flow diagram illustrating example aspects of social merchant consumer bridging in some embodiments of the EOOR, e.g., a Social Merchant Consumer Bridging (“SMCB”) component 5700. In some implementations, a social pay server may be triggered to provide services that bridge consumers and merchants over social networks, e.g., 5701. Upon obtaining a trigger to perform merchant-consumer bridging, the social pay server may invoke a transaction data aggregation component such as the TDA component 2600 described further below in the discussion with reference to FIG. 26, e.g., 5702. The social pay server may query a social pay database for offer generation rules, e.g., 5703. For example, the social pay server may utilize PHP/SQL commands similar to the other examples described herein. In response, the database may provide the requested offer generation rules, e.g., 5704. Using the aggregated transaction data and the offer generation rules, the social pay server may generate merchant(s) offer social post messages for posting to profiles of the user on social networks, e.g., 5705. For example, the social pay server may invoke a transaction-based offer generation component, such as the example UBOR 3900 component described further below in the discussion with reference to FIG. 39. The social pay server may provide the generated social post messages to a social network server. The social network server may store the social post messages to a social network database for distribution to the user (e.g., when the user logs onto the social networking service provided by the social network server). In some embodiments, the social network server may generate, using social graph data of the user, social post messages for the user and/or members of the user's social graph, e.g., 5706, and store the social post message in a social network database for posting to their profiles, e.g., 5707.

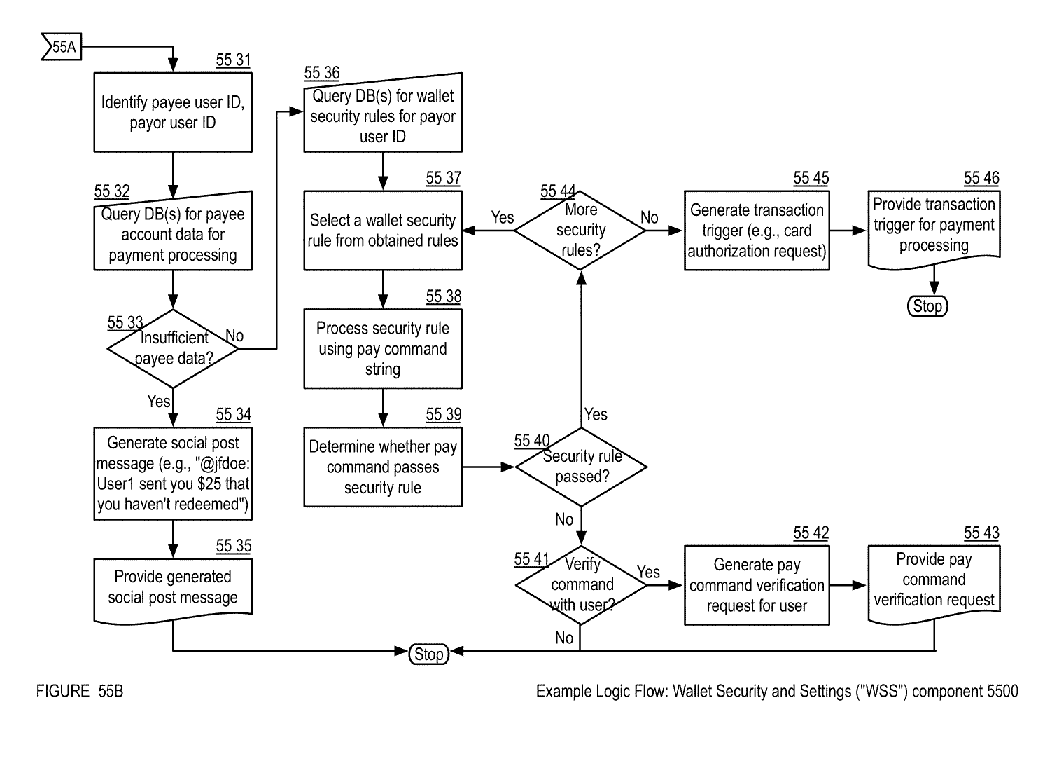

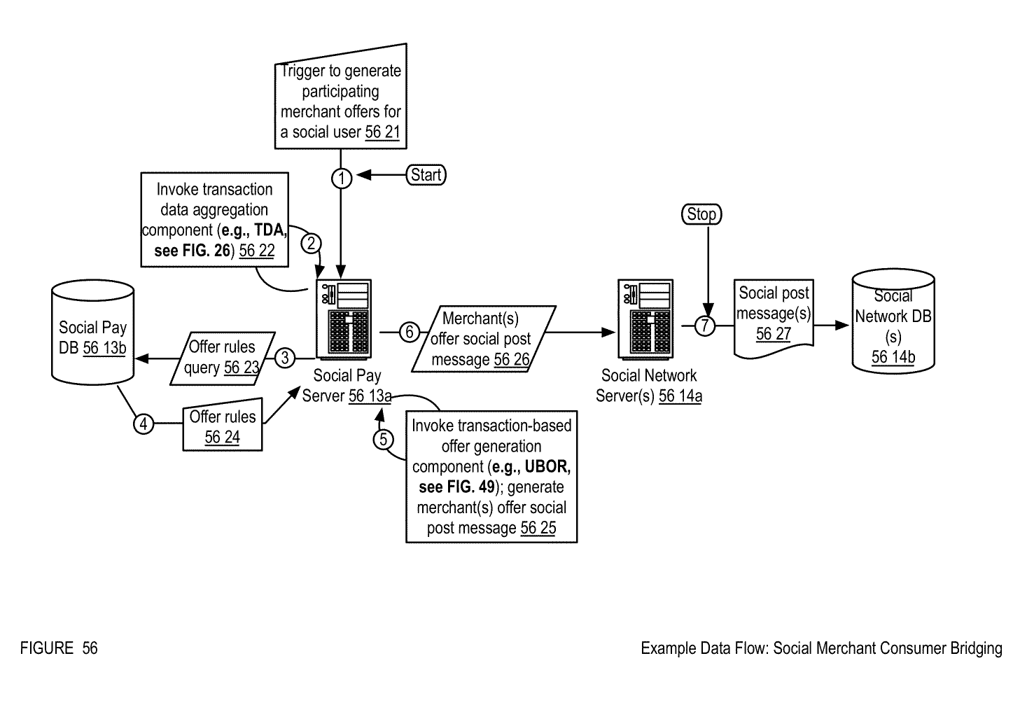

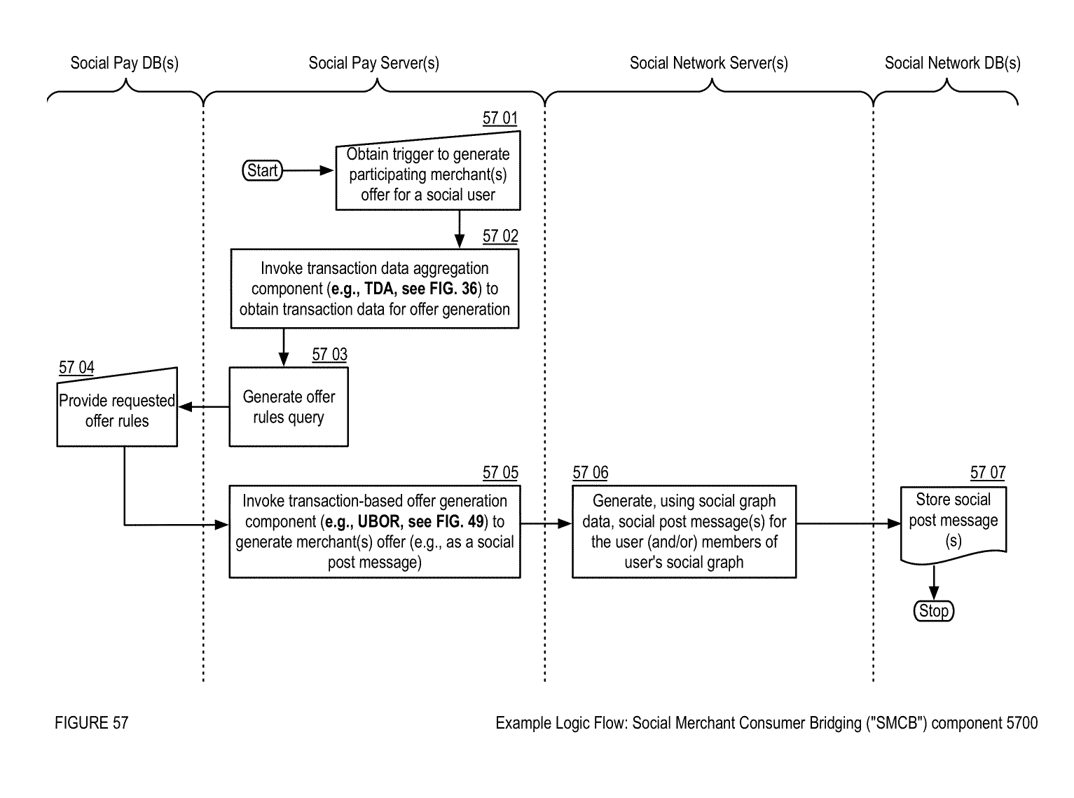

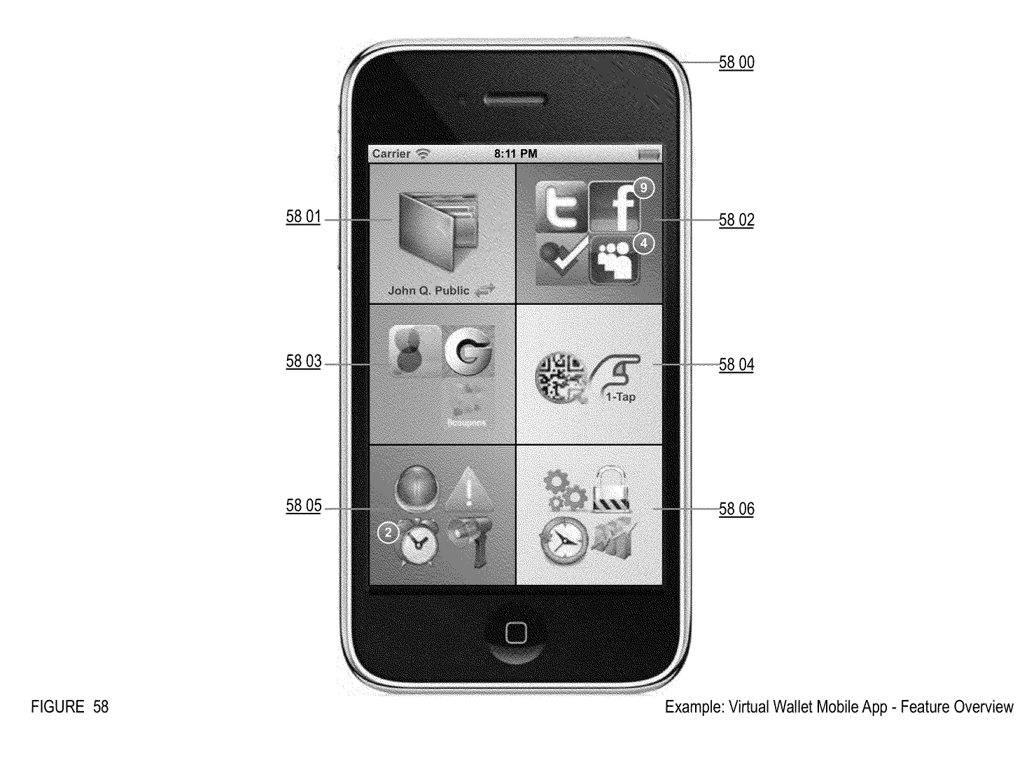

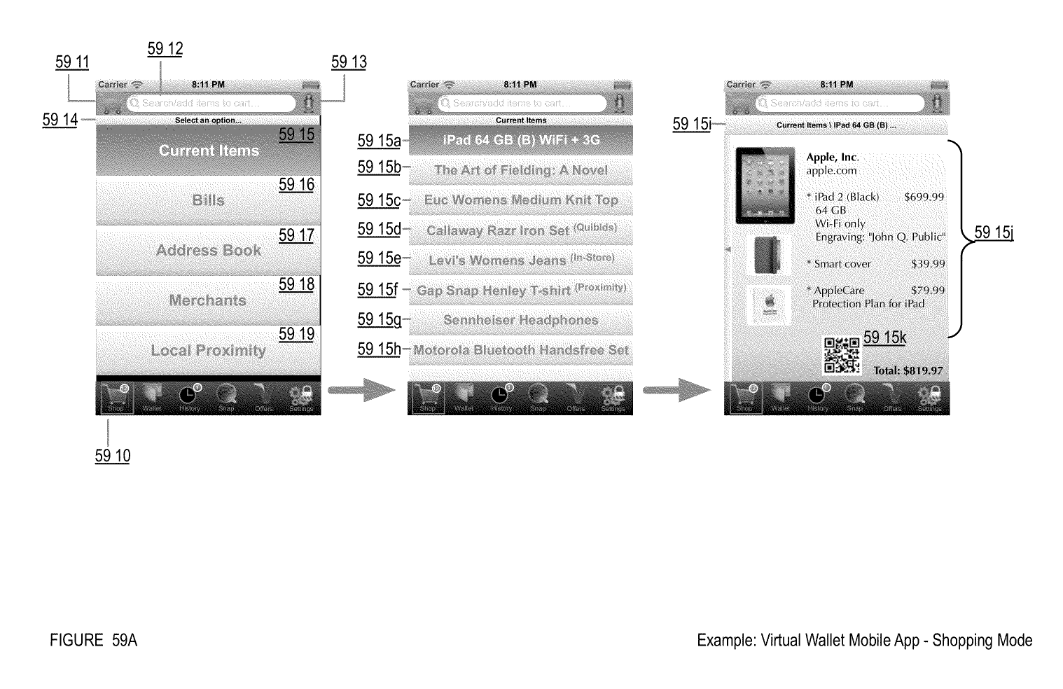

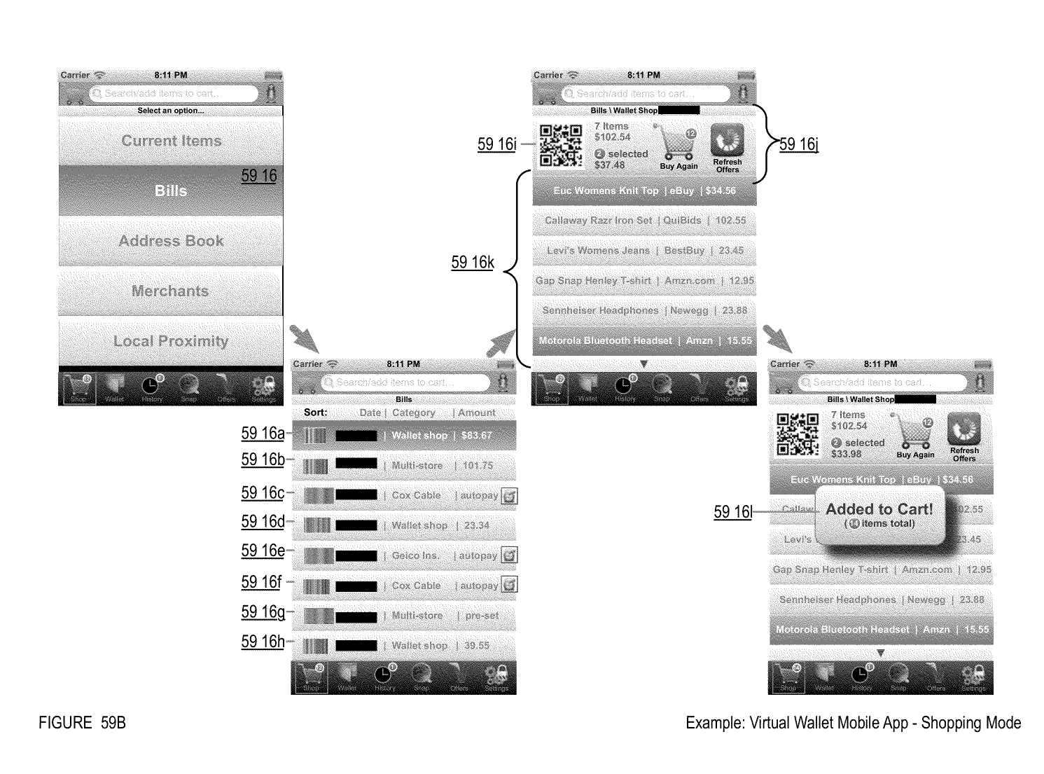

FIG. 58 shows a user interface diagram illustrating an overview of example features of virtual wallet applications in some embodiments of the EOOR. FIG. 58 shows an illustration of various exemplary features of a virtual wallet mobile application 5800. Some of the features displayed include a wallet 5801, social integration via TWITTER, FACEBOOK, etc., offers and loyalty 5803, snap mobile purchase 5804, alerts 5805 and security, setting and analytics 5896. These features are explored in further detail below.

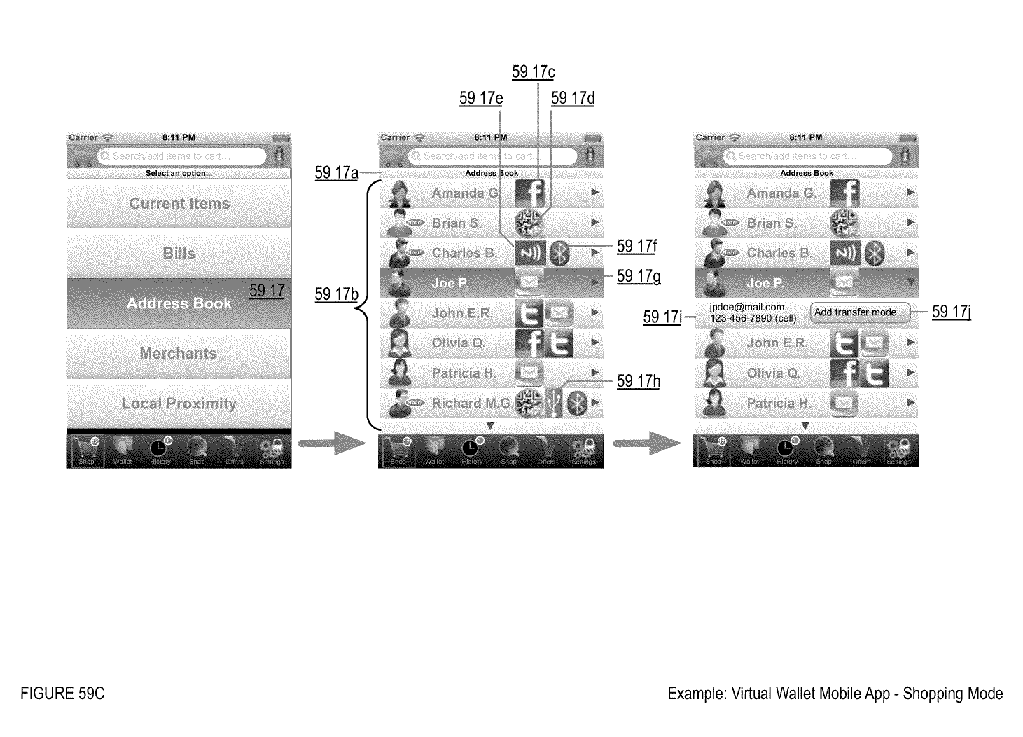

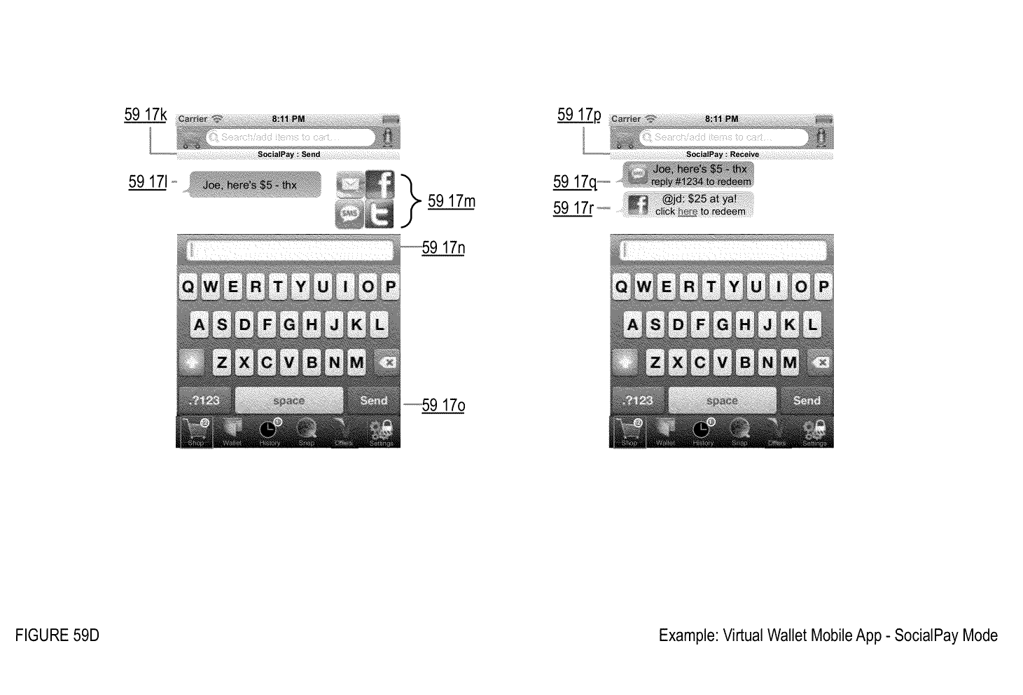

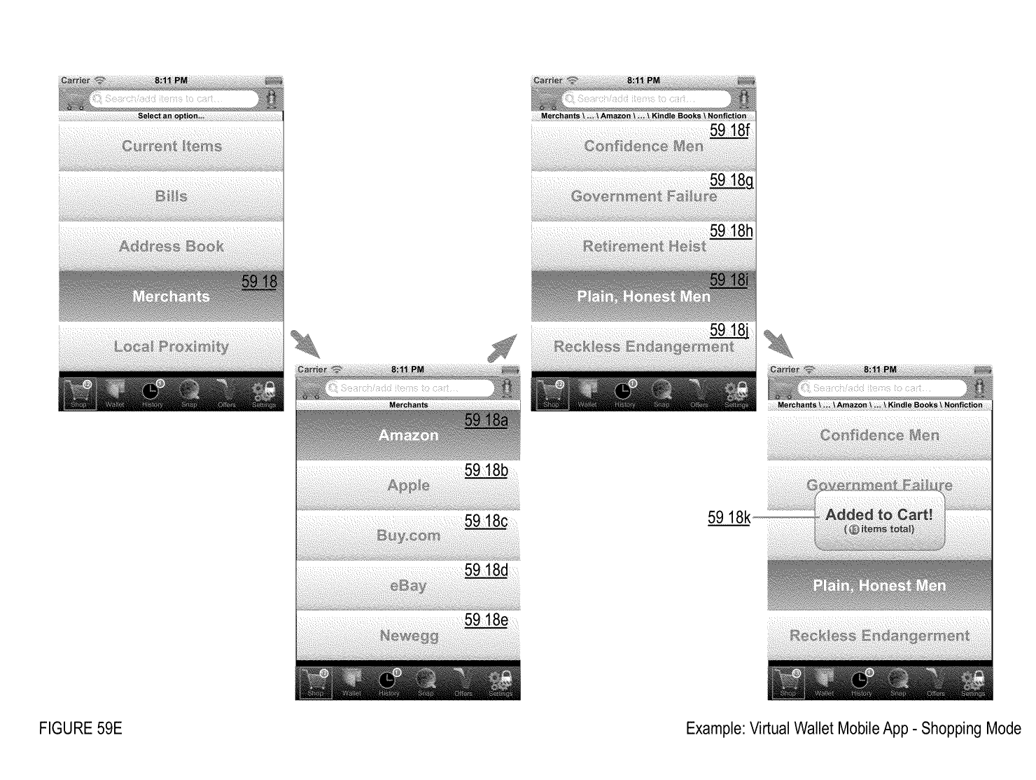

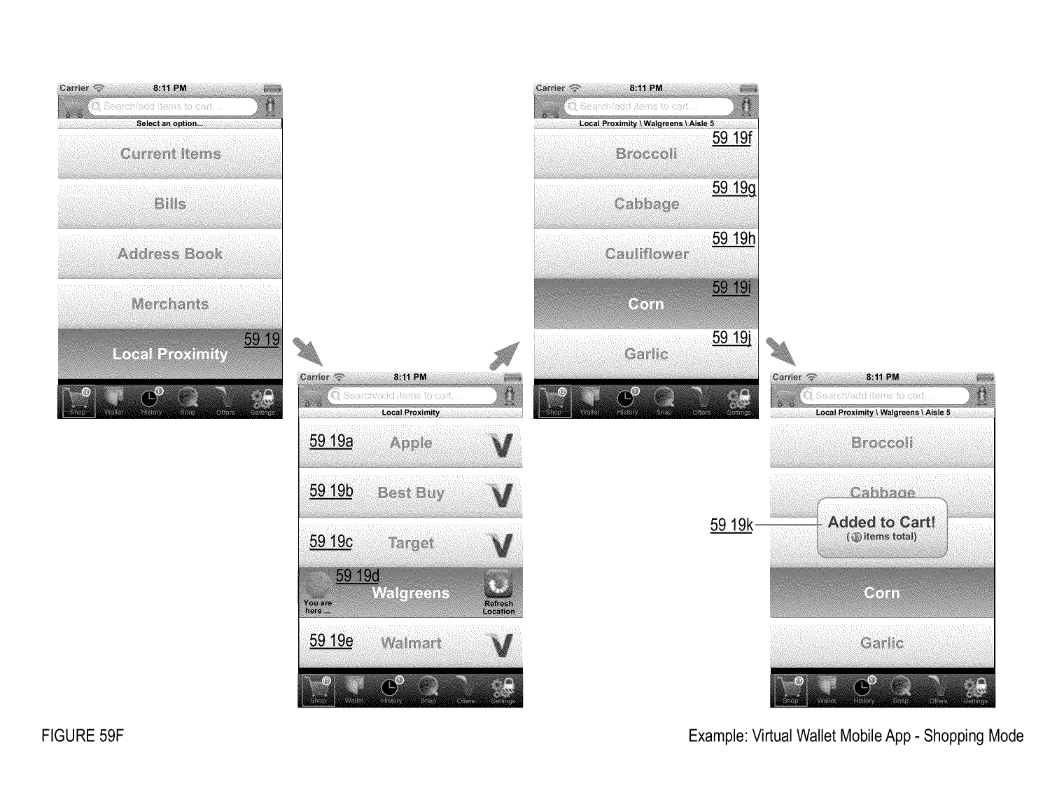

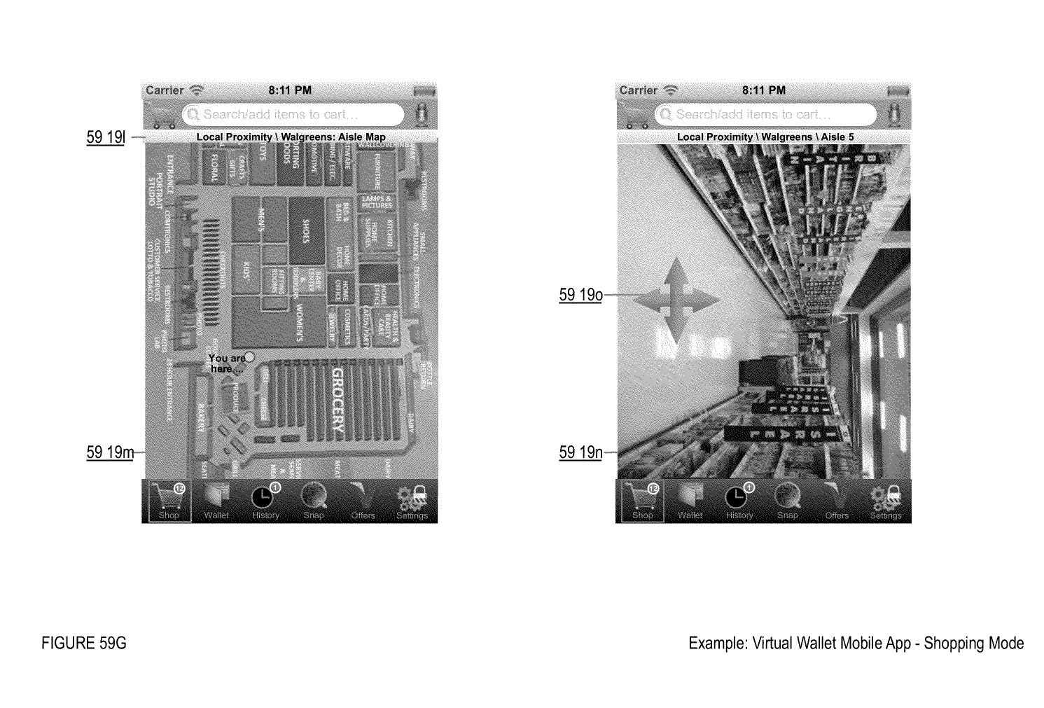

FIGS. 59A-G show user interface diagrams illustrating example features of virtual wallet applications in a shopping mode, in some embodiments of the EOOR. With reference to FIG. 59A, some embodiments of the virtual wallet mobile app facilitate and greatly enhance the shopping experience of consumers. A variety of shopping modes, as shown in FIG. 59A, may be available for a consumer to peruse. In one implementation, for example, a user may launch the shopping mode by selecting the shop icon 5910 at the bottom of the user interface. A user may type in an item in the search field 5912 to search and/or add an item to a cart 5911. A user may also use a voice activated shopping mode by saying the name or description of an item to be searched and/or added to the cart into a microphone 5913. In a further implementation, a user may also select other shopping options 5914 such as current items 5915, bills 5916, address book 5917, merchants 5918 and local proximity 5919.

In one embodiment, for example, a user may select the option current items 5915, as shown in the left most user interface of FIG. 59A. When the current items 5915 option is selected, the middle user interface may be displayed. As shown, the middle user interface may provide a current list of items 5915a-h in a user's shopping cart 5911. A user may select an item, for example item 5915a, to view product description 5915j of the selected item and/or other items from the same merchant. The price and total payable information may also be displayed, along with a QR code 5915k that captures the information necessary to effect a snap mobile purchase transaction.

With reference to FIG. 59B, in another embodiment, a user may select the bills 5916 option. Upon selecting the bills 5916 option, the user interface may display a list of bills and/or receipts 5916a-h from one or more merchants. Next to each of the bills, additional information such as date of visit, whether items from multiple stores are present, last bill payment date, auto-payment, number of items, and/or the like may be displayed. In one example, the wallet shop bill 5916a dated Jan. 20, 2011 may be selected. The wallet shop bill selection may display a user interface that provides a variety of information regarding the selected bill. For example, the user interface may display a list of items 5916k purchased, <<5916i>>, a total number of items and the corresponding value. For example, 7 items worth $102.54 were in the selected wallet shop bill. A user may now select any of the items and select buy again to add purchase the items. The user may also refresh offers 5916j to clear any invalid offers from last time and/or search for new offers that may be applicable for the current purchase. As shown in FIG. 59B, a user may select two items for repeat purchase. Upon addition, a message 59161 may be displayed to confirm the addition of the two items, which makes the total number of items in the cart 14.

With reference to FIG. 59C, in yet another embodiment, a user may select the address book option 5917 to view the address book 5917a which includes a list of contacts 5917b and make any money transfers or payments. In one embodiment, the address book may identify each contact using their names and available and/or preferred modes of payment. For example, a contact Amanda G. may be paid via social pay (e.g., via FACEBOOK) as indicated by the icon 5917c. In another example, money may be transferred to Brian S. via QR code as indicated by the QR code icon 5917d. In yet another example, Charles B. may accept payment via near field communication 5917e, Bluetooth 5917f and email 5917g. Payment may also be made via USB 5917h (e.g., by physically connecting two mobile devices) as well as other social channels such as TWITTER.

In one implementation, a user may select Joe P. for payment. Joe P., as shown in the user interface, has an email icon 5917g next to his name indicating that Joe P. accepts payment via email. When his name is selected, the user interface may display his contact information such as email, phone, etc. If a user wishes to make a payment to Joe P. by a method other than email, the user may add another transfer mode 5917j to his contact information and make a payment transfer. With reference to FIG. 59D, the user may be provided with a screen 5917k where the user can enter an amount to send Joe, as well as add other text to provide Joe with context for the payment transaction 59171. The user can choose modes (e.g., SMS, email, social networking) via which Joe may be contacted via graphical user interface elements, 5917m. As the user types, the text entered may be provided for review within a GUI element 5917n. When the user has completed entering in the necessary information, the user can press the send button 59170 to send the social message to Joe. If Joe also has a virtual wallet application, Joe may be able to review 5917p social pay message within the app, or directly at the website of the social network (e.g., for Twitter™, Facebook®, etc.). Messages may be aggregated from the various social networks and other sources (e.g., SMS, email). The method of redemption appropriate for each messaging mode may be indicated along with the social pay message. In the illustration in FIG. 59D, the SMS 5917q Joe received indicates that Joe can redeem the $5 obtained via SMS by replying to the SMS and entering the hash tag value ‘#1234’. In the same illustration, Joe has also received a message 5917r via Facebook®, which includes a URL link that Joe can activate to initiate redemption of the $25 payment.

With reference to FIG. 59E, in some other embodiments, a user may select merchants 5918 from the list of options in the shopping mode to view a select list of merchants 5918a-e. In one implementation, the merchants in the list may be affiliated to the wallet, or have affinity relationship with the wallet. In another implementation, the merchants may include a list of merchants meeting a user-defined or other criteria. For example, the list may be one that is curated by the user, merchants where the user most frequently shops or spends more than an x amount of sum or shopped for three consecutive months, and/or the like. In one implementation, the user may further select one of the merchants, Amazon 5918a for example. The user may then navigate through the merchant's listings to find items of interest such as 5918f-j. Directly through the wallet and without visiting the merchant site from a separate page, the user may make a selection of an item 5918j from the catalog of Amazon 5918a. As shown in the right most user interface of FIG. 59D, the selected item may then be added to cart. The message 5918k indicates that the selected item has been added to the cart, and updated number of items in the cart is now 13.

With reference to FIG. 59F, in one embodiment, there may be a local proximity option 5919 which may be selected by a user to view a list of merchants that are geographically in close proximity to the user. For example, the list of merchants 5919a-e may be the merchants that are located close to the user. In one implementation, the mobile application may further identify when the user in a store based on the user's location. For example, position icon 5919d may be displayed next to a store (e.g., Walgreens) when the user is in close proximity to the store. In one implementation, the mobile application may refresh its location periodically in case the user moved away from the store (e.g., Walgreens). In a further implementation, the user may navigate the offerings of the selected Walgreens store through the mobile application. For example, the user may navigate, using the mobile application, to items 5919f-j available on aisle 5 of Walgreens. In one implementation, the user may select corn 5919i from his or her mobile application to add to cart 5919k.

With reference to FIG. 59G, in another embodiment, the local proximity option 5919 may include a store map and a real time map features among others. For example, upon selecting the Walgreens store, the user may launch an aisle map 5919l which displays a map 5919m showing the organization of the store and the position of the user (indicated by a yellow circle). In one implementation, the user may easily configure the map to add one or more other users (e.g., user's kids) to share each other's location within the store. In another implementation, the user may have the option to launch a “store view” similar to street views in maps. The store view 5919n may display images/video of the user's surrounding. For example, if the user is about to enter aisle 5, the store view map may show the view of aisle 5. Further the user may manipulate the orientation of the map using the navigation tool 59190 to move the store view forwards, backwards, right, left as well clockwise and counterclockwise rotation

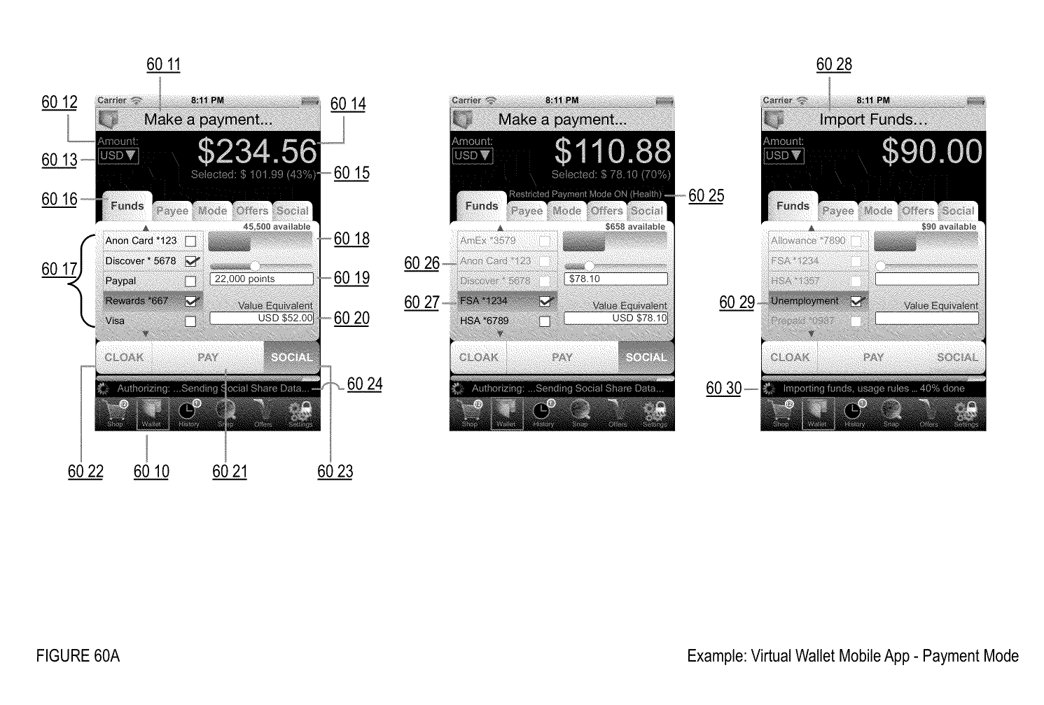

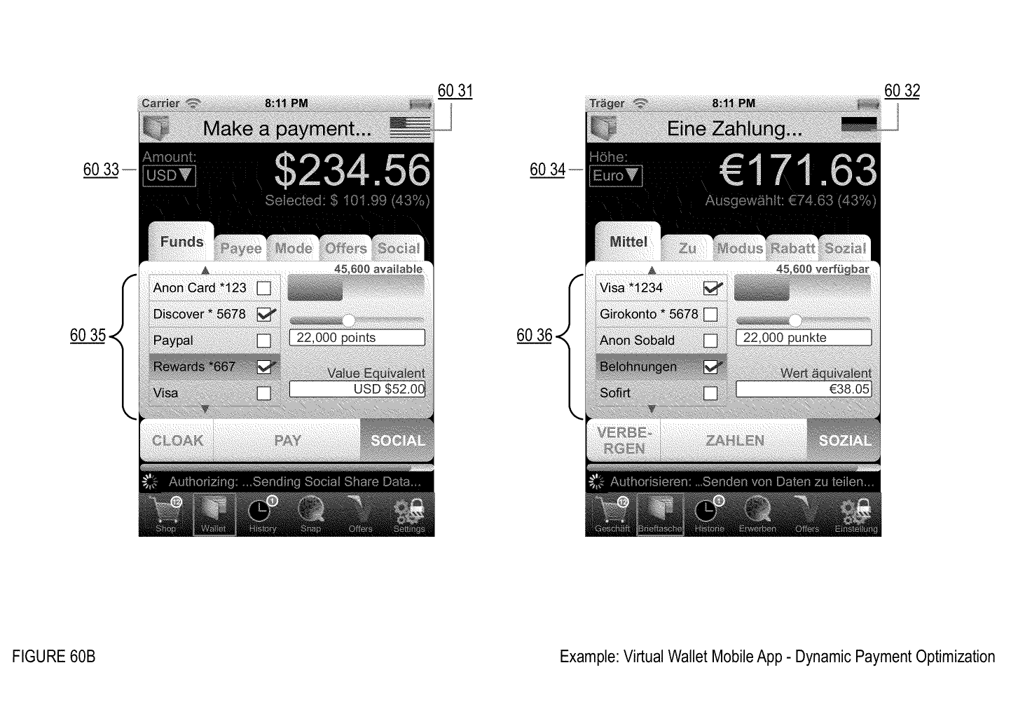

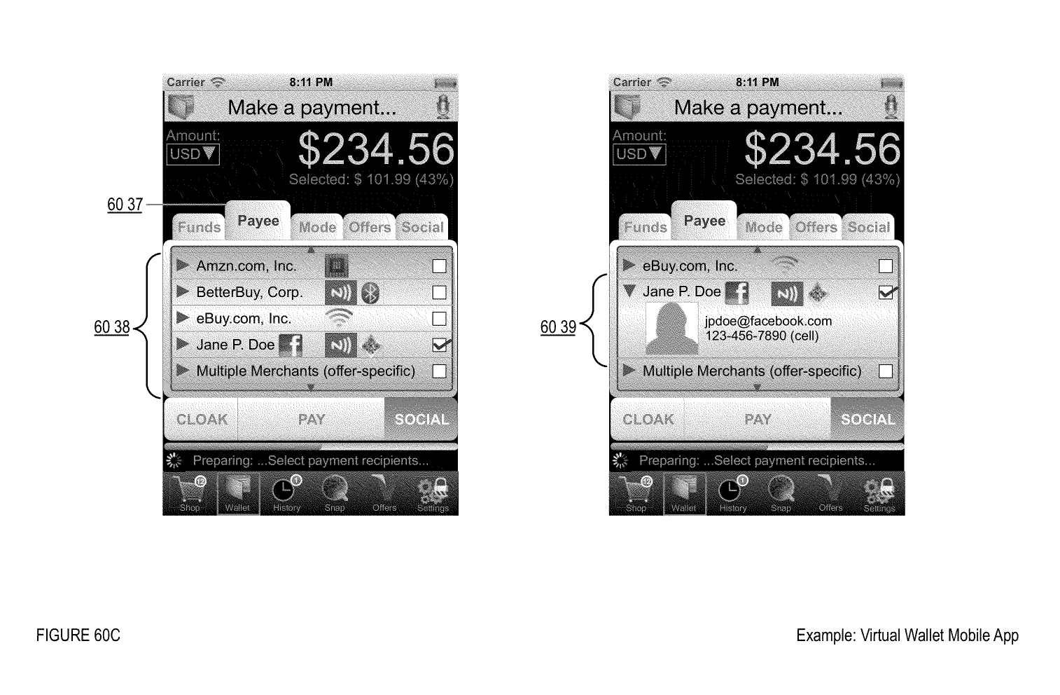

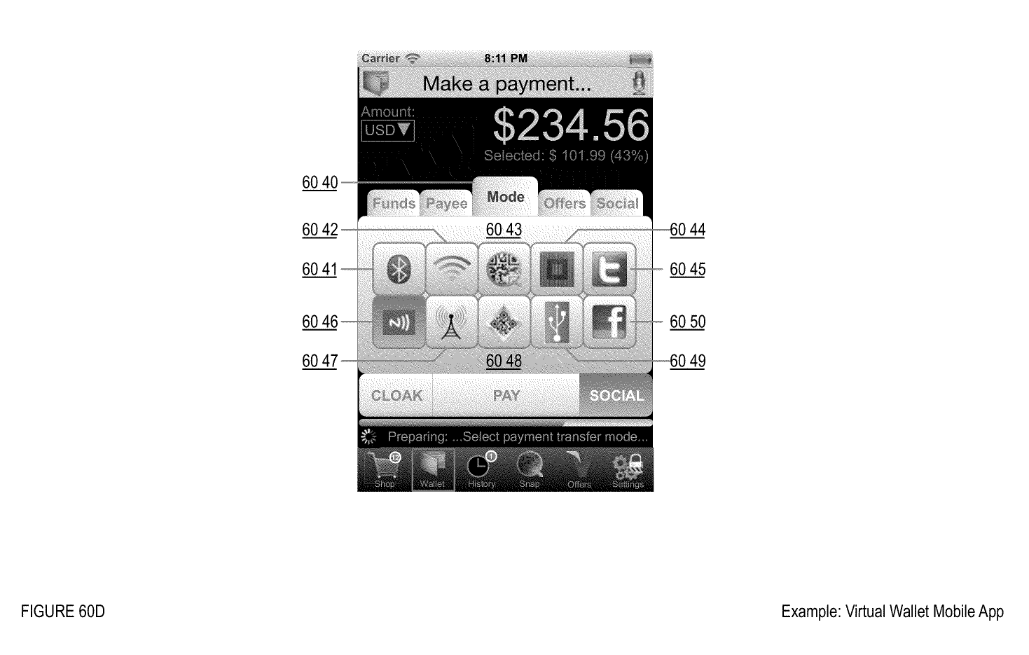

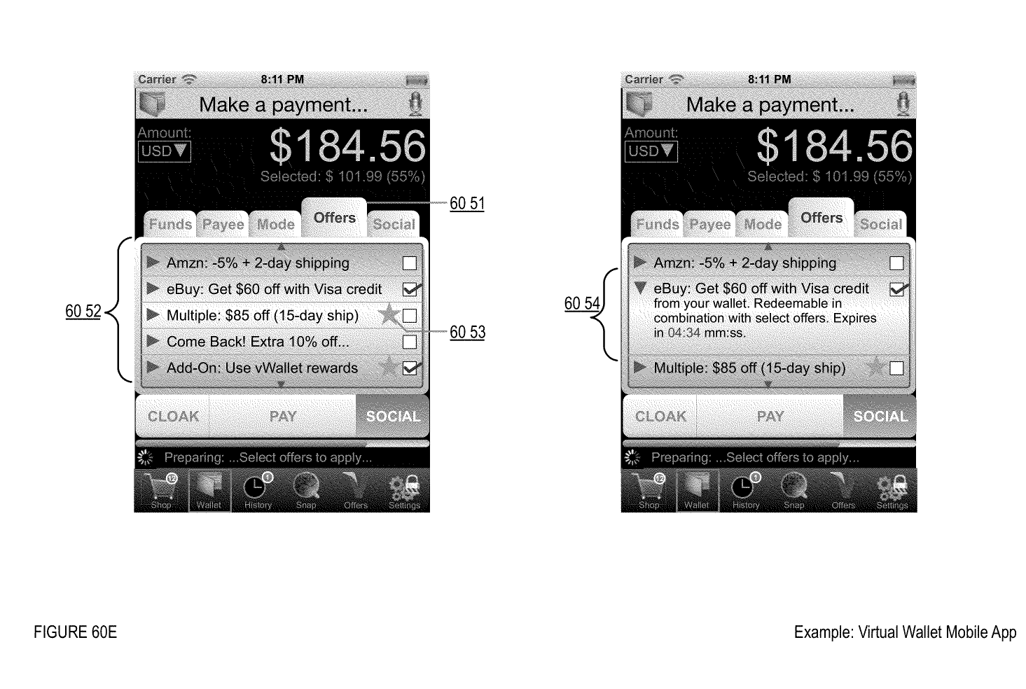

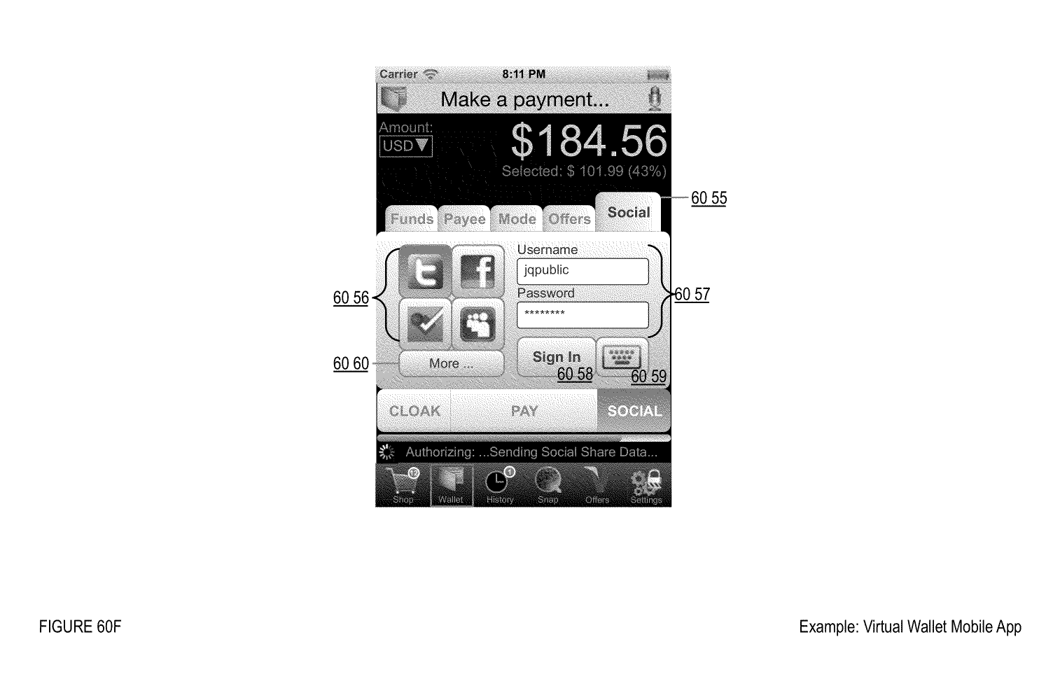

FIGS. 60A-F show user interface diagrams illustrating example features of virtual wallet applications in a payment mode, in some embodiments of the EOOR. With reference to FIG. 60A, in one embodiment, the wallet mobile application may provide a user with a number of options for paying for a transaction via the wallet mode 6010. In one implementation, an example user interface 6011 for making a payment is shown. The user interface may clearly identify the amount 6012 and the currency 6013 for the transaction. The amount may be the amount payable and the currency may include real currencies such as dollars and euros, as well as virtual currencies such as reward points. The amount of the transaction 6014 may also be prominently displayed on the user interface. The user may select the funds tab 6016 to select one or more forms of payment 6017, which may include various credit, debit, gift, rewards and/or prepaid cards. The user may also have the option of paying, wholly or in part, with reward points. For example, the graphical indicator 6018 on the user interface shows the number of points available, the graphical indicator 6019 shows the number of points to be used towards the amount due 234.56 and the equivalent 6020 of the number of points in a selected currency (USD, for example).

In one implementation, the user may combine funds from multiple sources to pay for the transaction. The amount 6015 displayed on the user interface may provide an indication of the amount of total funds covered so far by the selected forms of payment (e.g., Discover card and rewards points). The user may choose another form of payment or adjust the amount to be debited from one or more forms of payment until the amount 6015 matches the amount payable 6014. Once the amounts to be debited from one or more forms of payment are finalized by the user, payment authorization may begin.

In one implementation, the user may select a secure authorization of the transaction by selecting the cloak button 6022 to effectively cloak or anonymize some (e.g., pre-configured) or all identifying information such that when the user selects pay button 6021, the transaction authorization is conducted in a secure and anonymous manner. In another implementation, the user may select the pay button 6021 which may use standard authorization techniques for transaction processing. In yet another implementation, when the user selects the social button 6023, a message regarding the transaction may be communicated to one of more social networks (set up by the user) which may post or announce the purchase transaction in a social forum such as a wall post or a tweet. In one implementation, the user may select a social payment processing option 6023. The indicator 6024 may show the authorizing and sending social share data in progress.

In another implementation, a restricted payment mode 6025 may be activated for certain purchase activities such as prescription purchases. The mode may be activated in accordance with rules defined by issuers, insurers, merchants, payment processor and/or other entities to facilitate processing of specialized goods and services. In this mode, the user may scroll down the list of forms of payments 6026 under the funds tab to select specialized accounts such as a flexible spending account (FSA) 6027, health savings account (HAS), and/or the like and amounts to be debited to the selected accounts. In one implementation, such restricted payment mode 1925 processing may disable social sharing of purchase information.

In one embodiment, the wallet mobile application may facilitate importing of funds via the import funds user interface 6028. For example, a user who is unemployed may obtain unemployment benefit fund 6029 via the wallet mobile application. In one implementation, the entity providing the funds may also configure rules for using the fund as shown by the processing indicator message 6030. The wallet may read and apply the rules prior, and may reject any purchases with the unemployment funds that fail to meet the criteria set by the rules. Example criteria may include, for example, merchant category code (MCC), time of transaction, location of transaction, and/or the like. As an example, a transaction with a grocery merchant having MCC 5411 may be approved, while a transaction with a bar merchant having an MCC 5813 may be refused.

With reference to FIG. 60B, in one embodiment, the wallet mobile application may facilitate dynamic payment optimization based on factors such as user location, preferences and currency value preferences among others. For example, when a user is in the United States, the country indicator 6031 may display a flag of the United States and may set the currency 6033 to the United States. In a further implementation, the wallet mobile application may automatically rearrange the order in which the forms of payments 6035 are listed to reflect the popularity or acceptability of various forms of payment. In one implementation, the arrangement may reflect the user's preference, which may not be changed by the wallet mobile application.

Similarly, when a German user operates a wallet in Germany, the mobile wallet application user interface may be dynamically updated to reflect the country of operation 6032 and the currency 6034. In a further implementation, the wallet application may rearrange the order in which different forms of payment 6036 are listed based on their acceptance level in that country. Of course, the order of these forms of payments may be modified by the user to suit his or her own preferences.

With reference to FIG. 60C, in one embodiment, the payee tab 6037 in the wallet mobile application user interface may facilitate user selection of one or more payees receiving the funds selected in the funds tab. In one implementation, the user interface may show a list of all payees 6038 with whom the user has previously transacted or available to transact. The user may then select one or more payees. The payees 6038 may include larger merchants such as Amazon.com Inc., and individuals such as Jane P. Doe. Next to each payee name, a list of accepted payment modes for the payee may be displayed. In one implementation, the user may select the payee Jane P. Doe 6039 for receiving payment. Upon selection, the user interface may display additional identifying information relating to the payee.

With reference to FIG. 60D, in one embodiment, the mode tab 1940 may facilitate selection of a payment mode accepted by the payee. A number of payment modes may be available for selection. Example modes include, blue tooth 6041, wireless 6042, snap mobile by user-obtained QR code 6043, secure chip 6044, TWITTER 6045, near-field communication (NFC) 6046, cellular 6047, snap mobile by user-provided QR code 6048, USB 6049 and FACEBOOK 6050, among others. In one implementation, only the payment modes that are accepted by the payee may be selectable by the user. Other non-accepted payment modes may be disabled.

With reference to FIG. 60E, in one embodiment, the offers tab 6051 may provide real-time offers that are relevant to items in a user's cart for selection by the user. The user may select one or more offers from the list of applicable offers 6052 for redemption. In one implementation, some offers may be combined, while others may not. When the user selects an offer that may not be combined with another offer, the unselected offers may be disabled. In a further implementation, offers that are recommended by the wallet application's recommendation engine may be identified by an indicator, such as the one shown by 6053. In a further implementation, the user may read the details of the offer by expanding the offer row as shown by 6054 in the user interface.

With reference to FIG. 60F, in one embodiment, the social tab 6055 may facilitate integration of the wallet application with social channels 6056. In one implementation, a user may select one or more social channels 6056 and may sign in to the selected social channel from the wallet application by providing to the wallet application the social channel user name and password 6057 and signing in 6058. The user may then use the social button 6059 to send or receive money through the integrated social channels. In a further implementation, the user may send social share data such as purchase information or links through integrated social channels. In another embodiment, the user supplied login credentials may allow EOOR to engage in interception parsing.

FIG. 61 shows a user interface diagram illustrating example features of virtual wallet applications, in a history mode, in some embodiments of the EOOR. In one embodiment, a user may select the history mode 6110 to view a history of prior purchases and perform various actions on those prior purchases. For example, a user may enter a merchant identifying information such as name, product, MCC, and/or the like in the search bar 6111. In another implementation, the user may use voice activated search feature by clicking on the microphone icon 6114. The wallet application may query the storage areas in the mobile device or elsewhere (e.g., one or more databases and/or tables remote from the mobile device) for transactions matching the search keywords. The user interface may then display the results of the query such as transaction 6115. The user interface may also identify the date 6112 of the transaction, the merchants and items 6113 relating to the transaction, a barcode of the receipt confirming that a transaction was made, the amount of the transaction and any other relevant information.

In one implementation, the user may select a transaction, for example transaction 6115, to view the details of the transaction. For example, the user may view the details of the items associated with the transaction and the amounts 6116 of each item. In a further implementation, the user may select the show option 6117 to view actions 6118 that the user may take in regards to the transaction or the items in the transaction. For example, the user may add a photo to the transaction (e.g., a picture of the user and the iPad the user bought). In a further implementation, if the user previously shared the purchase via social channels, a post including the photo may be generated and sent to the social channels for publishing. In one implementation, any sharing may be optional, and the user, who did not share the purchase via social channels, may still share the photo through one or more social channels of his or her choice directly from the history mode of the wallet application. In another implementation, the user may add the transaction to a group such as company expense, home expense, travel expense or other categories set up by the user. Such grouping may facilitate year-end accounting of expenses, submission of work expense reports, submission for value added tax (VAT) refunds, personal expenses, and/or the like. In yet another implementation, the user may buy one or more items purchased in the transaction. The user may then execute a transaction without going to the merchant catalog or site to find the items. In a further implementation, the user may also cart one or more items in the transaction for later purchase.

The history mode, in another embodiment, may offer facilities for obtaining and displaying ratings 6119 of the items in the transaction. The source of the ratings may be the user, the user's friends (e.g., from social channels, contacts, etc.), reviews aggregated from the web, and/or the like. The user interface in some implementations may also allow the user to post messages to other users of social channels (e.g., TWITTER or FACEBOOK). For example, the display area 6120 shows FACEBOOK message exchanges between two users. In one implementation, a user may share a link via a message 6121. Selection of such a message having embedded link to a product may allow the user to view a description of the product and/or purchase the product directly from the history mode.

In one embodiment, the history mode may also include facilities for exporting receipts. The export receipts pop up 6122 may provide a number of options for exporting the receipts of transactions in the history. For example, a user may use one or more of the options 6125, which include save (to local mobile memory, to server, to a cloud account, and/or the like), print to a printer, fax, email, and/or the like. The user may utilize his or her address book 6123 to look up email or fax number for exporting. The user may also specify format options 6124 for exporting receipts. Example format options may include, without limitation, text files (.doc, .txt, .rtf, iif, etc.), spreadsheet (.csv, .xls, etc.), image files (.jpg, .tff, .png, etc.), portable document format (.pdf), postscript (.ps), and/or the like. The user may then click or tap the export button 6127 to initiate export of receipts.

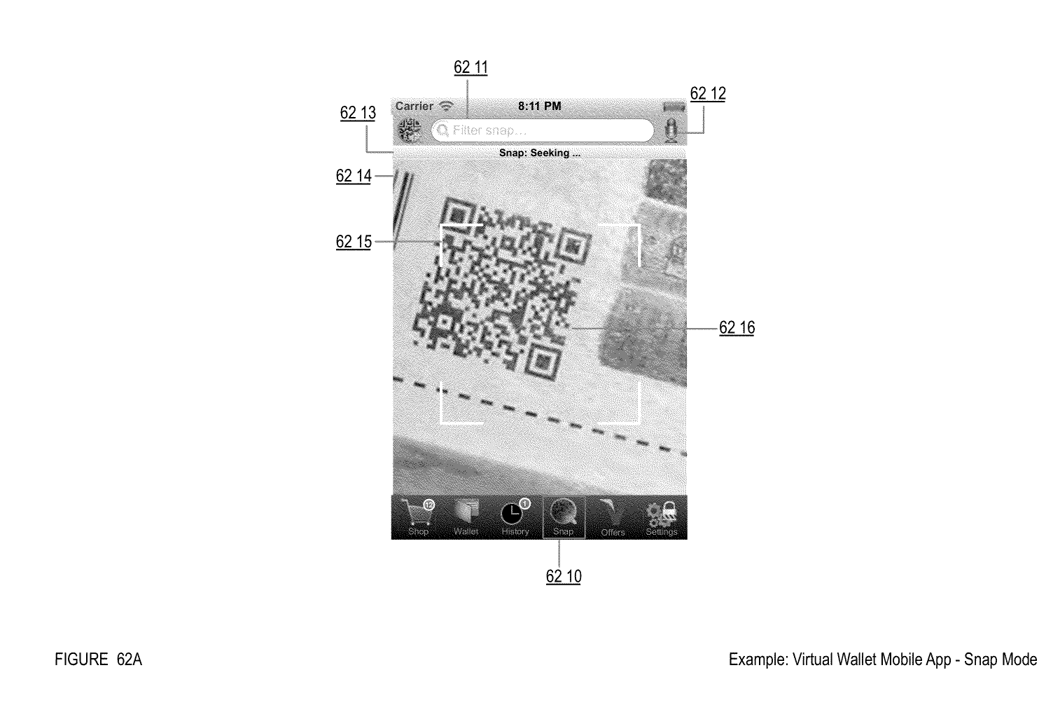

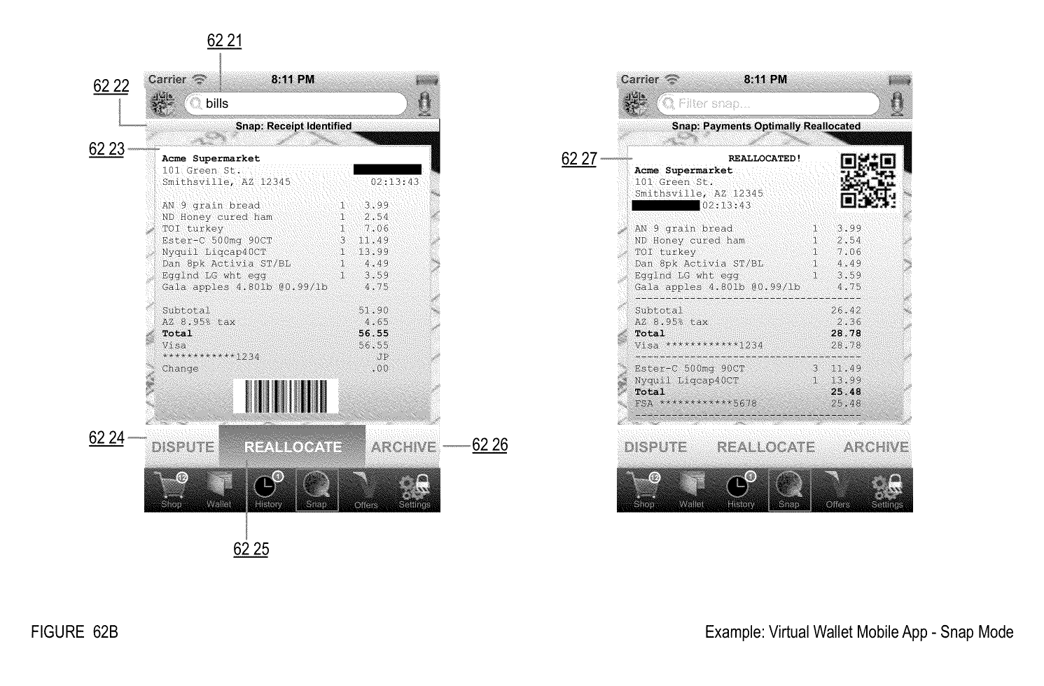

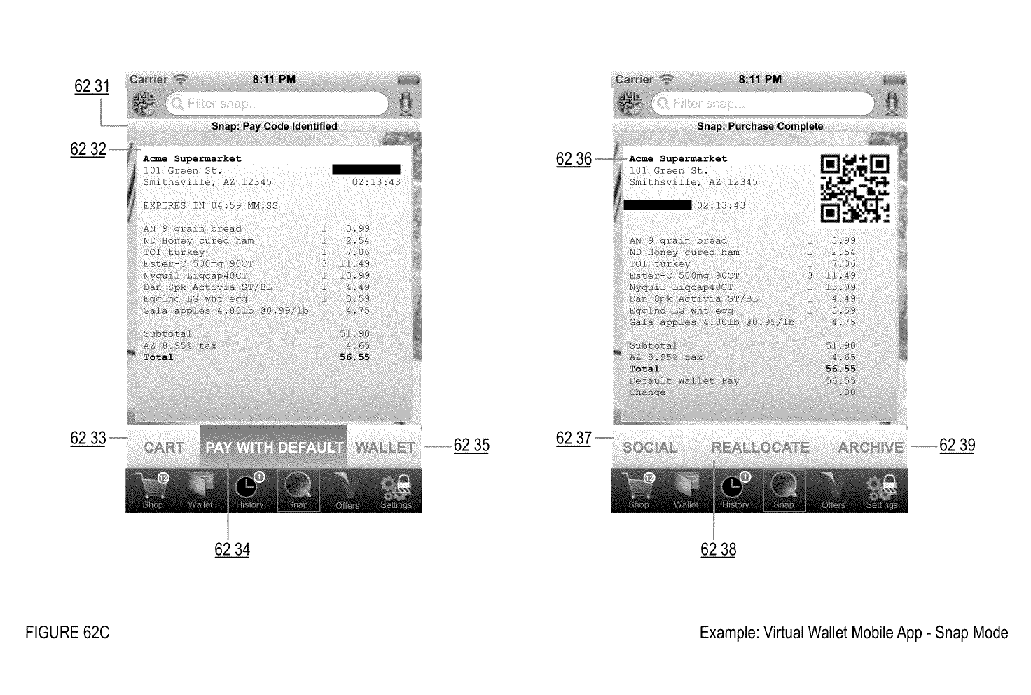

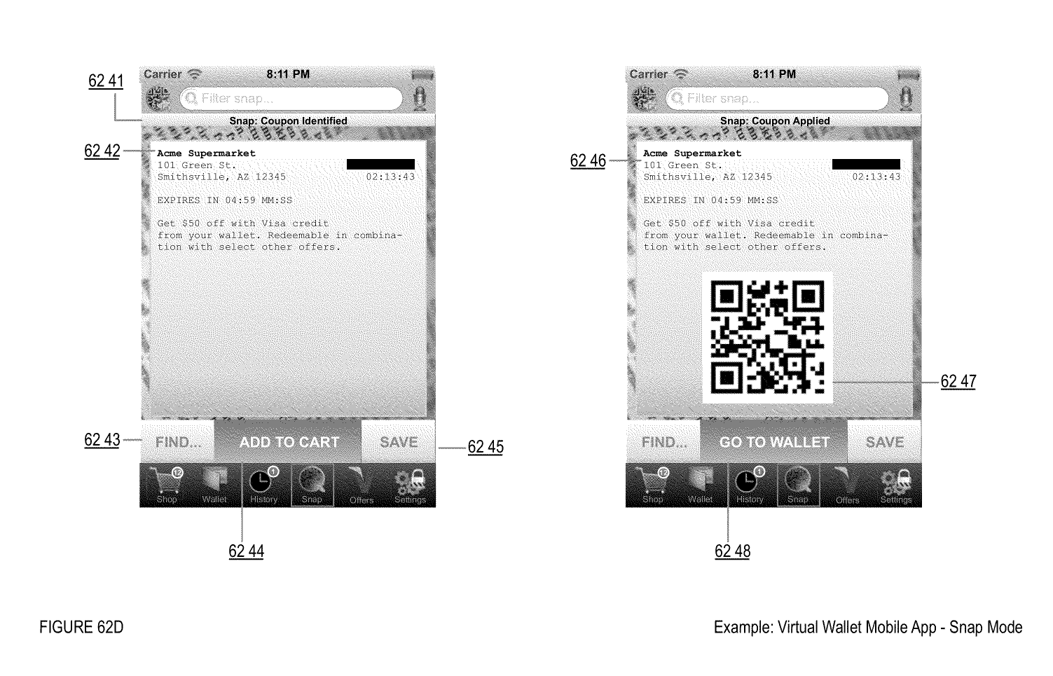

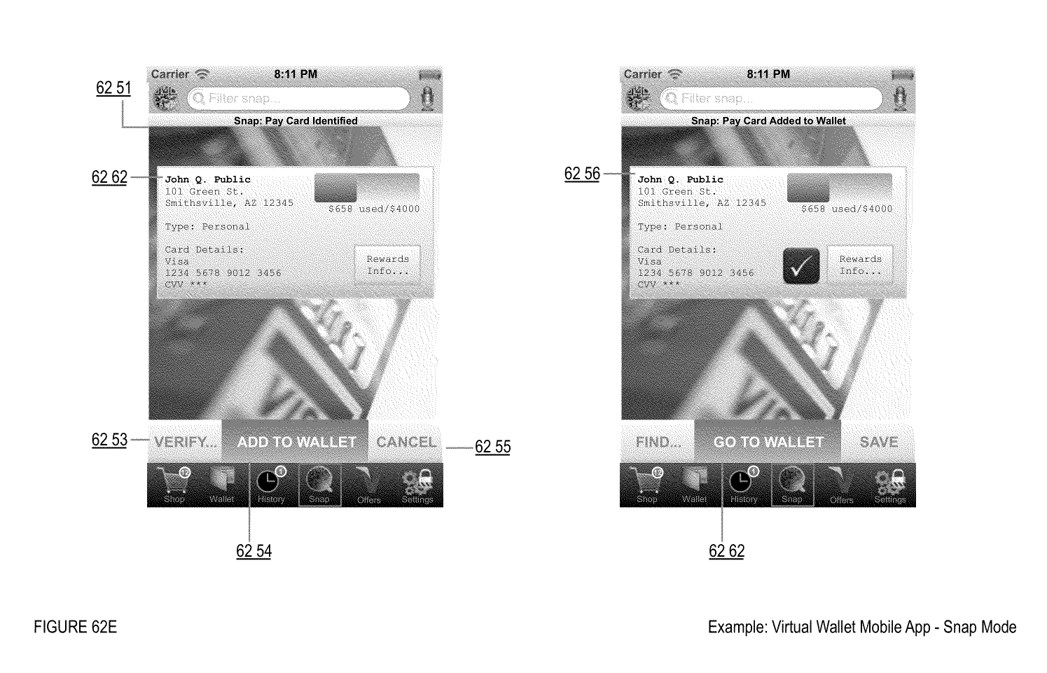

FIGS. 62A-E show user interface diagrams illustrating example features of virtual wallet applications in a snap mode, in some embodiments of the EOOR. With reference to FIG. 62A, in one embodiment, a user may select the snap mode 2110 to access its snap features. The snap mode may handle any machine-readable representation of data. Examples of such data may include linear and 2D bar codes such as UPC code and QR codes. These codes may be found on receipts, product packaging, and/or the like. The snap mode may also process and handle pictures of receipts, products, offers, credit cards or other payment devices, and/or the like. An example user interface in snap mode is shown in FIG. 62A. A user may use his or her mobile phone to take a picture of a QR code 6215 and/or a barcode 6214. In one implementation, the bar 6213 and snap frame 6215 may assist the user in snapping codes properly. For example, the snap frame 6215, as shown, does not capture the entirety of the code 6216. As such, the code captured in this view may not be resolvable as information in the code may be incomplete. This is indicated by the message on the bar 6213 that indicates that the snap mode is still seeking the code. When the code 6216 is completely framed by the snap frame 6215, the bar message may be updated to, for example, “snap found.” Upon finding the code, in one implementation, the user may initiate code capture using the mobile device camera. In another implementation, the snap mode may automatically snap the code using the mobile device camera.

With reference to FIG. 62B, in one embodiment, the snap mode may facilitate payment reallocation post transaction. For example, a user may buy grocery and prescription items from a retailer Acme Supermarket. The user may, inadvertently or for ease of checkout for example, use his or her Visa card to pay for both grocery and prescription items. However, the user may have an FSA account that could be used to pay for prescription items, and which would provide the user tax benefits. In such a situation, the user may use the snap mode to initiate transaction reallocation.

As shown, the user may enter a search term (e.g., bills) in the search bar 2121. The user may then identify in the tab 6222 the receipt 6223 the user wants to reallocate. Alternatively, the user may directly snap a picture of a barcode on a receipt, and the snap mode may generate and display a receipt 6223 using information from the barcode. The user may now reallocate 6225. In some implementations, the user may also dispute the transaction 6224 or archive the receipt 6226.

In one implementation, when the reallocate button 6225 is selected, the wallet application may perform optical character recognition (OCR) of the receipt. Each of the items in the receipt may then be examined to identify one or more items which could be charged to which payment device or account for tax or other benefits such as cash back, reward points, etc. In this example, there is a tax benefit if the prescription medication charged to the user's Visa card is charged to the user's FSA. The wallet application may then perform the reallocation as the back end. The reallocation process may include the wallet contacting the payment processor to credit the amount of the prescription medication to the Visa card and debit the same amount to the user's FSA account. In an alternate implementation, the payment processor (e.g., Visa or MasterCard) may obtain and OCR the receipt, identify items and payment accounts for reallocation and perform the reallocation. In one implementation, the wallet application may request the user to confirm reallocation of charges for the selected items to another payment account. The receipt 6227 may be generated after the completion of the reallocation process. As discussed, the receipt shows that some charges have been moved from the Visa account to the FSA.

With reference to FIG. 62C, in one embodiment, the snap mode may facilitate payment via pay code such as barcodes or QR codes. For example, a user may snap a QR code of a transaction that is not yet complete. The QR code may be displayed at a merchant POS terminal, a web site, or a web application and may be encoded with information identifying items for purchase, merchant details and other relevant information. When the user snaps such as a QR code, the snap mode may decode the information in the QR code and may use the decoded information to generate a receipt 6232. Once the QR code is identified, the navigation bar 6231 may indicate that the pay code is identified. The user may now have an option to add to cart 6233, pay with a default payment account 6234 or pay with wallet 6235.

In one implementation, the user may decide to pay with default 6234. The wallet application may then use the user's default method of payment, in this example the wallet, to complete the purchase transaction. Upon completion of the transaction, a receipt may be automatically generated for proof of purchase. The user interface may also be updated to provide other options for handling a completed transaction. Example options include social 6237 to share purchase information with others, reallocate 6238 as discussed with regard to FIG. 62B, and archive 6239 to store the receipt.

With reference to FIG. 62D, in one embodiment, the snap mode may also facilitate offer identification, application and storage for future use. For example, in one implementation, a user may snap an offer code 6241 (e.g., a bar code, a QR code, and/or the like). The wallet application may then generate an offer text 6242 from the information encoded in the offer code. The user may perform a number of actions on the offer code. For example, the user use the find button 6243 to find all merchants who accept the offer code, merchants in the proximity who accept the offer code, products from merchants that qualify for the offer code, and/or the like. The user may also apply the offer code to items that are currently in the cart using the add to cart button 6244. Furthermore, the user may also save the offer for future use by selecting the save button 6245.

In one implementation, after the offer or coupon 6246 is applied, the user may have the option to find qualifying merchants and/or products using find, the user may go to the wallet using 6248, and the user may also save the offer or coupon 6246 for later use.

With reference to FIG. 62E, in one embodiment, the snap mode may also offer facilities for adding a funding source to the wallet application. In one implementation, a pay card such as a credit card, debit card, pre-paid card, smart card and other pay accounts may have an associated code such as a bar code or QR code. Such a code may have encoded therein pay card information including, but not limited to, name, address, pay card type, pay card account details, balance amount, spending limit, rewards balance, and/or the like. In one implementation, the code may be found on a face of the physical pay card. In another implementation, the code may be obtained by accessing an associated online account or another secure location. In yet another implementation, the code may be printed on a letter accompanying the pay card. A user, in one implementation, may snap a picture of the code. The wallet application may identify the pay card 6251 and may display the textual information 6252 encoded in the pay card. The user may then perform verification of the information 6252 by selecting the verify button 6253. In one implementation, the verification may include contacting the issuer of the pay card for confirmation of the decoded information 6252 and any other relevant information. In one implementation, the user may add the pay card to the wallet by selecting the ‘add to wallet’ button 6254. The instruction to add the pay card to the wallet may cause the pay card to appear as one of the forms of payment under the funds tab 6016 discussed in FIG. 60A. The user may also cancel importing of the pay card as a funding source by selecting the cancel button 6255. When the pay card has been added to the wallet, the user interface may be updated to indicate that the importing is complete via the notification display 6256. The user may then access the wallet 6257 to begin using the added pay card as a funding source.

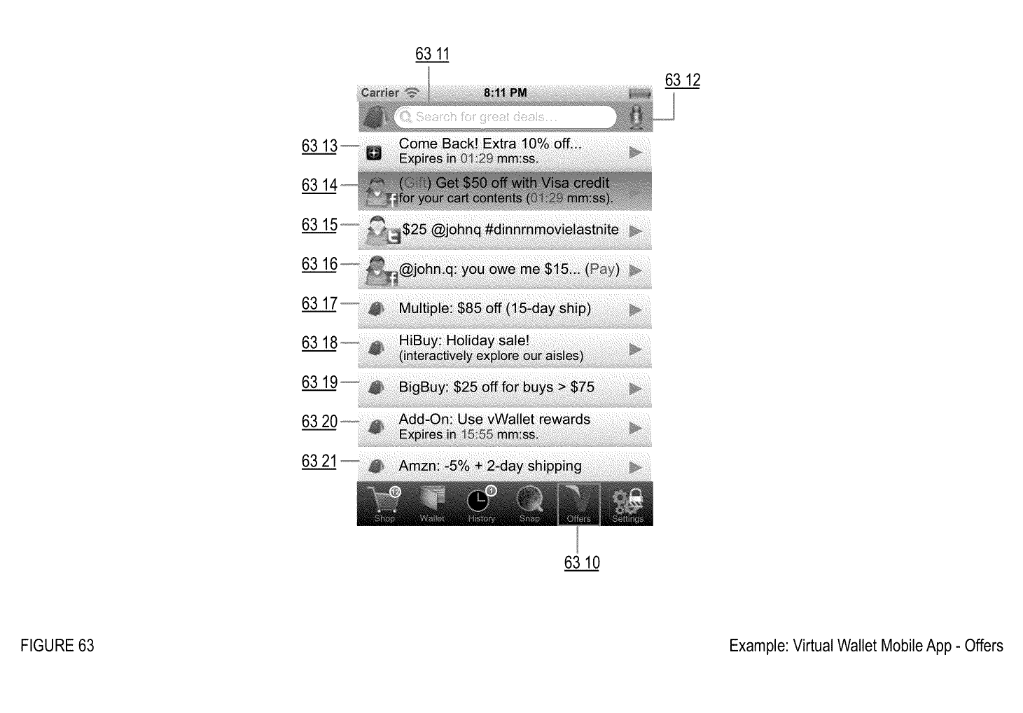

FIG. 63 shows a user interface diagram illustrating example features of virtual wallet applications, in an offers mode, in some embodiments of the EOOR. In some implementations, the EOOR may allow a user to search for offers for products and/or services from within the virtual wallet mobile application. For example, the user may enter text into a graphical user interface (“GUI”) element 6311, or issue voice commands by activating GUI element 6312 and speaking commands into the device. In some implementations, the EOOR may provide offers based on the user's prior behavior, demographics, current location, current cart selection or purchase items, and/or the like. For example, if a user is in a brick-and-mortar store, or an online shopping website, and leaves the (virtual) store, then the merchant associated with the store may desire to provide a sweetener deal to entice the consumer back into the (virtual) store. The merchant may provide such an offer 6313. For example, the offer may provide a discount, and may include an expiry time. In some implementations, other users may provide gifts (e.g., 6314) to the user, which the user may redeem. In some implementations, the offers section may include alerts as to payment of funds outstanding to other users (e.g., 6315). In some implementations, the offers section may include alerts as to requesting receipt of funds from other users (e.g., 6316). For example, such a feature may identify funds receivable from other applications (e.g., mail, calendar, tasks, notes, reminder programs, alarm, etc.), or by a manual entry by the user into the virtual wallet application. In some implementations, the offers section may provide offers from participating merchants in the EOOR, e.g., 6317-6319, 6320. These offers may sometimes be assembled using a combination of participating merchants, e.g., 6317. In some implementations, the EOOR itself may provide offers for users contingent on the user utilizing particular payment forms from within the virtual wallet application, e.g., 6320.

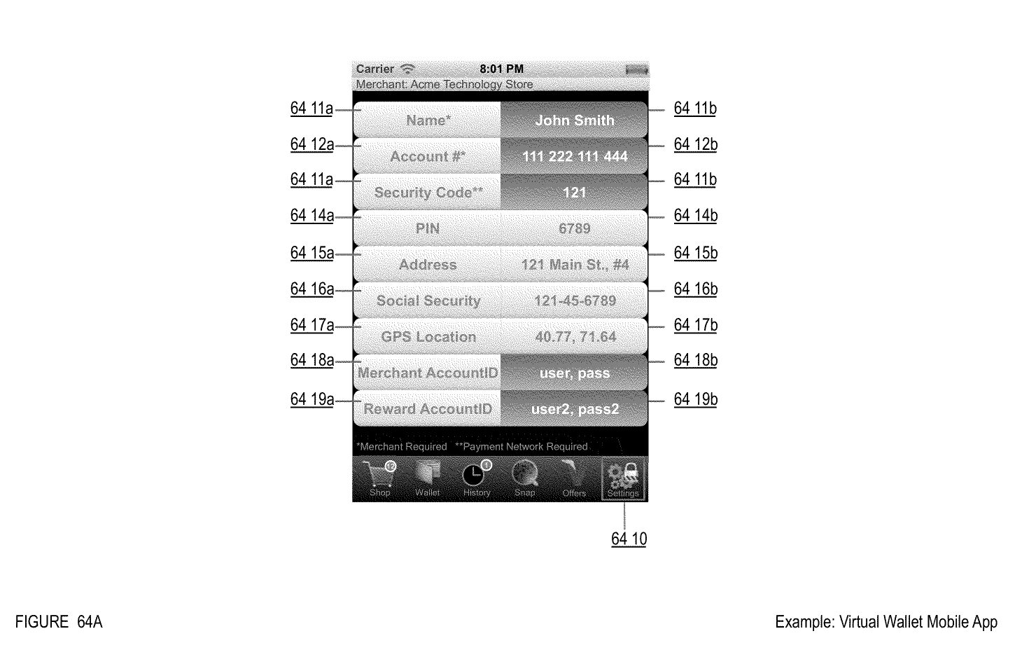

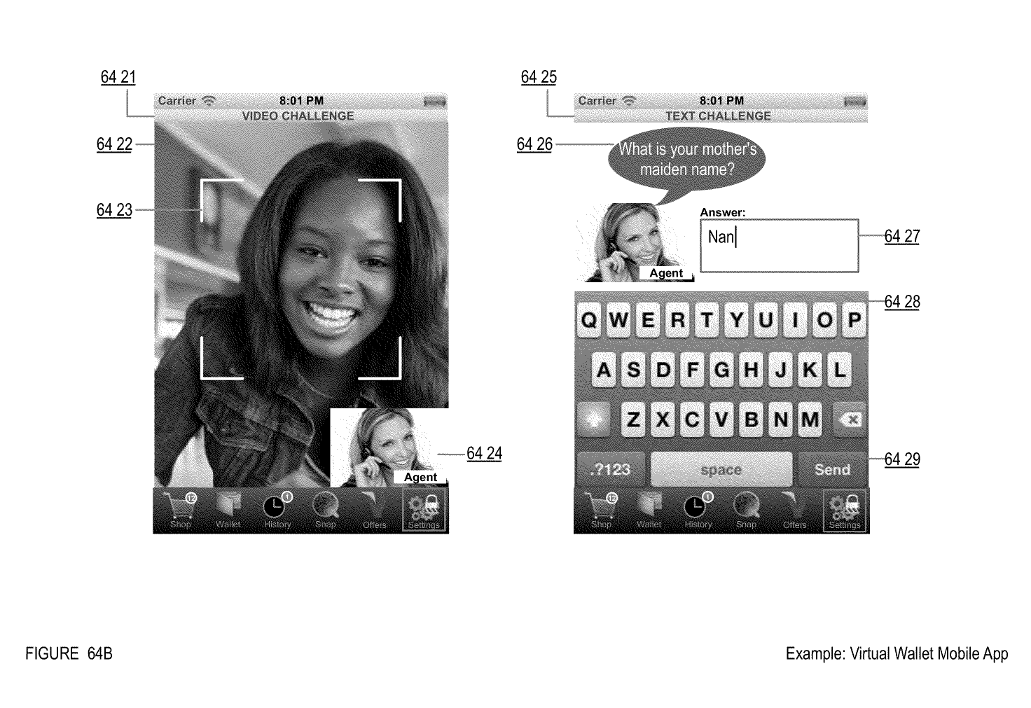

FIGS. 64A-B show user interface diagrams illustrating example features of virtual wallet applications, in a security and privacy mode, in some embodiments of the EOOR. With reference to FIG. 64A, in some implementations, the user may be able to view and/or modify the user profile and/or settings of the user, e.g., by activating a user interface element. For example, the user may be able to view/modify a user name (e.g., 6411a-b), account number (e.g., 6412a-b), user security access code (e.g., 6413-b), user pin (e.g., 6414-b), user address (e.g., 6415-b), social security number associated with the user (e.g., 6416-b), current device GPS location (e.g., 6417-b), user account of the merchant in whose store the user currently is (e.g., 6418-b), the user's rewards accounts (e.g., 6419-b), and/or the like. In some implementations, the user may be able to select which of the data fields and their associated values should be transmitted to facilitate the purchase transaction, thus providing enhanced data security for the user. For example, in the example illustration in FIG. 64A, the user has selected the name 6411a, account number 6412a, security code 6413a, merchant account ID 6418a and rewards account ID 6419a as the fields to be sent as part of the notification to process the purchase transaction. In some implementations, the user may toggle the fields and/or data values that are sent as part of the notification to process the purchase transactions. In some implementations, the app may provide multiple screens of data fields and/or associated values stored for the user to select as part of the purchase order transmission. In some implementations, the app may provide the EOOR with the GPS location of the user. Based on the GPS location of the user, the EOOR may determine the context of the user (e.g., whether the user is in a store, doctor's office, hospital, postal service office, etc.). Based on the context, the user app may present the appropriate fields to the user, from which the user may select fields and/or field values to send as part of the purchase order transmission.

For example, a user may go to doctor's office and desire to pay the co-pay for doctor's appointment. In addition to basic transactional information such as account number and name, the app may provide the user the ability to select to transfer medical records, health information, which may be provided to the medical provider, insurance company, as well as the transaction processor to reconcile payments between the parties. In some implementations, the records may be sent in a Health Insurance Portability and Accountability Act (HIPAA)-compliant data format and encrypted, and only the recipients who are authorized to view such records may have appropriate decryption keys to decrypt and view the private user information.

With reference to FIG. 64B, in some implementations, the app executing on the user's device may provide a “VerifyChat” feature for fraud prevention. For example, the EOOR may detect an unusual and/or suspicious transaction. The EOOR may utilize the VerifyChat feature to communicate with the user, and verify the authenticity of the originator of the purchase transaction. In various implementations, the EOOR may send electronic mail message, text (SMS) messages, Facebook® messages, Twitter™ tweets, text chat, voice chat, video chat (e.g., Apple FaceTime), and/or the like to communicate with the user. For example, the EOOR may initiate a video challenge for the user, e.g., 6421. For example, the user may need to present him/her-self via a video chat, e.g., 6422. In some implementations, a customer service representative, e.g., agent 6424, may manually determine the authenticity of the user using the video of the user. In some implementations, the EOOR may utilize face, biometric and/or like recognition (e.g., using pattern classification techniques) to determine the identity of the user. In some implementations, the app may provide reference marker (e.g., cross-hairs, target box, etc.), e.g., 6423, so that the user may the video to facilitate the EOOR's automated recognition of the user. In some implementations, the user may not have initiated the transaction, e.g., the transaction is fraudulent. In such implementations, the user may cancel the challenge. The EOOR may then cancel the transaction, and/or initiate fraud investigation procedures on behalf of the user.

In some implementations, the EOOR may utilize a text challenge procedure to verify the authenticity of the user, e.g., 6425. For example, the EOOR may communicate with the user via text chat, SMS messages, electronic mail, Facebook® messages, Twitter™ tweets, and/or the like. The EOOR may pose a challenge question, e.g., 6426, for the user. The app may provide a user input interface element(s) (e.g., virtual keyboard 6428) to answer the challenge question posed by the EOOR. In some implementations, the challenge question may be randomly selected by the EOOR automatically; in some implementations, a customer service representative may manually communicate with the user. In some implementations, the user may not have initiated the transaction, e.g., the transaction is fraudulent. In such implementations, the user may cancel the text challenge. The EOOR may cancel the transaction, and/or initiate fraud investigation on behalf of the user.

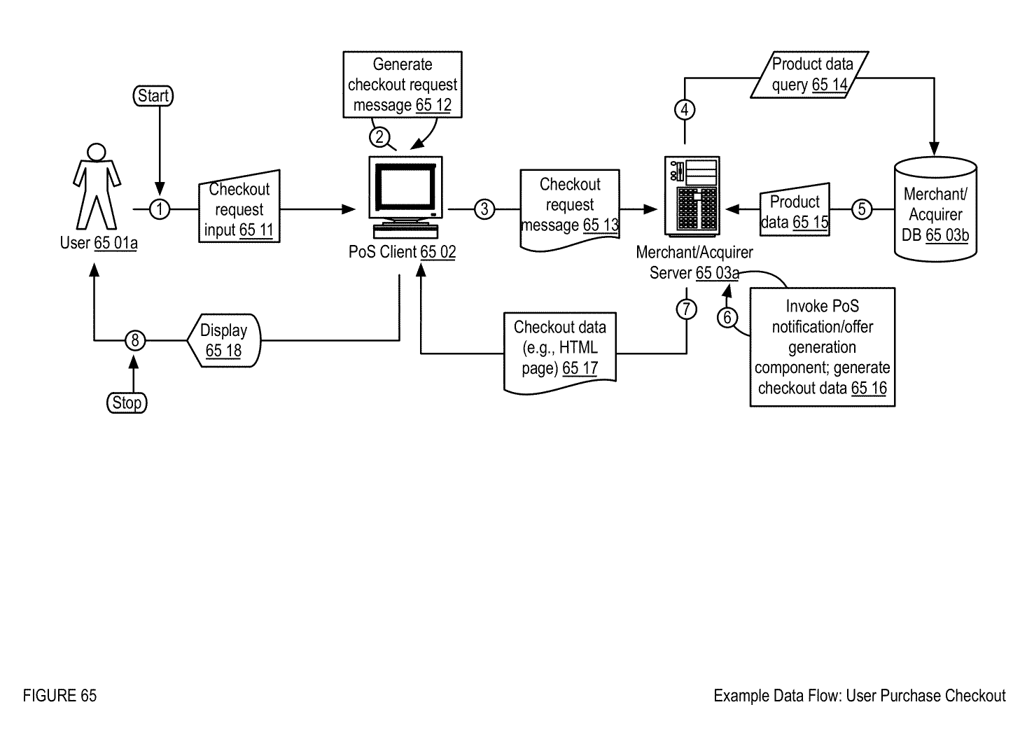

FIG. 65 shows a data flow diagram illustrating an example user purchase checkout procedure in some embodiments of the EOOR. In some embodiments, a user, e.g., 6501a, may desire to purchase a product, service, offering, and/or the like (“product”), from a merchant via a merchant online site or in the merchant's store. The user may communicate with a merchant/acquirer (“merchant”) server, e.g., 6503a, via a client such as, but not limited to: a personal computer, mobile device, television, point-of-sale terminal, kiosk, ATM, and/or the like (e.g., 6502). For example, the user may provide user input, e.g., checkout input 6511, into the client indicating the user's desire to purchase the product. In various embodiments, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. As an example, a user in a merchant store may scan a product barcode of the product via a barcode scanner at a point-of-sale terminal. As another example, the user may select a product from a webpage catalog on the merchant's website, and add the product to a virtual shopping cart on the merchant's website. The user may then indicate the user's desire to checkout the items in the (virtual) shopping cart. For example, the user may activate a user interface element provided by the client to indicate the user's desire to complete the user purchase checkout. The client may generate a checkout request, e.g., 6512, and provide the checkout request, e.g., 6513, to the merchant server. For example, the client may provide a (Secure) Hypertext Transfer Protocol (“HTTP(S)”) POST message including the product details for the merchant server in the form of data formatted according to the eXtensible Markup Language (“XML”). An example listing of a checkout request 6512, substantially in the form of a HTTP(S) POST message including XML-formatted data, is provided below:

```
POST /checkoutrequest.php HTTP/1.1
Host: www.merchant.com
Content-Type: Application/XML
Content-Length: 667
<?XML version = “1.0” encoding = “UTF-8”?>
<checkout_request>
  <checkout_ID>4NFU4RG94</checkout_ID>
  <timestamp>2011-02-22 15:22:43</timestamp>
  <purchase_detail>
    <num_products>5</num_products>
    <product_ID>AE95049324</product_ID>
    <product_ID>MD09808755</product_ID>
    <product_ID>OC12345764</product_ID>
    <product_ID>KE76549043</product_ID>
    <product_ID>SP27674509</product_ID>
  </purchase_detail>
<!--optional parameters-->
  <user_ID>john.q.public@gmail.com</user_ID>
  <PoS_client_detail>
    <client_IP>192.168.23.126</client_IP>
    <client_type>smartphone</client_type>
    <client_model>HTC Hero</client_model>
    <OS>Android 2.2</OS>
    <app_installed_flag>true</app_installed_flag>
  </PoS_client_detail>
</checkout_request>
```

In some embodiments, the merchant server may obtain the checkout request from the client, and extract the checkout detail (e.g., XML data) from the checkout request. For example, the merchant server may utilize a parser such as the example parsers described below in the discussion with reference to FIG. 71. Based on parsing the checkout request 6512, the merchant server may extract product data (e.g., product identifiers), as well as available PoS client data, from the checkout request. In some embodiments, using the product data, the merchant server may query, e.g., 6514, a merchant/acquirer (“merchant”) database, e.g., 6503b, to obtain product data, e.g., 6515, such as product information, product pricing, sales tax, offers, discounts, rewards, and/or other information to process the purchase transaction and/or provide value-added services for the user. For example, the merchant database may be a relational database responsive to Structured Query Language (“SQL”) commands. The merchant server may execute a hypertext preprocessor (“PHP”) script including SQL commands to query a database table (such as FIG. 71, Products 7119l) for product data. An example product data query 6514, substantially in the form of PHP/SQL commands, is provided below:

```
<?PHP
header(‘Content-Type: text/plain’);
mysql_connect(“254.93.179.112”,$DBserver,$password); // access
database server
mysql_select_db(“EOOR_DB.SQL”); // select database table to search
//create query
$query = “SELECT product_title product_attributes_list product_price
    tax_info_list related_products_list offers_list discounts_list
    rewards_list merchants_list merchant_availability_list FROM
    ProductsTable WHERE product_ID LIKE ‘%’ $prodID”;
$result = mysql_query($query); // perform the search query
mysql_close(“EOOR_DB.SQL”); // close database access
?>
```

In some embodiments, in response to obtaining the product data, the merchant server may generate, e.g., 6516, checkout data to provide for the PoS client. In some embodiments, such checkout data, e.g., 6517, may be embodied, in part, in a HyperText Markup Language (“HTML”) page including data for display, such as product detail, product pricing, total pricing, tax information, shipping information, offers, discounts, rewards, value-added service information, etc., and input fields to provide payment information to process the purchase transaction, such as account holder name, account number, billing address, shipping address, tip amount, etc. In some embodiments, the checkout data may be embodied, in part, in a Quick Response (“QR”) code image that the PoS client can display, so that the user may capture the QR code using a user's device to obtain merchant and/or product data for generating a purchase transaction processing request. In some embodiments, a user alert mechanism may be built into the checkout data. For example, the merchant server may embed a URL specific to the transaction into the checkout data. In some embodiments, the alerts URL may further be embedded into optional level 3 data in card authorization requests, such as those discussed further below with reference to FIGS. 67-68. The URL may point to a webpage, data file, executable script, etc., stored on the merchant's server dedicated to the transaction that is the subject of the card authorization request. For example, the object pointed to by the URL may include details on the purchase transaction, e.g., products being purchased, purchase cost, time expiry, status of order processing, and/or the like. Thus, the merchant server may provide to the payment network the details of the transaction by passing the URL of the webpage to the payment network. In some embodiments, the payment network may provide notifications to the user, such as a payment receipt, transaction authorization confirmation message, shipping notification and/or the like. In such messages, the payment network may provide the URL to the user device. The user may navigate to the URL on the user's device to obtain alerts regarding the user's purchase, as well as other information such as offers, coupons, related products, rewards notifications, and/or the like. An example listing of a checkout data 6517, substantially in the form of XML-formatted data, is provided below:

```
<?XML version = “1.0” encoding = “UTF-8”?>
<checkout_data>
    <session_ID>4NFU4RG94</session_ID>
    <timestamp>2011-02-22 15:22:43</timestamp>
    <expiry_lapse>00:00:30</expiry_lapse>
    <transaction_cost>$34.78</transaction_cost>
    <alerts_URL>www.merchant.com/shopcarts.php?sessionID=
    4NFU4RG94</alerts_URL>
    <!--optional data-->
    <user_ID>john.q.public@gmail.com</user_ID>
    <client_details>
        <client_IP>192.168.23.126</client_IP>
        <client_type>smartphone</client_type>
        <client_model>HTC Hero</client_model>
        <OS>Android 2.2</OS>
        <app_installed_flag>true</app_installed_flag>
    </client_details>
    <purchase_details>
        <num_products>1</num_products>
        <product>
            <product_type>book</product_type>
            <product_params>
                <product_title>XML for dummies
                </product_title>
                <ISBN>938-2-14-168710-0</ISBN>
                <edition>2nd ed.</edition>
                <cover>hardbound</cover>
                <seller>bestbuybooks</seller>
            </product_params>
            <quantity>1</quantity>
        </product>
    </purchase_details>
    <offers_details>
        <num_offers>1</num_offers>
        <product>
            <product_type>book</product_type>
            <product_params>
                <product_title>Here's more XML
                </product_title>
                <ISBN>922-7-14-165720-1</ISBN>
                <edition>1nd ed.</edition>
                <cover>hardbound</cover>
                <seller>digibooks</seller>
            </product_params>
            <quantity>1</quantity>
        </product>
    </offers_details>
    <secure_element>www.merchant.com/securedyn/0394733/
    123.png</secure_element>
    <merchant_params>
        <merchant_id>3FBCR4INC</merchant_id>
        <merchant_name>Books & Things, Inc.
        </merchant_name>
        <merchant_auth_key>1NNF484MCP59CHB27365
        </merchant_auth_key>
    </merchant_params>
<checkout_data>
```

Upon obtaining the checkout data, e.g., 6517, the PoS client may render and display, e.g., 6518, the checkout data for the user.

FIG. 66 shows a logic flow diagram illustrating example aspects of a user purchase checkout in some embodiments of the EOOR, e.g., a User Purchase Checkout (“UPC”) component 6600. In some embodiments, a user may desire to purchase a product, service, offering, and/or the like (“product”), from a merchant via a merchant online site or in the merchant's store. The user may communicate with a merchant/acquirer (“merchant”) server via a PoS client. For example, the user may provide user input, e.g., 6601, into the client indicating the user's desire to purchase the product. The client may generate a checkout request, e.g., 6602, and provide the checkout request to the merchant server. In some embodiments, the merchant server may obtain the checkout request from the client, and extract the checkout detail (e.g., XML data) from the checkout request. For example, the merchant server may utilize a parser such as the example parsers described below in the discussion with reference to FIG. 71. Based on parsing the checkout request, the merchant server may extract product data (e.g., product identifiers), as well as available PoS client data, from the checkout request. In some embodiments, using the product data, the merchant server may query, e.g., 6603, a merchant/acquirer (“merchant”) database to obtain product data, e.g., 6604, such as product information, product pricing, sales tax, offers, discounts, rewards, and/or other information to process the purchase transaction and/or provide value-added services for the user. In some embodiments, in response to obtaining the product data, the merchant server may generate, e.g., 6605, checkout data to provide, e.g., 6606, for the PoS client. Upon obtaining the checkout data, the PoS client may render and display, e.g., 6607, the checkout data for the user.

FIGS. 67A-B show data flow diagrams illustrating an example purchase transaction authorization procedure in some embodiments of the EOOR. With reference to FIG. 67A, in some embodiments, a user, e.g., 6701a, may wish to utilize a virtual wallet account to purchase a product, service, offering, and/or the like (“product”), from a merchant via a merchant online site or in the merchant's store. The user may utilize a physical card, or a user wallet device, e.g., 6701b, to access the user's virtual wallet account. For example, the user wallet device may be a personal/laptop computer, cellular telephone, smartphone, tablet, eBook reader, netbook, gaming console, and/or the like. The user may provide a wallet access input, e.g., 6711 into the user wallet device. In various embodiments, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. In some embodiments, the user wallet device may authenticate the user based on the user's wallet access input, and provide virtual wallet features for the user.

In some embodiments, upon authenticating the user for access to virtual wallet features, the user wallet device may provide a transaction authorization input, e.g., 6714, to a point-of-sale (“PoS”) client, e.g., 6702. For example, the user wallet device may communicate with the PoS client via Bluetooth, Wi-Fi, cellular communication, one- or two-way near-field communication (“NFC”), and/or the like. In embodiments where the user utilizes a plastic card instead of the user wallet device, the user may swipe the plastic card at the PoS client to transfer information from the plastic card into the PoS client. For example, the PoS client may obtain, as transaction authorization input 6714, track 1 data from the user's plastic card (e.g., credit card, debit card, prepaid card, charge card, etc.), such as the example track 1 data provided below:

```
%B123456789012345\hat{ }PUBLIC/
J.Q.\hat{ }99011200000000000000**901******?*
(wherein ‘123456789012345’ is the card number of ‘J.Q. Public’ and
    has a CVV number of 901. ‘990112’ is a service code, and ***
    represents decimal digits which change randomly each time the card
    is used.)
```

In embodiments where the user utilizes a user wallet device, the user wallet device may provide payment information to the PoS client, formatted according to a data formatting protocol appropriate to the communication mechanism employed in the communication between the user wallet device and the PoS client. An example listing of transaction authorization input 6714, substantially in the form of XML-formatted data, is provided below:

```
<?XML version = “1.0” encoding = “UTF-8”?>
<transaction_authorization_input>
    <payment_data>
        <account>
            <charge_priority>1</charge_priority>
            <charge_ratio>40%</charge_ratio>
            <account_number>123456789012345</account_number>
            <account_name>John Q. Public</account_name>
            <bill_add>987 Green St #456, Chicago, IL 94652
            </bill_add>
            <ship_add>987 Green St #456, Chicago, IL 94652
            </ship_add>
            <CVV>123</CVV>
        </account>
        <account>
            <charge_priority>1</charge_priority>
            <charge_ratio>60%</charge_ratio>
            <account_number>234567890123456</account_number>
            <account_name>John Q. Public</account_name>
            <bill_add>987 Green St #456, Chicago, IL 94652
            </bill_add>
            <ship_add>987 Green St #456, Chicago, IL 94652
            </ship_add>
            <CVV>173</CVV>
        </account>
        <account>
            <charge_priority>2</charge_priority>
            <charge_ratio>100%</charge_ratio>
            <account_number>345678901234567</account_number>
            <account_name>John Q. Public</account_name>
            <bill_add>987 Green St #456, Chicago, IL 94652
            </bill_add>
            <ship_add>987 Green St #456, Chicago, IL 94652
            </ship_add>
            <CVV>695</CVV>
        </account>
    </payment_data>
    <!--optional data-->
    <timestamp>2011-02-22 15:22:43</timestamp>
    <expiry_lapse>00:00:30</expiry_lapse>
    <secure_key>0445329070598623487956543322</secure_key>
    <alerts_track_flag>TRUE</alerts_track_flag>
    <wallet_device_details>
        <device_IP>192.168.23.126</client_IP>
        <device_type>smartphone</client_type>
        <device_model>HTC Hero</client_model>
        <OS>Android 2.2</OS>
        <wallet_app_installed_flag>true</wallet_app_installed_flag>
    </wallet_device_details>
</transaction_authorization_input>
```

In some embodiments, the PoS client may generate a card authorization request, e.g., 6715, using the obtained transaction authorization input from the user wallet device, and/or product/checkout data (see, e.g., FIG. 65, 6515-6517). An example listing of a card authorization request 6715, substantially in the form of a HTTP(S) POST message including XML-formatted data, is provided below:

```
POST /authorizationrequests.php HTTP/1.1
Host: www.acquirer.com
Content-Type: Application/XML
Content-Length: 1306
<?XML version = “1.0” encoding = “UTF-8”?>
<card_authorization_request>
    <session_ID>4NFU4RG94</order_ID>
    <timestamp>2011-02-22 15:22:43</timestamp>
    <expiry>00:00:30</expiry>
    <alerts_URL>www.merchant.com/shopcarts.php?sessionID=
    AEBB4356</alerts_URL>
    <!--optional data-->
    <user_ID>john.q.public@gmail.com</user_ID>
    <PoS_details>
        <PoS_IP>192.168.23.126</client_IP>
        <PoS_type>smartphone</client_type>
        <PoS_model>HTC Hero</client_model>
        <OS>Android 2.2</OS>
        <app_installed_flag>true</app_installed_flag>
    </PoS_details>
    <purchase_details>
        <num_products>1</num_products>
        <product>
            <product_type>book</product_type>
            <product_params>
                <product_title>XML for dummies
                </product_title>
                <ISBN>938-2-14-168710-0</ISBN>
                <edition>2nd ed.</edition>
                <cover>hardbound</cover>
                <seller>bestbuybooks</seller>
            </product_params>
            <quantity>1</quantity>
        </product>
    </purchase_details>
    <merchant_params>
        <merchant_id>3FBCR4INC</merchant_id>
        <merchant_name>Books & Things, Inc.
        </merchant_name>
        <merchant_auth_key>1NNF484MCP59CHB27365
        </merchant_auth_key>
    </merchant_params>
    <account_params>
        <account_name>John Q. Public</account_name>
        <account_type>credit</account_type>
        <account_num>123456789012345</account_num>
        <billing_address>123 Green St., Norman, OK 98765
        </billing_address>
        <phone>123-456-7809</phone>
        <sign>/jqp/</sign>
        <confirm_type>email</confirm_type>
        <contact_info>john.q.public@gmail.com</contact_info>
    </account_params>
    <shipping_info>
        <shipping_adress>same as billing</shipping_address>
        <ship_type>expedited</ship_type>
        <ship_carrier>FedEx</ship_carrier>
        <ship_account>123-45-678</ship_account>
        <tracking_flag>true</tracking_flag>
        <sign_flag>false</sign_flag>
    </shipping_info>
</card_authorization_request>
```

In some embodiments, the card authorization request generated by the user device may include a minimum of information required to process the purchase transaction. For example, this may improve the efficiency of communicating the purchase transaction request, and may also advantageously improve the privacy protections provided to the user and/or merchant. For example, in some embodiments, the card authorization request may include at least a session ID for the user's shopping session with the merchant. The session ID may be utilized by any component and/or entity having the appropriate access authority to access a secure site on the merchant server to obtain alerts, reminders, and/or other data about the transaction(s) within that shopping session between the user and the merchant. In some embodiments, the PoS client may provide the generated card authorization request to the merchant server, e.g., 6716. The merchant server may forward the card authorization request to a pay gateway server, e.g., 6704a, for routing the card authorization request to the appropriate payment network for payment processing. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the merchant server may query a database, e.g., merchant/acquirer database 6703b, for a network address of the payment gateway server, for example by using a portion of a user payment card number, or a user ID (such as an email address) as a keyword for the database query. For example, the merchant server may issue PHP/SQL commands to query a database table (such as FIG. 71, Pay Gateways 7119h) for a URL of the pay gateway server. An example payment gateway address query 6717, substantially in the form of PHP/SQL commands, is provided below:

<?PHP
header(‘Content-Type: text/plain’);
mysql_connect(“254.93.179.112”,$DBserver,$password); // access
database server
mysql_select_db(“EOOR_DB.SQL”); // select database table to search
//create query
$query = “SELECT paygate_id paygate_address paygate_URL
paygate_name FROM
PayGatewayTable WHERE card_num LIKE ‘%’ $cardnum”;
$result = mysql_query($query); // perform the search query
mysql_close(“EOOR_DB.SQL”); // close database access
?>

In response, the merchant/acquirer database may provide the requested payment gateway address, e.g., 6718. The merchant server may forward the card authorization request to the pay gateway server using the provided address, e.g., 6719. In some embodiments, upon receiving the card authorization request from the merchant server, the pay gateway server may invoke a component to provide one or more services associated with purchase transaction authorization. For example, the pay gateway server may invoke components for fraud prevention, loyalty and/or rewards, and/or other services for which the user-merchant combination is authorized. The pay gateway server may forward the card authorization request to a pay network server, e.g., 6705a, for payment processing. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the pay gateway server may query a database, e.g., pay gateway database 6704b, for a network address of the payment network server, for example by using a portion of a user payment card number, or a user ID (such as an email address) as a keyword for the database query. For example, the pay gateway server may issue PHP/SQL commands to query a database table (such as FIG. 71, Pay Gateways 7119h) for a URL of the pay network server. An example payment network address query 6721, substantially in the form of PHP/SQL commands, is provided below:

<?PHP
header(‘Content-Type: text/plain’);
mysql_connect(“254.93.179.112”,$DBserver,$password); // access
database server
mysql_select_db(“EOOR_DB.SQL”); // select database table to search
//create query
$query = “SELECT payNET_id payNET_address payNET_URL
payNET_name FROM
PayGatewayTable WHERE card_num LIKE ‘%’ $cardnum”;
$result = mysql_query($query); // perform the search query
mysql_close(“EOOR_DB.SQL”); // close database access
?>

In response, the payment gateway database may provide the requested payment network address, e.g., 6722. The pay gateway server may forward the card authorization request to the pay network server using the provided address, e.g., 6723.

With reference to FIG. 67B, in some embodiments, the pay network server may process the transaction so as to transfer funds for the purchase into an account stored on an acquirer of the merchant. For example, the acquirer may be a financial institution maintaining an account of the merchant. For example, the proceeds of transactions processed by the merchant may be deposited into an account maintained by at a server of the acquirer.

In some embodiments, the pay network server may generate a query, e.g., 6724, for issuer server(s) corresponding to the user-selected payment options. For example, the user's account may be linked to one or more issuer financial institutions (“issuers”), such as banking institutions, which issued the account(s) for the user. For example, such accounts may include, but not be limited to: credit card, debit card, prepaid card, checking, savings, money market, certificates of deposit, stored (cash) value accounts and/or the like. Issuer server(s), e.g., 6706a, of the issuer(s) may maintain details of the user's account(s). In some embodiments, a database, e.g., pay network database 6705b, may store details of the issuer server(s) associated with the issuer(s). In some embodiments, the pay network server may query a database, e.g., pay network database 6705b, for a network address of the issuer(s) server(s), for example by using a portion of a user payment card number, or a user ID (such as an email address) as a keyword for the database query. For example, the merchant server may issue PHP/SQL commands to query a database table (such as FIG. 71, Issuers 71190f) for network address(es) of the issuer(s) server(s). An example issuer server address(es) query 6724, substantially in the form of PHP/SQL commands, is provided below:

<?PHP
header(‘Content-Type: text/plain’);
mysql_connect(“254.93.179.112”,$DBserver,$password); // access
database server
mysql_select_db(“EOOR_DB.SQL”); // select database table to search
//create query
$query = “SELECT issuer_id issuer_address issuer_URL
issuer_name FROM
IssuersTable WHERE card_num LIKE ‘%’ $cardnum”;
$result = mysql_query($query); // perform the search query
mysql_close(“EOOR_DB.SQL”); // close database access
?>

In response to obtaining the issuer server query, e.g., 6724, the pay network database may provide, e.g., 6725, the requested issuer server data to the pay network server. In some embodiments, the pay network server may utilize the issuer server data to generate funds authorization request(s), e.g., 6726, for each of the issuer server(s) selected based on the pre-defined payment settings associated with the user's virtual wallet, and/or the user's payment options input, and provide the funds authorization request(s) to the issuer server(s). In some embodiments, the funds authorization request(s) may include details such as, but not limited to: the costs to the user involved in the transaction, card account details of the user, user billing and/or shipping information, and/or the like. An example listing of a funds authorization request 6726, substantially in the form of a HTTP(S) POST message including XML-formatted data, is provided below:

```
POST /fundsauthorizationrequest.php HTTP/1.1
Host: www.issuer.com
Content-Type: Application/XML
Content-Length: 624
<?XML version = “1.0” encoding = “UTF-8”?>
<funds_authorization_request>
    <query_ID>VNEI39FK</query_ID>
    <timestamp>2011-02-22 15:22:44</timestamp>
    <transaction_cost>$22.61</transaction_cost>
    <account_params>
        <account_type>checking</account_type>
        <account_num>1234567890123456</account_num>
    </account_params>
    <!--optional parameters-->
    <purchase_summary>
        <num_products>1</num_products>
        <product>
            <product_summary>Book - XML for dummies
            </product_summary>
            <product_quantity>1</product_quantity?
        </product>
    </purchase_summary>
    <merchant_params>
        <merchant_id>3FBCR4INC</merchant_id>
        <merchant_name>Books & Things, Inc.</merchant_name>
        <merchant_auth_key>1NNF484MCP59CHB27365
        </merchant_auth_key>
    </merchant_params>
</funds_authorization_request>
```

In some embodiments, an issuer server may parse the authorization request(s), and based on the request details may query a database, e.g., user profile database 6706b, for data associated with an account linked to the user. For example, the merchant server may issue PHP/SQL commands to query a database table (such as FIG. 71, Accounts 7119d) for user account(s) data. An example user account(s) query 6727, substantially in the form of PHP/SQL commands, is provided below:

<?PHP
header(‘Content-Type: text/plain’);
mysql_connect(“254.93.179.112”,$DBserver,$password); // access
database server
mysql_select_db(“EOOR_DB.SQL”); // select database table to search
//create query
$query = “SELECT issuer user_id user_name user_balance
account_type FROM
AccountsTable WHERE account_num LIKE ‘%’ $accountnum”;
$result = mysql_query($query); // perform the search query
mysql_close(“EOOR_DB.SQL”); // close database access
?>

In some embodiments, on obtaining the user account(s) data, e.g., 6728, the issuer server may determine whether the user can pay for the transaction using funds available in the account, 6729. For example, the issuer server may determine whether the user has a sufficient balance remaining in the account, sufficient credit associated with the account, and/or the like. Based on the determination, the issuer server(s) may provide a funds authorization response, e.g., 6730, to the pay network server. For example, the issuer server(s) may provide a HTTP(S) POST message similar to the examples above. In some embodiments, if at least one issuer server determines that the user cannot pay for the transaction using the funds available in the account, the pay network server may request payment options again from the user (e.g., by providing an authorization fail message to the user device and requesting the user device to provide new payment options), and re-attempt authorization for the purchase transaction. In some embodiments, if the number of failed authorization attempts exceeds a threshold, the pay network server may abort the authorization process, and provide an “authorization fail” message to the merchant server, user device and/or client.

In some embodiments, the pay network server may obtain the funds authorization response including a notification of successful authorization, and parse the message to extract authorization details. Upon determining that the user possesses sufficient funds for the transaction, e.g., 6731, the pay network server may invoke a component to provide value-add services for the user.

In some embodiments, the pay network server may generate a transaction data record from the authorization request and/or authorization response, and store the details of the transaction and authorization relating to the transaction in a transactions database. For example, the pay network server may issue PHP/SQL commands to store the data to a database table (such as FIG. 71, Transactions 7119i). An example transaction store command, substantially in the form of PHP/SQL commands, is provided below:

```
<?PHP
header(‘Content-Type: text/plain’);
mysql_connect(“254.92.185.103”,$DBserver,$password); // access
database server
mysql_select(“EOOR_DB.SQL”); // select database to append
mysql_query(“INSERT INTO TransactionsTable (PurchasesTable
    (timestamp, purchase_summary_list, num_products,
    product_summary, product_quantity, transaction_cost,
    account_params_list, account_name, account_type,
    account_num, billing_addres, zipcode, phone, sign,
    merchant_params_list, merchant_id, merchant_name,
    merchant_auth_key)
VALUES (time( ), $purchase_summary_list, $num_products,
    $product_summary, $product_quantity, $transaction_cost,
    $account_params_list, $account_name, $account_type,
    $account_num, $billing_addres, $zipcode, $phone, $sign,
    $merchant_params_list, $merchant_id, $merchant_name,
    $merchant_auth_key)”);
    // add data to table in database
mysql_close(“EOOR_DB.SQL”); // close connection to database
?>
```

In some embodiments, the pay network server may forward a transaction authorization response, e.g., 6732, to the user wallet device, PoS client, and/or merchant server. The merchant may obtain the transaction authorization response, and determine from it that the user possesses sufficient funds in the card account to conduct the transaction. The merchant server may add a record of the transaction for the user to a batch of transaction data relating to authorized transactions. For example, the merchant may append the XML data pertaining to the user transaction to an XML data file comprising XML data for transactions that have been authorized for various users, e.g., 6733, and store the XML data file, e.g., 6734, in a database, e.g., merchant database 404. For example, a batch XML data file may be structured similar to the example XML data structure template provided below:

```
<?XML version = “1.0” encoding = “UTF-8”?>
<merchant_data>
    <merchant_id>3FBCR4INC</merchant_id>
    <merchant_name>Books & Things, Inc.</merchant_name>
    <merchant_auth_key>1NNF484MCP59CHB27365
    </merchant_auth_key>
    <account_number>123456789</account_number>
</merchant_data>
<transaction_data>
    <transaction 1>
        ...
    </transaction 1>
    <transaction 2>
        ...
    </transaction 2>
        .
        .
        .
    <transaction n>
        ...
    </transaction n>
</transaction_data>
```

In some embodiments, the server may also generate a purchase receipt, e.g., 6733, and provide the purchase receipt to the client, e.g., 6735. The client may render and display, e.g., 6736, the purchase receipt for the user. In some embodiments, the user's wallet device may also provide a notification of successful authorization to the user. For example, the PoS client/user device may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

FIGS. 68A-B show logic flow diagrams illustrating example aspects of purchase transaction authorization in some embodiments of the EOOR, e.g., a Purchase Transaction Authorization (“PTA”) component 6800. With reference to FIG. 68A, in some embodiments, a user may wish to utilize a virtual wallet account to purchase a product, service, offering, and/or the like (“product”), from a merchant via a merchant online site or in the merchant's store. The user may utilize a physical card, or a user wallet device to access the user's virtual wallet account. For example, the user wallet device may be a personal/laptop computer, cellular telephone, smartphone, tablet, eBook reader, netbook, gaming console, and/or the like. The user may provide a wallet access input, e.g., 6801, into the user wallet device. In various embodiments, the user input may include, but not be limited to: a single tap (e.g., a one-tap mobile app purchasing embodiment) of a touchscreen interface, keyboard entry, card swipe, activating a RFID/NFC enabled hardware device (e.g., electronic card having multiple accounts, smartphone, tablet, etc.) within the user device, mouse clicks, depressing buttons on a joystick/game console, voice commands, single/multi-touch gestures on a touch-sensitive interface, touching user interface elements on a touch-sensitive display, and/or the like. In some embodiments, the user wallet device may authenticate the user based on the user's wallet access input, and provide virtual wallet features for the user, e.g., 6802-6803.

In some embodiments, upon authenticating the user for access to virtual wallet features, the user wallet device may provide a transaction authorization input, e.g., 6804, to a point-of-sale (“PoS”) client. For example, the user wallet device may communicate with the PoS client via Bluetooth, Wi-Fi, cellular communication, one- or two-way near-field communication (“NFC”), and/or the like. In embodiments where the user utilizes a plastic card instead of the user wallet device, the user may swipe the plastic card at the PoS client to transfer information from the plastic card into the PoS client. In embodiments where the user utilizes a user wallet device, the user wallet device may provide payment information to the PoS client, formatted according to a data formatting protocol appropriate to the communication mechanism employed in the communication between the user wallet device and the PoS client.

In some embodiments, the PoS client may obtain the transaction authorization input, and parse the input to extract payment information from the transaction authorization input, e.g., 6805. For example, the PoS client may utilize a parser, such as the example parsers provided below in the discussion with reference to FIG. 71. The PoS client may generate a card authorization request, e.g., 6806, using the obtained transaction authorization input from the user wallet device, and/or product/checkout data (see, e.g., FIG. 65, 6515-6517).

In some embodiments, the PoS client may provide the generated card authorization request to the merchant server. The merchant server may forward the card authorization request to a pay gateway server, for routing the card authorization request to the appropriate payment network for payment processing. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the merchant server may query a database, e.g., 6808, for a network address of the payment gateway server, for example by using a portion of a user payment card number, or a user ID (such as an email address) as a keyword for the database query. In response, the merchant/acquirer database may provide the requested payment gateway address, e.g., 6810. The merchant server may forward the card authorization request to the pay gateway server using the provided address. In some embodiments, upon receiving the card authorization request from the merchant server, the pay gateway server may invoke a component to provide one or more service associated with purchase transaction authorization, e.g., 6811. For example, the pay gateway server may invoke components for fraud prevention, loyalty and/or rewards, and/or other services for which the user-merchant combination is authorized.

The pay gateway server may forward the card authorization request to a pay network server for payment processing, e.g., 6814. For example, the pay gateway server may be able to select from payment networks, such as Visa, Mastercard, American Express, Paypal, etc., to process various types of transactions including, but not limited to: credit card, debit card, prepaid card, B2B and/or like transactions. In some embodiments, the pay gateway server may query a database, e.g., 6812, for a network address of the payment network server, for example by using a portion of a user payment card number, or a user ID (such as an email address) as a keyword for the database query. In response, the payment gateway database may provide the requested payment network address, e.g., 6813. The pay gateway server may forward the card authorization request to the pay network server using the provided address, e.g., 6814.

With reference to FIG. 68B, in some embodiments, the pay network server may process the transaction so as to transfer funds for the purchase into an account stored on an acquirer of the merchant. For example, the acquirer may be a financial institution maintaining an account of the merchant. For example, the proceeds of transactions processed by the merchant may be deposited into an account maintained by at a server of the acquirer. In some embodiments, the pay network server may generate a query, e.g., 6815, for issuer server(s) corresponding to the user-selected payment options. For example, the user's account may be linked to one or more issuer financial institutions (“issuers”), such as banking institutions, which issued the account(s) for the user. For example, such accounts may include, but not be limited to: credit card, debit card, prepaid card, checking, savings, money market, certificates of deposit, stored (cash) value accounts and/or the like. Issuer server(s) of the issuer(s) may maintain details of the user's account(s). In some embodiments, a database, e.g., a pay network database, may store details of the issuer server(s) associated with the issuer(s). In some embodiments, the pay network server may query a database, e.g., 6815, for a network address of the issuer(s) server(s), for example by using a portion of a user payment card number, or a user ID (such as an email address) as a keyword for the database query.

In response to obtaining the issuer server query, the pay network database may provide, e.g., 6816, the requested issuer server data to the pay network server. In some embodiments, the pay network server may utilize the issuer server data to generate funds authorization request(s), e.g., 6817, for each of the issuer server(s) selected based on the pre-defined payment settings associated with the user's virtual wallet, and/or the user's payment options input, and provide the funds authorization request(s) to the issuer server(s). In some embodiments, the funds authorization request(s) may include details such as, but not limited to: the costs to the user involved in the transaction, card account details of the user, user billing and/or shipping information, and/or the like. In some embodiments, an issuer server may parse the authorization request(s), e.g., 6818, and based on the request details may query a database, e.g., 6819, for data associated with an account linked to the user.

In some embodiments, on obtaining the user account(s) data, e.g., 6820, the issuer server may determine whether the user can pay for the transaction using funds available in the account, e.g., 6821. For example, the issuer server may determine whether the user has a sufficient balance remaining in the account, sufficient credit associated with the account, and/or the like. Based on the determination, the issuer server(s) may provide a funds authorization response, e.g., 6822, to the pay network server. In some embodiments, if at least one issuer server determines that the user cannot pay for the transaction using the funds available in the account, the pay network server may request payment options again from the user (e.g., by providing an authorization fail message to the user device and requesting the user device to provide new payment options), and re-attempt authorization for the purchase transaction. In some embodiments, if the number of failed authorization attempts exceeds a threshold, the pay network server may abort the authorization process, and provide an “authorization fail” message to the merchant server, user device and/or client.

In some embodiments, the pay network server may obtain the funds authorization response including a notification of successful authorization, and parse the message to extract authorization details. Upon determining that the user possesses sufficient funds for the transaction, e.g., 6823, the pay network server may invoke a component to provide value-add services for the user, e.g., 6823.

In some embodiments, the pay network server may forward a transaction authorization response to the user wallet device, PoS client, and/or merchant server. The merchant may parse, e.g., 6824, the transaction authorization response, and determine from it that the user possesses sufficient funds in the card account to conduct the transaction, e.g., 6825, option “Yes.” The merchant server may add a record of the transaction for the user to a batch of transaction data relating to authorized transactions. For example, the merchant may append the XML data pertaining to the user transaction to an XML data file comprising XML data for transactions that have been authorized for various users, e.g., 6826, and store the XML data file, e.g., 6827, in a database. In some embodiments, the server may also generate a purchase receipt, e.g., 6828, and provide the purchase receipt to the client. The client may render and display, e.g., 6829, the purchase receipt for the user. In some embodiments, the user's wallet device may also provide a notification of successful authorization to the user. For example, the PoS client/user device may render a webpage, electronic message, text/SMS message, buffer a voicemail, emit a ring tone, and/or play an audio message, etc., and provide output including, but not limited to: sounds, music, audio, video, images, tactile feedback, vibration alerts (e.g., on vibration-capable client devices such as a smartphone etc.), and/or the like.

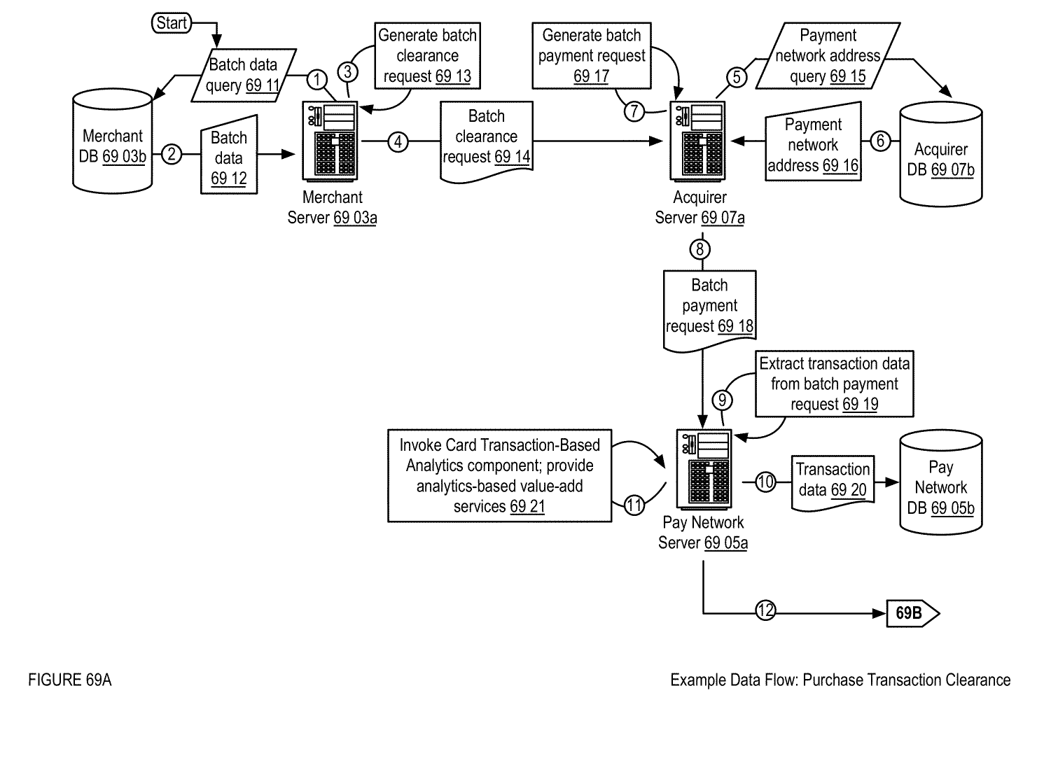

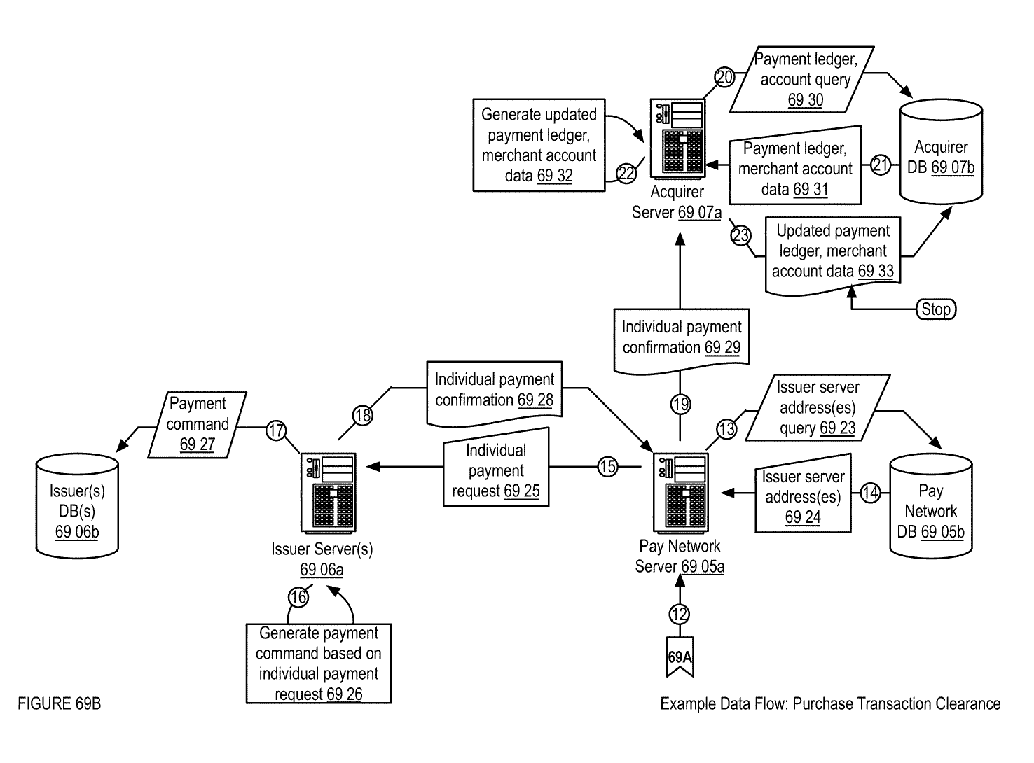

FIGS. 69A-B show data flow diagrams illustrating an example purchase transaction clearance procedure in some embodiments of the EOOR. With reference to FIG. 69A, in some embodiments, a merchant server, e.g., 6903a, may initiate clearance of a batch of authorized transactions. For example, the merchant server may generate a batch data request, e.g., 6911, and provide the request, to a merchant database, e.g., 6903b. For example, the merchant server may utilize PHP/SQL commands similar to the examples provided above to query a relational database. In response to the batch data request, the database may provide the requested batch data, e.g., 6912. The server may generate a batch clearance request, e.g., 6913, using the batch data obtained from the database, and provide, e.g., 6914, the batch clearance request to an acquirer server, e.g., 6907a. For example, the merchant server may provide a HTTP(S) POST message including XML-formatted batch data in the message body for the acquirer server. The acquirer server may generate, e.g., 6915, a batch payment request using the obtained batch clearance request, and provide, e.g., 6918, the batch payment request to the pay network server, e.g., 6905a. The pay network server may parse the batch payment request, and extract the transaction data for each transaction stored in the batch payment request, e.g., 6919. The pay network server may store the transaction data, e.g., 6920, for each transaction in a database, e.g., pay network database 6905b. In some embodiments, the pay network server may invoke a component to provide value-add analytics services based on analysis of the transactions of the merchant for whom the EOOR is clearing purchase transactions. Thus, in some embodiments, the pay network server may provide analytics-based value-added services for the merchant and/or the merchant's users.

With reference to FIG. 69B, in some embodiments, for each extracted transaction, the pay network server may query, e.g., 6923, a database, e.g., pay network database 6905b, for an address of an issuer server. For example, the pay network server may utilize PHP/SQL commands similar to the examples provided above. The pay network server may generate an individual payment request, e.g., 6925, for each transaction for which it has extracted transaction data, and provide the individual payment request, e.g., 6925, to the issuer server, e.g., 6906a. For example, the pay network server may provide an individual payment request to the issuer server(s) as a HTTP(S) POST message including XML-formatted data. An example listing of an individual payment request 6925, substantially in the form of a HTTP(S) POST message including XML-formatted data, is provided below:

```
POST /paymentrequest.php HTTP/1.1
Host: www.issuer.com
Content-Type: Application/XML
Content-Length: 788
<?XML version = “1.0” encoding = “UTF-8”?>
<pay_request>
    <request_ID>CNI4ICNW2</request_ID>
    <timestamp>2011-02-22 17:00:01</timestamp>
    <pay_amount>$34.78</pay_amount>
    <account_params>
        <account_name>John Q. Public</account_name>
        <account_type>credit</account_type>
        <account_num>123456789012345</account_num>
        <billing_address>123 Green St., Norman, OK 98765
        </billing_address>
        <phone>123-456-7809</phone>
        <sign>/jqp/</sign>
    </account_params>
    <merchant_params>
        <merchant_id>3FBCR4INC</merchant_id>
        <merchant_name>Books & Things, Inc.</merchant_name>
        <merchant_auth_key>1NNF484MCP59CHB27365
        </merchant_auth_key>
    </merchant_params>
    <purchase_summary>
        <num_products>1</num_products>
        <product>
            <product_summary>Book - XML for dummies
            </product_summary>
            <product_quantity>1</product_quantity?
        </product>
    </purchase_summary>
</pay_request>
```

In some embodiments, the issuer server may generate a payment command, e.g., 6927. For example, the issuer server may issue a command to deduct funds from the user's account (or add a charge to the user's credit card account). The issuer server may issue a payment command, e.g., 6927, to a database storing the user's account information, e.g., user profile database 6906b. The issuer server may provide an individual payment confirmation, e.g., 6928, to the pay network server, which may forward, e.g., 6929, the funds transfer message to the acquirer server. An example listing of an individual payment confirmation 6928, substantially in the form of a HTTP(S) POST message including XML-formatted data, is provided below:

```
POST /clearance.php HTTP/1.1
Host: www.acquirer.com
Content-Type: Application/XML
Content-Length: 206
<?XML version = “1.0” encoding = “UTF-8”?>
<deposit_ack>
    <request_ID>CNI4ICNW2</request_ID>
    <clear_flag>true</clear_flag>
    <timestamp>2011-02-22 17:00:02</timestamp>
    <deposit_amount>$34.78</deposit_amount>
</deposit_ack>
```

In some embodiments, the acquirer server may parse the individual payment confirmation, and correlate the transaction (e.g., using the request_ID field in the example above) to the merchant. The acquirer server may then transfer the funds specified in the funds transfer message to an account of the merchant. For example, the acquirer server may query, e.g. 6930, an acquirer database 6907b for payment ledger and/or merchant account data, e.g., 6931. The acquirer server may utilize payment ledger and/or merchant account data from the acquirer database, along with the individual payment confirmation, to generate updated payment ledger and/or merchant account data, e.g., 6932. The acquirer server may then store, e.g., 6933, the updated payment ledger and/or merchant account data to the acquire database.

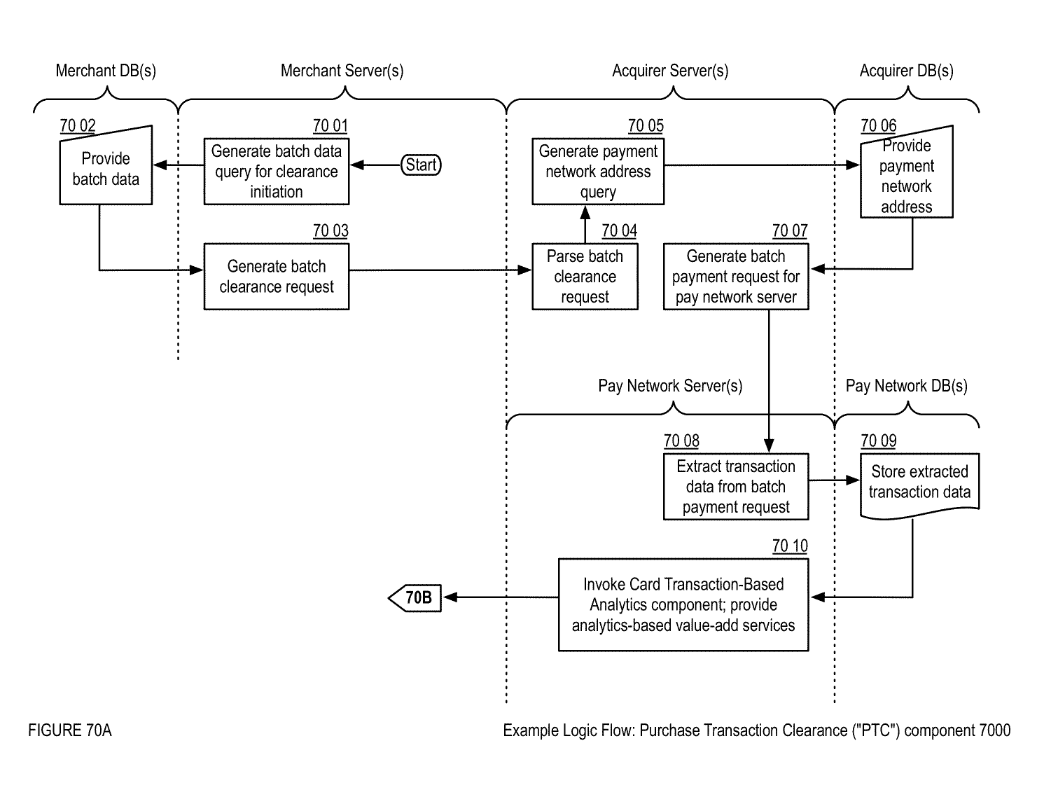

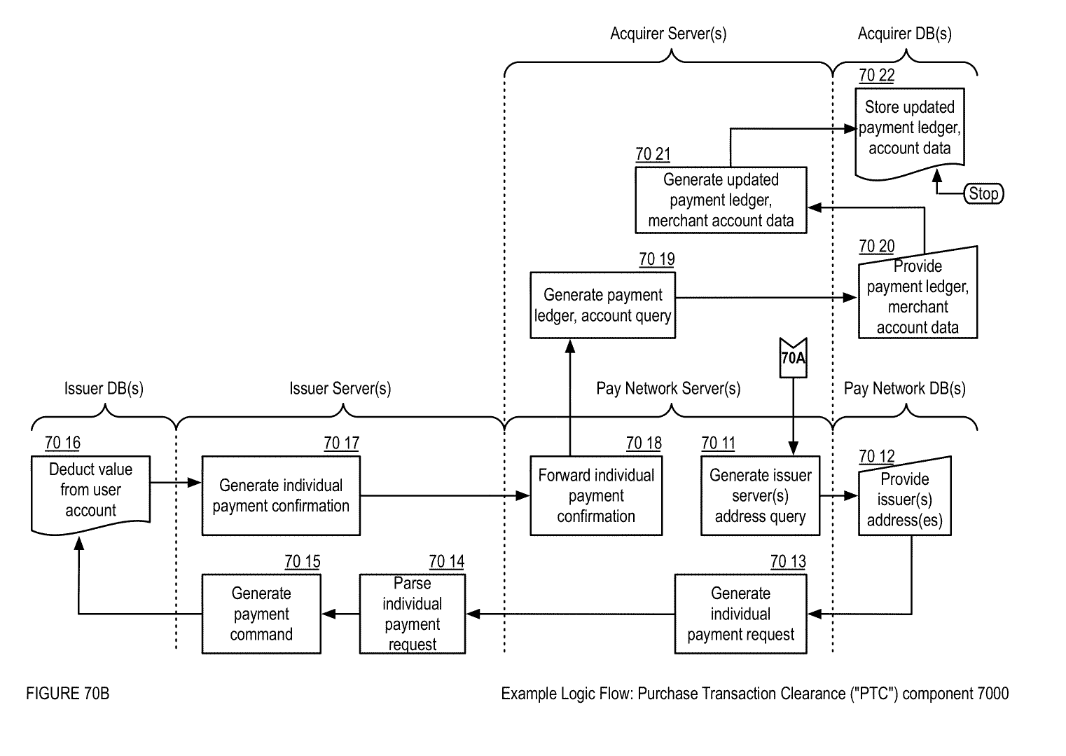

FIGS. 70A-B show logic flow diagrams illustrating example aspects of purchase transaction clearance in some embodiments of the EOOR, e.g., a Purchase Transaction Clearance (“PTC”) component 7000. With reference to FIG. 70A, in some embodiments, a merchant server may initiate clearance of a batch of authorized transactions. For example, the merchant server may generate a batch data request, e.g., 7001, and provide the request to a merchant database. In response to the batch data request, the database may provide the requested batch data, e.g., 7002. The server may generate a batch clearance request, e.g., 7003, using the batch data obtained from the database, and provide the batch clearance request to an acquirer server. The acquirer server may parse, e.g., 7004, the obtained batch clearance request, and generate, e.g., 7007, a batch payment request using the obtained batch clearance request to provide, the batch payment request to a pay network server. For example, the acquirer server may query, e.g., 7005, an acquirer database for an address of a payment network server, and utilize the obtained address, e.g., 7006, to forward the generated batch payment request to the pay network server.

The pay network server may parse the batch payment request obtained from the acquirer server, and extract the transaction data for each transaction stored in the batch payment request, e.g., 7008. The pay network server may store the transaction data, e.g., 7009, for each transaction in a pay network database. In some embodiments, the pay network server may invoke a component, e.g., 7010, to provide analytics based on the transactions of the merchant for whom purchase transaction are being cleared.

With reference to FIG. 70B, in some embodiments, for each extracted transaction, the pay network server may query, e.g., 7011, a pay network database for an address of an issuer server. The pay network server may generate an individual payment request, e.g., 7013, for each transaction for which it has extracted transaction data, and provide the individual payment request to the issuer server. In some embodiments, the issuer server may parse the individual payment request, e.g., 7014, and generate a payment command, e.g., 7015, based on the parsed individual payment request. For example, the issuer server may issue a command to deduct funds from the user's account (or add a charge to the user's credit card account). The issuer server may issue a payment command, e.g., 7015, to a database storing the user's account information, e.g., a user profile database. The issuer server may provide an individual payment confirmation, e.g., 7017, to the pay network server, which may forward, e.g., 7018, the individual payment confirmation to the acquirer server.

In some embodiments, the acquirer server may parse the individual payment confirmation, and correlate the transaction (e.g., using the request_ID field in the example above) to the merchant. The acquirer server may then transfer the funds specified in the funds transfer message to an account of the merchant. For example, the acquirer server may query, e.g. 7019, an acquirer database for payment ledger and/or merchant account data, e.g., 7020. The acquirer server may utilize payment ledger and/or merchant account data from the acquirer database, along with the individual payment confirmation, to generate updated payment ledger and/or merchant account data, e.g., 7021. The acquirer server may then store, e.g., 7022, the updated payment ledger and/or merchant account data to the acquire database.

### EOOR Controller

FIG. 71 shows a block diagram illustrating embodiments of a EOOR controller 7101. In this embodiment, the EOOR controller 7101 may serve to aggregate, process, store, search, serve, identify, instruct, generate, match, and/or facilitate interactions with a computer through various technologies, and/or other related data.

Typically, users, e.g., 7133a, which may be people and/or other systems, may engage information technology systems (e.g., computers) to facilitate information processing. In turn, computers employ processors to process information; such processors 7103 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 7129 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the EOOR controller 7101 may be connected to and/or communicate with entities such as, but not limited to: one or more users from user input devices 7111; peripheral devices 7112; an optional cryptographic processor device 7128; and/or a communications network 7113. For example, the EOOR controller 7101 may be connected to and/or communicate with users, e.g., 7133a, operating client device(s), e.g., 7133b, including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s), and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The EOOR controller 7101 may be based on computer systems that may comprise, but are not limited to, components such as: a computer systemization 7102 connected to memory 7129.

### Computer Systemization

A computer systemization 7102 may comprise a clock 7130, central processing unit (“CPU(s)” and/or “processor(s)” (these terms are used interchangeable throughout the disclosure unless noted to the contrary)) 7103, a memory 7129 (e.g., a read only memory (ROM) 7106, a random access memory (RAM) 7105, etc.), and/or an interface bus 7107, and most frequently, although not necessarily, are all interconnected and/or communicating through a system bus 7104 on one or more (mother)board(s) 7102 having conductive and/or otherwise transportive circuit pathways through which instructions (e.g., binary encoded signals) may travel to effectuate communications, operations, storage, etc. The computer systemization may be connected to a power source 7186; e.g., optionally the power source may be internal. Optionally, a cryptographic processor 7126 and/or transceivers (e.g., ICs) 7174 may be connected to the system bus. In another embodiment, the cryptographic processor and/or transceivers may be connected as either internal and/or external peripheral devices 7112 via the interface bus I/O. In turn, the transceivers may be connected to antenna(s) 7175, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing EOOR controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests.

Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 7129 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the EOOR controller and beyond through various interfaces. Should processing requirements dictate a greater amount speed and/or capacity, distributed processors (e.g., Distributed EOOR), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the EOOR may be achieved by implementing a microcontroller such as CAST's R8051XC2 microcontroller; Intel's MCS 51 (i.e., 8051 microcontroller); and/or the like. Also, to implement certain features of the EOOR, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the EOOR component collection (distributed or otherwise) and/or features may be implemented via the microprocessor and/or via embedded components; e.g., via ASIC, coprocessor, DSP, FPGA, and/or the like. Alternately, some implementations of the EOOR may be implemented with embedded components that are configured and used to achieve a variety of features or signal processing.

Depending on the particular implementation, the embedded components may include software solutions, hardware solutions, and/or some combination of both hardware/software solutions. For example, EOOR features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the EOOR features. A hierarchy of programmable interconnects allow logic blocks to be interconnected as needed by the EOOR system designer/administrator, somewhat like a one-chip programmable breadboard. An FPGA's logic blocks can be programmed to perform the operation of basic logic gates such as AND, and XOR, or more complex combinational operators such as decoders or simple mathematical operations. In most FPGAs, the logic blocks also include memory elements, which may be circuit flip-flops or more complete blocks of memory. In some circumstances, the EOOR may be developed on regular FPGAs and then migrated into a fixed version that more resembles ASIC implementations. Alternate or coordinating implementations may migrate EOOR controller features to a final ASIC instead of or in addition to FPGAs. Depending on the implementation all of the aforementioned embedded components and microprocessors may be considered the “CPU” and/or “processor” for the EOOR.

### Power Source

The power source 7186 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 7186 is connected to at least one of the interconnected subsequent components of the EOOR thereby providing an electric current to all subsequent components. In one example, the power source 7186 is connected to the system bus component 7104. In an alternative embodiment, an outside power source 7186 is provided through a connection across the I/O 7108 interface. For example, a USB and/or IEEE 1394 connection carries both data and power across the connection and is therefore a suitable source of power.

### Interface Adapters

Interface bus(ses) 7107 may accept, connect, and/or communicate to a number of interface adapters, conventionally although not necessarily in the form of adapter cards, such as but not limited to: input output interfaces (I/O) 7108, storage interfaces 7109, network interfaces 7110, and/or the like. Optionally, cryptographic processor interfaces 7127 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 7109 may accept, communicate, and/or connect to a number of storage devices such as, but not limited to: storage devices 7114, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 7110 may accept, communicate, and/or connect to a communications network 7113. Through a communications network 7113, the EOOR controller is accessible through remote clients 7133b (e.g., computers with web browsers) by users 7133a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed EOOR), architectures may similarly be employed to pool, load balance, and/or otherwise increase the communicative bandwidth required by the EOOR controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 7110 may be used to engage with various communications network types 7113. For example, multiple network interfaces may be employed to allow for the communication over broadcast, multicast, and/or unicast networks.

Input Output interfaces (I/O) 7108 may accept, communicate, and/or connect to user input devices 7111, peripheral devices 7112, cryptographic processor devices 7128, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 7111 often are a type of peripheral device 7112 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 7112 may be connected and/or communicate to I/O and/or other facilities of the like such as network interfaces, storage interfaces, directly to the interface bus, system bus, the CPU, and/or the like. Peripheral devices may be external, internal and/or part of the EOOR controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 7128), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the EOOR controller may be embodied as an embedded, dedicated, and/or monitor-less (i.e., headless) device, wherein access would be provided over a network interface connection.

Cryptographic units such as, but not limited to, microcontrollers, processors 7126, interfaces 7127, and/or devices 7128 may be attached, and/or communicate with the EOOR controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 7129. However, memory is a fungible technology and resource, thus, any number of memory embodiments may be employed in lieu of or in concert with one another. It is to be understood that the EOOR controller and/or a computer systemization may employ various forms of memory 7129. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 7129 will include ROM 7106, RAM 7105, and a storage device 7114. A storage device 7114 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 7129 may contain a collection of program and/or database components and/or data such as, but not limited to: operating system component(s) 7115 (operating system); information server component(s) 7116 (information server); user interface component(s) 7117 (user interface); Web browser component(s) 7118 (Web browser); database(s) 7119; mail server component(s) 7121; mail client component(s) 7122; cryptographic server component(s) 7120 (cryptographic server); the EOOR component(s) 7135; and/or the like (i.e., collectively a component collection). These components may be stored and accessed from the storage devices and/or from storage devices accessible through an interface bus. Although non-conventional program components such as those in the component collection, typically, are stored in a local storage device 7114, they may also be loaded and/or stored in memory such as: peripheral devices, RAM, remote storage facilities through a communications network, ROM, various forms of memory, and/or the like.

### Operating System

The operating system component 7115 is an executable program component facilitating the operation of the EOOR controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the EOOR controller to communicate with other entities through a communications network 7113. Various communication protocols may be used by the EOOR controller as a subcarrier transport mechanism for interaction, such as, but not limited to: multicast, TCP/IP, UDP, unicast, and/or the like.

### Information Server

An information server component 7116 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the EOOR controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the EOOR database 7119, operating systems, other program components, user interfaces, Web browsers, and/or the like.

Access to the EOOR database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the EOOR. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the EOOR as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 7117 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 7118 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the EOOR enabled nodes. The combined application may be nugatory on systems employing standard Web browsers.

### Mail Server

A mail server component 7121 is a stored program component that is executed by a CPU 7103. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the EOOR.

Access to the EOOR mail may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component 7122 is a stored program component that is executed by a CPU 7103. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 7120 is a stored program component that is executed by a CPU 7103, cryptographic processor 7126, cryptographic processor interface 7127, cryptographic processor device 7128, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the EOOR may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the EOOR component to engage in secure transactions if so desired. The cryptographic component facilitates the secure accessing of resources on the EOOR and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The EOOR Database

The EOOR database component 7119 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the EOOR database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the EOOR database is implemented as a data-structure, the use of the EOOR database 7119 may be integrated into another component such as the EOOR component 7135. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 7119 includes several tables 7119a-r. A Users table 7119a may include fields such as, but not limited to: user_id, ssn, dob, first_name, last_name, age, state, address_firstline, address_secondline, zipcode, devices_list, contact_info, contact type, alt_contact_info, alt_contact type, and/or the like. The Users table may support and/or track multiple entity accounts on a EOOR. A Devices table 7119b may include fields such as, but not limited to: device_ID, device_name, device_IP, device_MAC, device_type, device_model, device_version, device_OS, device_apps_list, device_securekey, wallet_app_installed_flag, and/or the like. An Apps table 7119c may include fields such as, but not limited to: app_ID, app_name, app_type, app_dependencies, and/or the like. An Accounts table 7119d may include fields such as, but not limited to: account_number, account_security_code, account_name, issuer_acquirer_flag, issuer_name, acquirer_name, account_address, routing number, access_API_call, linked_wallets_list, and/or the like. A Merchants table 7119e may include fields such as, but not limited to: merchant_id, merchant_name, merchant_address, ip_address, mac_address, auth_key, port_num, security_settings_list, and/or the like. An Issuers table 7119f may include fields such as, but not limited to: issuer_id, issuer_name, issuer_address, ip_address, mac_address, auth_key, port_num, security_settings_list, and/or the like. An Acquirers table 7119g may include fields such as, but not limited to: account_firstname, account_lastname, account_type, account_num, account_balance_list, billingaddress_line1, billingaddress_line2, billing_zipcode, billing_state, shipping_preferences, shippingaddress_line1, shippingaddress_line2, shipping_zipcode, shipping_state, and/or the like. A Pay Gateways table 7119h may include fields such as, but not limited to: gateway_ID, gateway_IP, gateway_MAC, gateway_secure_key, gateway_access_list, gateway_API_call_list, gateway_services_list, and/or the like. A Transactions table 7119i may include fields such as, but not limited to: order_id, user_id, timestamp, transaction_cost, purchase_details_list, num_products, products_list, product_type, product_params_list, product_title, product_summary, quantity, user_id, client_id, client_ip, client_type, client_model, operating_system, os_version, app_installed_flag, user_id, account_firstname, account_lastname, account_type, account_num, account priority account_ratio, billingaddress_line1, billingaddress_line2, billing_zipcode, billing_state, shipping_preferences, shippingaddress_line1, shippingaddress_line2, shipping_zipcode, shipping_state, merchant_id, merchant_name, merchant_auth_key, and/or the like. A Batches table 7119j may include fields such as, but not limited to: batch_id, transaction_id_list, timestamp_list, cleared_flag_list, clearance_trigger_settings, and/or the like. A Ledgers table 7119k may include fields such as, but not limited to: request_id, timestamp, deposit_amount, batch_id, transaction_id, clear_flag, deposit_account, transaction_summary, payor_name, payor_account, and/or the like. A Products table 7119l may include fields such as, but not limited to: product_ID, product_title, product_attributes_list, product_price, tax_info_list, related_products_list, offers_list, discounts_list, rewards_list, merchants_list, merchant_availability_list, and/or the like. An Offers table 7119m may include fields such as, but not limited to: offer_ID, offer_title, offer_attributes_list, offer_price, offer_expiry, related_products_list, discounts_list, rewards_list, merchants_list, merchant_availability_list, and/or the like. A Behavior Data table 7119n may include fields such as, but not limited to: user_id, timestamp, activity_type, activity_location, activity attribute_list, activity_attribute_values_list, and/or the like. An Analytics table 71190 may include fields such as, but not limited to: report_id, user_id, report_type, report_algorithm_id, report_destination_address, and/or the like. A Market Data table 7119p may include fields such as, but not limited to: market_data_feed_ID, asset_ID, asset_symbol, asset_name, spot_price, bid_price, ask_price, and/or the like; in one embodiment, the market data table is populated through a market data feed (e.g., Bloomberg's PhatPipe, Dun & Bradstreet, Reuter's Tib, Triarch, etc.), for example, through Microsoft's Active Template Library and Dealing Object Technology's real-time toolkit Rtt.Multi. An Account/Offer Metadata table 7119q may include fileds such as, user_id, account_number, rewards_id, rewards_rules, purchase_details, order_id, coupon_ID, benefits_id, befenits_params, and/or the like. An illustrating example of the Account/offer Metadata table is provided in FIG. 6C. A Coupon/Rewards table 7119r may include fields such as, but not limited to: coupon_ID, coupon_title, coupon_attributes_list, coupon_price, coupon_expiry, related_products_list, discounts_list, rewards_list, merchants_list, merchant_availability_list, and/or the like.

In one embodiment, the EOOR database may interact with other database systems. For example, employing a distributed database system, queries and data access by search EOOR component may treat the combination of the EOOR database, an integrated data security layer database as a single database entity.

In one embodiment, user programs may contain various user interface primitives, which may serve to update the EOOR. Also, various accounts may require custom database tables depending upon the environments and the types of clients the EOOR may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 7119a-r. The EOOR may be configured to keep track of various settings, inputs, and parameters via database controllers.

The EOOR database may communicate to and/or with other components in a component collection, including itself, and/or facilities of the like. Most frequently, the EOOR database communicates with the EOOR component, other program components, and/or the like. The database may contain, retain, and provide information regarding other nodes and data.

### The EOORs

The EOOR component 7135 is a stored program component that is executed by a CPU. In one embodiment, the EOOR component incorporates any and/or all combinations of the aspects of the EOOR discussed in the previous figures. As such, the EOOR affects accessing, obtaining and the provision of information, services, transactions, and/or the like across various communications networks.

In one embodiment, the EOOR component may transform payment card information, user card selection preference, and purchase inputs via EOOR components into card addition completion, and purchase transactions using optimized payment card and coupon outputs outputs, and/or the like and use of the EOOR. In one embodiment, the EOOR component 7135 takes payment card information, user card selection preference, and purchase inputs and transforms the inputs via various components (e.g., Card Selector 7170; Offer Selector 7171; and/or the like), into card addition completion, and purchase transactions using optimized payment card and coupon outputs. The EOOR component may transform touchscreen inputs into a virtual wallet mobile application interface via EOOR components into purchase transaction triggers and receipt notices, and/or the like and use of the EOOR. In one embodiment, the EOOR component 7135 takes inputs (e.g., checkout request 6511; product data 6515; wallet access input 6711; transaction authorization input 6714; payment gateway address 6718; payment network address 6722; issuer server address(es) 6725; funds authorization request(s) 6726; user(s) account(s) data 6728; batch data 6912; payment network address 6916; issuer server address(es) 6924; individual payment request 6925; payment ledger, merchant account data 6931; and/or the like) etc., and transforms the inputs via various components (e.g., UPC 7141; PTA 7142; PTC 7143; STG 7144; EPGU 7145; EAA 7146; CEC 7147; ETC 7148; DFR 7149; ADRN 7150; VASE 7151; SDA 7152; TDA 7153; CTDA 7154; SRA 7155; UBA 7156; UBOR 7157; SPE 7158; SPT 7159; WSS 7160; SMCB 7161; VWSC 7162; ORE 7163; QRCP 7164; SMPE 7165; PCS 7166; UST 7167; STRS 7168; USTG 7169; and/or the like), into outputs (e.g., checkout request message 6513; checkout data 6517; card authorization request 6716, 6723; funds authorization response(s) 6730; transaction authorization response 6732; batch append data 6734; purchase receipt 6735; batch clearance request 6914; batch payment request 6918; transaction data 6920; individual payment confirmation 6928, 6929; updated payment ledger, merchant account data 6933; and/or the like).

The EOOR component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the EOOR server employs a cryptographic server to encrypt and decrypt communications. The EOOR component may communicate to and/or with other components in a component collection, including itself, and/or facilities of the like. Most frequently, the EOOR component communicates with the EOOR database, operating systems, other program components, and/or the like. The EOOR may contain, communicate, generate, obtain, and/or provide program component, system, user, and/or data communications, requests, and/or responses.

### Distributed EOORs

The structure and/or operation of any of the EOOR node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the EOOR controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the EOOR controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(‘Content-Type: text/plain’);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {
    $input = “”;
    $input = socket_read($client, 1024);
    $data .= $input;
} while($input != “”);
// parse data to extract variables
$obj = json_decode($data, true);
// store input data in a database
mysql_connect(“201.408.185.132”,$DBserver,$password); // access
database server
mysql_select(“CLIENT_DB.SQL”); // select database to append
mysql_query(“INSERT INTO UserTable (transmission)
VALUES ($data)”); // add data to UserTable table in a CLIENT database
mysql_close(“CLIENT_DB.SQL”); // close connection to database
?>
```

Also, the following resources may be used to provide example embodiments regarding SOAP parser implementation:
http://www.xav.com/perl/site/lib/SOAP/Parser.html
http://publib.boulder.ibm.com/infocenter/tivihelp/v2rl/index.jsp?topic=/com.ibm.IBMDI.doc/referenceguide295.htm

and other parser implementations:
http://publib.boulder.ibm.com/infocenter/tivihelp/v2rl/index.jsp?topic=/com.ibm.IBMDI.doc/referenceguide259. htm

all of which are hereby expressly incorporated by reference herein.

Additional embodiments of the EOOR may include:

1. An electronic offer optimization and redemption processor-implemented method embodiment transforming payment card information, user payment card selection preference, and purchase inputs into card addition completion, and purchase transactions using optimized payment card and coupon outputs, comprising:

receiving a purchase order request via a consumer wallet device;

determining a wallet account identifier from the purchase order request;

determining a merchant from the purchase order request;

retrieving a payment card identifier of at least one payment card associated with the wallet account identifier;

generating an offer data query on the payment card identifier;

executing the offer data query and retrieving offer data;

obtaining user payment card and offer selection preference data;

determining an optimized payment card selection, and an optimized offer from the retrieved offer data based on the user payment card and offer selection preference data; and

executing a payment transaction using the optimized payment card and offer selection in response to the purchase order request.

2. The method of embodiment 1, wherein the consumer wallet device comprises any of an electronic mobile wallet, a desktop application, a plug-in to existing applications, a standalone mobile application, a web based application, and a smart prepaid card.

3. The method of embodiment 1, wherein the purchase order request further comprises purchase item information and merchant information.

4. The method of embodiment 1, wherein the offer comprises any of mileage, cash backs, and purchase discounts.

5. The method of embodiment 1, wherein the offer is associated with a category of purchase item.

6. The method of embodiment 1, wherein the offer is associated with a merchant.

7. The method of embodiment 1, wherein the user payment card and offer selection preference data is specified by a user when adding the user payment card to the consumer wallet device.

8. The method of embodiment 1, wherein the user payment card and offer selection preference data comprises a user payment card and offer optimization mode indicator and a user payment card and offer optimization objective indicator.

9. The method of embodiment 8, wherein the user payment card and offer optimization mode indicator comprises any of: user manually specifying user payment card and offer selection, automatic payment card selection, automatic offer selection and automatic payment card and offer selection.

10. The method of embodiment 8, wherein the user payment card and offer optimization objective indicator indicates the user payment card and offer are selected for any of: maximizing an overall dollar savings;

maximizing an upfront dollar savings;

maximizing cash back dollar savings;

maximizing the rewards points;

providing lowest interest; and

providing best insurance terms.

11. The method of embodiment 1, wherein the user payment card and offer selection preference data further comprises:

using the payment card to purchase a preferred product category.

12. The method of embodiment 1, wherein the user payment card and offer selection preference data further comprises user payment card usage controls, including any of:

a spend range;

a usage proximity requirement;

a usage geographical requirement;

a usage frequency range; and

an overall spend limit.

13. The method of embodiment 1, wherein the user payment card and offer selection preference data is specified by a user to apply to multiple user payment cards.

14. The method of embodiment 1, wherein the determining an optimized payment card and offer selection based on the user payment card and offer selection preference data further comprises:

determining the payment card has a sufficient balance.

15. The method of embodiment 1, wherein the determining an optimized payment card and offer selection based on the user payment card and offer selection preference data further comprises:

comparing benefits of each payment card;

sorting payment cards in the order of benefits; and

selecting the optimized payment card that maximizes user desired benefits.

16. The method of embodiment 1, further comprising:

receiving an image of merchant-specific customer information on a customer card; and
performing an optical character recognition process on the image to produce searchable data.

17. The method of embodiment 16, further comprising:

automatically parsing the searchable data and adding the information to a secure virtual wallet profile for the customer stored in a payment network database.

18. The method of embodiment 16, further comprising:

automatically applying the merchant-specific customer information to effectuate any applicable discounts at a point-of-sale terminal for a merchant based on the merchant-specific customer information.

19. The method of embodiment 16, further comprising:

automatically detecting a location of the consumer wallet device being used by the user and determining an identity of a merchant at the location.

20. The method of embodiment 16, further comprising:

automatically searching a designated email account for additional discounts to be applied to the customer's purchase at the point of sale.

21. An electronic offer optimization and redemption system embodiment, comprising:

means for receiving a purchase order request via a consumer wallet device;

means for determining a wallet account identifier from the purchase order request;

means for determining a merchant from the purchase order request;

means for retrieving a payment card identifier of at least one payment card associated with the wallet account identifier;

means for generating an offer data query on the payment card identifier;

means for executing the offer data query and retrieving offer data;

means for obtaining user payment card and offer selection preference data;

means for determining an optimized payment card selection, and an optimized offer from the retrieved offer data based on the user payment card and offer selection preference data; and

means for executing a payment transaction using the optimized payment card and offer selection in response to the purchase order request.

22. The system of embodiment 21, wherein the consumer wallet device comprises any of an electronic mobile wallet, a desktop application, a plug-in to existing applications, a standalone mobile application, a web based application, and a smart prepaid card.

23. The system of embodiment 21, wherein the purchase order request further comprises purchase item information and merchant information.

24. The system of embodiment 21, wherein the offer comprises any of mileage, cash backs, and purchase discounts.

25. The system of embodiment 21, wherein the offer is associated with a category of purchase item.

26. The system of embodiment 21, wherein the offer is associated with a merchant.

27. The system of embodiment 21, wherein the user payment card and offer selection preference data is specified by a user when adding the user payment card to the consumer wallet device.

28. The system of embodiment 21, wherein the user payment card and offer selection preference data comprises a user payment card and offer optimization mode indicator and a user payment card and offer optimization objective indicator.

29. The system of embodiment 28, wherein the user payment card and offer optimization mode indicator comprises any of: user manually specifying user payment card and offer selection, automatic payment card selection, automatic offer selection and automatic payment card and offer selection.

30. The system of embodiment 28, wherein the user payment card and offer optimization objective indicator indicates the user payment card and offer are selected for any of: maximizing an overall dollar savings;

maximizing an upfront dollar savings;

maximizing cash back dollar savings;

maximizing the rewards points;

providing lowest interest; and

providing best insurance terms.

31. The system of embodiment 21, wherein the user payment card and offer selection preference data further comprises:

using the payment card to purchase a preferred product category.

32. The system of embodiment 21, wherein the user payment card and offer selection preference data further comprises user payment card usage controls, including any of:

a spend range;

a usage proximity requirement;

a usage geographical requirement;

a usage frequency range; and

an overall spend limit.

33. The system of embodiment 21, wherein the user payment card and offer selection preference data is specified by a user to apply to multiple user payment cards.

34. The system of embodiment 21, wherein the determining an optimized payment card and offer selection based on the user payment card and offer selection preference data further comprises:

determining the payment card has a sufficient balance.

35. The system of embodiment 21, wherein the determining an optimized payment card and offer selection based on the user payment card and offer selection preference data further comprises:

comparing benefits of each payment card;

sorting payment cards in the order of benefits; and

selecting the optimized payment card that maximizes user desired benefits.

36. The system of embodiment 21, further comprising:

means for receiving an image of merchant-specific customer information on a customer card; and

means for performing an optical character recognition process on the image to produce searchable data.

37. The system of embodiment 36, further comprising:

means for automatically parsing the searchable data and adding the information to a secure virtual wallet profile for the customer stored in a payment network database.

38. The system of embodiment 36, further comprising:

automatically applying the merchant-specific customer information to effectuate any applicable discounts at a point-of-sale terminal for a merchant based on the merchant-specific customer information.

39. The system of embodiment 36, further comprising:

means for automatically detecting a location of the consumer wallet device being used by the user and determining an identity of a merchant at the location.

40. The system of embodiment 36, further comprising:

means for automatically searching a designated email account for additional discounts to be applied to the customer's purchase at the point of sale.

41. An electronic offer optimization and redemption apparatus embodiment, comprising:

a processor; and

a memory disposed in communication with the processor and storing processor-executable instructions to:

receive a purchase order request via a consumer wallet device;

determine a wallet account identifier from the purchase order request;

determine a merchant from the purchase order request;

retrieve a payment card identifier of at least one payment card associated with the wallet account identifier;

generate an offer data query on the payment card identifier;

execute the offer data query and retrieving offer data;

obtain user payment card and offer selection preference data;

determine an optimized payment card selection, and an optimized offer from the retrieved offer data based on the user payment card and offer selection preference data; and

execute a payment transaction using the optimized payment card and offer selection in response to the purchase order request.

42. The apparatus of embodiment 41, wherein the consumer wallet device comprises any of an electronic mobile wallet, a desktop application, a plug-in to existing applications, a standalone mobile application, a web based application, and a smart prepaid card.

43. The apparatus of embodiment 41, wherein the purchase order request further comprises purchase item information and merchant information.

44. The apparatus of embodiment 41, wherein the offer comprises any of mileage, cash backs, and purchase discounts.

45. The apparatus of embodiment 41, wherein the offer is associated with a category of purchase item.

46. The apparatus of embodiment 41, wherein the offer is associated with a merchant.

47. The apparatus of embodiment 41, wherein the user payment card and offer selection preference data is specified by a user when adding the user payment card to the consumer wallet device.

48. The apparatus of embodiment 41, wherein the user payment card and offer selection preference data comprises a user payment card and offer optimization mode indicator and a user payment card and offer optimization objective indicator.

49. The apparatus of embodiment 48, wherein the user payment card and offer optimization mode indicator comprises any of: user manually specifying user payment card and offer selection, automatic payment card selection, automatic offer selection and automatic payment card and offer selection.

50. The apparatus of embodiment 48, wherein the user payment card and offer optimization objective indicator indicates the user payment card and offer are selected for any of: maximizing an overall dollar savings;

maximizing an upfront dollar savings;

maximizing cash back dollar savings;

maximizing the rewards points;

providing lowest interest; and

providing best insurance terms.

51. The apparatus of embodiment 41, wherein the user payment card and offer selection preference data further comprises:

using the payment card to purchase a preferred product category.

52. The apparatus of embodiment 41, wherein the user payment card and offer selection preference data further comprises user payment card usage controls, including any of:

a spend range;

a usage proximity requirement;

a usage geographical requirement;

a usage frequency range; and

an overall spend limit.

53. The apparatus of embodiment 41, wherein the user payment card and offer selection preference data is specified by a user to apply to multiple user payment cards.

54. The apparatus of embodiment 41, wherein the determining an optimized payment card and offer selection based on the user payment card and offer selection preference data further comprises:

determining the payment card has a sufficient balance.

55. The apparatus of embodiment 41, wherein the determining an optimized payment card and offer selection based on the user payment card and offer selection preference data further comprises:

comparing benefits of each payment card;

sorting payment cards in the order of benefits; and

selecting the optimized payment card that maximizes user desired benefits.

56. The apparatus of embodiment 41, wherein the processor further issues instructions to:

receive an image of merchant-specific customer information on a customer card; and

perform an optical character recognition process on the image to produce searchable data.

57. The apparatus of embodiment 56, wherein the processor further issues instructions to:

automatically parse the searchable data and adding the information to a secure virtual wallet profile for the customer stored in a payment network database.

58. The apparatus of embodiment 56, wherein the processor further issues instructions to:

automatically apply the merchant-specific customer information to effectuate any applicable discounts at a point-of-sale terminal for a merchant based on the merchant-specific customer information.

59. The apparatus of embodiment 56, wherein the processor further issues instructions to:

automatically detect a location of the consumer wallet device being used by the user and determining an identity of a merchant at the location.

60. The apparatus of embodiment 56, wherein the processor further issues instructions to:

automatically search a designated email account for additional discounts to be applied to the customer's purchase at the point of sale.

61. An electronic offer optimization and redemption processor-readable non-transitory medium embodiment storing processor-executable instructions issuable by a processor to:

receive a purchase order request via a consumer wallet device;

determine a wallet account identifier from the purchase order request;

determine a merchant from the purchase order request;

retrieve a payment card identifier of at least one payment card associated with the wallet account identifier;

generate an offer data query on the payment card identifier;

execute the offer data query and retrieving offer data;

obtain user payment card and offer selection preference data;

determine an optimized payment card selection, and an optimized offer from the retrieved offer data based on the user payment card and offer selection preference data; and

execute a payment transaction using the optimized payment card and offer selection in response to the purchase order request.

62. The medium of embodiment 61, wherein the consumer wallet device comprises any of an electronic mobile wallet, a desktop application, a plug-in to existing applications, a standalone mobile application, a web based application, and a smart prepaid card.

63. The medium of embodiment 61, wherein the purchase order request further comprises purchase item information and merchant information.

64. The medium of embodiment 61, wherein the offer comprises any of mileage, cash backs, and purchase discounts.

65. The medium of embodiment 61, wherein the offer is associated with a category of purchase item.

66. The medium of embodiment 61, wherein the offer is associated with a merchant.

67. The medium of embodiment 61, wherein the user payment card and offer selection preference data is specified by a user when adding the user payment card to the consumer wallet device.

68. The medium of embodiment 61, wherein the user payment card and offer selection preference data comprises a user payment card and offer optimization mode indicator and a user payment card and offer optimization objective indicator.

69. The medium of embodiment 68, wherein the user payment card and offer optimization mode indicator comprises any of: user manually specifying user payment card and offer selection, automatic payment card selection, automatic offer selection and automatic payment card and offer selection.

70. The medium of embodiment 68, wherein the user payment card and offer optimization objective indicator indicates the user payment card and offer are selected for any of: maximizing an overall dollar savings;

maximizing an upfront dollar savings;

maximizing cash back dollar savings;

maximizing the rewards points;

providing lowest interest; and

providing best insurance terms.

71. The medium of embodiment 61, wherein the user payment card and offer selection preference data further comprises:

using the payment card to purchase a preferred product category.

72. The medium of embodiment 61, wherein the user payment card and offer selection preference data further comprises user payment card usage controls, including any of:

a spend range;

a usage proximity requirement;

a usage geographical requirement;

a usage frequency range; and

an overall spend limit.

73. The medium of embodiment 61, wherein the user payment card and offer selection preference data is specified by a user to apply to multiple user payment cards.

74. The medium of embodiment 61, wherein the determining an optimized payment card and offer selection based on the user payment card and offer selection preference data further comprises:

determining the payment card has a sufficient balance.

75. The medium of embodiment 61, wherein the determining an optimized payment card and offer selection based on the user payment card and offer selection preference data further comprises:

comparing benefits of each payment card;

sorting payment cards in the order of benefits; and

selecting the optimized payment card that maximizes user desired benefits.

76. The medium of embodiment 61, further storing processor-executable instructions issuable by the processor to:

receive an image of merchant-specific customer information on a customer card; and

perform an optical character recognition process on the image to produce searchable data.

77. The medium of embodiment 76, further storing processor-executable instructions issuable by the processor to:

automatically parse the searchable data and adding the information to a secure virtual wallet profile for the customer stored in a payment network database.

78. The medium of embodiment 76, further storing processor-executable instructions issuable by the processor to:

automatically apply the merchant-specific customer information to effectuate any applicable discounts at a point-of-sale terminal for a merchant based on the merchant-specific customer information.

79. The medium of embodiment 76, further storing processor-executable instructions issuable by the processor to:

automatically detect a location of the consumer wallet device being used by the user and determining an identity of a merchant at the location.

80. The medium of embodiment 76, further storing processor-executable instructions issuable by the processor to:

automatically search a designated email account for additional discounts to be applied to the customer's purchase at the point of sale.

81. An electronic offer optimization and redemption processor-implemented method embodiment of transforming an image of a customer card into searchable customer information stored in a pay network database, the method comprising:

receiving, via a mobile device of a customer, an image of customer information on a customer card;

performing an optical character recognition procedure on the image to produce searchable data; and

automatically parsing the searchable data and adding the information to a secure virtual wallet profile for the customer stored in a payment network database; and

transmitting the secure virtual wallet profile for the customer from the payment network database to a point-of-sale device for a merchant.

82. The processor-implemented method of embodiment 81, further comprising automatically detecting the location of a mobile device being used by the customer and determining the identity of the merchant at that location.

83. The processor-implemented method of embodiment 81, further comprising automatically searching a designated email account for additional discounts to be applied to the customer's purchase at the point of sale.

84. The processor-implemented method of embodiment 81, further comprising automatically searching publicly available network sources for additional discounts to be applied at the point of sale.

85. The processor-implemented method of embodiment 81, wherein the searchable data comprises any of:

a card number; and

a customer name.

86. The processor-implemented method of embodiment 81, wherein the customer card is added to the virtual wallet profile based on the searchable data.

87. The processor-implemented method of embodiment 81, further comprising:

automatically applying the merchant-specific customer information to effectuate any applicable discounts at the point-of-sale terminal for the merchant based on the merchant-specific customer information.

88. The processor-implemented method of embodiment 81, further comprising:

receiving a payment authorization request at a payment network using product information obtained from the merchant, merchant information, and the secure digital wallet profile for the customer.

89. The processor-implemented method of embodiment 81, further comprising:

automatically search a designated email account for additional discounts to be applied to the customer's purchase at the point of sale.

90. The processor-implemented method of embodiment 81, further comprising:

automatically detect a location of the consumer wallet device being used by the user and determining an identity of a merchant at the location.

91. An electronic offer optimization and redemption processor-implemented method embodiment of transforming an image of a customer card into a discount applicable at the point of sale, the method comprising:

receiving, via a mobile device of a customer, an image of merchant-specific customer information on a customer card;

automatically parsing the merchant-specific customer information shown on the customer card and adding the information to a secure virtual wallet profile for the customer stored in a payment network database;

transmitting the secure virtual wallet profile for the customer from the payment network database to a point-of-sale device for a merchant;

automatically applying the merchant-specific customer information to effectuate any applicable discounts at the point-of-sale terminal for the merchant based on the merchant-specific customer information;

receiving a payment authorization request at a payment network using product information obtained from the merchant, merchant information, and the secure digital wallet profile for the customer; and

sending a purchase receipt confirming processing of the transaction at the merchant by the customer.

In order to address various issues and advance the art, the entirety of this application for ELECTRONIC OFFER OPTIMIZATION AND REDEMPTION APPARATUSES, METHODS AND SYSTEMS (including the Cover Page, Title, Headings, Field, Background, Summary, Brief Description of the Drawings, Detailed Description, Claims, Abstract, Figures, Appendices and/or otherwise) shows by way of illustration various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations, including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a EOOR individual and/or enterprise user, database configuration and/or relational model, data type, data transmission and/or network framework, syntax structure, and/or the like, various embodiments of the EOOR may be implemented that enable a great deal of flexibility and customization. For example, aspects of the EOOR may be adapted for financial trading; operations security; resource management; and/or the like. While various embodiments and discussions of the EOOR have been directed to electronic commerce, however, it is to be understood that the embodiments described herein may be readily configured and/or customized for a wide variety of other applications and/or implementations.

What is claimed is:

1. An electronic offer optimization and redemption processor-implemented method transforming payment card information, user payment card selection preference, and purchase inputs into card addition completion, and purchase transactions using optimized payment card and coupon outputs, comprising:
receiving a purchase order request via a consumer wallet device;
determining a wallet account identifier from the purchase order request;
determining a merchant from the purchase order request;
retrieving a payment card identifier of at least one payment card associated with the wallet account identifier;
generating an offer data query on the payment card identifier;
executing the offer data query and retrieving offer data;
obtaining user payment card and offer selection preference data;
determining an optimized payment card selection, and an optimized offer from the retrieved offer data based on the user payment card and offer selection preference data; and
executing a payment transaction using the optimized payment card and offer selection in response to the purchase order request.

2. The method of claim 1, wherein the consumer wallet device comprises any of an electronic mobile wallet, a desktop application, a plug-in to existing applications, a standalone mobile application, a web based application, and a smart prepaid card.

3. The method of claim 1, wherein the purchase order request further comprises purchase item information and merchant information.

4. The method of claim 1, wherein the offer comprises any of mileage, cash backs, and purchase discounts.

5. The method of claim 1, wherein the offer is associated with a category of purchase item.

6. The method of claim 1, wherein the offer is associated with a merchant.

7. The method of claim 1, wherein the user payment card and offer selection preference data is specified by a user when adding the user payment card to the consumer wallet device.

8. The method of claim 1, wherein the user payment card and offer selection preference data comprises a user payment card and offer optimization mode indicator and a user payment card and offer optimization objective indicator.

9. The method of claim 8, wherein the user payment card and offer optimization mode indicator comprises any of: user manually specifying user payment card and offer selection, automatic payment card selection, automatic offer selection and automatic payment card and offer selection.

10. The method of claim 8, wherein the user payment card and offer optimization objective indicator indicates the user payment card and offer are selected for any of: maximizing an overall dollar savings;
maximizing an upfront dollar savings;
maximizing cash back dollar savings;
maximizing the rewards points;
providing lowest interest; and
providing best insurance terms.

11. The method of claim 1, wherein the user payment card and offer selection preference data further comprises:
using the payment card to purchase a preferred product category.

12. The method of claim 1, wherein the user payment card and offer selection preference data further comprises user payment card usage controls, including any of:
a spend range;
a usage proximity requirement;
a usage geographical requirement;
a usage frequency range; and
an overall spend limit.

13. The method of claim 1, wherein the user payment card and offer selection preference data is specified by a user to apply to multiple user payment cards.

14. The method of claim 1, wherein the determining an optimized payment card and offer selection based on the user payment card and offer selection preference data further comprises:
determining the payment card has a sufficient balance.

15. The method of claim 1, wherein the determining an optimized payment card and offer selection based on the user payment card and offer selection preference data further comprises:
comparing benefits of each payment card;
sorting payment cards in the order of benefits; and
selecting the optimized payment card that maximizes user desired benefits.

16. The method of claim 1, further comprising:
receiving an image of merchant-specific customer information on a customer card; and
performing an optical character recognition process on the image to produce searchable data.

17. The method of claim 16, further comprising:
automatically parsing the searchable data and adding the information to a secure virtual wallet profile for the customer stored in a payment network database.

18. The method of claim 16, further comprising:
automatically applying the merchant-specific customer information to effectuate any applicable discounts at a point-of-sale terminal for a merchant based on the merchant-specific customer information.

19. An electronic offer optimization and redemption apparatus, comprising:
a processor; and
a memory disposed in communication with the processor and storing processor-executable instructions to:
receive a purchase order request via a consumer wallet device;
determine a wallet account identifier from the purchase order request;
determine a merchant from the purchase order request;
retrieve a payment card identifier of at least one payment card associated with the wallet account identifier;
generate an offer data query on the payment card identifier;
execute the offer data query and retrieving offer data;
obtain user payment card and offer selection preference data;
determine an optimized payment card selection, and an optimized offer from the retrieved offer data based on the user payment card and offer selection preference data; and
execute a payment transaction using the optimized payment card and offer selection in response to the purchase order request.

20. An electronic offer optimization and redemption processor-readable non-transitory medium storing processor-executable instructions issuable by a processor to:
receive a purchase order request via a consumer wallet device;
determine a wallet account identifier from the purchase order request;
determine a merchant from the purchase order request;
retrieve a payment card identifier of at least one payment card associated with the wallet account identifier;
generate an offer data query on the payment card identifier;
execute the offer data query and retrieving offer data;
obtain user payment card and offer selection preference data;
determine an optimized payment card selection, and an optimized offer from the retrieved offer data based on the user payment card and offer selection preference data; and
execute a payment transaction using the optimized payment card and offer selection in response to the purchase order request.
